(19) United States
(12) Patent Application Publication
(10) Pub. No.: US 2024/0253123 A1
(43) Pub. Date: Aug. 1, 2024

(54) SKILLFULL ADDITIVE MANUFACTURING

(71) Applicant: Velo3D, Inc., Fremont, CA (US)

(72) Inventors: Abraham SALDIVAR VALDES, Menlo Park, CA (US); Joseph Andrew TRALONGO, El Cajon, CA (US); Gregory Ferguson BROWN, San Jose, CA (US); Benyamin BULLER, Cupertino, CA (US); Erel MILSHTEIN, Morgan Hill, CA (US); Tasso LAPPAS, Pasadena, CA (US); Thomas BREZOCZKY, Los Gatos, CA (US); Kimon SYMEONIDIS, Easton, PA (US); Sherman SEELINGER, Afton, WY (US); Rueben MENDELSBERG, Hawthorne, CA (US); Daniel CHRISTIANSEN, Mountain View, CA (US); Zachary Ryan MURPHREE, San Jose, CA (US); Alan Rick LAPPEN, Rio Rancho, NM (US)

(21) Appl. No.: 18/620,085

(22) Filed: Mar. 28, 2024

Related U.S. Application Data
(63) Continuation of application No. PCT/US22/51107, filed on Nov. 28, 2022.
(60) Provisional application No. 63/290,281, filed on Dec. 16, 2021.
(60) Provisional application No. 63/427,700, filed on Nov. 23, 2022.

(51) Int. Cl. B22F 10/28; B22F 10/30; B33Y 30/00; B33Y 50/02

(52) U.S. Cl. CPC B22F 10/28; B22F 10/30; B33Y 30/00; B33Y 50/02

(57) ABSTRACT

The present disclosure various apparatuses, and systems for 3D printing. The present disclosure provides three-dimensional (3D) printing methods, apparatuses, software, and systems for a step and repeat energy irradiation process; controlling material characteristics and/or deformation of the 3D object; reducing deformation in a printed 3D object; and planarizing a material bed including usage of a non-contact material removal mechanism.

### PRIORITY APPLICATIONS

This application claims priority from prior-filed International Patent Application Serial No. PCT/US22/51107 filed Nov. 28, 2022, which claims priority from U.S. Provisional patent application Ser. No. 63/290,281 filed on Dec. 16, 2021, and from U.S. Provisional patent application Ser. No. 63/427,700 filed on Nov. 23, 2022, each of which is entirely incorporated herein by reference.

### BACKGROUND

Three-dimensional (3D) printing (e.g., additive manufacturing) is a process for making a three-dimensional (3D) object of any shape from a design. The design may be in the form of a data source such as an electronic data source, hard copy, or physical structure (e.g., physical model). The hard copy may be a two-dimensional representation of a 3D object. The data source may be an electronic 3D model. 3D printing may be accomplished through an additive process in which successive layers of material are laid down one on top of each other to form a layered 3D object (e.g., of hardened material). This process may be controlled (e.g., computer controlled, and/or manually controlled). For example, a 3D printer can be an industrial robot.

3D printing can generate custom parts quickly and efficiently. A variety of materials can be used in a 3D printing process including elemental metal, metal alloy, ceramic, elemental carbon, or a polymeric material. In a typical additive 3D printing process, a first material-layer is formed, and thereafter, successive material-layers (or parts thereof) are added one by one, wherein each new material-layer is added on a pre-formed material-layer, until the entire designed three-dimensional structure (3D object) is materialized.

3D models may be created utilizing a computer aided design package or via 3D scanner. The manual modeling process of preparing geometric data for 3D computer graphics may be similar to plastic arts, such as sculpting or animating. 3D scanning is a process of analyzing and collecting digital data on the shape (e.g., and appearance) of a real object. Based on this data, 3D models of the scanned object can be produced. The 3D models may include computer-aided design (CAD).

Various additive processes are currently available. They may differ in the manner layers are deposited to create the materialized structure. They may vary in the material or materials that are used to generate the designed structure. Some methods melt or soften material to produce the layers.

At times, the printed three-dimensional (3D) object may bend, warp, roll, curl, or otherwise deform during and/or after the 3D printing process. Auxiliary supports may be inserted to circumvent such deformation. These auxiliary supports may be subsequently removed from the printed 3D object to produce a requested 3D product (e.g., 3D object). The presence of auxiliary supports may increase the cost and/or time required to manufacture the 3D object. At times, the requirement for the presence of auxiliary supports hinders (e.g., prevent) formation of a requested 3D object. For example, the presence of auxiliary support may hinder formation of certain hanging structures (e.g., ledges) and/or cavities as part of the requested 3D object. The requirement for the presence of auxiliary supports may place constraints on the design of 3D objects, and/or on their respective materialization.

The 3D printing process includes layerwise formation of the 3D object. This entails at times deposition of a material bed layerwise, e.g., by a layer dispensing mechanism. At times, portion of the 3D object that deforms (e.g., bend, warp, roll, and/or curl) penetrates the exposed surface of the material bed to such an extent that may cause damage to the end of the layer dispensing mechanism (e.g., a leveling mechanism thereof) facing the exposed surface of the material bed. At times, there may be variations in the amounts of material bed spread and/or removed by the layer dispensing mechanism, e.g., due to variability in temperature of the material bed and/or of various portions of the material bed.

### SUMMARY

In some aspects, the present disclosure delineates methods, systems, devices, apparatuses, and/or software that alleviate the above hardships.

In some aspects, the inventions in the present disclosure facilitate the generation of 3D objects with a reduced degree of deformation. In some embodiments, the inventions in the present disclosure facilitate the generation of 3D objects that are fabricated with diminished number (e.g., absence) of auxiliary supports (e.g., without auxiliary supports). In some embodiments, the inventions in the present disclosure facilitate generation of 3D objects with diminished amount of design and/or fabrication constraints (referred to herein as “constraint-less 3D object”). In some embodiments, a layer forming the 3D object is fabricated using large tiles. The tiles may be formed by hatching the tile interior with a small diameter energy beam (e.g., scanning energy beam). The tiles may be formed by irradiating a (e.g., substantially) stationary large diameter energy beam (e.g., tiling energy flux). The tiles may be formed with a low power energy beam that, in some examples, penetrates a portion of a previously formed 3D object layers (e.g., that is disposed below the irradiated portion), and allows these layers to reach an elevated temperature (i) above the solidus temperature and below the liquidus temperature of the bottom skin layer material (e.g., at the liquefying temperature), or (ii) at which a material in the bottom skin layer plastically yields. For example, the previously formed layer can be a bottom skin layer of the entire 3D object, of a hanging structure of the 3D object, or of a crevice ceiling within the 3D object. The energy beam forming the tile can be a defocused beam. The present disclosure delineates methods for forming such a beam using an optical diffuser.

In some aspects disclosed herein are various portions of a layer dispensing mechanism that overcome some of the hardships relating to dispensing a planar layer of material to form an exposed surface of a material bed, e.g., with increased consistency and/or increased efficiency. The layer dispensing mechanism may comprise, or may exclude, a material removal mechanism.

In an aspect disclosed herein are methods, systems, software, and/or apparatuses for generating a 3D object with a reduced degree of deformation, e.g., (e.g., substantially) non-deformed. The 3D object can be devoid of one or more auxiliary supports. The 3D object can be devoid of a mark indicating the prior presence of one or more auxiliary supports. The 3D object can be an extensive 3D object. The 3D object can be a large 3D object. The 3D object may comprise a large hanging structure (e.g., wire, ledge, or shelf). Large may be a 3D object having a fundamental length scale (FLS) of at least about 10 centimeters.

Sometimes, it is requested to control the microstructure of a 3D object to form a specific type of a microstructure (e.g., in at least a portion of the 3D object). Occasionally, it is requested to fabricate a 3D object with varied materials and/or material microstructures in one or more (e.g., specific) portions of the 3D object. For example, there may be a requirement for a motor comprising a dense center, and porous blades. The present disclosure describes formation of such requested 3D object(s). In some instances, it is requested to control the way in which at least a portion of a layer of hardened material is formed (e.g., which may affect the material properties of that portion). The layer of hardened material may comprise at least one melt pool. In some instances, it may be requested to control one or more characteristics of that melt pool.

In some instances, the 3D object deforms during the 3D printing process, and protrudes from the material bed. Such phenomenon may make it difficult to form a 3D object that will adhere the customer requests. Such phenomenon may also burden the deposition and/or leveling of a planarized layer of pre-transformed (e.g., particulate) material. The present disclosure delineates methods and apparatuses that cope with a protruding object from an exposed surface of a material bed. For example, by using a material removal member that planarizes the exposed surface material bed without contacting it, for example, using a force that directs (e.g., attracts and/or maneuvers) the pre-transformed material and/or debris away from the target surface.

At times, it is requested to remove any remainder of the material bed that did not form the 3D object, from the printed 3D object, under the same atmosphere in which it was printed. For example, when the pre-transformed material is sensitive to oxygen and/or water and/or otherwise highly reactive in the ambient environment. The present disclosure delineates methods and apparatuses that allow cleaning of the 3D object from a material be remainder in the same environment in which the 3D object is formed.

In another aspect, a method for printing a three-dimensional object comprises: (a) providing a material bed comprising a pre-transformed material; (b) irradiating an exposed surface of the material bed using an energy beam directed at a first position of the exposed surface that is (e.g., substantially) stationary during a first time-period of at least one millisecond, to transform the pre-transformed material at the first position to a transformed material to form a first tile; (c) translating the energy beam to a second position of the exposed surface, which second position is different from the first position, wherein the energy beam is translated without transforming the pre-transformed material; and (d) irradiating the exposed surface of the material bed at the second position with the energy beam that is (e.g., substantially) stationary at the second position during a second time-period, to transform the pre-transformed material at the second position to a transformed material to form a second tile. In some embodiments, the second time-period is of at least about one millisecond. In some embodiments, the method comprises altering the beam profile. In some embodiments, the energy beam has a beam profile that is altered at least one time during the printing, e.g., during printing of a layer of transformed material as part of a 3D object. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the energy beam has a power density of at most about 8000 Watts per millimeter squared*W/mm²), or 6000 W/mm². In some embodiments, the energy beam is a defocused energy beam. In some embodiments, the diameter of the defocused energy beam is at least about 300 micrometers. In some embodiments, the power density is at most 5000 W/mm². In some embodiments, the first time-period is (e.g., substantially) equal to the second time-period. In some embodiments, the energy beam translates within a third time-period of at least about 1 millisecond. In some embodiments, a distance between the first position and the second position is at least 100 micrometers. In some embodiments, the second tile at least contacts the first tile. In some embodiments, the second tile at least partially overlaps the first tile. In some embodiments, the overlap is by at least about 40%. In some embodiments, the overlap is any value of the horizontal cross section overlap disclosed herein. In some embodiments, the first time-period is at least about one millisecond (msec), 10 msec, 50 msec, 250 msec, or 500 msec. In some embodiments, the first time-period is (e.g., substantially) equal to the second time-period. In some embodiments, the first time-period is at least about one millisecond (msec). In some embodiments, the energy beam is translated during a third time-period of at least about 1 msec, 10 msec, 50 msec, 250 msec, or 500 msec. In some embodiments, the cross section of the energy beam is at least about 0.1 millimeter squared (mm²), or 0.2. In some embodiments, the diameter of the energy beam is at least about 300 micrometers. In some embodiments, the distance between the first position and the second position is at least about 100 micrometers, 200 micrometers, or 250 micrometers. In some embodiments, the horizontal cross section of the second tile at least contacts the horizontal cross section of the first tile. In some embodiments, contact comprises overlap. In some embodiments, the horizontal cross section of the second tile at least partially overlaps the horizontal cross section of the first tile. In some embodiments, the second tile overlaps at least about 40% of the first tile. In some embodiments, the horizontal cross section of the second tile is (e.g., completely) overlap the horizontal cross section of the first tile by at least about 40%. In some embodiments, the method further comprises dispensing a layer of the pre-transformed material by removing an excess of pre-transformed material from the exposed surface of the material bed (e.g., by using a gas flow and optionally (e.g., cyclonically) separating the pre-transformed material from the gas flow). In some embodiments, the second tile at least contacts the first tile. In some embodiments, the second tile at least partially overlaps the first tile. In some embodiments, the overlap is by at least about 40%. In some embodiments, the overlap can be any value of the horizontal cross section overlap mentioned herein. In some embodiments, the method further comprises generating the material bed at least in part by using a layer dispensing mechanism comprising a material removal mechanism, e.g., a material remover. In some embodiments, the material remover is operatively coupled to an attractive force, e.g., vacuum source. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side (e.g., comprising a leading edge) promotes attraction of the pre-transformed material from the material bed and into the channel of the nozzle, the surface facing the material bed. In some embodiments, a shape of a surface of the tailing side (e.g., comprising a tailing edge) minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement. In some embodiments, the pre-transformed material comprises elemental metal, metal alloy, ceramic, and an allotrope of elemental carbon. In some embodiments, transform comprises fuse. In some embodiments, fuse comprises sinter or melt. In some embodiments, melt comprises completely melt. In some embodiments, the 3D printing is at an ambient pressure external to the 3D printer. In some embodiments, the 3D printing is at an atmospheric pressure (e.g., a pressure of about 1 atmosphere). In some embodiments, the 3D printing is at an ambient temperature. In some embodiments, the 3D printing is at room temperature. In some embodiments, the 3D printing comprises additive manufacturing. In some embodiments, the energy beam is a diffused energy beam. In some embodiments, the method further comprises (e.g., after operation (a)) directing the energy beam to an optical diffuser to generate a diffused energy beam. In some embodiments, the optical diffuser distorts the wave front of the energy beam. In some embodiments, the optical diffuser comprises a micro lens (e.g., array) or a digital mask. In some embodiments, the optical diffuser is included in a diffuser wheel. In some embodiments, a distance between the first position and the second position is at least about 100 micrometers. In some embodiments, the second tile at least contacts (e.g., or overlaps) the first tile. In some embodiments, the second tile at least partially overlaps the first tile. In some embodiments, the overlap is by at least about 40%. In some embodiments, the overlap is any value of the horizontal cross section overlap disclosed herein. In some embodiments, the first time-period is at least about one millisecond (msec), 10 msec, 50 msec, 250 msec, or 500 msec.

In another aspect, a system for printing a three-dimensional object comprises: a container configured to enclose a material bed comprising an exposed surface and a pre-transformed material; an energy source configured to generate an energy beam that transforms at least a portion of the exposed surface to a transformed material as part of the three-dimensional object, wherein the energy source is disposed adjacent to the material bed; and one or more controllers operatively coupled to the material bed, and the energy source, which one or more controllers direct the energy beam to: (i) irradiate the exposed surface of the material bed at a first position that is (e.g., substantially) stationary during a first time-period that is at least one millisecond and transform the pre-transformed material in the first position to a transformed material to form a first tile, (ii) translate the energy beam to a second position in the exposed surface, which second position is different from the first position, which translate is without transforming the pre-transformed material; and (iii) irradiate the exposed surface of the material bed at the second position with the energy beam that is (e.g., substantially) stationary at the second position during a second time-period to transform the pre-transformed material in the first position to a transformed material to form a second tile that overlaps the first tile. In some embodiments, the second time period is at least about one millisecond.

In another aspect, a system for printing a three-dimensional object comprises: a container configured to enclose a material bed comprising an exposed surface and a pre-transformed material; an energy source configured to generate an energy beam that transforms at least a portion of the exposed surface to a transformed material as part of the three-dimensional object; wherein the energy source is disposed adjacent to the material bed; and one or more controllers operatively coupled to the material bed, and the energy source, which one or more controllers direct the energy beam to: (i) irradiate the exposed surface of the material bed at a first position that is (e.g., substantially) stationary during a first time-period and transform the pre-transformed material in the first position to a transformed material to form a first tile, (ii) translate the energy beam to a second position in the exposed surface, which second position is different from the first position, which translate is without transforming the pre-transformed material; and (iii) irradiate the exposed surface of the material bed at the second position with the energy beam that is (e.g., substantially) stationary at the second position during a second time-period to transform the pre-transformed material in the first position to a transformed material to form a second tile that overlaps the first tile. In some embodiments, the energy beam has a power density of at most about 8000 watts per millimeter squared.

In another aspect, a system for printing a three-dimensional object comprises: a container configured to enclose a material bed comprising an exposed surface and a pre-transformed material; a defocused energy source configured to generate the energy beam that transforms at least a portion of the material bed to a transformed material as part of the three-dimensional object, wherein the energy source is disposed adjacent to the material bed; and one or more controllers operatively coupled to the material bed, the energy source, and the optical diffuser, which one or more controllers direct the defocused energy beam to (i) irradiate the exposed surface of the material bed at a first position that is (e.g., substantially) stationary during a first time-period to transform the pre-transformed material in the first position to a transformed material to form a first tile; (ii) translate a second position in the exposed surface, which second position is different from the first position, which translate is without transforming the pre-transformed material; and (iii) irradiate the exposed surface of the material bed at the second position with the energy beam that is (e.g., substantially) stationary at the second position during a second time-period to transform the pre-transformed material in the first position to a transformed material to form a second tile. In some embodiments, the first tile at least contacts the second tile.

In another aspect, a system for printing a three-dimensional object comprises: a container configured to enclosure a material bed comprising an exposed surface and a pre-transformed material; an optical diffuser configured to diffuse a first cross section of an energy beam to form a second cross section that is diffused relative to the first cross section; an energy source configured to generate the energy beam that transforms at least a portion of the material bed to a transformed material as part of the three-dimensional object, wherein the energy source is disposed adjacent to the material bed; and one or more controllers operatively coupled to the material bed, the energy source, and the optical diffuser, which one or more controllers (e.g., collectively or individually) direct (I) the energy beam having the first cross section to travel through the optical diffuser to diffuse the first cross section and form the second cross section (II) the energy beam having the second cross section to (i) irradiate the exposed surface of the material bed at a first position that is (e.g., substantially) stationary during a first time-period to transform the pre-transformed material in the first position to a transformed material to form a first tile; (ii) translate a second position in the exposed surface, which second position is different from the first position, which translate is without transforming the pre-transformed material; and (iii) irradiate the exposed surface of the material bed at the second position with the energy beam that is (e.g., substantially) stationary at the second position during a second time-period to transform the pre-transformed material in the first position to a transformed material to form a second tile that overlaps the first tile.

In another aspect, a method for printing a three-dimensional object comprises: (A) providing a first pre-transformed material to a bottom skin layer of hardened material that is disposed above a platform, which bottom skin layer is part of the three-dimensional object; and (B) using an energy beam to: (I) transform the pre-transformed material to a first portion of transformed material as part of the three-dimensional object, which first portion has a first lateral cross section, (II) increase a temperature of a second portion that (a) is part of the bottom skin layer and (b) has a second lateral cross section that at least partially overlaps the first lateral cross section, to at least a target temperature value that is at least one of (i) above the solidus temperature and below the liquidus temperature of the material of the bottom skin layer, and (ii) at a temperature at which the material of the bottom skin layer in the second portion plastically yields. In some embodiments, the bottom skin layer of hardened material is disposed above the platform along a direction perpendicular to the platform. In some embodiments, above is directly above (e.g., such that the bottom skin layer contacts the platform). In some embodiments, providing comprises streaming. In some embodiments, the transformation (i) is above the bottom skin layer, or (ii) is at the bottom skin layer. In some embodiments, transform is prior to contact formation between the bottom skin layer and the transformed material. In some embodiments, the transformation is at the bottom skin layer. In some embodiments, the energy beam has a beam profile that is altered at least one time during the printing, e.g., during printing of a layer of transformed material as part of a 3D object. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the center of the first cross section is above (e.g., aligned with) the second cross section. In some embodiments, above is along a direction (i) perpendicular to the platform and/or (ii) along a gravitational vector pointing to a gravitational center of the environment (e.g., Earth). In some embodiments, above is in the direction opposing the platform. In some embodiments, above is in the direction opposite to the gravitational center. Increase comprises using (i) closed loop or (i) open loop, control scheme(s). In some embodiments, control comprises temperature control. In some embodiments, increase comprises using control scheme(s) comprising (i) feedback or (ii) feed-forward, control. In some embodiments, the control comprises using technology comprising: a graphical processing unit (GPU), system-on-chip (SOC), application specific integrated circuit (ASIC), application specific instruction-set processor (ASIPs), programmable logic device (PLD), or field programmable gate array (FPGA). Increase comprises using a simulation, e.g., The temperature of the second portion is increased with the aid of a simulation. In some embodiments, the simulation pertains to the 3D printing of the 3D object(s), the simulation being a temperature simulation and/or a mechanical simulation. In some embodiments, the simulation comprises thermo-mechanical simulation pertaining to the 3D printing of the 3D object(s). In some embodiments, the simulation comprises (e.g., takes into account, or considers) a material property of the 3D object, e.g., that is requested by a user. In some embodiments, the thermo-mechanical simulation comprises elastic simulation or plastic simulation. In some embodiments, the temperature of the second portion is increased with the aid of a graphical processing unit (GPU), system-on-chip (SOC), application specific integrated circuit (ASIC), application specific instruction-set processor (ASIPs), programmable logic device (PLD), or field programmable gate array (FPGA). In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a method for printing a three-dimensional object comprises: (A) providing a material bed comprising a pre-transformed material and a bottom skin layer of hardened material, which material bed is disposed above a platform, wherein the bottom skin layer is part of the three-dimensional object, wherein at least a fraction of the pre-transformed material is disposed above the bottom skin layer; and (B) irradiating a first portion of the planar layer with an energy beam to: (I) transform the pre-transformed material in the first portion to a transformed material as part of the three-dimensional object, which first portion has a first lateral cross section; (II) increase a temperature of a second portion that (a) is part of the bottom skin layer and (b) has a second lateral cross section that overlaps the first lateral cross section, to at least a target temperature value that is at least one of (i) above the solidus temperature and below the liquidus temperature of the material of the bottom skin layer, and (ii) at a temperature at which the material of the bottom skin layer in the second portion plastically yields. In some embodiments, the energy beam has a beam profile that is altered at least one time during the printing, e.g., during printing of a layer of transformed material as part of a 3D object. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the at least a fraction comprises a planar exposed surface of the material bed. In some embodiments, above is along a direction opposite to the platform and/or a gravitational vector pointing to the gravitational center of the environment. In some embodiments, above is directly above such that the bottom skin layer contacts the platform. In some embodiments, transform is above or at the bottom skin layer. In some embodiments, transform is at the bottom skin layer. In some embodiments, the center of the first cross section is above the second cross section. In some embodiments, above is along the direction perpendicular to the platform. In some embodiments, above is in the direction opposing the platform. In some embodiments, above is in the direction opposite to the gravitational center. Increase comprises using closed loop or open loop temperature control, e.g., the temperature of the second portion is increased using closed loop or open loop control scheme. In some embodiments, increase comprises using feedback or feed-forward control, e.g., the temperature of the second portion is increased using feedback or feed-forward control scheme. In some embodiments, increase comprises using a simulation. In some embodiments, the simulation comprises a simulation of the 3D printing, the simulation comprising a temperature simulation or mechanical simulation. In some embodiments, the simulation comprises thermo-mechanical simulation, e.g., of the 3D printing and/or of the 3D object during its fabrication in the 3D printing. In some embodiments, the simulation comprises a material property of the requested 3D object. In some embodiments, the mechanical simulation comprises elastic simulation or plastic simulation. In some embodiments, the control comprises using a graphical processing unit (GPU), system-on-chip (SOC), application specific integrated circuit (ASIC), application specific instruction-set processor (ASIPs), programmable logic device (PLD), or field programmable gate array (FPGA). In some embodiments, the method further comprises dispensing at least one layer of the pre-transformed material to generate the material bed, e.g., by removing an excess of pre-transformed material from the exposed surface of the material bed using an attractive force and/or gas flow. In some embodiments, the method further comprises cyclonically separating the pre-transformed material from the gas flow, e.g., during the printing. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a method for printing a three-dimensional object comprises: (a) providing a pre-transformed material to a bottom skin layer of hardened material disposed above a platform, wherein the bottom skin layer is part of the three-dimensional object; (b) using an energy beam to transform a portion of the pre-transformed material to a portion of transformed material disposed above the bottom skin layer; and (c) setting at least one characteristic of the energy beam such that a temperature of the three-dimensional object at the bottom skin layer below the portion of transformed material is at least one of (i) above the solidus temperature and below the liquidus temperature of the material of the bottom skin layer, and (ii) at temperature at which a material of the bottom skin layer plastically yields. In some embodiments, the energy beam has a beam profile that is altered at least one time during the printing, e.g., during printing of a layer of transformed material as part of a 3D object. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the transformed material is a melt pool. In some embodiments, the method further comprises after operation (c), repeating at least operation (b), e.g., repeating operation (b) subsequent to operation (c). In some embodiments, below the portion is along a direction perpendicular to the platform and in the direction towards the platform (e.g., the bottom skin layer is below the portion of transformed along a direction perpendicular to the platform). In some embodiments, the at least one characteristic comprises power density, cross sectional area, trajectory, speed, focus, energy profile, dwell time, intermission time, or fluence of the energy beam. In some embodiments, the method further comprises dispensing a layer of the pre-transformed material at least in part by removing an excess of pre-transformed material from the exposed surface of the material bed using an attractive force and/or a gas flow. In some embodiments, the method further comprises cyclonically separating the pre-transformed material from the gas flow. In some embodiments, the separated pre-transformed material is recycled to be used in the 3D printing cycle, or in another 3D printing cycle. In some embodiments, above is directly above such that the bottom skin layer contacts the platform. In some embodiments, providing comprises streaming. In some embodiments, the transformation is above the bottom skin layer, or at the bottom skin layer. In some embodiments, the transformation is prior to contact formation between the bottom skin layer and the transformed material. In some embodiments, the transformation is at the bottom skin layer. In some embodiments, the center of the first cross section is above the second cross section. In some embodiments, above is along the direction perpendicular to the platform. In some embodiments, above is in the direction opposing the platform. In some embodiments, above is in the direction opposite to the gravitational center. In some embodiments, increase comprises using closed loop or using open loop (e.g., temperature) control scheme(s). In some embodiments, the control is of at least one characteristic of the energy beam, e.g., as disclosed herein. In some embodiments, increase comprises using feedback or feed-forward control. Increase comprises using a simulation. In some embodiments, the simulation of the 3D printing, the simulation comprises a temperature simulation or a mechanical simulation. In some embodiments, the simulation comprises thermo-mechanical simulation. In some embodiments, the simulation comprises a material property of the requested 3D object. In some embodiments, the thermo-mechanical simulation comprises elastic simulation or plastic simulation. In some embodiments, the control comprises using a graphical processing unit (GPU), system-on-chip (SOC), application specific integrated circuit (ASIC), application specific instruction-set processor (ASIPs), programmable logic device (PLD), or field programmable gate array (FPGA). In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a method for printing a three-dimensional object comprises: (a) providing a material bed comprising a pre-transformed material and a bottom skin layer of hardened material, which material bed is disposed above a platform, wherein the bottom skin layer is part of the three-dimensional object, wherein at least a fraction of the pre-transformed material is disposed above the bottom skin layer, wherein above is along a direction opposite to the platform; (b) using an energy beam to transform a portion of at least a fraction of the pre-transformed material into a transformed material as part of the three-dimensional object; and (c) setting at least one characteristic of the energy beam such that a temperature of the three-dimensional object at the bottom skin layer below the portion is at least one of (i) above the solidus temperature and below the liquidus temperature of the bottom skin layer material, and (ii) at temperature at which a material in the bottom skin layer plastically yields. In some embodiments, the energy beam has a beam profile that is altered at least one time during the printing, e.g., during printing of a layer of transformed material as part of a 3D object. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the method further comprises repeating at least operation (b) after operation (c). In some embodiments, below the portion is along a direction perpendicular to the platform and in the direction towards the platform. In some embodiments, the at least a fraction comprises a planar exposed surface of the material bed. In some embodiments, the bottom skin layer is a first formed layer of (i) the three-dimensional object, (ii) a hanging structure of the three-dimensional object, or (iii) a cavity ceiling of the three-dimensional object. In some embodiments, the bottom skin layer has a sphere of radius XY on a bottom surface of the bottom skin layer, wherein an acute angle between the straight line XY and the direction normal to a central tendency of the layering plane (e.g., an average layering plane) of the bottom skin layer is in the range from about 45 degrees to about 90 degrees, or from about 60 degrees to about 90 degrees. In some embodiments, the first formed layer of the three-dimensional object is disconnected from the platform during the 3D printing. In some embodiments, the first formed layer of the three-dimensional object comprises auxiliary support that is disconnected from (e.g., not anchored to) the platform during the 3D printing. In some embodiments, during the 3D printing, the first formed layer of the three-dimensional object comprises auxiliary support features that are spaced apart by about two (2) millimeters or more. In some embodiments, the hanging structure of the three-dimensional object comprises at least one side that is not connected to (e.g., is disconnected from) the three-dimensional object or to the platform. In some embodiments, the hanging structure of the three-dimensional object comprises at least two sides that are not connected to (e.g., are disconnected from) the three-dimensional object or to the platform. In some embodiments, the hanging structure of the three-dimensional object comprises at least three sides that are not connected to (e.g., disconnected from) the three-dimensional object or to the platform. In some embodiments, the hanging structure comprises auxiliary support that is not anchored to the platform. In some embodiments, the hanging structure comprises auxiliary support features that are spaced apart by about two (2) millimeters or more. In some embodiments, the cavity ceiling of the three-dimensional object comprises at least one side that is not connected to the three-dimensional object or to the platform. In some embodiments, the cavity ceiling of the three-dimensional object comprises at least two sides that are not connected to the three-dimensional object or to the platform. In some embodiments, the cavity ceiling of the three-dimensional object comprises at least three sides that are not connected to the three-dimensional object or to the platform. In some embodiments, the cavity ceiling comprises an auxiliary support that is not anchored to the platform. In some embodiments, the hanging structure comprises auxiliary support features that are spaced apart by about two (2) millimeters or more. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a system for printing a three-dimensional object comprises: a platform and a bottom skin layer of hardened material that is a part of the three-dimensional object, wherein the bottom skin layer is disposed above the platform; a material dispenser configured to dispense a pre-transformed material towards the platform through an opening, wherein the material dispenser is disposed adjacent to the platform; an energy source configured to generate an energy beam that transforms at least a portion of the pre-transformed material in at or adjacent to the platform, wherein the energy source is disposed adjacent to the platform; and one or more controllers operatively coupled to the material bed, the material dispenser, and the energy source, which one or more controllers are individually or collectively programmed to: (A) direct the material dispenser to dispense a pre-transformed material at or above the bottom skin layer, and (B) direct the energy beam to (I) transform the pre-transformed material and form a first portion at or above the bottom skin layer (e.g., which above is in the direction opposite to the platform), which first portion has a first lateral cross section; and (II) increase a temperature of a second portion that (a) is part of the bottom skin layer and (b) has a second lateral cross section that at least partially overlaps the first lateral cross section, to at least a target temperature value that is at least one of (i) above the solidus temperature and below the liquidus temperature of the material of the bottom skin layer, and (ii) at a temperature at which the material of the bottom skin layer in the second portion plastically yields. In some embodiments, the energy beam has a beam profile that is altered at least one time during the printing, e.g., during printing of a layer of transformed material as part of a 3D object. In some embodiments, the one or more controllers are configured to direct alteration of the beam profile that comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the first portion is above the bottom skin layer along a direction perpendicular to the platform. In some embodiments, above is directly above such that the bottom skin layer contacts the platform. In some embodiments, above is indirectly above such that the bottom skin layer does not connect and/or does not contact, the platform. In some embodiments, the bottom skin layer is separated from the platform by the pre-transformed material. In some embodiments, the bottom skin layer is separated from the platform by a layer of the pre-transformed material. In some embodiments, the bottom skin layer floats anchorlessly above the platform. In some embodiments, the bottom skin layer comprises one or more auxiliary supports. In some embodiments, the one or more auxiliary supports is anchored to the platform. In some embodiments, the one or more auxiliary supports floats anchorlessly above the platform. In some embodiments, dispensing in operation (b) comprises streaming. In some embodiments, control comprises using closed loop control scheme or an open loop control scheme. In some embodiments, increase comprises using a control scheme comprising feedback control or feed-forward control. In some embodiments, control comprises using a simulation. In some embodiments, the one or more controllers are individually or collectively programmed to direct the energy beam to increase the temperature of the second portion using a simulation. In some embodiments, the simulation comprises a simulation of the 3D printing, the simulation comprising a temperature simulation or mechanical simulation. In some embodiments, the simulation comprises thermo-mechanical simulation. In some embodiments, the simulation comprises a material property of the requested 3D object. In some embodiments, the thermo-mechanical simulation comprises elastic simulation or plastic simulation. In some embodiments, the one or more controllers are individually or collectively programmed to direct the energy beam to increase the temperature of the second portion using a graphical processing unit (GPU), system-on-chip (SOC), application specific integrated circuit (ASIC), application specific instruction-set processor (ASIPs), programmable logic device (PLD), or field programmable gate array (FPGA). In some embodiments, the one or more controllers are configured to direct a cyclonic separator to separate any excess of pre-transformed material that did not transform to form the three-dimensional object. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a system for printing a three-dimensional object comprises: a container configured to support a material bed comprising an exposed surface, a pre-transformed material, and a bottom skin layer of hardened material, wherein at least a fraction of the pre-transformed material is disposed above the bottom skin layer, wherein the bottom skin layer is part of the three-dimensional object; an energy source for generating an energy beam that is configured to transform at least a portion of the at least a fraction of the pre-transformed material to a transformed material as part of the three-dimensional object, wherein the energy source is disposed adjacent to the material bed; and one or more controllers operatively coupled to the material bed, the layer dispensing mechanism and the energy source, which one or more controllers are individually or collectively programmed to direct the energy beam to: (I) transform the at least a portion of the pre-transformed material to a first portion of transformed material, which first portion has a first lateral cross section; and (II) increase a temperature of a second portion that (a) is part of the bottom skin layer and (b) has a second lateral cross section that overlaps the first lateral cross section, to at least a target temperature value that is at least one of (i) above the solidus temperature and below the liquidus temperature of the material of the bottom skin layer, and (ii) at a temperature at which the material of the bottom skin layer in the second portion plastically yields. In some embodiments, the energy beam has a beam profile that is altered at least one time during the printing, e.g., during printing of a layer of transformed material as part of a 3D object. In some embodiments, the one or more controllers are configured to direct alteration of the beam profile that comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the pre-transformed material comprises a particulate material comprising an elemental metal, metal alloy, ceramic, an allotrope of elemental carbon, polymer, or a resin. In some embodiments, the pre-transformed material comprises a particulate material comprising elemental metal, metal alloy, ceramic, or an allotrope of elemental carbon. In some embodiments, increase of the temperature of a second portion comprises using feedback or feed-forward control. In some embodiments, the one or more controllers is individually or collectively programmed to direct the energy beam to increase the temperature of the second portion using feedback or feed-forward control. In some embodiments, the increase of the temperature of the second portion comprises using closed loop control scheme or open loop control scheme, e.g., based at least in part on the temperature. In some embodiments, the one or more controllers are individually or collectively programmed to direct the energy beam to increase the temperature of the second portion using closed loop control scheme and/or open loop control scheme. In some embodiments, the increase of the temperature of the second portion comprises using a graphical processing unit (GPU), system-on-chip (SOC), application specific integrated circuit (ASIC), application specific instruction-set processor (ASIPs), programmable logic device (PLD), or field programmable gate array (FPGA). In some embodiments, the one or more controllers are individually or collectively programmed to direct the energy beam to increase the temperature of the second portion using a graphical processing unit (GPU), system-on-chip (SOC), application specific integrated circuit (ASIC), application specific instruction-set processor (ASIPs), programmable logic device (PLD), or field programmable gate array (FPGA). In some embodiments, the material bed is formed at least in part by dispensing a (e.g., planar) layer of the pre-transformed material generated by removing an excess of pre-transformed material from the exposed surface of the material bed using and attractive force and/or a gas flow. In some embodiments, at one or more controllers are configured to direct cyclonically separating the pre-transformed material from the gas flow. The (e.g., first or second portion of the) transformed material comprises a melt pool.

In another aspect, a system for printing a three-dimensional object comprises: a platform and a bottom skin layer of hardened material disposed above the platform; a material dispenser configured to dispense a pre-transformed material towards a target surface through an opening of the material dispenser, wherein the material dispenser is disposed adjacent to the target surface; an energy source configured to generate an energy beam that transforms at least a portion of the pre-transformed material at or adjacent to the target surface, wherein the energy source is disposed adjacent to the target surface; and one or more controllers operatively coupled to the material bed and the energy source, wherein the one or more controllers are individually or collectively programmed to: (I) direct the energy beam to transform the at least a portion of the pre-transformed material at or adjacent to the target surface to a transformed material disposed above the bottom skin layer, and (II) control at least one characteristic of the energy beam such that a temperature of the three-dimensional object at the bottom skin layer below the portion is at least one of (i) above the solidus temperature and below the liquidus temperature of the bottom skin layer material, and (ii) at temperature at which a material in the bottom skin layer plastically yields. In some embodiments, above in (I) is directly above such that the transformed material contacts the bottom skin layer. In some embodiments, the energy beam has a beam profile that is altered at least one time during the printing, e.g., during printing of a layer of transformed material as part of a 3D object. In some embodiments, the one or more controllers are configured to direct alteration of the beam profile that comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the controller is further direct repeating operation (I). In some embodiments, the one or more controllers are individually or collectively programmed to repeat operation (I) subsequent to operation (II). In some embodiments, above is directly above such that the bottom skin layer contacts the platform. In some embodiments, above is indirectly above such that the bottom skin layer does not connect and/or contact, the platform. In some embodiments, the bottom skin layer is separated from the platform by the pre-transformed material. In some embodiments, the bottom skin layer is separated from the platform by a layer of the pre-transformed material. In some embodiments, the bottom skin layer floats anchorlessly above the platform. In some embodiments, the bottom skin layer comprises one or more auxiliary supports. In some embodiments, the one or more auxiliary supports are anchored to the platform. In some embodiments, the one or more auxiliary supports float anchorlessly above the platform. In some embodiments, dispensing a pre-transformed material comprises streaming. In some embodiments, the control comprises a closed loop control scheme or an open loop control scheme. In some embodiments, controlling at least one characteristic of the energy beam comprises using feedback or feed-forward control. In some embodiments, the control comprises using a simulation. In some embodiments, the simulation comprises a simulation of the 3D printing, the simulation comprising a temperature simulation or mechanical simulation. In some embodiments, the simulation comprises thermo-mechanical simulation. In some embodiments, the simulation comprises a material property of the requested 3D object. In some embodiments, the thermo-mechanical simulation comprises elastic simulation or plastic simulation. In some embodiments, the control comprises using a graphical processing unit (GPU), system-on-chip (SOC), application specific integrated circuit (ASIC), application specific instruction-set processor (ASIPs), programmable logic device (PLD), or field programmable gate array (FPGA). In some embodiments, the system further comprises a cyclonic separator configured to separate an excess of pre-transformed material that did not transform to form the three-dimensional object, e.g., from debris, e.g., byproduct of the 3D printing such as soot, splatter, or spatter. In some embodiments, the transformed material comprises a melt pool. In some embodiments, below the portion is along a direction perpendicularly towards the platform. In some embodiments, the bottom skin layer is below the portion along a direction perpendicular to the platform. In some embodiments, the at least one characteristic comprises power density, cross sectional area, trajectory, speed, focus, energy profile, dwell time, intermission time, or fluence of the energy beam.

In another aspect, a system for printing a three-dimensional object comprises: a container configured to support a material bed comprising an exposed surface, a pre-transformed material, and a bottom skin layer of hardened material, wherein at least a fraction of the pre-transformed material is disposed above the bottom skin layer, wherein the bottom skin layer is part of the three-dimensional object; an energy source configured to generate an energy beam that transforms at least a portion of the at least a fraction of the pre-transformed material to a transformed material as part of the three-dimensional object, wherein the energy source is disposed adjacent to the material bed; and one or more controllers operatively coupled to the material bed and the energy source, which one or more controllers are individually or collectively programmed to: (I) transform the at least a portion of the pre-transformed material to a first portion of transformed material, and (II) control at least one characteristic of the energy beam such that a temperature of the three-dimensional object at the bottom skin layer below the first portion is at least one of (i) above the solidus temperature and below the liquidus temperature of the bottom skin layer material, and (ii) at temperature at which a material in the bottom skin layer plastically yields. In some embodiments, the energy beam has a beam profile that is altered at least one time during the printing, e.g., during printing of a layer of transformed material as part of a 3D object. In some embodiments, the one or more controllers are configured to direct alteration of the beam profile that comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, below the first portion is along a direction perpendicular to the average plane of the bottom skin layer. In some embodiments, below the first portion is towards the bottom skin layer. In some embodiments, control comprises altering at least one characteristic of the energy beam. In some embodiments, the at least one characteristic of the energy beam comprises power density, cross sectional area, trajectory, speed, focus, energy profile, dwell time, intermission time, or fluence of the energy beam. In some embodiments, the one or more controllers are configured to direct dispensing a layer of the pre-transformed material by removing an excess of pre-transformed material from the exposed surface of the material bed using an attracting force and/or a gas flow. In some embodiments, the one or more controllers are configured to direct cyclonically separating the pre-transformed material from the gas flow. In some embodiments, during the 3D printing, the bottom skin layer is the first formed layer of (i) the three-dimensional object, (ii) a hanging structure of the three-dimensional object, or (iii) a cavity ceiling of the three-dimensional object. In some embodiments, the bottom skin layer has a sphere of radius XY on a bottom surface of the bottom skin layer, wherein an acute angle between the straight line XY and the direction normal to the average layering plane of the bottom skin layer is in the range from about 45 degrees to about 90 degrees, or from about 60 degrees to about 90 degrees. In some embodiments, during the 3D printing the first formed layer of the three-dimensional object comprises auxiliary support that are spaced apart by about two (2) millimeters or more. In some embodiments, the hanging structure of the three-dimensional object has at least one side that is not connected to the three-dimensional object or to the platform. In some embodiments, the hanging structure comprises auxiliary supports that are spaced apart by about (2) millimeters or more. In some embodiments, the cavity ceiling of the three-dimensional object has at least one side that is not connected to the three-dimensional object or to the platform. In some embodiments, the hanging structure comprises auxiliary supports that are spaced apart by about (2) millimeters or more.

In some embodiments, the energy source comprises an electromagnetic beam or a particle beam. In some embodiments, the electromagnetic beam comprises a laser. In some embodiments, the particle beam comprises an electron beam. In some embodiments, the pre-transformed material comprises a solid, semi solid, or liquid material. In some embodiments, the pre-transformed material comprises a particulate material. In some embodiments, the particulate material comprises powder or vesicles. In some embodiments, the powder comprises solid material. In some embodiments, the pre-transformed material comprises a particulate material comprising elemental metal, metal alloy, ceramic, an allotrope of elemental carbon, polymer, or a resin. In some embodiments, the pre-transformed material comprises a particulate material comprising elemental metal, metal alloy, ceramic, or an allotrope of elemental carbon. In some embodiments, the pre-transformed material comprises a polymer or a resin. In some embodiments, the pre-transformed material and the bottom skin layer comprises (e.g., substantially) the same material. In some embodiments, the pre-transformed material and the bottom skin layer comprises different materials. In some embodiments, the three-dimensional object comprises functionally graded materials.

In another aspect, a method for printing a three-dimensional object comprises: (a) providing a material bed comprising an exposed surface and a pre-transformed material; (b) planarizing the exposed surface by displacing with a first force, the pre-transformed material from the exposed surface into an internal compartment of a material remover; (c) removing the pre-transformed material from the internal compartment with a second force; and (d) using an energy beam to irradiate at least a portion of the exposed surface to transform the pre-transformed material at the at least the portion of the exposed surface into a transformed material, wherein the transformed material is at least a portion of the three-dimensional object. In some embodiments, the energy beam has a beam profile that is altered at least one time during the printing, e.g., during printing of a layer of transformed material as part of a 3D object. In some embodiments, the method comprises altering the beam profile. In some embodiments, alteration of the beam profile that comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, displacing the pre-transformed material comprises attracting the pre-transformed material. In some embodiments, removing the pre-transformed material comprises pushing or attracting, the pre-transformed material. In some embodiments, the first force is different from the second force in at least one of force type, force direction, and force amount. In some embodiments, removing is after the planarizing in operation (b). In some embodiments, removing is after the using in operation (d). In some embodiments, removing in operation (d) is contemporaneous with the using in operation (d). In some embodiments, a direction of the first force is (e.g., substantially) perpendicular to a direction of the second force. In some embodiments, the second force is directed (e.g., is run) perpendicular to first force. In some embodiments, the pre-transformed material accumulates in the internal compartment of the material remover (e.g., material removal mechanism). In some embodiments, accumulate is during the removing in operation (c). In some embodiments, while removing the pre-transformed material, the pre-transformed material accumulates in the internal compartment of the material remover. In some embodiments, accumulate comprises separating the pre-transformed material from a gas flow that is formed during the displacing (e.g., attracting) operation. In some embodiments, separating comprises cyclonically separating. In some embodiments, the direction of the first force is (e.g., substantially) perpendicular to the direction of the second force. In some embodiments, the first force is generated by a first force source. In some embodiments, the second force is generated by a second force source. In some embodiments, the first force source is connected to the internal compartment through a first opening. In some embodiments, the second force source is connected to the internal compartment through a second opening. In some embodiments, the first opening is different than the second opening. In some embodiments, the first opening is the same as the second opening. In some embodiments, at least one of the first opening and the second opening comprises a valve. In some embodiments, at least one of the first force and second force is regulated by the valve. In some embodiments, the pre-transformed material that is removed in operation (c) is treated. In some embodiments, treated comprises separated and/or reconditioned. In some embodiments, the pre-transformed material that is removed in (c) is recycled, e.g., to be used to form the material bed. In some embodiments, the method further comprises, subsequent to operation (b), or contemporaneous with operation (b), recycling the pre-transformed material for use in the material bed. In some embodiments, the treatment and/or recycling is (e.g., continuous) during the 3D printing. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a method for printing a three-dimensional object comprises: (a) providing a material bed comprising an exposed surface and a pre-transformed material; (b) planarizing the exposed surface by displacing the pre-transformed material from the exposed surface into an internal compartment of a material remover, which pre-transformed material accumulates within the internal compartment while planarizing the exposed surface; and (c) using an energy beam to irradiate at least a portion of the exposed surface to transform the pre-transformed material at the at least the portion of the exposed surface into a transformed material, wherein the transformed material is at least a portion of the three-dimensional object. In some embodiments, the accumulation of pre-transformed material comprises separating the pre-transformed material from a gas flow that is formed while displacing. In some embodiments, the energy beam has a beam profile that is altered at least one time during the printing, e.g., during printing of a layer of transformed material as part of a 3D object. In some embodiments, the method comprises altering the beam profile. In some embodiments, alteration of the beam profile that comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the pre-transformed material accumulates at least in part by separating the pre-transformed material from a gas flow that is formed while displacing the pre-transformed material from the exposed surface. In some embodiments, the method further comprises separating the pre-transformed material at least in part by cyclonic separation, e.g., the separation being from the gas flow. In some embodiments, displacing the pre-transformed material comprises attracting the pre-transformed material, e.g., using a force comprising electrostatic force, magnetic force, or gas flow. In some embodiments, the gas flow is an over pressurized gas or vacuum. In some embodiments, for example, the gas flow is caused at least in part by a vacuum source. In some embodiments, the material remover is disconnected from (e.g., separated from, and/or does not contact) the exposed surface at least while planarizing the exposed surface. In some embodiments, the material remover is separated from the exposed surface by a gaseous gap, e.g., any gap disclosed herein. In some embodiments, displacing comprises a gas flow. In some embodiments, the pre-transformed material is separate from the gas flow in the internal compartment, e.g., as it accumulates within the internal compartment. In some embodiments, while planarizing the exposed surface comprises while planarizing the exposed surface of the material bed one or more times, e.g., one or more planarization runs with each planarization run planarizing an exposed surface of the material bed. In some embodiments, while planarizing the exposed surface comprises while planarizing one exposed surface of the material bed, e.g., a single planarization run by the material remover. In some embodiments, the separation of the pre-transformed material from the gas flow comprises cyclonic separation. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a system for printing a three-dimensional object comprises: container configured to support a material bed comprising an exposed surface and a pre-transformed material; a first force source configured to generate a first force that displaces the pre-transformed material in a direction away from the gravitational center, wherein the first force source is disposed adjacent to the material bed; a second force source configured to generate a second force that maneuvers the pre-transformed material, wherein the second force source is disposed adjacent to the material bed; a material remover comprising an internal compartment, which material remover is configured to displace (e.g., facilitates displacing) a portion of the exposed surface to planarize the exposed surface of the material bed by using the first force, wherein the material remover is operatively coupled to the first force source and to the second force source, wherein the material remover is disposed adjacent to the material bed; an energy source configured to generate an energy beam that transforms at least a portion of the exposed surface to a transformed material as part of the three-dimensional object, wherein the energy source is disposed adjacent to the material bed; and one or more controllers operatively coupled to the material bed, the material remover, the first force source, the second force source, and the energy source, which one or more controllers direct (i) the material remover to planarize the exposed surface by displacing at least the pre-transformed material from the exposed surface to the internal compartment by using the first force, and (ii) the material remover to maneuver the pre-transformed material away from the internal compartment by using the second force, and (iii) the energy source to transform at least a portion of the pre-transformed material with the energy beam to a transformed material as part of the three-dimensional object. In some embodiments, the energy beam has a beam profile that is altered at least one time during the printing, e.g., during printing of a layer of transformed material as part of a 3D object. In some embodiments, the one or more controllers are configured to direct alteration of the beam profile that comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the planarization in operation (i) comprises additionally displacing debris from the exposed surface to the internal compartment by using the first force. In some embodiments, the debris comprises a byproduct of the 3D printing. In some embodiments, the debris comprises (i) a transformed material that is not part of the three-dimensional object, (ii) soot, (iii) spatter, or (iv) splatter. In some embodiments, away from the internal compartment comprises away from the material remover. In some embodiments, the first force is different from the second force, e.g., in a force type or a force amount. In some embodiments, the first force is vacuum, and the second force is compressed air. In some embodiments, the first force source is different from the second force source. In some embodiments, maneuvering is in a direction that is (e.g., substantially) perpendicular to the attracting. In some embodiments, the first force source comprises electronic force, magnetic force, pressurized gas, or vacuum. In some embodiments, the second force source comprises electronic force, magnetic force, pressurized gas, or vacuum. In some embodiments, displacing comprises attracting. In some embodiments, maneuver comprises repel or push. In some embodiments, operation (ii) occurs after planarizing the material bed in operation (i) to form a planar exposed surface of the material bed.

In some embodiments, the one or more controllers are a plurality of controllers, and wherein at least two operations (e.g., of the controller, the apparatus, the method, or the system) are control with the same controller. In some embodiments, for example, the one or more controllers is a plurality of controllers, and wherein at least two of operations (i), (ii), and (iii) are control with the same controller. In some embodiments, the one or more controllers are a plurality of controllers, wherein at least two operations (e.g., of the controller, the apparatus, the method, or the system) are controlled by different controllers, e.g., that are operatively coupled. In some embodiments, the one or more controllers is a plurality of controllers, and wherein at least two of operations (i), (ii), and (iii) are control with different controllers, e.g., that are operatively coupled. In some embodiments, the one or more controllers direct at least one of a plurality of operations (e.g., of the controller, the apparatus, the method, or the system) in real time during the 3D printing. In some embodiments, the one or more controllers direct at least one of a plurality of operations (e.g., of the controller, the apparatus, the method, or the system) in real time during the 3D printing. In some embodiments, the one or more controllers directs at least one of operations (i), (ii), and (iii) in real time during the 3D printing.

In another aspect, a system for printing a three-dimensional object comprises: a container configured to support a material bed comprising an exposed surface and a pre-transformed material; a material remover comprising an internal compartment, which material remover is configured to displace a portion of the pre-transformed material from the exposed surface to planarize the exposed surface of the material bed, wherein the material remover is disposed adjacent to the material bed; an energy source that is configured to generate an energy beam that transforms at least a portion of the exposed surface to a transformed material as part of the three-dimensional object, wherein the energy source is disposed adjacent to the material bed; and one or more controllers operatively coupled to the material bed, the material remover, and the energy source, which one or more controllers direct (i) the material remover to planarize the exposed surface by displacing at least the pre-transformed material from the exposed surface to accumulate in the internal compartment, and (ii) the energy source to transform at least a portion of the pre-transformed material with the energy beam to a transformed material as part of the three-dimensional object. In some embodiments, accumulate is during the planarize to form a planar exposed surface of the material bed. In some embodiments, planarize in (i) comprises additionally displacing a debris from the exposed surface to the internal compartment by using the first force. In some embodiments, the debris comprises a transformed material that is not part of the three-dimensional object. In some embodiments, the energy beam has a beam profile that is altered at least one time during the printing, e.g., during printing of a layer of transformed material as part of a 3D object. In some embodiments, the one or more controllers are configured to direct alteration of the beam profile that comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme.

In another aspect, a method for 3D printing comprises: (a) providing a material bed within an enclosure; and (b) irradiating a tiling energy flux onto an exposed surface of the material bed in a first position for a first time-period to form a first heated tile, which tiling energy flux is (e.g., substantially) uniform within a footprint of the first heated tile, wherein the tiling energy flux is (e.g., substantially) stationary within the first time-period, and wherein at least one characteristic of the tiling energy flux is determined using a measurement within (e.g., of) the first heated tile. In some embodiments, the tiling energy flux has a beam profile that is altered at least one time during the printing, e.g., during printing of a layer of transformed material as part of a 3D object. In some embodiments, the method comprises altering the beam profile. In some embodiments, alteration of the beam profile that comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a method for printing a three-dimensional object comprises: (a) providing a material bed comprising an exposed surface and a pre-transformed material; (b) planarizing the exposed surface by attracting the pre-transformed material from the exposed surface into an internal compartment of a material remover through a nozzle of the material remover, which nozzle comprises an adjustable volume; and (c) using an energy beam to transform at least a portion of the exposed surface to a transformed material, wherein the transformed material as at least a portion of the three-dimensional object. In some embodiments, the energy beam has a beam profile that is altered at least one time during the printing, e.g., during printing of a layer of transformed material as part of a 3D object. In some embodiments, the method comprises altering the beam profile. In some embodiments, alteration of the beam profile that comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, planarizing is in the absence of contact between the material remover and the exposed surface of the material bed. In some embodiments, the pre-transformed material accumulates in the internal compartment. In some embodiments, accumulate comprises separating the pre-transformed material from a gas flow that is formed during the attracting. In some embodiments, separating comprises cyclonically separating. In some embodiments, attracting comprises using an electrostatic force, magnetic force, or gas flow. In some embodiments, the pre-transformed material is attracted using an electrostatic force, magnetic force, or gas flow. In some embodiments, the gas flow comprises vacuum or compressed gas. In some embodiments, the adjustable volume is the internal volume of the nozzle. In some embodiments, the nozzle comprises at least one adjustable part. In some embodiments, the part is a mechanical part. In some embodiments, the nozzle comprises at least two, three or four adjustable parts. In some embodiments, the nozzle comprises a Venturi nozzle. In some embodiments, the adjustable volume of the nozzle is asymmetric. In some embodiments, the method further comprises adjusting the nozzle to regulate the volume (e.g., area and/or depth) from which the pre-transformed material is attracted from the material bed into the nozzle. In some embodiments, the method further comprises adjusting the nozzle to regulate a rate at which the pre-transformed material is attracted from the material bed into the nozzle. In some embodiments, the method further comprises adjusting the nozzle to regulate the fidelity at which the exposed surface is planarized. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a method for printing a three-dimensional object comprises: (a) providing a material bed comprising an exposed surface and a pre-transformed material; (b) planarizing the exposed surface by attracting the pre-transformed material from the exposed surface through a nozzle of a material remover, which attracting comprises using an attractive force that is (e.g., substantially) equal along a horizontal cross-section of the nozzle, which nozzle spans at least a portion of a width of the material bed that is perpendicular to the direction of movement of the material remover; and (c) using an energy beam to transform the at least the portion of the width of the material bed into a transformed material, wherein the transformed material is at least a portion of the three-dimensional object. In some embodiments, the energy beam has a beam profile that is altered at least one time during the printing, e.g., during printing of a layer of transformed material as part of a 3D object. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the at least a portion is greater than about 50%, 80%, 90%, or 100%, of the width of the material bed. In some embodiments, the at least the portion of the width of the material bed is greater than about 50% of the width of the material bed. In some embodiments, the pre-transformed material that is attracted through the nozzle is accumulate in an internal compartment of the material remover. In some embodiments, accumulate comprises separate the pre-transformed material from a gas flow that is formed during the attracting. In some embodiments, the pre-transformed material accumulates in the internal compartment at least in part by separating the pre-transformed material from a gas flow that is formed upon attracting the pre-transformed material from the exposed surface through a nozzle of a material remover. In some embodiments, the separation comprises a cyclonic separation. In some embodiments, a vertical cross-sectional area of the internal compartment is greater by at least about three times, ten times, thirty times, or fifty times a horizontal cross-sectional area of the opening of the nozzle. In some embodiments, for example, a vertical cross-sectional area of the internal compartment is greater by at least three times the horizontal cross-sectional area of the nozzle opening. In some embodiments, the method further comprises controlling the attractive force to regulate the volume from which the pre-transformed material is attracted from the material bed into the nozzle. In some embodiments, the method further comprises controlling the attractive force to regulate the rate at which the pre-transformed material is attracted from the material bed into the nozzle. In some embodiments, the method further comprises controlling the attractive force to regulate a fidelity at which the material remover planarizes the exposed surface. In some embodiments, the method further comprises controlling the translational speed of the material remover across the material bed to regulate the fidelity at which the material remover planarizes the exposed surface. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a method for printing a three-dimensional object, comprises: (a) providing a material bed comprising an exposed surface and a pre-transformed material; (b) planarizing the exposed surface by displacing (e.g., attracting) the pre-transformed material from the exposed surface into an internal compartment of a material remover, which internal compartment has a narrowing horizontal cross-section; and (c) using an energy beam to irradiate at least a portion of the exposed surface to transform the pre-transformed material at the at least the portion of the exposed surface into a transformed material, wherein the transformed material is at least a portion of the three-dimensional object. In some embodiments, the energy beam has a beam profile that is altered at least one time during the printing, e.g., during printing of a layer of transformed material as part of a 3D object. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the narrowing horizontal cross section has a long axis that is (e.g., substantially) perpendicular to a direction of movement of the material remover, e.g., along the exposed surface. In some embodiments, the pre-transformed material accumulates in the internal compartment of the material remover. In some embodiments, the material remover comprises an opening that is directed towards the exposed surface of the material bed, e.g., and toward a platform on which the material bed is disposed. In some embodiments, the opening is the opening through which the pre-transformed material enters the material removal, e.g., and into the internal compartment thereof. In some embodiments, accumulate comprises separating the pre-transformed material from a gas flow that is formed during the attracting. In some embodiments, separating comprises cyclonically separating. In some embodiments, the material bed is disposed above a platform. In some embodiments, the narrowing horizontal cross-section is (e.g., substantially) parallel to the platform. In some embodiments, the internal compartment comprises a narrowing (e.g., conical) shape, e.g., having its long axis parallel to the platform. In some embodiments, the attracting is from a position in the larger cross sectional vertical face of the cone, e.g., base of the cone. In some embodiments, the attracting is from a position in the larger circular cross section of the cone, e.g., base of the cone. In some embodiments, the narrowing horizontal cross section has an axis that is (e.g., substantially) perpendicular to the direction of movement. The pre-transformed material is displaced using a force that is distributed (e.g., substantially) homogenously along the horizontal cross section, e.g., wherein (e.g., substantially) is relative to the operation of the material remover, such as relative to the resulting planarity of the exposed surface. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a system for printing a three-dimensional object comprises: a container configured to support a material bed comprising an exposed surface and a pre-transformed material; a material remover comprising a nozzle through which pre-transformed material is displaced (e.g., attracted) away from the exposed surface, which nozzle comprises an adjustable volume, wherein the material remover is disposed adjacent to the material bed; an energy source configured to project an energy beam that transforms a portion of the pre-transformed material into a transformed material as part of the three-dimensional object, wherein the energy source is disposed adjacent to the material bed; and one or more controllers operatively coupled to the material bed, the material remover, and the energy source, which one or more controllers direct (i) the material remover to adjust the volume of the nozzle, (ii) the material remover to planarize the exposed surface, and (iii) the energy source to transform at least a portion of the pre-transformed material with the energy beam to a transformed material as part of the three-dimensional object. In some embodiments, the one or more controllers are a plurality of controllers. In some embodiments, at least two of operations (i), (ii), and (iii) are controlled by the same controller. In some embodiments, at least two of operations (i), (ii), and (iii) are controlled by different controllers (e.g., that are operatively coupled). In some embodiments, the one or more controllers are direct at least one of operations (i), (ii), and (iii) in real time during the 3D printing. In some embodiments, adjustment of the volume of the nozzle is during the 3D printing. In some embodiments, adjustment of the volume of the nozzle is before the 3D printing. In some embodiments, the energy beam has a beam profile that is altered at least one time during the printing, e.g., during printing of a layer of transformed material as part of a 3D object. In some embodiments, the one or more controllers are configured to direct alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme.

In another aspect, a system for printing a three-dimensional object comprises: a container configured to support a material bed comprising an exposed surface and a pre-transformed material; a force source that is configured to generate an attractive force that attracts the pre-transformed material, wherein the force source is disposed adjacent to the material bed; a material remover comprising a nozzle that spans at least a portion of the width of the material bed that is perpendicular to the direction of movement of the material remover, which material remover planarizes the exposed surface by attracting a portion of the pre-transformed material; an energy source that is configured to generate an energy beam that transforms at least a portion of the exposed surface to a transformed material as part of the three-dimensional object, wherein the energy source is disposed adjacent to the material bed; and one or more controllers operatively coupled to the material bed, the material remover, the force source, and the energy source, which one or more controllers direct (i) the material remover to planarize the exposed surface by attracting the pre-transformed material from the exposed surface through the nozzle, which attracting comprises using an attractive force that is (e.g., substantially) equal along the horizontal cross section of the nozzle entrance opening through which the pre-transformed material enters the material-removal mechanism, and (ii) the energy source to transform at least a portion of the pre-transformed material with the energy beam to a transformed material as part of the three-dimensional object. In some embodiments, the one or more controllers are one controller. In some embodiments, the one or more controllers are a plurality of controllers. In some embodiments, each of operations (i), and (ii), is controlled by different controllers, e.g., that are operatively coupled. In some embodiments, the energy beam has a beam profile that is altered at least one time during the printing, e.g., during printing of a layer of transformed material as part of a 3D object. In some embodiments, the one or more controllers are configured to direct alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme.

In another aspect, a system for printing a three-dimensional object comprises: a container configured to enclose a material bed comprising an exposed surface and a pre-transformed material; a material remover comprising an internal compartment having a narrowing horizontal cross section, which material remover is configured to attract a portion of the pre-transformed material from the exposed surface to planarize the exposed surface of the material bed, wherein the material remover is disposed adjacent to the material bed; an energy source configured to generate an energy beam that transforms at least a portion of the exposed surface to a transformed material as part of the three-dimensional object, wherein the energy source is disposed adjacent to the material bed; and one or more controllers operatively coupled to the material bed, the material remover, and the energy source, which one or more controllers direct (i) the material remover to planarize the exposed surface by attracting the pre-transformed material from the exposed surface through the nozzle, which attracting comprises using an attractive force that is (e.g., substantially) equal along the horizontal cross section of the nozzle, and (ii) the energy source to transform at least a portion of the pre-transformed material with the energy beam to a transformed material as part of the three-dimensional object. In some embodiments, the one or more controllers is one controller. In some embodiments, the one or more controllers are a plurality of controllers. In some embodiments, each of operations (i), and (ii), is controlled by different controllers, e.g., that are operatively coupled. In some embodiments, the energy beam has a beam profile that is altered at least one time during the printing, e.g., during printing of a layer of transformed material as part of a 3D object. In some embodiments, the one or more controllers are configured to direct alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme.

In another aspect, a method for printing a three-dimensional object comprises: providing a material bed comprising a pre-transformed material above a platform; generating a layer of transformed material as part of the three-dimensional object, which generating comprises irradiating a first portion of the material bed with a first energy beam to transform the pre-transformed material in the first portion into a first transformed material as part of the three-dimensional object, which first energy beam travels along a first trajectory; and controlling at least one of (i) a temperature and (ii) a shape of the first transformed material, wherein said controlling is in real time (e.g., during formation of the first transformed material). In some embodiments, the first transformed material comprises a melt pool. In some embodiments, the method further comprises irradiating a second portion of the material bed with a second energy beam to transform the pre-transformed material into a second transformed material as part of the three-dimensional object. In some embodiments, the second energy beam travels along a second trajectory different from the first trajectory. In some embodiments, at least one energy beam has a beam profile that is altered at least one time during the printing, e.g., during printing of a layer of transformed material as part of a 3D object, the at least one energy beam comprising the first energy beam and the second energy beam. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the second energy beam differs from the first energy beam by at least one characteristic. In some embodiments, the at least one characteristic comprises power density, cross sectional area, trajectory, speed, focus, energy profile, dwell time, intermission time, or fluence of the energy beam. In some embodiments, controlling further comprises controlling at least one of (i) a temperature and (ii) a shape, of the first transformed material. In some embodiments, the control is in real time, e.g., during formation of the second transformed material. In some embodiments, the second transformed material is a melt pool. In some embodiments, providing comprises dispensing a layer of the pre-transformed material by removing an excess of pre-transformed material from the exposed surface of the material bed using a gas flow, e.g., and cyclonically separating the pre-transformed material from the gas flow. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a system for printing a three-dimensional object comprises: a container configured to enclose material bed comprising an exposed surface and a pre-transformed material; a first energy source configured to generate a first energy beam that transforms at least a portion of the material bed to a transformed material as part of the three-dimensional object, wherein the first energy source is disposed adjacent to the material bed; and one or more controllers operatively coupled to the material bed, and the first energy source, which one or more controllers (e.g., individually or collectively) (I) direct the first energy beam to generate a first transformed material from a first portion of the material bed, which first energy beam travels along a first trajectory, and (II) control at least one of (i) a temperature and (ii) a shape, of the first transformed material, which control is in real time (e.g., during formation of the first transformed material to form the three-dimensional object). In some embodiments, the first transformed material comprises a first melt pool. In some embodiments, the system further comprises a second energy source generating a second energy beam that transforms at least a portion of the material bed to a transformed material as part of the three-dimensional object. In some embodiments, the second energy source is disposed adjacent to the material bed. In some embodiments, the one or more controllers is further operatively coupled to the second energy source. In some embodiments, the one or more controllers directs the second energy beam to generate a second transformed material from a second portion of the material bed. In some embodiments, the second portion of the material bed is different from the first portion of the material bed. In some embodiments, the second energy beam is travel along a second trajectory. In some embodiments, the second trajectory is different from the first trajectory. In some embodiments, the one or more controllers is control at least one of (i) a temperature and (ii) a shape, of the second transformed material. In some embodiments, the control is in real time, e.g., during formation of the second transformed material to form the 3D object. In some embodiments, the second energy beam is different from the first energy beam by at least one characteristic. In some embodiments, the at least one characteristic comprises power density, cross sectional area, trajectory, speed, focus, energy profile, dwell time, intermission time, or fluence of the energy beam. In some embodiments, the second transformed material comprises a second melt pool, e.g., that is different from the first melt pool. In some embodiments, at least one energy beam has a beam profile that is altered at least one time during the printing, e.g., during printing of a layer of transformed material as part of a 3D object, the at least one energy beam comprising the first energy beam and the second energy beam. In some embodiments, the one or more controllers are configured to direct alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme.

In another aspect, a method for 3D printing comprises: (a) providing a material bed within an enclosure; and (b) irradiating a tiling energy flux onto an exposed surface of the material bed in a first position for a first time period to form a first heated tile, which tiling energy flux is (e.g., substantially) uniform within a footprint of the first heated tile, wherein the tiling energy flux is (e.g., substantially) stationary within the first time period, and wherein at least one characteristic of the tiling energy flux is determined using a measurement within (e.g., of) the first heated tile. In some embodiments, the at least one characteristic comprises wavelength, power, amplitude, trajectory, footprint, intensity, energy, fluence, Andrew Number, hatch spacing, sis speed, or charge. In some embodiments, the measurement comprises a temperature measurement. In some embodiments, the method further comprises: (c) translating the tiling energy flux to a second position on the exposed surface of the material bed; and (d) irradiating the tiling energy flux for a second time-period to form a second heated tile, wherein the tiling energy flux is (e.g., substantially) stationary within the second time-period. In some embodiments, the tiling energy flux is (e.g., substantially) uniform within (e.g., within the area of) the second heated tile. In some embodiments, the material bed comprises one or more layers of material. In some embodiments, the material bed is a powder bed. In some embodiments, the material bed comprises particulate material that is selected from the group consisting of an elemental metal, metal alloy, ceramic, and an allotrope of elemental carbon. In some embodiments, a shape of the first heated tile is (e.g., substantially) identical to a shape of the second heated tile. In some embodiments, a shape of the first heated tile is different from a shape of the second heated tile. In some embodiments, the first heated tile borders the second heated tile. In some embodiments, the second heated tile is at least partially overlapping the first heated tile. In some embodiments, the second heated tile is separated from the first heated tile by a gap. In some embodiments, the irradiating comprises heating. In some embodiments, the heating is (e.g., substantially) exclude transforming. In some embodiments, the heating comprises transforming. In some embodiments, the method further comprises transforming at least a fraction of a material within the first heated tile. In some embodiments, the method further comprises transforming at least a fraction of a material within the second heated tile. In some embodiments, transforming comprises fusing. In some embodiments, fusing comprises melting or sintering. In some embodiments, the exposed surface of the material bed comprises an exposed surface of a 3D object that includes the first position and the second position. In some embodiments, the method further comprises cooling the material bed using a heat sink disposed above the exposed surface of the material bed. In some embodiments, the cooling is before, during, and/or after operation (b). In some embodiments, the cooling is before, during, and/or after operation (c). In some embodiments, the energy flux is (e.g., substantially) off (e.g., shut down) between the first position and the second position. In some embodiments, the energy flux is (e.g., substantially) off at least when translating between the first position and the second position. In some embodiments, the method further comprises irradiating at least a portion of the exposed surface of the material bed using a scanning energy beam that is different from the tiling energy flux. In some embodiments, the at least a portion of the exposed surface is disposed within the exposed surface of a 3D object (e.g., embedded within the material bed). In some embodiments, the velocity (e.g., speed) of the scanning energy beam is at least about 50 mm/sec. In some embodiments, the exposure time (e.g., dwell time) of the tiling energy beam is at least one millisecond. In some embodiments, the power per unit area (e.g., power density) of the tiling energy beam is at most about 1000 Watt per millimeter squared. In some embodiments, the power per unit area of the tiling energy beam is at most 10000 Watt per millimeter squared. In some embodiments, the fundamental length scale (abbreviated herein as “FLS”) of a cross section of the tiling energy beam is at least 0.3 millimeter. In some embodiments, the FLS (e.g., diameter) of a cross section of the scanning energy beam is at most 250 micrometers. In some embodiments, FLS is a diameter, spherical equivalent diameter, diameter of a bounding circle, or the largest of: height, width, and length. In some embodiments, at least one energy beam has a beam profile that is altered at least one time during the printing, e.g., during printing of a layer of transformed material as part of a 3D object, the at least one energy beam comprising the tiling energy beam and the scanning energy beam. In some embodiments, the method comprises altering the beam profile. In some embodiments, the one or more controllers are configured to direct alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the method further comprises controlling a rate at which the first heated tile cools down. In some embodiments, the controlling comprises imaging the first heated tile. In some embodiments, the imaging comprises analyzing a spectrum. In some embodiments, the imaging comprises image processing. In some embodiments, the controlling comprises sensing the temperature of the first heated tile. In some embodiments, the sensing comprises imaging. In some embodiments, the sensing comprises analyzing a spectrum. In some embodiments, the controlling comprises using feedback control. In some embodiments, the controlling comprises using open loop control. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, an apparatus for 3D printing comprises: (a) an enclosure comprising a material bed; and (b) a tiling energy source that generates a tiling energy flux that irradiates an exposed surface of the material bed to form a heated tile, which tiling energy flux is (e.g., substantially) uniform within the first heated tile; and (c) at least one controller operatively coupled to the enclosure and to the tiling energy source and directs the tiling energy beam to irradiate a first position of the exposed surface for a first time-period to form a first heated tile, wherein the tiling energy flux is (e.g., substantially) stationary within the first time-period, wherein at least one characteristic of the tiling energy flux is determined using a measurement of the first heated tile. In some embodiments, the tiling energy flux has a beam profile that is altered at least one time during the printing, e.g., during printing of a layer of transformed material as part of a 3D object. In some embodiments, the at least one controller is configured to direct alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme.

In another aspect, a method for 3D printing comprises: (a) providing a material bed within an enclosure; (b) irradiating a tiling energy flux onto an exposed surface of the material bed in a first position for a first time-period to form a first heated tile, wherein the irradiating comprises altering the power density of the tiling energy flux during the first time-period, and wherein the spatial distribution of the power density is (e.g., substantially) uniform within a footprint of the tile (e.g., on the exposed surface). In some embodiments, the tiling energy flux has a beam profile that is altered at least one time during the printing, e.g., during printing of a layer of transformed material as part of a 3D object. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the irradiating is related to a temperature measurement within (e.g., of) the first heated tile. In some embodiments, the method further comprises translating the tiling energy flux to a second position on the exposed surface of the material bed; and irradiating the tiling energy flux for a second time-period to form a second heated tile with the tiling energy flux, which tiling energy flux has a power density during the second time-period that is (e.g., substantially) uniform within an area of the second heated tile. In some embodiments, the altering comprises increasing the power density followed by decreasing the power density. In some embodiments, at least one of the increasing and decreasing is controlled. In some embodiments, the tiling energy flux is (e.g., substantially) stationary within the first time-period. In some embodiments, at least one characteristic of the tiling energy flux is determined using a measurement of the first heated tile. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, an apparatus for 3D printing comprises: (a) an enclosure comprising a material bed; and (b) a tiling energy source that generates a tiling energy flux that irradiates an exposed surface of the material bed for a first time-period to form a heated tile; and (c) at least one controller operatively coupled to the enclosure and to the tiling energy source and directs the tiling energy beam to irradiate a first position of the exposed surface for a first time-period to form a first heated tile, wherein the irradiate comprises alter the power density of the tiling energy flux during the first time-period, and wherein the spatial distribution of the power density is (e.g., substantially) uniform within a footprint of the tile (e.g., on the exposed surface). In some embodiments, the tiling energy flux has a beam profile that is altered at least one time during the printing, e.g., during printing of a layer of transformed material as part of a 3D object. In some embodiments, the at least one controller is configured to direct alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme.

In another aspect, a method for 3D printing comprises: (a) providing a material bed within an enclosure; (b) irradiating a tiling energy flux to portion of an exposed surface of the material bed in a first position for a first time-period to form a first heated tile, wherein a power density of the tiling energy flux during the first time-period is (e.g., substantially) uniform within an area of the first heated tile on the exposed surface of the material bed, which forming comprises: (i) increasing a power density of the tiling energy flux monotonously across an area of the first heated tile up to a power density peak; and (ii) decreasing the power density of the tiling energy flux monotonously across the area of the first heated tile, wherein the time at which the power density peak is reached for two points within the area of the first heated tile is (e.g., substantially) simultaneous. In some embodiments, the tiling energy flux has a beam profile that is altered at least one time during the printing, e.g., during printing of a layer of transformed material as part of a 3D object. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the area is a cross section of the tile in the exposed surface of the material bed. In some embodiments, the at least one of the increasing and the decreasing is related to a temperature measurement within the first heated tile. In some embodiments, within the first heated tile comprises one or more positions within the first heated tile. In some embodiments, within the first tile is of the first heated tile. In some embodiments, the method further comprises translating the tiling energy flux to a second position on the exposed surface of the material bed; and irradiating the tiling energy flux for a second time-period to form a second heated tile with the tiling energy flux, which tiling energy flux has a power density during the second time-period that is (e.g., substantially) uniform within an area of the second heated tile. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, an apparatus for 3D printing comprises: (a) an enclosure comprising a material bed; and (b) a tiling energy source that generates a tiling energy flux that irradiates an exposed surface of the material bed for a first time-period to form a heated tile, wherein a power density of the tiling energy flux during the first time-period is (e.g., substantially) uniform within an area of a first heated tile on an exposed surface of the material bed; and (c) at least one controller operatively coupled to the enclosure and to the tiling energy source and directs the tiling energy beam to irradiate a first position in the exposed surface of the material be for a first time-period to form the heated tile, which form comprises: (i) increase a power density of the tiling energy flux monotonously across an area of the first heated tile up to a power density peak; and (ii) decrease the power density of the tiling energy flux monotonously across the area of the first heated tile, wherein the time at which the power density peak is reached for two points within the area of the first heated tile is (e.g., substantially) simultaneous. In some embodiments, the tiling energy flux has a beam profile that is altered at least one time during the printing, e.g., during printing of a layer of transformed material as part of a 3D object. In some embodiments, the at least one controller is configured to direct alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme.

In another aspect, a method for 3D printing comprises: (a) providing a material bed within an enclosure; (b) transforming at least a portion of the material bed to form a transformed material by forming one or more successive melt pools, which transformed material subsequently hardens to form a hardened material as at least a portion of the 3D object; and (c) controlling the one or more melt-pools in real-time. In some embodiments, the transformation is related to a temperature measurement within (e.g., at various position within, or of) the first heated tile. In some embodiments, transforming comprises using an energy beam to irradiate the at least the portion of the material bed. In some embodiments, the energy beam has a beam profile that is altered at least one time during the printing, e.g., during printing of a layer of transformed material as part of a 3D object. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, controlling the one or more successive melt-pools comprises controlling the volume of the one or more successive melt-pools. In some embodiments, controlling the one or more successive melt-pools comprises controlling the average fundamental length scale of the one or more successive melt-pools. In some embodiments, controlling the one or more successive melt-pools comprises controlling the microstructure of the one or more successive melt-pools. In some embodiments, controlling the one or more successive melt-pools comprises controlling the cooling rate of the one or more successive melt-pools. In some embodiments, controlling the one or more successive melt-pools comprises controlling the heating rate of the one or more successive melt-pools. In some embodiments, controlling the one or more successive melt-pools comprises controlling the temperature variation within the one or more successive melt-pools. In some embodiments, controlling the one or more successive melt-pools comprises controlling the overall shape of the one or more successive melt-pools. In some embodiments, controlling the one or more successive melt-pools comprises controlling the overall shape of a cross section of the one or more successive melt-pools. In some embodiments, the cross section comprises a vertical cross section. In some embodiments, the cross section comprises a horizontal cross section. In some embodiments, controlling comprises sensing the temperature of the one or more successive melt-pools. In some embodiments, sensing comprises imaging (e.g., using a camera). In some embodiments, controlling comprises evaluating the volume of the melt pool based on the sensing. In some embodiments, controlling comprises regulating by a controller. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, the material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a method for generating a three-dimensional object by tiling comprises: a) depositing a layer of pre-transformed material to form a material bed; b) providing an energy beam to a first portion of the layer of pre-transformed material at a first location to transform the pre-transformed material at the first portion to form a first tile of transformed material; c) moving the energy beam to a second location at the layer of pre-transformed material, wherein the moving is at a speed of at most about 500 millimeters per second; and d) providing the energy beam to a second portion of the layer of pre-transformed material at the second location to transform the pre-transformed material at the second portion to form a second tile of transformed material; wherein the first tile of transformed material and second tile of transformed material harden to form at least a portion of the three-dimensional object. In some embodiments, the energy beam has a beam profile configured to be altered at least one time during the printing, e.g., during printing of a layer of transformed material as part of a 3D object. In some embodiments, the method comprises altering the beam profile. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, moving is at a speed of at most about 200 millimeters per second. In some embodiments, moving is at a speed of at most about 100 millimeters per second. In some embodiments, moving is at a speed of at most about 50 millimeters per second. In some embodiments, moving is at a speed of at most about 30 millimeters per second. In some embodiments, the energy beam has a power density of at most about 5000 watts per millimeter square. In some embodiments, the energy beam has a power density of at most about 3000 watts per millimeter square. In some embodiments, the energy beam has a power density of at most about 1500 watts per millimeter square. In some embodiments, the energy beam has a diameter of at least about 200 micrometers. In some embodiments, the energy beam has a diameter of at least about 300 micrometers. In some embodiments, the energy beam has a diameter of at least about 400 micrometers. In some embodiments, the material remover generates a planar layer of material having a central tendency of planarity that deviates from an ideally planar surface by at most about 70%, 50% or 30% relative to the height of the layer. In some embodiments, the material remover generates a planar layer of material having an Ra value of at most about 70 micrometers, 50 micrometers, or 20 micrometers. In some embodiments, layer removal mechanism is configured to generate a final layer having a final height at least in part by removing an excess height from an initial layer having an initial height, the initial height being larger than the excess height that is larger than the final height. In some embodiments the excess height is at most 75*, 50*, 25*, or 10* the final height of the layer, wherein “*” designates the mathematical operation “times”. In some embodiments, the material removal comprises a nozzle comprising a first body side and a second body side joined together to form a channel of the nozzle. In some embodiments, the nozzle is symmetric. In some embodiments, the nozzle is asymmetric. In some embodiments, a first body side and a second body side are symmetrically related to each other. In some embodiments, a first body side and a second body side are asymmetrically related to each other. In some embodiments, the method further comprises translating the material remover laterally in a direction along the material bed to reduce a height of the material bed and generate a planar exposed surface of the material bed. In some embodiments, the first body side of the nozzle is a leading side of the nozzle with respect to the direction. In some embodiments, a shape of a surface of the leading side promotes attraction of the pre-transformed material from the material bed and into the channel of the nozzle, the surface facing the material bed. In some embodiments, a shape of a surface of the tailing side minimizes disturbance of the planarized surface of the material bed after the pre-transformed material has entered the nozzle channel. In some embodiments, the channel is straight. In some embodiments, the channel is configured such that it is tilted away from the direction during removal operation of the material removal mechanism. In some embodiments, the channel comprises an angle. In another embodiments, a material removal mechanism comprising a body, the material removal mechanism (e.g., remover) being part of, or operatively coupled to, a layer dispensing mechanism (e.g., a recoater) configured to generate a material bed having pre-transformed material that is transformed during the three-dimensional printing to form at least one three-dimensional object. In some embodiments, the material removal mechanism being configured to facilitate attraction of the pre-transformed material from the material bed to the nozzle, through the channel into the cavity. In another embodiments, the material removal mechanism comprising the body that comprises (i) a nozzle having a first body side coupled to a second body side to form a channel in the nozzle, and (ii) a cavity coupled to the channel. In some embodiments, the material removal mechanism is configured to facilitate attraction of the pre-transformed material while moving in a direction along the material bed. In another embodiment, the material removal mechanism comprising the body that comprises a nozzle and a cavity coupled by a channel of the nozzle, the channel having a bent and/or angled portion. In some embodiments, the material removal mechanism is configured to facilitate the attraction of the pre-transformed material (a) while moving in a direction along the material bed and (b) optionally at a position preceding a vertical alignment of the nozzle with the material bed in the direction of movement.

In another aspect, a device for three-dimensional printing, the device comprises: a device body comprising (i) a nozzle having a first body side coupled to a second body side to form a channel in the nozzle, and (ii) a cavity coupled to the channel; the device being part of, or operatively coupled to, a layer dispensing mechanism (e.g., a recoater) configured to generate a material bed having pre-transformed material that is transformed during the three-dimensional printing to form at least one three-dimensional object; the device being configured to attract the pre-transformed material from the material bed to the nozzle through the channel and into the cavity; and the device being configured to facilitate attraction of the pre-transformed material while moving in a direction along the material bed. In some embodiments, the layer dispensing mechanism is configured to generate a first layer of pre-transformed material as part of the material bed, the first layer having a first exposed surface that is substantially planar according to a first central tendency of planarity, the first layer having a second central tendency of a thickness, the first layer being dispensed on a target surface of the material bed. In some embodiments, the device where the material bed includes one or more protrusions from the target surface, the one or more protrusions being of one or more three-dimensional objects, and where the second central tendency of the thickness of the first layer is smaller than a maximal height (e.g., vertical distance) of the one or more protrusions from the target surface. In some embodiments, the device where the device configured to attract a second portion of powder material from the first layer to generate a second layer of pre-transformed material having a second exposed surface that is substantially planar according to a third central tendency of planarity, the third central tendency of planarity being of the same type as the first central tendency of planarity, and where the third central tendency of planarity is smaller than the first central tendency of planarity of the first layer such that the third central tendency of planarity is indicative of a more planar surface than the first tendency of planarity. In some embodiments, the device where the second layer has a thickness having a fourth central tendency of thickness of the same type as the second central tendency of thickness, where during operation of the device, a closest distance between the target surface and the device is larger than (a) the second central tendency of thickness of the first layer and/or (b) the fourth central tendency of thickness of the second layer. In some embodiments, the device is configured to generate a planar, or a substantially planar, exposed surface of the material bed at least in part by attracting the pre-transformed material through the channel and into the cavity. In some embodiments, the device is configured to generate the exposed surface having an arithmetic average roughness (Ra) value of at most about 70 micrometers, 50 micrometers, or 20 micrometers. In some embodiments, the device is configured to generate a layer of material as part of the material bed, the layer of material having a height of at most about 100 micrometers, 50 micrometers, 20 micrometers, or 10 micrometers. In some embodiments, the device is configured to generate the exposed surface having a central tendency of planarity that deviates from an ideally planar surface by at most about 70%, 50% or 30% relative to the height of the layer. In some embodiments, the device is configured to translate laterally along the material bed at a speed of at least about 50 millimeters per second, where removal of the pre-transformed material is at least in part by attraction. In some embodiments, the device is configured to remove the pre-transformed material from the material bed at a rate of at least about two milliliters of the material bed per second. In some embodiments, the device is configured to remove the pre-transformed material from the material bed using a vacuum source that generates a pressure differential in the device, the pressure differential being at most about 30 kilo pascals, where removal of the pre-transformed material is at least in part by attraction. In some embodiments, the pressure differential is above an ambient pressure external to an enclosure in which the device is disposed during operation. In some embodiments, the device is configured to generate a final layer having a final height at least in part by removing an excess height from an initial layer having an initial height, the initial height being larger than the excess height that is larger than the final height. In some embodiments, the excess height is at most 75*, 50*, 25*, or 10* the final height of the layer, where * designates the mathematical operation of times. In some embodiments, the device is configured to evacuate the pre-transformed material from the cavity along a direction parallel to the exposed surface of the material bed. In some embodiments, the device is configured to operatively couple to an energy beam (e.g., a tiling energy beam) configured to for the three-dimensional printing comprising tiling. In some embodiments, the energy beam has a beam profile configured to be altered at least one time during the printing, e.g., during printing of a layer of transformed material as part of a 3D object. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the device comprises, or is operatively coupled to, a cyclonic separator configured to separate the pre-transformed material. In some embodiments, the device is configured to evacuate the pre-transformed material from the cavity along a direction parallel to an exposed surface of the material bed. In some embodiments, the layer dispensing mechanism comprises a material dispenser or a material leveler. In some embodiments, the first body side has one end and an opposing second end; and the second body side has a third end and an opposing fourth end; and where the one end is coupled to the third end. In some embodiments, the one end is indirectly coupled to the third end through a coupler. In some embodiments, the one end is directly coupled to the third end through a coupler. In some embodiments, the device comprises, or is operatively coupled to, an energy source and/or a scanner configured to direct the energy beam to impinge on the material bed during the three-dimensional printing to transform the pre-transformed material to the transformed material that forms at least a portion of a three-dimensional object; and where the energy source and/or the scanner are controlled based at least in part on a physics simulation. In some embodiments, the physics simulation consider thermal and/or material properties comprising (i) physical properties of the pre-transformed material, (ii) physical properties of the transformed material, or (iii) physical properties of the transformation. In some embodiments, the device comprises, or is operatively coupled to, compliant mounting. In some embodiments, the layer dispensing mechanism comprises a material dispensing mechanism configured to dispense the pre-transformed material during generation of the material bed. In some embodiments, the device is configured facilitate attraction at least in part by being configured to operatively couple to an attractive force source. In some embodiments, the material bed is disposed in an enclosure having an atmosphere, and where the pre-transformed material is attracted at least in part by utilizing a force comprising (i) magnetic, (ii) electrostatic, or (iii) negative pressure differential that is more negative in the cavity as compared to (I) the pressure of the atmosphere of the enclosure and/or (II) a pressure of an ambient atmosphere outside of the enclosure. In some embodiments, the material bed is disposed in an enclosure having an atmosphere including (i) a positive pressure above ambient pressure external to the enclosure and/or (ii) a reactive species at a level below its level at the ambient atmosphere external to the enclosure, which reactive species reacts with the pre-transformed material during printing; where the device is configured to operate in the enclosure during the three-dimensional printing; where the method is performed in the enclosure. In some embodiments, the reactive species comprises oxygen or water. In some embodiments, the atmosphere of the enclosure comprises an inert atmosphere. In some embodiments, the nozzle has a vertical cross section that is asymmetrical. In some embodiments, the channel of the nozzle is straight. In some embodiments, the channel of the nozzle is concavely bent and/or angled, towards the direction of movement of the device along the material bed. In some embodiments, an interior of the channel is concavely bent and/or angled. In some embodiments, during operation, the channel is configured for flow of the pre-transformed material therethrough, and where the channel is concavely bent and/or angled, along a flow direction in which the pre-transformed material flows in the channel during removal. In some embodiments, the device is configured such that during attraction of the pre-transformed material, the first body side is a leading side of the nozzle, and the second body side is a tailing side of the nozzle. In some embodiments, the leading side of the nozzle is configured to facilitate attraction of the pre-transformed material from the material bed into the channel of the nozzle to generate a planar exposed surface of the material bed. In some embodiments, the device is configured to attract the pre-transformed material homogenously, or substantially homogenously, along the channel entrance opening. In some embodiments, the tailing side of the nozzle is configured to facilitate minimizing disturbance of the exposed surface of the material bed. In some embodiments, the leading side of the nozzle comprises a first surface section facing the material bed, the first surface section being planar or substantially planar. In some embodiments, the first surface section is parallel or substantially parallel to the exposed surface of the material bed. In some embodiments, the tailing side of the nozzle comprises a second surface section facing the material bed, the second surface section being planar or substantially planar. In some embodiments, the second surface section of the nozzle is non-parallel to the exposed surface of the material bed. In some embodiments, the tailing side of the nozzle is angled relative to the exposed surface of the material bed. In some embodiments, the first body side and the second body side are symmetrically related to each other. In some embodiments, the first body side and the second body side are symmetrically related to each other along the channel. In some embodiments, the first body side and the second body side are asymmetrically related to each other. In some embodiments, at least one of the first body side and the second body side have a surface facing the material bed, the surface being disposed parallel, or substantially parallel to an exposed surface of the material bed. In some embodiments, at least one of the first body side and the second body side, has a surface facing the material bed, the surface being disposed at an angle relative to an exposed surface of the material bed. In some embodiments, the angle opens away from an entrance port of the channel configured to accept attracted pre-transformed material during operation of the device. In some embodiments, the angle is from about zero degrees to about 85 degrees. In some embodiments, the angle is from about 30 degrees to about 80 degrees. In some embodiments, the pre-transformed material comprises a powder material. In some embodiments, the pre-transformed material comprises a material before it has been transformed in the three-dimensional printing. In some embodiments, the pre-transformed material comprises elemental metal, metal alloy, ceramic, or an allotrope of elemental carbon. In some embodiments, the at least one three-dimensional object comprises elemental metal, metal alloy, ceramic, or an allotrope of elemental carbon. In some embodiments, the transformed material is a fused pre-transformed material. In some embodiments, fused pre-transformed material comprises (I) molten pre-transformed material, or (II) sintered pre-transformed material. In some embodiments, the cavity has an oval or oblong vertical cross section in a first plane. In some embodiments, the oval vertical cross section is a round cross section. In some embodiments, the cavity has an asymmetrical vertical cross section in a second plane perpendicular to the first plane. In some embodiments, the direction of movement is a first direction and where in a second direction perpendicular to the first direction, the cavity is largest at a first end and smallest at a second end opposing the first end. In some embodiments, the cavity extends horizontally beyond the channel of the nozzle at the first end. In some embodiments, the cavity has an opening at the first end to facilitate evacuation of the pre-transformed material from the cavity towards a reservoir. In some embodiments, the opening is in the second plane. In some embodiments, the direction is a first direction, and where an entrance port of the channel of the nozzle substantially spans, or spans, the material bed in a second direction perpendicular to the first direction. In some embodiments, the direction is a first direction, and where the device is configured to attract pre-transformed material substantially evenly, or evenly, from the material bed in a second direction perpendicular to the first direction. In some embodiments, the device is part of a three-dimensional printing system. In some embodiments, during the printing, the three-dimensional printing system is configured to facilitate gas flow away from the one or more optical windows of the three-dimensional printing system, the gas flow being in a direction towards the build platform. In some embodiments, the three-dimensional printing system comprises a build platform. In some embodiments, the build platform is rectangular or elliptical. In some embodiments, the build platform is square or circular. In some embodiments, the material bed generated is generated on the build platform comprising at least one fundamental length scale having a value of at least about 400 mm, 600 mm, 1000 mm, 1200 mm, 1500 mm, or 1750 mm. In some embodiments, the build platform is configured to support a weight of the material bed being of at least about 1000 kg. In some embodiments, the three-dimensional printing system is configured to vertically translate the build platform with an error in vertical positioning of the vertical translation at most about 10%, 5%, or 2% of the vertical translation of the build platform. In some embodiments, the device is configured to operatively couple to a recycling system that is configured to recycle at least a fraction of a portion of the pre-transformed material removed by the device. In some embodiments, the portion removed by the remover is at least about 70%, 50% or 30% of the deposited pre-transformed material. In some embodiments, the fraction recycled is at least about 70% or 90% of the portion removed by the remover. In some embodiments, the device is configured to operate under a positive pressure atmosphere relative to an ambient atmosphere external to the device. In some embodiments, the device is configured to operate under an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide. In some embodiments, the device is configured to facilitate printing one or more three-dimensional objects in an atmosphere maintained to be different from an ambient atmosphere by at least one characteristic, the ambient atmosphere being external to a build module and to a processing chamber. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, the device is configured to facilitate three-dimensional printing, where a portion of the three-dimensional printing comprises connecting particulate matter to facilitate printing the at least one three-dimensional object. In some embodiments, at least a portion of the particulate matter is disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the super alloy comprises Inconel, In718, Ti64, F357, Haynes282, GRCop-42, C22, CA6NM, or Hastelloy-X. In some embodiments, the device facilitates uniform attraction of the pre-transformed material from the material bed along (i) an interior of the channel of the nozzle, (ii) a material entrance port of the channel, or (iii) any combination of (i) and (ii).

In another aspect, a method for three-dimensional printing, the method comprising executing one or more operations associated with at least one configuration of the device of any of the devices above. For example, a method for three-dimensional printing, the method comprises: providing a device body comprising (i) a nozzle having a first body side coupled to a second body side to form a channel in the nozzle, and (ii) a cavity coupled to the channel; the device being part of or operatively coupled to a layer dispensing mechanism that generates a material bed having pre-transformed material that is transformed during the three-dimensional printing to form at least one three-dimensional object; and generating a planar or a substantially planar exposed surface of the material bed at least in part by attracting the pre-transformed material through the channel and into the cavity of the device, where attracting the pre-transformed material is while moving the device in a direction along the material bed without contacting the material bed.

In another aspect, an apparatus for three-dimensional printing, the apparatus comprising at least one controller is configured (i) operatively couple to the device, and (ii) direct executing one or more operations associated with at least one configuration of the device of any of the devices above. For example, an apparatus for three-dimensional printing, the apparatus comprising at least one controller is configured to: (I) operatively couple to the device having a device body comprising (i) a nozzle having a first body side coupled to a second body side to form a channel in the nozzle, and (ii) a cavity coupled to the channel, the device being part of or operatively coupled to a layer dispensing mechanism configured to generate a material bed having pre-transformed material that is transformed during the three-dimensional printing to form at least one three-dimensional object; and (II) direct the device to generate a planar or a substantially planar exposed surface of the material bed at least in part by attracting the pre-transformed material through the channel and into the cavity of the device, where attraction of the pre-transformed material is while moving the device in a direction along the material bed.

In another aspect, non-transitory computer readable program instructions for three-dimensional printing, the non-transitory computer readable program instructions, when read by one or more processors operatively coupled to the device, cause the one or more processors to direct executing operations comprising one or more operations associated with at least one configuration of the device of any of the devices above. For example, non-transitory computer readable program instructions for three-dimensional printing, the non-transitory computer readable program instructions, when read by one or more processors operatively coupled to a device cause the one or more processors to direct executing operations comprising one or more operations, the device having a device body comprising (i) a nozzle having a first body side coupled to a second body side to form a channel in the nozzle, and (ii) a cavity coupled to the channel, the device being part of or operatively coupled to a layer dispensing mechanism configured to generate a material bed having pre-transformed material that is transformed during the three-dimensional printing to form at least one three-dimensional object, the one or more operations comprises: generating a planar or a substantially planar exposed surface of the material bed at least in part by attracting the pre-transformed material through the channel and into the cavity of the device, where attracting the pre-transformed material is while moving the device in a direction along the material bed without contacting the material bed.

In another aspect, a system for three-dimensional printing, the system comprises: at least one energy source; a material leveling mechanism configured to generate a planar exposed surface of the material bed; and at least one controller configured to direct the at least one energy source to generate at least one energy beam configured to generate one or more three-dimensional objects in a printing cycle at least in part by using a tiling printing methodology.

In another aspect, a device for three-dimensional printing, the device comprises: a body having a nozzle and a cavity coupled by a channel of the nozzle, the channel having a bent and/or angled portion, the device being part of, or operatively coupled to, a layer dispensing mechanism (e.g., a recoater) configured to generate a material bed having pre-transformed material that is transformed during the three-dimensional printing to form at least one three-dimensional object; the device being configured to facilitate attraction of the pre-transformed material from the material bed to the nozzle, through the channel into the cavity; and the device being configured to facilitate the attraction of the pre-transformed material (a) while moving in a direction along the material bed and (b) optionally at a position preceding a vertical alignment of the nozzle with the material bed in the direction of movement. In some embodiments, the device is configured to generate a planar, or a substantially planar, exposed surface of the material bed at least in part by attracting the pre-transformed material through the channel and into the cavity. In some embodiments, the device is configured to generate a planar layer of material having an arithmetic average roughness (Ra) value of at most about 70 micrometers, 50 micrometers, or 20 micrometers. In some embodiments, the device is configured to generate a layer of material as part of the material bed, the layer of material having a height of at most about 100 micrometers, 50 micrometers, 20 micrometers, or 10 micrometers. In some embodiments, the device is configured to generate a planar layer of material having a central tendency of planarity that deviates from an ideally planar surface by at most about 70%, 50% or 30% relative to the height of the layer. In some embodiments, the device is configured to translate laterally along the material bed at a speed of at least about 50 millimeters per second. In some embodiments, the device is configured to remove the pre-transformed material from the material bed at a rate of at least about two milliliters of the material bed per second, where removal of the pre-transformed material is at least in part by the attraction. In some embodiments, the device is configured to remove the pre-transformed material from the using a vacuum source generating a pressure differential in the device, the pressure differential being at most about 30 kilo pascals, where removal of the pre-transformed material is at least in part by the attraction. In some embodiments, the pressure differential is above an ambient pressure external to an enclosure in which the device is disposed during operation. In some embodiments, the device is configured to generate a final layer having a final height at least in part by removing an excess height from an initial layer having an initial height, the initial height being larger than the excess height that is larger than the final height, where removal of the pre-transformed material is at least in part by the attraction. In some embodiments, the excess height is at most 75*, 50*, 25*, or 10* the final height of the layer, where * designates the mathematical operation of times. In some embodiments, the device is configured to generate a layer of material as part of the material bed, the layer of material having a height of at most about 100 micrometers, 50 micrometers, 20 micrometers, or 10 micrometers. In some embodiments, the device is configured to evacuate the pre-transformed material from the cavity along a direction parallel to the exposed surface of the material bed. In some embodiments, the device is configured to operatively couple to an energy beam (e.g., a tiling energy beam) configured to for the three-dimensional printing comprising tiling. In some embodiments, the energy beam has a beam profile that is altered at least one time during the printing, e.g., during printing of a layer of transformed material as part of a 3D object. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme. In some embodiments, the device comprises, or is operatively coupled to, a cyclonic separator configured to separate the pre-transformed material. In some embodiments, the device is configured to evacuate the pre-transformed material from the cavity along a direction parallel to an exposed surface of the material bed. In some embodiments, the first body side has one end and an opposing second end; and the second body side has a third end and an opposing fourth end; and where the one end is coupled to the third end. In some embodiments, the one end is indirectly coupled to the third end through a coupler. In some embodiments, the one end is directly coupled to the third end through a coupler. In some embodiments, the device comprises, or is operatively coupled to, an energy source and/or a scanner configured to direct the energy beam to impinge on the material bed during the three-dimensional printing to transform the pre-transformed material to the transformed material that forms at least a portion of a three-dimensional object; and where the energy source and/or the scanner are controlled based at least in part on a physics simulation. In some embodiments, the physics simulation consider thermal and/or material properties comprising (i) physical properties of the pre-transformed material, (ii) physical properties of the transformed material, or (iii) physical properties of the transformation. In some embodiments, the device comprises, or is operatively coupled to, compliant mounting. In some embodiments, the layer dispensing mechanism comprises a material dispensing mechanism configured to dispense the pre-transformed material during generation of the material bed. In some embodiments, the device is configured to facilitate attraction at least in part by being configured to operatively couple to an attractive force source. In some embodiments, the material bed is disposed in an enclosure having an atmosphere, and where the pre-transformed material is attracted at least in part by utilizing a force comprising (i) magnetic, (ii) electrostatic, or (iii) negative pressure differential that is more negative in the cavity as compared to (I) the pressure of the atmosphere of the enclosure and/or (II) a pressure of an ambient atmosphere outside of the enclosure. In some embodiments, the material bed is disposed in an enclosure having an atmosphere including (i) a positive pressure above ambient pressure external to the enclosure and/or (ii) a reactive species at a level below its level at the ambient atmosphere external to the enclosure, which reactive species reacts with the pre-transformed material during printing; where the device is configured to operate in the enclosure during the three-dimensional printing. In some embodiments, the reactive species comprises oxygen or water. In some embodiments, the atmosphere of the enclosure comprises an inert atmosphere. In some embodiments, the nozzle has a vertical cross section that is asymmetrical. In some embodiments, the channel of the nozzle is concavely bent and/or angled, towards the direction of movement of the device along the material bed. In some embodiments, an interior of the channel is concavely bent and/or angled. In some embodiments, during operation, the channel is configured for flow of the pre-transformed material therethrough, and where the channel is concavely bent and/or angled, along a flow direction in which the pre-transformed material flows in the channel during the removal operation. In some embodiments, the nozzle body comprises a first side and a second side that joint together to form the channel. In some embodiments, the device is configured such that during removal operation, the first side is a leading side of the nozzle, and the second side is a tailing side of the nozzle. In some embodiments, the leading side of the nozzle is configured to facilitate attraction of the pre-transformed material from the material bed into the channel of the nozzle to generate a planar exposed surface of the material bed. In some embodiments, the device is configured to attract the pre-transformed material homogenously, or substantially homogenously, along the channel entrance opening. In some embodiments, the tailing side of the nozzle is configured to facilitate minimizing disturbance of the exposed surface of the material bed. In some embodiments, the leading side of the nozzle comprises a first surface section facing the material bed, the first surface section being planar or substantially planar. In some embodiments, the first surface section is parallel or substantially parallel to the exposed surface of the material bed. In some embodiments, the tailing side of the nozzle comprises a second surface section facing the material bed, the second surface section being planar or substantially planar. In some embodiments, the second surface section of the nozzle is non-parallel to the exposed surface of the material bed. In some embodiments, the tailing side of the nozzle is angled relative to the exposed surface of the material bed. In some embodiments, the first side and the second side are symmetrically related to each other. In some embodiments, the first side and the second side are asymmetrically related to each other. In some embodiments, at least one of the first side and the second side have a surface facing the material bed, the surface being disposed parallel, or substantially parallel to an exposed surface of the material bed. In some embodiments, at least one of the first side and the second side have a surface facing the material bed, the surface being disposed at an angle relative to an exposed surface of the material bed. In some embodiments, the angle opens away from an entrance port of the channel configured to accept attracted pre-transformed material during operation of the device. In some embodiments, the angle is from about zero degrees to about 85 degrees. In some embodiments, the angle is from about 30 degrees to about 80 degrees. In some embodiments, the pre-transformed material comprises a powder material. In some embodiments, the pre-transformed material comprises a material before it has been transformed in the three-dimensional printing. In some embodiments, the pre-transformed material comprises elemental metal, metal alloy, ceramic, or an allotrope of elemental carbon. In some embodiments, the at least one three-dimensional object comprises elemental metal, metal alloy, ceramic, or an allotrope of elemental carbon. In some embodiments, the transformed material is a fused pre-transformed material. In some embodiments, fused pre-transformed material comprises (I) molten pre-transformed material, or (II) sintered pre-transformed material. In some embodiments, the cavity has an oval or oblong vertical cross section in a first plane. In some embodiments, the oval vertical cross section is a round cross section. In some embodiments, the cavity has an asymmetrical vertical cross section in a second plane perpendicular to the first plane. In some embodiments, the direction of movement is a first direction and where in a second direction perpendicular to the first direction, the cavity is largest at a first end and smallest at a second end opposing the first end. In some embodiments, the cavity extends horizontally beyond the channel of the nozzle at the first end. In some embodiments, the cavity has an opening at the first end to facilitate evacuation of the pre-transformed material from the cavity towards a reservoir. In some embodiments, the opening is in the second plane. In some embodiments, the direction is a first direction, and where an opening of the channel of the nozzle substantially spans, or spans, the material bed in a second direction perpendicular to the first direction. In some embodiments, the direction is a first direction, and where the device is configured to attract pre-transformed material substantially evenly, or evenly, from the material bed in a second direction perpendicular to the first direction. In some embodiments, the device is part of a three-dimensional printing system. In some embodiments, the three-dimensional printing system comprises a build platform. In some embodiments, the build platform is rectangular or elliptical. In some embodiments, the build platform is square or circular. In some embodiments, the material bed generated is generated on the build platform comprising at least one fundamental length scale having a value of at least about 400 mm, 600 mm, 1000 mm, 1200 mm, 1500 mm, or 1750 mm. In some embodiments, the build platform is configured to support a weight of the material bed being of at least about 1000 kg. In some embodiments, the three-dimensional printing system is configured to vertically translate the build platform with an error in vertical positioning of the vertical translation at most about 10%, 5%, or 2% of the vertical translation of the build platform. In some embodiments, the device is configured to operatively couple to a recycling system that is configured to recycle at least a fraction of a portion of the pre-transformed material removed by the device. In some embodiments, the portion removed by the remover is at least about 70%, 50% or 30% of the deposited pre-transformed material. In some embodiments, the fraction recycled is at least about 70% or 90% of the portion removed by the remover. In some embodiments, the device is configured to operate under a positive pressure atmosphere relative to an ambient atmosphere external to the device. In some embodiments, the device is configured to operate under an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide. In some embodiments, the device is configured to facilitate printing one or more three-dimensional objects in an atmosphere maintained to be different from an ambient atmosphere by at least one characteristic, the ambient atmosphere being external to a build module and to a processing chamber. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, during the printing, the three-dimensional printing system is configured to facilitate gas flow away from the one or more optical windows of the three-dimensional printing system, the gas flow being in a direction towards the build platform. In some embodiments, the device is configured to facilitate three-dimensional printing, where a portion of the three-dimensional printing comprises connecting particulate matter to facilitate printing the at least one three-dimensional object. In some embodiments, at least a portion of the particulate matter is disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the super alloy comprises Inconel, In718, Ti64, F357, Haynes282, GRCop-42, C22, CA6NM, or Hastelloy-X. In some embodiments, the device facilitates uniform attraction of the pre-transformed material from the material bed along (i) an interior of the channel of the nozzle, (ii) a material entrance port of the channel, or (iii) any combination of (i) and (ii).

In another aspect, an apparatus for three-dimensional printing, the apparatus comprising at least one controller is configured (i) operatively couple to the device, and (ii) direct executing one or more operations associated with at least one configuration of the device of any of the devices above.

In another aspect, a non-transitory computer readable program instructions for three-dimensional printing, the non-transitory computer readable program instructions, when read by one or more processors operatively coupled to the device, cause the one or more processors to direct executing operations comprising one or more operations associated with at least one configuration of the device of any of the devices above.

In another aspect, a method for three-dimensional printing, the method comprising executing one or more operations associated with at least one configuration of the device of any of the devices above. For example, a method for three-dimensional printing, the method comprises: attracting pre-transformed material from a material bed into a device through a channel of a nozzle of the device and into a cavity of the device; the device comprising the nozzle, the cavity coupled by the channel disposed in the nozzle, the channel having a bent and/or angled portion; the attracting of the pre-transformed material is (a) while moving in a direction along the material bed and (b) at a position preceding a vertical alignment of the nozzle with the material bed in the direction of movement; and the device being part of, or operatively coupled to, a recoater of the material bed having the pre-transformed material that is transformed during the three-dimensional printing to form at least one three-dimensional object. In some embodiments, the method where the material bed is disposed in an enclosure having an atmosphere, and where the pre-transformed material is attracted at least in part by utilizing a force comprising (i) magnetic, (ii) electrostatic, or (iii) negative pressure differential that is more negative in the cavity as compared to (I) the pressure of the atmosphere of the enclosure and/or (II) a pressure of an ambient atmosphere outside of the enclosure. In some embodiments, the material bed is disposed in an enclosure having an atmosphere including (i) a positive pressure above ambient pressure external to the enclosure and/or (ii) a reactive species at a level below its level at the ambient atmosphere external to the enclosure, which reactive species reacts with the pre-transformed material during printing. In some embodiments, the reactive species comprises oxygen or water. In some embodiments, the atmosphere of the enclosure comprises an inert atmosphere. In some embodiments, the method where the nozzle has a vertical cross section that is asymmetrical. In some embodiments, the method where the channel of the nozzle is bent and/or angled towards the direction of movement of the device along the material bed. In some embodiments, the method where the pre-transformed material comprises a powder material. In some embodiments, the method where the pre-transformed material comprises a material before it has been transformed in the three-dimensional printing. In some embodiments, the method where the pre-transformed material comprises elemental metal, metal alloy, ceramic, or an allotrope of elemental carbon. In some embodiments, the method where the channel has a bent and/or angled portion in the direction away from the direction of propagation of the device during attraction of the pre-transformed material from the material bed and into the cavity of the device. In some embodiments, the method where the at least one three-dimensional object comprises elemental metal, metal alloy, ceramic, or an allotrope of elemental carbon. In some embodiments, the method where the transformed material is a fused pre-transformed material. In some embodiments, the method where fused pre-transformed material comprises (I) molten pre-transformed material, or (II) sintered pre-transformed material. In some embodiments, the method where the cavity has an oval or oblong vertical cross section in a first plane. In some embodiments, the oval vertical cross section is a round cross section. In some embodiments, the method where the cavity has an asymmetrical vertical cross section in a second plane perpendicular to the first plane. In some embodiments, the method where the direction of movement is a first direction and where in a second direction perpendicular to the first direction, the cavity is largest at a first end and smallest at a second end opposing the first end. In some embodiments, the method where the cavity extends horizontally beyond the channel of the nozzle at the first end. In some embodiments, the method where the cavity has an opening at the first end to facilitate evacuation of the pre-transformed material from the cavity towards a reservoir. In some embodiments, the opening is in the second plane. In some embodiments, the method where the direction is a first direction, and where an opening of the channel substantially spans, or spans, the material bed in a second direction perpendicular to the first direction. In some embodiments, the method where the direction is a first direction, and where the device is configured to attract pre-transformed material substantially evenly, or evenly, from the material bed in a second direction perpendicular to the first direction. In some embodiments, the method where the device facilitates uniform attraction of the pre-transformed material from the material bed along (i) an interior of the channel, (ii) a material entrance port of the channel, or (iii) any combination of (i) and (ii).

In another aspect, an apparatus for three-dimensional printing, the apparatus comprising at least one controller is configured (i) operatively couple to the device, and (ii) direct execution of any of the methods above. For example, an apparatus for three-dimensional printing, the apparatus comprising at least one controller configured to: direct attraction of pre-transformed material from a material bed to a nozzle of a device through a channel of the device into a cavity of the device; the device comprising the cavity coupled by the channel disposed in the nozzle, the channel having a bent and/or angled portion; the attraction of the pre-transformed material being (a) while moving in a direction along the material bed and (b) at a position preceding a vertical alignment of the nozzle with the material bed in the direction of movement; and the device being part of, or is operatively coupled to, a recoater of the material bed having the pre-transformed material that is transformed during the three-dimensional printing to form at least one three-dimensional object. In some embodiments, the apparatus where the at least one controller is configured to (i) operatively couple to an attractive force source, and (ii) direct the attractive force source to generate the attractive force for attracting the pre-transformed material from a material bed to the channel of the nozzle of the device. In some embodiments, the apparatus where the attractive force source comprises a vacuum pump, a magnet, a magnetic force generator, or an electrostatic force generator. In some embodiments, the apparatus where the at least one controller comprises circuitry. In some embodiments, the apparatus where the at least one controller is part of, or is operatively coupled to, a hierarchical network of controllers. In some embodiments, the hierarchical network of controllers comprises three or more control hierarchical control levels. In some embodiments, the hierarchical network of controllers comprises a microcontroller. In some embodiments, the apparatus where the at least one controller is configured to control, or direct control of, the three-dimensional printing.

In another aspect, a non-transitory computer readable program instructions for three-dimensional printing, the non-transitory computer readable program instructions, when read by one or more processors operatively coupled to the device, cause the one or more processors to execute operations comprising any of the methods above. For example, a non-transitory computer readable program instructions for three-dimensional printing, the non-transitory computer readable program instructions, when read by one or more processors operatively coupled to a device, cause the one or more processors to execute operations comprising: directing attracting of pre-transformed material from a material bed into a device, and through a channel of the device into a cavity of the device, the channel being disposed in a nozzle of the device; the device comprising the cavity coupled by the channel to the nozzle, the channel having a bent and/or angled portion; the attraction of the pre-transformed material being (a) while moving in a direction along the material bed and (b) at a position preceding a vertical alignment of the device with the material bed in the direction of movement; and the device being part of, or being operatively coupled to, a recoater of the material bed having the pre-transformed material that is transformed during the three-dimensional printing to form at least one three-dimensional object. In some embodiments, the non-transitory computer readable program instructions where the one or more processors are part of, or are operatively coupled to, a hierarchical network of processors. In some embodiments, the non-transitory computer readable program instructions where the hierarchical network of processors comprises three or more hierarchical levels. In some embodiments, the non-transitory computer readable program instructions where the hierarchical network of processors comprises a microprocessor. In some embodiments, the non-transitory computer readable program instructions where the one or more processors are configured to control, or direct control of, the three-dimensional printing. In some embodiments, the non-transitory computer readable program instructions where the one or more processors are operatively coupled to an attractive force source, and where the program instructions are configured to cause the one or more processors to direct the attractive force source to generate the attractive force for attracting the pre-transformed material from a material bed to a nozzle of a device. In some embodiments, the non-transitory computer readable program instructions where the attractive force source comprises a vacuum pump, a magnet, a magnetic force generator, or an electrostatic force generator.

In another aspect, as system for three-dimensional printing comprises: at least one energy source; a layer dispensing mechanism configured to generate a layer of material having a planar exposed surface as part of a material bed; and at least one controller configured to direct the at least one energy source to generate at least one energy beam to transform at least a portion of the material bed to print one or more three-dimensional objects based at least in part on a tiling printing methodology, the one or more three-dimensional objects being printed in a printing cycle. In some embodiments, the layer dispensing mechanism comprises a material dispenser and a material remover. In some embodiments, the at least one energy beam comprises an energy beam. In some embodiments, the energy beam has a beam profile that is altered at least one time during the printing, e.g., during printing of a layer of transformed material as part of a 3D object. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the type of the beam profile is altered by a methodology comprising: physical alteration or alteration via a computational scheme.

In another aspect, a method for three-dimensional printing comprises: (a) impinging an energy beam on an exposed surface of a material bed to transform at least a portion of the material bed to a transformed material to print at least one three-dimensional object in a printing cycle, the energy beam having a beam profile, and (b) during the printing, altering the bream profile of the energy beam. In some embodiments, during printing of a layer of transformed material as part of a 3D object. In some embodiments, alteration of the beam profile comprises alteration of a type of the beam profile. In some embodiments, the type of the beam profile comprises: a gaussian beam profile, a top hat beam profile, or a doughnut (e.g., corona) beam profile. In some embodiments, the energy beam comprises a scanning energy beam or a tiling energy beam. In some embodiments, the energy beam follows a hatching pattern and/or methodology. In some embodiments, the energy beam follows a tiling pattern and/or methodology. In some embodiments, the type of the beam profile is altered by a methodology comprising: physical alteration or alteration via a computational scheme (e.g., algorithm such as a control algorithm).

In another aspect, a system for effectuating the methods, operations of an apparatus, operation of a device, and/or operations inscribed by a non-transitory computer readable program instructions (e.g., inscribed on a media/medium), disclosed herein.

In another aspect, device(s) (e.g., apparatus) for effectuating the methods, operations of an apparatus, and/or operations inscribed by a non-transitory computer readable program instructions (e.g., inscribed on a media/medium).

In another aspect, a system for effectuating the methods, operations of the device, operations of the apparatus, and/or operations inscribed by non-transitory computer readable program instructions (e.g., inscribed on a media/medium), disclosed herein.

In other aspects, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions is inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions is inscribed on at least one medium (e.g., on a medium or on media).

Another aspect of the present disclosure provides methods, systems, apparatuses (e.g., controller(s)), and/or non-transitory computer-readable program instructions (e.g., software) that implement any operation associated with any of the devices disclosed herein. In some embodiments, the program instructions is inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled to the mechanism. In some embodiments, the controller(s) implements any of the methods and/or operations disclosed herein. In some embodiments, the at least one controller comprises, or be operatively coupled to, a hierarchical control system. In some embodiments, the hierarchical control system comprises at least three, four, or five, control levels.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a 3D printer, outside of the 3D printer, in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled to the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two of operations of the apparatus are directed by the same controller. In some embodiments, at least two of operations of the apparatus are directed by different controllers.

In some embodiments, at least operations (e.g., instructions) are carried out by the same processor and/or by the same sub-computer software product. In some embodiments, at least two of operations (e.g., instructions) are carried out by different processors and/or sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled to the mechanism. In some embodiments, the mechanism comprises an apparatus or an apparatus component.

In another aspect, a non-transitory computer-readable medium/media comprising machine-executable code that, upon execution by one or more computer processors, implements any of the methods and/or operations disclosed herein.

In another aspect, a non-transitory computer-readable medium/media comprising machine-executable code that, upon execution by one or more computer processors, effectuates directions of the controller(s) (e.g., as disclosed herein).

In another aspect, a computer system comprising one or more computer processors and a non-transitory computer-readable medium coupled thereto. In some embodiments, the non-transitory computer-readable medium comprises machine-executable code that, upon execution by the one or more computer processors, implements any of the methods disclosed herein and/or effectuates directions of the controller(s) disclosed herein.

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively couple to the device, and (ii) direct executing one or more operations associated with at least one configuration of the device(s) disclosed herein.

In another aspect, non-transitory computer readable program instructions for three-dimensional printing, the non-transitory computer readable program instructions, when read by one or more processors operatively coupled to the device, cause the one or more processors to direct executing one or more operations associated with at least one configuration of the device(s) disclosed herein.

The various embodiments in any of the above aspects are combinable, as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.”, “FIGS.”, “Fig.”, and “Figs.” herein), of which:

FIG. 1 shows a schematic side view of a 3D printing system and apparatuses.

FIG. 2 illustrates a top view of various apertures;

FIG. 3 illustrates schematic top view of 3D objects;

FIGS. 4A-4F illustrate schematic top view of various 3D objects;

FIG. 5 illustrates a path;

FIG. 6 illustrates various paths;

FIG. 7 schematically illustrates an optical system;

FIG. 8 schematically illustrates a side view of a layer dispensing mechanism and various components thereof;

FIG. 9 schematically illustrates vertical cross sectional view of a material removal mechanism;

FIG. 10 schematically illustrates vertical cross sectional view of various nozzles;

FIG. 11 shows various vertical cross sectional views of different 3D objects;

FIG. 12 shows a horizontal view of a 3D object;

FIG. 13 schematically illustrates a coordinate system;

FIGS. 14A-14C show various 3D objects;

FIGS. 15A-15D show schematic top views of 3D objects

FIG. 16 schematically illustrates a computer control system that is programmed or otherwise configured to facilitate the formation of one or more 3D objects;

FIG. 17 schematically illustrates a flow chart for a control system;

FIG. 18 shows a schematic side view of a 3D printing system and apparatuses;

FIG. 19 shows a schematic example of a 3D plane;

FIGS. 20A-20C show various schematic bottom views of powder removal mechanisms;

FIGS. 21A-21E show various schematic bottom views of powder removal mechanisms;

FIG. 22 shows top views of 3D objects;

FIG. 23 illustrates tiling patterns;

FIG. 24 schematically illustrates side view of a material removal mechanism;

FIGS. 25A-25D schematically illustrate side views of layer dispensing mechanisms and various components thereof;

FIGS. 26A-26B schematically illustrate operations in forming a 3D object;

FIG. 27 shows examples of 3D objects;

FIG. 28 schematically illustrates operations in forming a 3D object viewed from the top;

FIG. 29 schematic illustrates a side view of a 3D object in a material bed;

FIGS. 30A-30B show examples of 3D objects;

FIG. 31 schematically illustrates an optical system;

FIG. 32 schematically shows a cross section in portion of a 3D object;

FIG. 33 schematically illustrates side view of a material removal mechanism;

FIGS. 34A-34B show various views of a material removal mechanisms;

FIGS. 35A-35F show various views of material removal mechanism parts;

FIG. 36 schematically shows various portion of a material removal mechanism;

FIG. 37 schematically shows various portion of a material removal mechanism;

FIG. 38 schematically shows various portion of a material removal mechanism;

FIG. 39 schematically shows various portion of a material removal mechanism;

FIGS. 40A-40D schematically illustrate operations in forming a 3D object;

FIG. 41 schematically illustrates a representation of a vertical cross section of a layer of prep-transformed material as part of a material bed; and

FIG. 42 shows topological maps of various exposed surface portions of material beds having a circular horizontal cross section.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a”, “an” and “the” are not intended to refer to only a singular entity, but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When a range is mentioned (e.g., between, at least, at most, and the like) its endpoint(s) is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in X and/or Y (including in the specification and claims) is meant to include (i) X, (ii) Y, and (iii) X and Y. The conjunction of “and/or” in the phrase “including X, Y, and/or Z” is meant to include any combination and plurality thereof. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

“Real time” as understood herein may be during at least part of the printing of a 3D object. Real time may be during a print operation. Real time may be during a print cycle. Real time may comprise: during formation of (i) a 3D object, (ii) a layer of hardened material as part of the 3D object, (iii) a hatch line, or (iv) a melt pool.

The phrase “is/are structured” or “is/are configured,” when modifying an article, refers to a structure of the article that is able to bring about the referred result.

A central tendency as understood herein comprises mean, median, or mode. The mean may comprise a geometric mean.

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid, phase.

The 3D printing process may comprise printing one or more layers of hardened material in a building cycle. A building cycle, as understood herein, comprises printing all (e.g., hardened, or solid) material layers of a print job, which may comprise printing one or more 3D objects above a platform and/or a base (e.g., in a single material bed).

Pre-transformed material, as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may have been transformed by a 3D printer process prior to the upcoming 3D printing process. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even through the remainder powder of the first 3D printing process may comprise transformed material (e.g., bits of sintered powder), it is still considered a pre-transformed material relative to the second 3D printing process. The remainder can be filtered and otherwise recycled for use as a pre-transformed material in the second 3D printing process.

Fundamental length scale (abbreviated herein as “FLS”) can be referred herein as to any suitable scale (e.g., dimension) of an object. For example, a FLS of an object may comprise a length, a width, a height, a diameter, a spherical equivalent diameter, or a diameter of a bounding sphere. In some cases, FLS may refer to an area, a volume, a shape, or a density.

Performing a reversible first operation is understood herein to mean performing the first operation and being capable of performing the opposite of that first operation (e.g., which is a second operation). For example, when a controller directs reversibly opening a shutter, that shutter can also close, and the controller can optionally direct a closure of that shutter.

Where suitable, one or more of the features shown in a figure comprising a 3D printer and/or components thereof can be combined with one or more of the various features of other 3D printers and/or components thereof described herein. A figure shown herein may not show certain features of a 3D printer and/or components thereof described herein. It should be understood that any such features can be incorporated within the 3D printer as requested and where suitable.

Three-dimensional printing (also “3D printing”) generally refers to a process for generating a 3D object. For example, 3D printing may refer to sequential addition of material layer or joining of material layers (or parts of material layers) to form a 3D structure, in a controlled manner. The controlled manner may include automated and/or manual control. In the 3D printing process, the deposited material can be transformed (e.g., fused, sintered, melted, bound, or otherwise connected) to subsequently harden and form at least a part of the 3D object. Fusing (e.g., sintering or melting) binding, or otherwise connecting the material is collectively referred to herein as transforming the material (e.g., transforming the powder material). Fusing the material may include melting or sintering the material. Binding can comprise chemical bonding. Chemical bonding can comprise covalent bonding. Examples of 3D printing include additive printing (e.g., layer by layer printing, or additive manufacturing). 3D printing may include layered manufacturing. 3D printing may include rapid prototyping. 3D printing may include solid freeform fabrication. The 3D printing may further comprise subtractive printing.

There are many different 3D printing methodologies. For example, 3D printing methodologies can comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition.

In some embodiments, the 3D printing method is an additive method in which a first layer is printed, and thereafter a volume of a material is added to the first layer as separate sequential layer (or parts thereof). In some examples, each additional sequential layer (or part thereof) is added to the previous layer by transforming (e.g., fusing (e.g., melting)) a fraction of the pre-transformed (e.g., powder) material and subsequently hardening the transformed material to form at least a portion of the 3D object. The hardening can be actively induced (e.g., by cooling) or can occur without intervention (e.g., naturally by temperature equilibration with the surrounding).

Transformed material, as understood herein, is a material that underwent a physical change. The physical change can comprise a phase change. The physical change can comprise fusing (e.g., melting or sintering), connecting, or bonding (e.g., physical or chemical bond). The physical change can be a phase transformation such as from a solid to a partially liquid, or to a liquid, phase.

The 3D printing process may comprise printing one or more layers of hardened material in a building cycle. A building cycle, as understood herein, comprises printing all (e.g., hardened, or solid) material layers of a print job, which may comprise printing one or more 3D objects above a platform and/or a base.

Pre-transformed material, as understood herein, is a material before it has been transformed (e.g., once transformed) by an energy beam during an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may have been transformed by a 3D printer process prior to the upcoming 3D printing process. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is still considered a pre-transformed material relative to the second 3D printing process. The remainder can be filtered and otherwise recycled for use as a pre-transformed material in the second 3D printing process.

In some embodiments, 3D printing methodologies differ from methods traditionally used in semiconductor device fabrication (e.g., vapor deposition, etching, annealing, masking, or molecular beam epitaxy). For example, 3D printing methodologies can differ from vapor deposition methods such as chemical vapor deposition, physical vapor deposition, or electrochemical deposition. In some instances, 3D printing further comprises one or more printing methodologies that are traditionally used in semiconductor device fabrication. For example, 3D printing may further include vapor deposition methods.

The methods, apparatuses, and systems of the present disclosure can be used to form 3D objects for various uses and applications. Such uses and applications include, without limitation, electronics, components of electronics (e.g., casings), machines, parts of machines, tools, implants, prosthetics, fashion items, clothing, shoes, or jewelry. The implants may be directed (e.g., integrated) to a hard, a soft tissue, or to a combination of hard and soft tissues. The implants may form adhesion with hard and/or soft tissue. The machines may include a motor or motor part. The machines may include a vehicle. The machines may comprise aerospace related machines. The machines may comprise airborne machines. The vehicle may include an airplane, drone, car, train, bicycle, boat, or shuttle (e.g., space shuttle). The machine may include a satellite or a missile. The uses and applications may include 3D objects relating to the industries and/or products listed herein.

The present disclosure provides systems, apparatuses, software, and/or methods for 3D printing of a requested (e.g., desired) 3D object from a pre-transformed material (e.g., powder material). The 3D object (or portions thereof) can be pre-ordered, pre-designed, pre-modeled, or designed in real time (e.g., during the process of 3D printing). For example, the object may be designed as part of the print preparation process of the 3D printing. For example, various portion of the object may be designed as other parts of that object are being printed. Real time is during formation of at least one of: 3D object, a layer of the 3D object, dwell time of an energy beam along a path, dwell time of an energy beam along a hatch line, dwell time of an energy beam forming a tile, and dwell time of an energy beam forming a melt pool.

Pre-transformed material, as understood herein, is a material before it has been first transformed (e.g., once transformed) by an energy beam and/or flux during the 3D printing process. The pre-transformed material may be a material that was, or was not, transformed prior to its use in the 3D printing process. The pre-transformed material may be liquid, solid, or semi-solid (e.g., gel). The pre-transformed material may be a particulate material. The particulate material may be a powder material. The powder material may comprise solid particles of material. The particulate material may comprise vesicles (e.g., containing liquid or semi-solid material). The particulate material may comprise solid or semi-solid material particles.

The fundamental length scale (e.g., the diameter, spherical equivalent diameter, diameter of a bounding circle, or the largest of height, width and length; abbreviated herein as “FLS”) of the printed 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object can be at most about 1000 m, 500 m, 100 m, 80 m, 50 m, 10 m, 5 m, 4 m, 3 m, 2 m, 1 m, 90 cm, 80 cm, 60 cm, 50 cm, 40 cm, 30 cm, 20 cm, 10 cm, or 5 cm. In some cases, the FLS of the printed 3D object may be in between any of the afore-mentioned FLSs (e.g., from about 50 μm to about 1000 m, from about 120 μm to about 1000 m, from about 120 μm to about 10 m, from about 200 μm to about 1 m, or from about 150 μm to about 10 m).

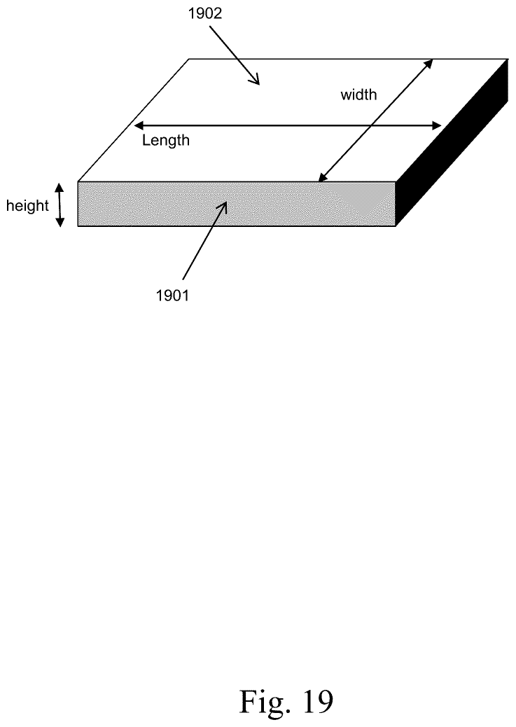

In some examples, the 3D object is a large 3D object. In some embodiments, the 3D object comprises a large hanging structure (e.g., wire, ledge, or shelf). Large may be a 3D object having a fundamental length scale of at least about 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The hanging structure may be a thin structure. The hanging structure may be a plane like structure (referred to herein as “three-dimensional plane,” or “3D plane”). The 3D plane may have a relatively small width as opposed to a relatively large surface area. For example, the 3D plane may have a small height relative to a large horizontal plane. FIG. 19 shows an example of a 3D plane that is planar. The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf.

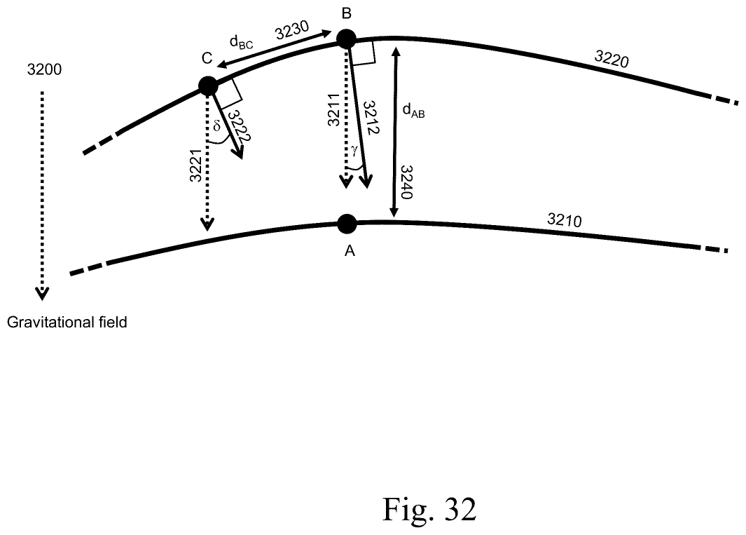

In some embodiments, the 3D object comprises a first portion and a second portion. The first portion may be connected to the rest of the 3D object at one, two, or three sides (e.g., as viewed from the top). The second portion may be connected to the rest of the 3D object at one, two, or three sides (e.g., as viewed from the top). For example, the first and second portion may be connected to a (e.g., central) column, post, or wall of the 3D object. For example, the first and second portion may be connected to an external cover that is a part of the 3D object. The first and/or second portion may be a wire or a 3D plane. The first and/or second portion may be different from a wire or 3D plane. The first and/or second portion may be a blade (e.g., turbine or impeller blade). The first portion may comprise a top surface. Top may be in the direction away from the platform and/or opposite to the gravitational field. The second portion may comprise a bottom surface (e.g., bottom skin surface). Bottom may be in the direction towards the platform and/or in the direction of the gravitational field. FIG. 32 shows an example of a first (e.g., top) surface 3210 and a second (e.g., bottom) surface 3220. At least a portion of the first and second surfaces are separated by a gap. At least a portion of the first surface is separated by at least a portion of the second surface (e.g., to constitute a gap). The gap may be filled with pre-transformed or transformed (e.g., and subsequently hardened) material during the formation of the 3D object. The second surface may be a bottom skin layer. FIG. 32 shows an example of a vertical gap distance 3240 that separates the first surface 3210 from the second surface 3220. The vertical gap distance may be equal to the distance disclosed herein between two adjacent 3D planes. The vertical gap distance may be equal to the vertical distance of the gap as disclosed herein.

Point A may reside on the top surface of the first portion. Point B may reside on the bottom surface of the second portion. The second portion may be a cavity ceiling or hanging structure as part of the 3D object. Point B may reside above point A. The gap may be the (e.g., shortest) distance (e.g., vertical distance) between points A and B. FIG. 32 shows an example of the gap 3240 that constitutes the shortest distance d_{AB} between points A and B. There may be a first normal to the bottom surface of the second portion at point B. FIG. 32 shows an example of a first normal 3212 to the surface 3220 at point B. The angle between the first normal 3212 and a direction of the gravitational acceleration vector 3200 (e.g., direction of the gravitational field) may be any angle γ. Point C may reside on the bottom surface of the second portion. There may be a second normal to the bottom surface of the second portion at point C. FIG. 32 shows an example of the second normal 3222 to the surface 3220 at point C. The angle between the second normal 3222 and the direction of the gravitational acceleration vector 3200 may be any angle δ. Vectors 3211, and 3221 are parallel to the gravitational acceleration vector 3200. The angles γ and δ may be the same or different. The angle between the first normal 3212 and/or the second normal 3222 to the direction of the gravitational acceleration vector 3200 may be any angle alpha. The angle between the first normal 3212 and/or the second normal 3222 with respect to the normal to the substrate may be any angle alpha. The angles γ and δ may be any angle alpha. For example, alpha may be at most about 45°, 40°, 30°, 20°, 10°, 5°, 3°, 2°, 1°, or 0.5°. The shortest distance between points B and C may be any value of the auxiliary support feature spacing distance mentioned herein. For example, the shortest distance BC (e.g., d_{BC}) may be at least about 0.1 millimeters (mm), 0.5 mm, 1 mm, 1.5 mm, 2 mm, 3 mm, 4 mm, 5 mm, 10 mm, 15 mm, 20 mm, 25 mm, 30 mm 35 mm, 40 mm, 50 mm, 100 mm, 200 mm, 300 mm, 400 mm, or 500 mm. As another example, the shortest distance BC may be at most about 500 mm, 400 mm, 300 mm, 200 mm, 100 mm, 50 mm, 40 mm, 35 mm, 30 mm, 25 mm, 20 mm, 15 mm, 10 mm, 5 mm, 4 mm, 3 mm, 2 mm, 1.5 mm, 1 mm, 0.5 mm, or 0.1 mm. FIG. 32 shows an example of the shortest distance BC (e.g., 3230, d_{BC}).

In some instances, it is requested to control the way at least a portion of a layer of hardened material is formed. The layer of hardened material may comprise a multiplicity of melt pools. The FLS (e.g., depth, or diameter) of the melt pool may be at least about 0.5 μm, 1 μm, 5 μm, 10 μm, 20 μm, 30 μm, 40 μm, or 50 m. The FLS of the melt pool may be at most about 0.5 μm, 1 μm, 5 μm, 10 μm, 20 μm, 30 μm, 40 μm, or 50 m. The FLS of the melt pool may be any value between the afore-mentioned values (e.g., from about 0.5 m to about 50 μm, from about 0.5 m to about 10 μm, from about 10 m to about 30 μm, or from about m to about 50 m.

In some instances, it is requested to control one or more characteristics of the fabricated 3D object (e.g., or portions thereof). For example, it may be requested to control a hanging structure (e.g., ceiling of a cavity or ledge) as part of the 3D object. The 3D printing methods described herein may utilize at least one of a tiling energy flux and a scanning energy beam (collectively referred to herein as “irradiated energy”). The tiling energy flux and the scanning energy beam may differ by at least one irradiated energy characteristics. For example, the tiling energy flux and the scanning energy beam differ in their cross section (e.g., with the tiling energy flux having a larger cross section than the scanning energy beam). For example, the tiling energy flux and the scanning energy beam differ in their power density (e.g., with the tiling energy flux having a lower power density than the scanning energy beam). For example, the tiling energy flux and the scanning energy beam differ in their focus (e.g., with the scanning energy source being more focused than the tiling energy flux). For example, the tiling energy flux and the scanning energy beam differ in their path trajectory while generating (e.g., directly or indirectly) a layer of hardened material (e.g., with the tiling energy flux traveling along the path of tile trajectory, whereas the scanning energy beam hatches along another trajectory). For example, the tiling energy flux and the scanning energy beam differ in the portions of transformed and/or hardened material they generate on forming a layer of transformed and/or hardened material as part of the 3D object (e.g., with the tiling energy flux forming a first portion of transformed material, whereas the scanning energy beam forms a second portion of transformed material that may or may not connect, or overlap). Both the tiling energy flux and the scanning energy be collimated. Both tiling energy flux and scanning energy source may be generated by the same (e.g., type of) energy source. Both tiling energy flux and scanning energy source may be directed by the same (e.g., type of) scanner. Both tiling energy flux and scanning energy source may travel through by the same (e.g., type of) optical window.

In some instances, it is requested to control one or more characteristics of the melt pools that forms the layer of hardened material. The characteristics may comprise the depth of a melt pool, microstructure, or the repertoire of microstructures of the melt pool. The microstructure of the melt pool may comprise the crystalline structure, or crystalline structure repertoire that is included in the melt pool. In some instances, a greater control over the one or more characteristics of the melt pool makes use of (i) a technique that will be referred to herein as “flash heating,” (ii) a technique that is referred to herein as “deep tiling,” (iii) a technique that is referred herein as “shallow tiling.” The flash heating and/or deep tiling methods allows, for example, control of microstructure(s) formed by cooling of a locally heated and/or transformed material. Flash heating is focused on the lateral (e.g., horizontal) spread of the irradiated energy in the material bed (e.g., and the 3D object within). Deep tiling focuses on the depth to which the irradiating energy penetrates the material bed (e.g., and 3D object within). The irradiation methodology may comprise flash heating or deep tiling. In an embodiment, the irradiation method includes both deep tiling and flash heating (e.g., the irradiation energy penetrates deep into the 3D object and considerably spreads laterally around the melt pool). In some examples, considerably is at least about 2, 3, 4, 5, 6, 7, or 10 melt pool fundamental length scales (e.g., diameters) away from the melt pool center formed by the irradiating energy.

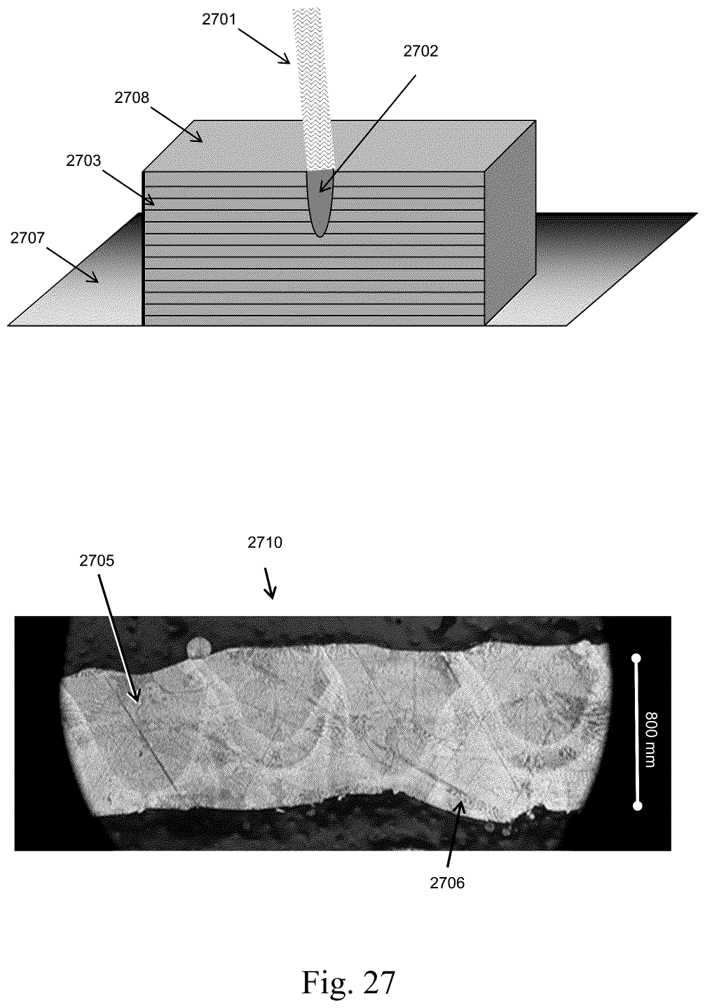

In some embodiments, the tiling method (e.g., deep tiling and/or shallow tiling) comprises heating at least a portion of a material bed, and/or a previously formed area of hardened material using at least one energy source which will be referred to herein as the “tiling energy source.” FIG. 27 shows an example of an energy beam 2701 that irradiates layers of hardened material that were previously formed (e.g., 2703 represents a layer of hardened material), which together make up a 3D object that is disposed on a platform 2707. The heated area is schematically shown in the example of 2702. In some embodiments, the heated area may comprise an area of transformed material. The heated area may encompass the bottom skin layer. The heated area may comprise a heat affected zone. The heated area may allow a parallel position at the bottom skin layer to reach an elevated temperature that is above the solidus temperature (e.g., and at or below the liquidus temperature) of the material at the bottom skin layer, transform (e.g., sinter or melt), become liquidus, and/or plastically yield. For example, the heated area may allow the layers comprising the bottom skin layer to reach an elevated temperature that is above the solidus temperature of the material (e.g., and at or below the liquidus temperature of the material at the previously formed layer such as the bottom skin layer), transform, become liquidus, and/or plastically yield (e.g., in the deep tiling process). Flash heating may be done with the tiling energy beam.

A tile, as understood herein, is a portion of material (e.g., transformed and/or hardened) that is generated or heated by the tiling energy flux or by the scanning energy beam. In some examples, the tiling energy source generates the tiling energy flux. The tiling energy source may generate an energy beam. The tiling energy source may be a radiative energy source. The tiling energy source may be a dispersive energy source. The tiling energy source may generate a (e.g., substantially) uniform (e.g., homogenous) energy stream. The tiling energy source may generate a (e.g., substantially) uniform (e.g., homogenous) energy stream at least across the beam area that forms the tile. The tiling energy source may comprise at least a portion of a cross section (e.g., and/or footprint on a target surface) having a (e.g., substantially) homogenous fluence. The energy generated by the tiling energy source is referred herein as the “tiling energy flux.” The tiling energy flux may heat a portion of a 3D object (e.g., an exposed surface of the 3D object). The tiling energy flux may heat a portion of the material bed. The portion of the material bed may comprise an exposed surface portion of the material bed and/or a deeper portion of the material bed that is not exposed). Heating by the tiling energy flux may be (e.g., substantially) uniform at least in the beam area that forms the tile. In an example, the material bed is a powder bed.

In an embodiment, the tilling energy flux irradiates (e.g., flashes, flares, shines, or streams to) a position on the target surface for a time-period (e.g., predetermined time-period). The time in which the tiling energy flux (e.g., beam) irradiates is referred to herein as a “dwell time” of the tiling energy flux. The heat irradiation may be further transmitted form the heated tile, for example, to adjacent portions of the material bed. During this time-period (e.g., of irradiating the tile), the tiling energy flux may be (e.g., substantially) stationary. During that time-period, the tiling energy may (e.g., substantially) not translate (e.g., neither in a raster form nor in a vector form). During this time-period the energy density of the tiling energy flux may be (e.g., substantially) constant. In some embodiments, during this time-period the energy density of the tiling energy flux may vary. The variation may be predetermined. The variation may be controlled (e.g., by a controller and/or manually). The controller may determine the variation based on a signal received by one or more sensors. The controller may determine the variation based on an algorithm. The controlled variation may comprise a closed loop or open loop control. For example, the variation may be determined based on temperature and/or imaging measurements, among other sensed signals. The variation may be determined by melt pool FLS (e.g., size) evaluation. The variation may be determined based on height measurements of the forming 3D object.

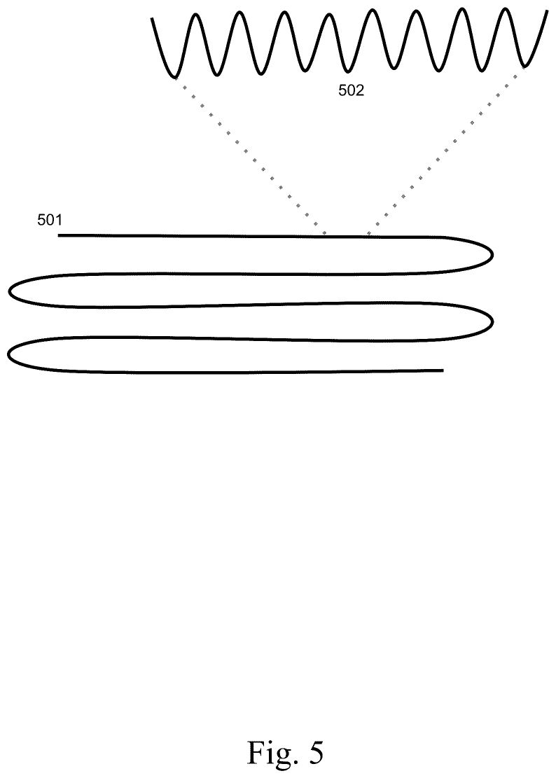

In some embodiments, (e.g., substantially) stationary comprise spatial oscillations that are smaller than the FLS (e.g., diameter) of the energy beam. The spatial oscillation may be in a range that is smaller than (i) the diameter of the cross section of the energy beam, and/or (ii) of the diameter equivalent of the footprint of the energy beam on the target surface. For example, the spatial oscillation range of the energy beam can be at most 90%, 80%, 60%, 50%, 40%, 30%, 20%, 10%, 5%, 1% or 0.5% of the diameter (i) of the cross section of the energy beam, and/or (ii) of the diameter equivalent of the footprint of the energy beam on the target surface. The energy beam may be the tiling energy flux and/or the scanning energy beam. Spatial oscillation is an oscillation in space (e.g., with respect to the target surface). Spatial oscillation may be oscillations in the location of the energy beam (e.g., with respect to the target surface). The spatial oscillation may be in the location of the irradiated beam. The spatial oscillations may be along the general movement direction of the irradiated energy (e.g., along the hatch. E.g., along the path of tiles); for example, the spatial oscillations may comprise back and forth movement of the irradiated energy; for example, the spatial oscillations may be in an axis parallel to the general direction of movement of the irradiated energy. The spatial oscillations may be along a direction that is perpendicular to the general movement direction of the irradiated energy; for example, side to side movement (e.g., FIG. 5, 502) with respect to the general direction of movement of the irradiated energy (e.g., 501); for example, the spatial oscillations may be in an axis perpendicular to the general direction of movement of the irradiated energy. The spatial oscillations may be along an axis forming any angle (e.g., that is not perpendicular or parallel) with the general movement direction of the irradiated energy, for example, side to side movement with respect to the general direction of movement of the irradiated energy.

In an example, the tilling energy flux irradiates a position on the target surface for a time-period (e.g., predetermined) to form the heated tile with (e.g., having) a constant or variable power density (i.e., power per unit area) of the tiling energy flux. The target surface may be an exposed surface of the material bed, platform, 3D object (e.g., forming 3D object), or any combination thereof. In some embodiments, the variation in the power density comprises an initial increase in power density of the tiling energy flux, followed by a decrease in the power density. For example, the variation may comprise initial increase in the power density of the tiling energy flux, followed by a plateau, and a subsequent decrease in the power density. The increase and/or decrease in the power density of the tiling energy flux may be linear, logarithmic, exponential, polynomial, or any combination or permutation thereof. The plateau may comprise of a (e.g., substantially) constant energy density. The manner of (e.g., function used in) the variation in the power density of the tiling energy flux may be influenced by (i) a measurement (e.g., a signal of the one or more sensors), (ii) theory (e.g., by simulation), (iii) or any combination thereof. The duration and/or peak of the power density plateau of the tiling energy flux may be influenced by (i) a measurement (e.g., a signal of the one or more sensors), (ii) theory (e.g., by simulations), (iii) or any combination thereof.

In some embodiments, the tiling energy flux has an extended cross section. For example, the tiling energy flux has a FLS (e.g., cross section) that is larger than the scanning energy beam. The FLS of a cross section of the tiling energy flux may be at least about 0.2 millimeters (mm), 0.3 mm, 0.4 mm, 0.5 mm, 0.8 mm, 1 mm, 1.5 mm, 2 mm, 2.5 mm, 3 mm, 3.5 mm, 4 mm, 4.5 mm, or 5 mm. The FLS of a cross section of the tiling energy flux may be between any of the afore-mentioned values (e.g., from about 0.2 mm to about 5 mm, from about 0.3 mm to about 2.5 mm, or from about 2.5 mm to about 5 mm). The cross section of the energy beam can be at least about 0.1 millimeter squared (mm²), or 0.2. The diameter of the energy beam can be at least about 300 micrometers, 500 micrometers, or 600 micrometers. The distance between the first position and the second position can be at least about 100 micrometers, 200 micrometers, or 250 micrometers. The FLS may be measured at full width half maximum intensity of the energy beam. In some embodiments, the tiling energy flux is a focused energy beam. In some embodiments, the tiling energy flux is a defocused energy beam. The energy profile of the tiling energy flux may be (e.g., substantially) uniform (e.g., in the beam cross sectional area that forms the tile). The energy profile of the tiling energy flux may be (e.g., substantially) uniform during the exposure time (e.g., also referred to herein as tiling time, or dwell time). The exposure time (e.g., at the target surface) of the tiling energy flux may be at least about 0.1 milliseconds (msec), 0.5 msec, 1 msec, 10 msec, 20 msec, 30 msec, 40 msec, 50 msec, 60 msec, 70 msec, 80 msec, 90 msec, 100 msec, 200 msec, 400 msec, 500 msec, 1000 msec, 2500 msec, or 5000 msec. The exposure time (e.g., at the target surface) of the tiling energy flux may be at most about 10 msec, 20 msec, 30 msec, 40 msec, 50 msec, 60 msec, 70 msec, 80 msec, 90 msec, 100 msec, 200 msec, 400 msec, 500 msec, 1000 msec, 2500 msec, or 5000 msec. The exposure time may be between any of the above-mentioned exposure times (e.g., from about 0.1 msec to about 5000 msec, from about 0.1 to about 1 msec, from about 1 msec to about 50 msec, from about 50 msec to about 100 msec, from about 100 msec to about 1000 msec, from about 20 msec to about 200 msec, or from about 1000 msec to about 5000 msec). The exposure time may be the dwell time. The power per unit area of the tiling energy flux may be at least about 100 Watts per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², or 7000 W/mm². The power per unit area of the tiling energy flux may be at most about 100 W/mm², 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², 8000 W/mm², 9000 W/mm², or 10000 W/mm². The power per unit area of the tiling energy flux may be any value between the afore-mentioned values (e.g., from about 100 W/mm² to about 3000 W/mm², from about 100 W/mm² to about 5000 W/mm², from about 100 W/mm² to about 9000 W/mm², from about 100 W/mm² to about 500 W/mm², from about 500 W/mm² to about 3000 W/mm², from about 1000 W/mm² to about 7000 W/mm², or from about 500 W/mm² to about 8000 W/mm²). The tiling energy flux may emit energy stream towards the target surface in a step and repeat sequence.

In some embodiments, the tiling energy flux emits an energy stream towards the target surface in a step and repeat type sequence to effectuate the tile forming process. The tiling energy flux may comprise radiative heat, electromagnetic radiation, charge particle radiation (e.g., e-beam), or a plasma beam. The tiling energy source may comprise a heater (e.g., radiator or lamp), electromagnetic radiation generator (e.g., laser), charge particle radiation generator (e.g., electron gun), or a plasma generator. The tiling energy source may comprise a diode laser. The tiling energy source may comprise s light emitting diode array (or LED array). The tiling energy source may be any radiation source disclosed herein. The tilling energy beam may be any energy beam disclosed herein.

In some embodiments, the tiling energy flux irradiates a pre-transformed material, a transformed material, and/or a hardened material. The pre-transformed material may be disposed in a material bed (e.g., a powder bed). The pre-transformed material may be ejected onto the target surface. In some examples, the tiling energy flux irradiates a target surface. The tiling energy flux may additionally irradiate the pre-transformed material as it travels towards the target surface (e.g., using a direct material deposition type 3D printing). The target surface may comprise a pre-transformed material, a transformed material, or a hardened material. The tiling energy source may generate a tiling energy flux direct (e.g., using an optical system) it on the target surface. The tiling energy flux may heat a portion of the target surface. The tiling energy flux may transform a portion (e.g., fraction) of the target surface. The tiling energy flux may preheat the target surface (e.g., to be followed by the scanning energy beam that optionally transforms at least a portion of the preheated surface). The tiling energy flux may post heat the target surface (e.g., following a transformation of the target surface). The tiling energy flux may post heat the target surface (e.g., to reduce a cooling rate of the target surface). The heating may be at a specific location (e.g., where the tile is formed from pre-transformed material).

In some examples, the tile forming procedure comprises a wide exposure space of the tiling energy flux (e.g., a wide footprint on the target surface). In some examples, the tile forming procedure comprises a long dwell time (e.g., exposure time) of the tiling energy flux, which dwell time may be at least about 0.5 millisecond, 1 millisecond, 0.5 second, 1 second, 0.5 minute, or 1 minute. The tiling energy flux may irradiate the target surface for even longer periods of time (e.g., for example, 1 hour, or 1 day). In principle, the tiling energy flux may have a dwell time that is infinity. The tiling energy flux (e.g., FIG. 27, 2701) may emit a low energy flux for a long time-period to transform portions of pre-formed layers of hardened material (e.g., 2702). These pre-formed layers of hardened material may be deep layers within the 3D object (e.g., FIG. 27, layer 2703). The tiling energy flux may emit a low energy flux to control the cooling rate of a position within a layer of transformed material. The low cooling rate may control the solidification (e.g., rate and/or microstructure) of the transformed (e.g., molten) material. For example, the low cooling rate may allow formation of crystals (e.g., single crystals) at specified location within the layer that is included in the 3D object.

In some examples, the tiling energy flux transforms (e.g., melts) a portion of a 3D object (e.g., comprising an exposed surface of the 3D object), at a time-period. In some embodiments, the transformation may be (e.g., substantially) uniform (e.g., in rate and/or microstructure). In some embodiments, the transformation may vary (e.g., in rate and/or microstructure). The (e.g., substantially) uniform heating may be akin to heat stamping of the target surface (e.g., a layer of hardened material and/or of pre-transformed material) by the tiling energy flux. A cross section of the heat stamp (also herein “heat tile”) may be (e.g., substantially) similar to the footprint of the tiling energy flux, on the target surface. The (e.g., (e.g., substantially) uniform) irradiation by the tiling energy flux may form heat tiles on the target surface.

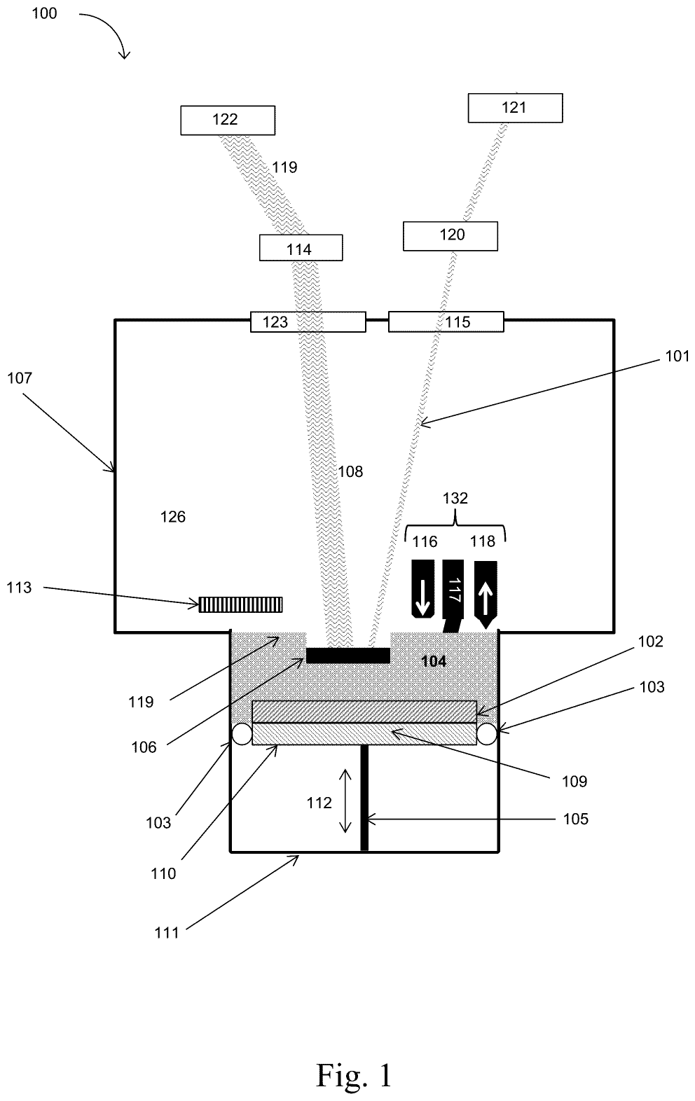

FIG. 1 shows an example of a 3D printing system and apparatuses, including a tiling energy source 122 that emits a tiling energy flux 119. The tiling energy flux may travel through an optical system (e.g., 114. E.g., comprising an aperture, lens, mirror, or deflector) and/or an optical window (e.g., 123) to irradiate a target surface. The optical system may comprise a scanner. The target surface may be a portion of a hardened material 106 that was formed by transforming at least a portion of a pre-transformed material (e.g., disposed in a material bed 104, or streamed towards a platform) by a scanning energy beam 101. The scanning energy beam 101 is generated by an energy source 121. The generated energy beam may travel through an optical mechanism 120 (e.g., scanner) and/or an optical window 115.

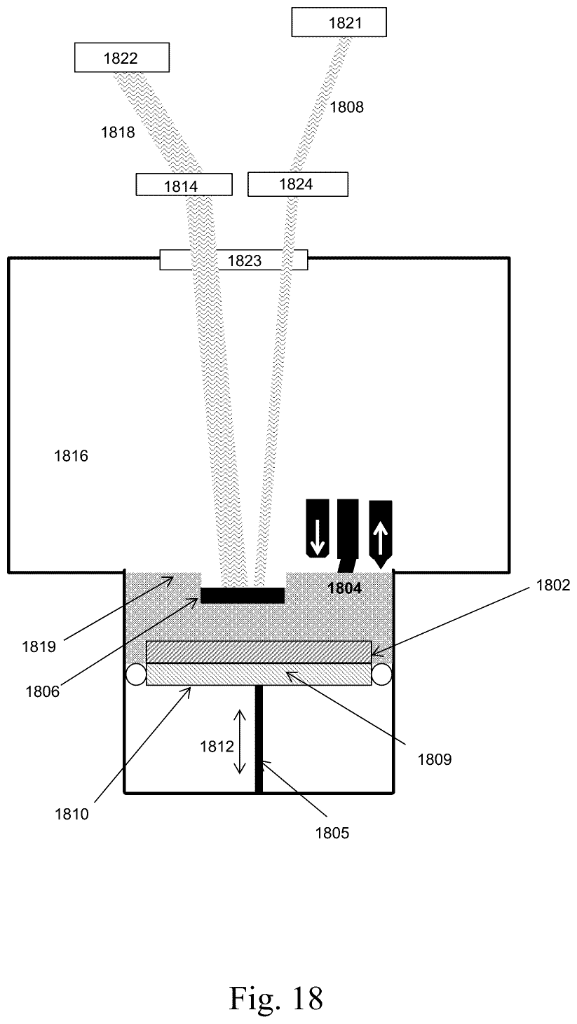

In some examples, the tiling energy flux and the scanning energy beam travel through the same optical window and/or through the same optical system. FIG. 18 shows an example where the tiling energy flux 1818 is generated by an energy source 1822, and travels through an optical system 1814; the scanning energy source 1821 generates a scanning energy beam 1808 which travels through an optical system 1824 and both travel through same optical window 1823 into the processing chamber 1816 to form the 3D object 1806 from a material bed 1804, while irradiating the exposed surface of the material bed, which material bed rests on a platform comprising a substrate 1809 and a base 1802, the material bed 1804 having an exposed surface 1819. The substrate 1809 (e.g., piston) is vertically translatable 1812 by an actuator 1805 (e.g., elevator). The tiling energy flux 1818 in the example of FIG. 18, has a larger cross section than the scanning energy beam 1808. In some embodiments, the tiling energy flux and the scanning energy beam both travel through the same optical system, albeit through different components within the optical system and/or at different instances. In some embodiments, the tiling energy flux and the scanning energy beam travel through different optical systems (e.g., and through the same optical window). The tiling energy flux and the scanning energy beam may travel through the same or different optical windows.

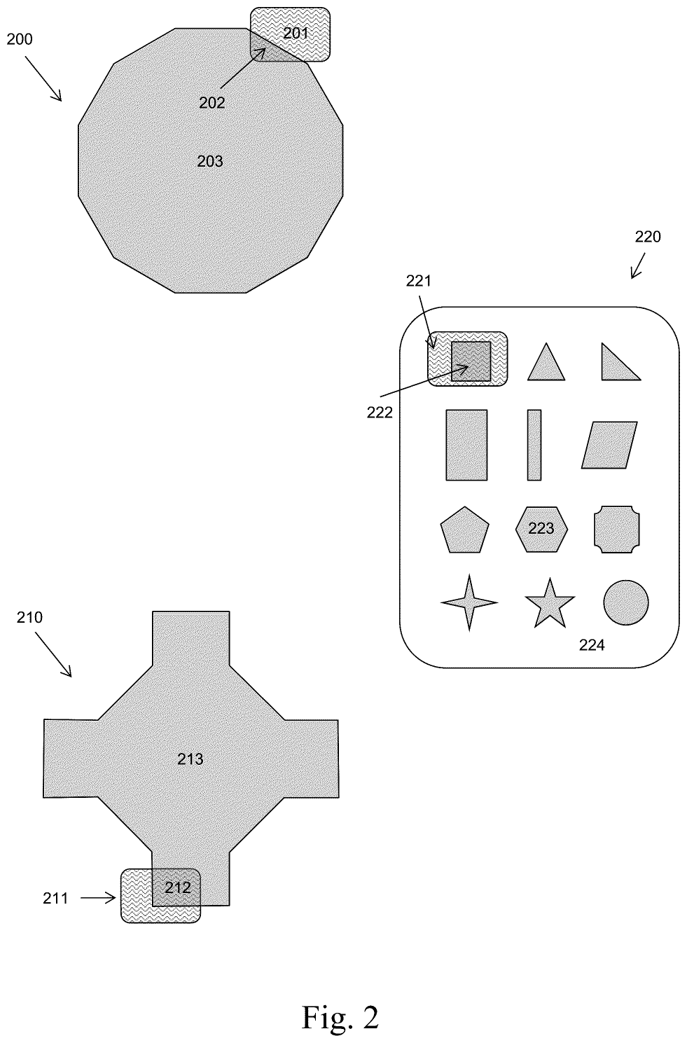

In some embodiments, the emitted radiative energy (e.g., FIG. 1, 119) travels through an aperture, deflector and/or other parts of an optical system (e.g., schematically represented as FIG. 1, 114). At times, the aperture restricts the amount of energy generated by the tiling energy source which reaches the target surface. The aperture restriction may redact (e.g., cut off, block, obstruct, or discontinue) the energy beam to form a requested shape of a footprint (e.g., that may form the tile). Redaction of the energy beam may comprise redaction of a cross-section or footprint of the energy beam. The restriction may redact the energy beam to form a redacted tile cross section. Examples of apertures are shown in FIGS. 2, 200, 210, and 220. The aperture may allow only a portion of the emitted tiling energy flux from the tiling energy source (e.g., 202, 212, or 222) to reach the target surface. Examples of aperture holes are represented in 203, 213, and 223. The aperture may include one opening or several openings (e.g., geometric shapes in 220). The cross section of the tiling energy flux may be seen in FIGS. 2, 201 and 202, wherein 202 is the portion of the footprint that is blocked by the aperture, and the section 202 is the part of the energy flux that is free to travel past the aperture.

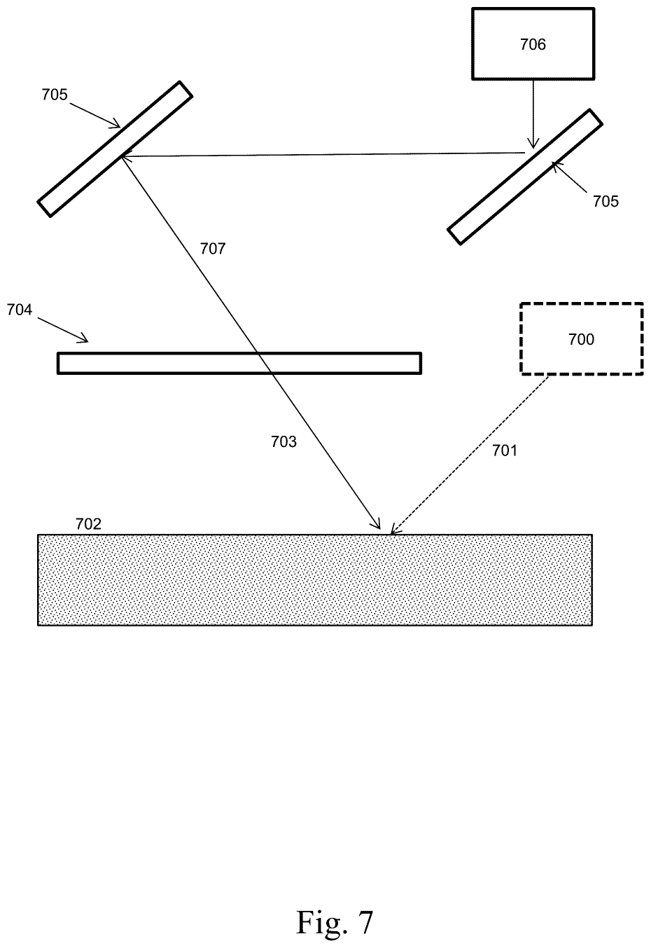

FIG. 7 shows an example of an optical mechanism within a 3D printing system: an energy source 706 irradiates energy (e.g., emits an energy beam) that travels between mirrors 705 that direct it through an optical window 704 to a position on the target surface 702 (e.g., exposed surface of a material bed). The irradiated energy may also be directly projected on the target surface, for example, irradiated energy (e.g., and energy beam) 701 can be generated by an energy source 700 (e.g., that may comprise an internal optical mechanism, such as within a laser) and be directly projected onto the target surface.

The hardened material may comprise at least a portion of one or more (e.g., a few) layers of hardened material disposed above a platform and/or a pre-transformed material (e.g., powder) disposed in the material bed. The one or more layers of hardened material may be susceptible to deformation during formation, or not susceptible to deformation during formation. The deformation may comprise bending, warping, arching, curving, twisting, balling, cracking, or dislocating. In some examples, the at least a portion of the one or more layers of hardened material may comprise a ledge or a ceiling of a cavity. The deformation may arise, for example, when the formed 3D object (or a portion thereof) lacks auxiliary support structure(s), during the cooling process of the transformed material. The deformation may arise, for example, when the formed structure (e.g., 3D object or a portion thereof) floats anchorless in the material bed), during the cooling process of the transformed material.

The tiling energy flux may comprise (i) an extended exposure area, (ii) extended exposure time, (iii) low power density (e.g., power per unit area) or (iv) an intensity profile that can fill an area with a flat (e.g., top head) energy profile. Extended may be in comparison with the scanning energy beam. The extended exposure time may be at least about 1 millisecond and at most 100 milliseconds. In some embodiments, an energy profile of the tiling energy source may exclude a Gaussian beam or round top beam. In some embodiments, an energy profile of the tiling energy source may include a Gaussian beam or round top beam. In some embodiments, the 3D printer comprises a first and/or second scanning energy beams. In some embodiments, an energy profile of the first and/or second scanning energy may comprise a Gaussian energy beam. In some embodiments, an energy profile of the first and/or second scanning energy may exclude a Gaussian energy beam. The first and/or second scanning energy may have any cross-sectional shape comprising an ellipse (e.g., circle), or a polygon (e.g., as disclosed herein). The scanning energy beam may have a cross section with a diameter of at least about 50 micrometers (μm), 100 μm, 150 μm, 200 μm, or 250 μm. The scanning energy may have a cross section with a diameter of at most about 60 micrometers (μm), 100 μm, 150 μm, 200 μm, or 250 μm. The scanning energy may have a cross section with a diameter of any value between the afore-mentioned values (e.g., from about 50 μm to about 250 μm, from about 50 μm to about 150 μm, or from about 150 μm to about 250 μm). The power density (e.g., power per unit area) of the scanning energy beam may at least about 5000 W/mm², 10000 W/mm², 20000 W/mm², 30000 W/mm², 50000 W/mm², 60000 W/mm², 70000 W/mm², 80000 W/mm², 90000 W/mm², or 100000 W/mm². The power density of the scanning energy beam may be at most about 5000 W/mm², 10000 W/mm², 20000 W/mm², 30000 W/mm², 50000 W/mm², 60000 W/mm², 70000 W/mm², 80000 W/mm², 90000 W/mm², or 100000 W/mm². The power density of the scanning energy beam may be any value between the afore-mentioned values (e.g., from about 5000 W/mm² to about 100000 W/mm², from about 10000 W/mm² to about 50000 W/mm², or from about 50000 W/mm² to about 100000 W/mm²). The scanning speed of the scanning energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the scanning energy beam may be at most about 50 mm/sec, 100 mm/sec, 500 mm/sec, 1000 mm/sec, 2000 mm/sec, 3000 mm/sec, 4000 mm/sec, or 50000 mm/sec. The scanning speed of the scanning energy beam may any value between the afore-mentioned values (e.g., from about 50 mm/sec to about 50000 mm/sec, from about 50 mm/sec to about 3000 mm/sec, or from about 2000 mm/sec to about 50000 mm/sec). The scanning energy beam may be continuous or non-continuous (e.g., pulsing). In some embodiments, the scanning energy beam compensates for heat loss at the edges of the target surface after the heat tiling process (e.g., forming the tiles by utilizing the tiling energy flux).

In some embodiments, the tiling energy source is the same as the scanning energy source. In some embodiments, the tiling energy source is different than the scanning energy source. FIG. 1 shows an example where the tiling energy source 122 is different from the scanning energy source 121. The tiling energy source may travel through an identical, or a different optical window than the scanning energy source. FIG. 1 shows an example where the tiling energy flux travels through one optical window 123, and the scanning energy 101 travels through a second energy window 115 that is different. The tiling energy source and/or scanning energy source can be disposed within the enclosure, outside of the enclosure (e.g., as in FIG. 1), or within at least one wall of the enclosure. The optical mechanism through which the tiling energy flux and/or the scanning energy beam travel can be disposed within the enclosure, outside of the enclosure, or within at least one wall of the enclosure (e.g., as in FIGS. 1, 123 and 115)

The energy profile of the energy flux (e.g., beam) may represent the spatial intensity profile of the energy flux (e.g., beam) at a particular plane transverse to the beam propagation path. The energy flux profile (e.g., energy beam profile) may be represented as the power or energy of the energy flux plotted as a function of a distance within its cross section (e.g., that is perpendicular to its propagation path). The energy flux profile of the tiling energy flux may be (e.g., substantially) uniform (e.g., homogenous). The energy flux profile may correspond to the tiling energy flux. The energy beam profile may correspond to the energy profile of the first scanning energy beam and/or the second scanning energy beam.

The system and/or apparatus may comprise an energy profile alteration device that evens (e.g., smooths, planarizes, or flattens) out any irregularities in the energy flux profile. The system and/or apparatus may comprise an energy profile alteration device that creates a more uniform energy flux profile, in at least a portion of the energy profile cross section (e.g., relative to the center of the beam). The energy profile alteration device may comprise an energy flux (e.g., beam) homogenizer. The homogenizer can comprise a mirror. The mirror may be multifaceted. The mirror may comprise square facets. The mirror may reflect the energy flux at various (e.g., different) angles to create a beam with a more uniform power across at least a portion (e.g., the entire) of the beam profile (e.g., resulting in a “top hat” profile), as compared to the original (e.g., incoming) energy flux. The energy profile alteration device may output a (e.g., substantially) evenly distributed power/energy of the energy flux across an energy beam cross section (e.g., forming an energy flux profile), instead of its original non-evenly distributed energy flux profile shape (e.g., Gaussian shape). The energy profile alteration device may comprise an energy flux profile shaper (e.g., beam shaper). The energy profile alteration device may create a certain (e.g., predetermined) shape to the energy flux profile. The energy profile alteration device may spread the central concentrated energy within the energy flux profile along the energy flux cross section (e.g., FLS of the energy flux, or FLS of the tile (a.k.a “stamp”)). The energy profile alteration device may output a grainy energy flux profile. The energy profile alteration device may comprise a dispersive or partially transparent glass. The glass can be a frosted, milky, or murky glass. The energy profile alteration device may generate a blurry energy flux. The energy profile alteration device may generate a defocused energy flux, after which the energy flux that entered the energy profile alteration device will emerge as an energy flux having a more homogenized energy flux profile.

In some examples, the apparatus and/or systems disclosed herein include an optical diffuser. The optical diffusion may create wave front distortion of an irradiated beam. The optical diffuser may comprise a digital phase mask. The optical diffuser may diffuse light (e.g., substantially) homogenously. The optical diffuser may remove high intensity energy (e.g., light) distribution and form a more even distribution of light across the footprint of the energy beam and/or flux. The optical diffuser may reduce the intensity of the energy beam and/or flux (e.g., act as a screen). For example, the optical diffuser may alter an energy beam with Gaussian profile, to an energy beam having a top-hat profile. The optical diffuser may comprise a diffuser wheel assembly. The energy profile alteration device may comprise a diffuser-wheel (a.k.a., diffusion-wheel). The diffuser-wheel may comprise a filter wheel. The diffuser-wheel may comprise a filter or diffuser. The diffuser-wheel may comprise multiple optical filters or multiple optical diffusers. The filters and/or diffusers in the diffuser-wheel may be arranged linearly, non-linearly, or any combination thereof. The energy profile alteration device and/or any of its components may be controlled (e.g., monitored and/or regulated) by the controller, and be operatively coupled thereto. The diffuser-wheel may comprise one or more ports (e.g., opening and/or exit ports) from/to which an energy ray (e.g., beam and/or flux) can travel. The diffuser-wheel may comprise a panel. The panel may block (e.g., entirely or partially) the energy ray. The energy profile alteration device may comprise a shutter wheel. In some examples, the diffuser-wheel rotates. In some examples, the diffuser-wheel switches (e.g., alternate) between several positions. A position of the diffuser-wheel may correspond to an optical filter. The filter may be maintained during the formation of a layer of hardened material. The filter may change during the formation of a layer of hardened material. The diffuser-wheel may change between position during the formation of a layer of hardened material (e.g., change between at least 2, 3, 4, 5, 6, 7 positions). The diffuser-wheel may maintain a position during the formation of a layer of hardened material. At times, during the formation of a 3D object, some positions of the diffuser-wheel may not be used. At times, during the formation of a 3D object, all the positions of the diffuser-wheel may be used. During the formation of the 3D object comprises during the formation of a layer of hardened material.

In some embodiments, the energy profile alteration device comprises a Micro Lens Array. The micro lens (also herein “microlens”) may have a FLS (e.g., diameter) of at most about 5 μm, 10 μm, 50 μm, 100 μm, 250 μm, 500 μm, 750 μm, 1 mm, 5 mm, or 10 mm. The micro lens (also herein “microlens”) may have a FLS of at least about 5 μm, 10 μm, 50 μm, 100 μm, 250 μm, 500 μm, 750 μm, 1 mm, or 5 mm. The micro lens (also herein “microlens”) may have a FLS of any value between the afore-mentioned values (e.g., from about 5 μm to about 5 mm, from about 5 μm to about 750 μm, from about 750 μm to about 1 mm, or from about 1 mm to about 5 mm). The microlens may include an element comprising a plane surface and/or a spherical convex surface (e.g., that refracts the light). The microlens may comprise an aspherical surface. The microlens may comprise one or more layers of optical material (e.g., to achieve a design performance). The microlens may comprise one, two, or more flat and parallel surfaces. In some instances, the focusing action of the energy profile alteration device is obtained by a variation of a refractive index across the micro lens (e.g., gradient-index (GRIN) lens). The microlens may comprise a variation in refractive index and/or a surface shape that allows focusing of the energy flux. The microlens may focus the energy flux by refraction in a set of concentric curved surfaces (e.g., micro-Fresnel lenses). The microlens may focus the energy flux by diffraction (e.g., binary-optic microlens). The microlens may comprise one or more grooves. The one or more grooves may comprise stepped edges or multi-levels. The stepped edges or multi-levels may afford approximation of the requested energy flux profile shape. Microlens arrays can contain multiple lenses formed in a one-dimensional, two-dimensional, or three-dimensional array (e.g., on a supporting substrate). When the individual micro lenses have circular apertures, and are not allowed to overlap, they may be placed in a hexagonal array to obtain maximum coverage of the substrate. The energy profile alteration device may comprise non-circular apertures (e.g., to reduce effects formed by any gaps between the lenses). The microlens (e.g., microlens array) may focus and/or concentrate the energy flux onto a target surface.

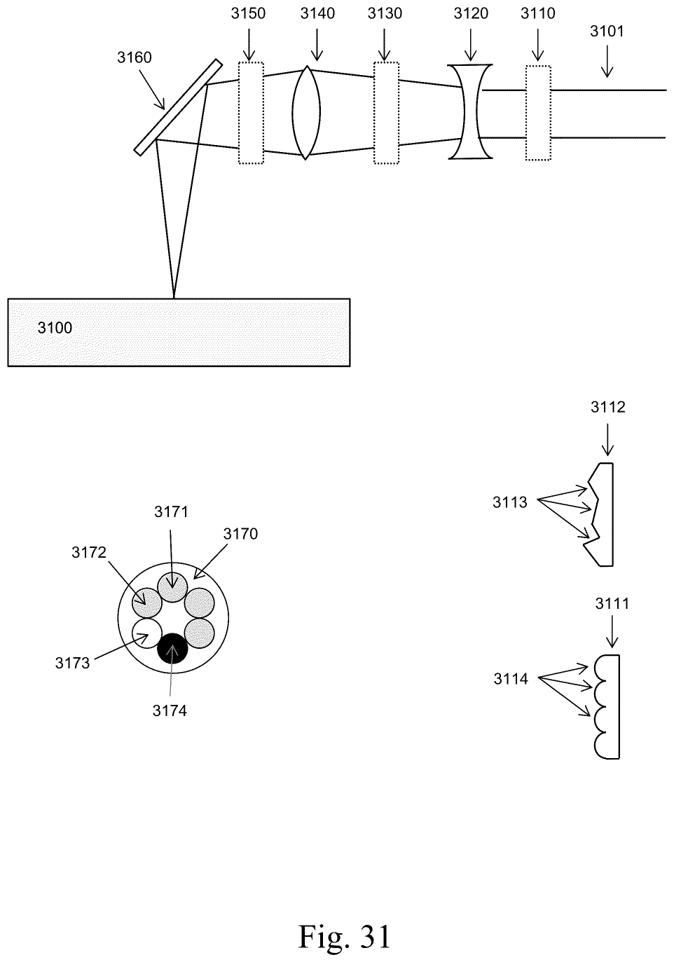

FIG. 31 shows an example of an optical path comprising an irradiated energy beam 3101 that travels through a diverging lens 3120, is consequently focused by a focusing lens 3140, and reflected by a mirror 3160 to project on a target surface 3100. Along the beam path from its projection until the mirror 3160, one or more optical diffusers (e.g., 3110, 3130, or 3150). FIG. 31, 3112 shows a vertical cross section of an optical diffuser comprising planes disposed in various (e.g., different) angles 3113 that cause a beam to diffuse. FIG. 31, 3111 shows a vertical cross section of an optical diffuser comprising microlenses 3114. FIG. 31, 3170 shows a cross section of an optical diffuser comprising various optical diffusers (e.g., 3171, and 3172), an open slot 3173 that allows the irradiated energy to pass through without being diffused, and a closed slot 3174 that does not allow the irradiated energy to pass through. The diffuser wheel may comprise one or more filters. The optical diffuser may create wave front distortion of the irradiated energy.

The energy flux has an energy profile. The energy flux profile may be (e.g., substantially) uniform. The energy flux profile may comprise a (e.g., substantially) uniform section. The energy flux profile may deviate from uniformity. The energy flux profile may be non-uniform. The energy flux profile may have a shape that facilitates (e.g., substantially) uniform heating of the tile (e.g., (e.g., substantially) all points within the tile (e.g., including its rim)). The energy flux profile may have a shape that facilitates (e.g., substantially) uniform temperature variation of the tile (e.g., at (e.g., substantially) all points within the tile (e.g., including its rim)). The energy flux profile may have a shape that facilitates (e.g., substantially) uniform phase of the tile (e.g., (e.g., substantially) all points within the tile (e.g., including its rim)). For example, the phase can be liquid or solid. (e.g., substantially) uniform may be (e.g., substantially) similar, even, homogenous, invariable, consistent, and/or equal.

In some examples, when the material bed is at a temperature of below 500° C., the deviation may be by any value between the afore-mentioned values (e.g., from about 1% to about 20%, from about 10% to about 20%, or from about 5% to about 15%). When the material bed is from about 500° C. to below about 1000° C., the deviation may be at most 10%, 15%, 20%, 25%, or 30%). When the material bed is from about 500° C. to below about 1000° C., the deviation may be by any value between the afore-mentioned values (e.g., from about 10% to about 30%, from about 20% to about 30%, or from about 15% to about 25%). When the material bed is above about 1000° C., the deviation may be at most 20%, 25%, 30%, 35%, or 40%). When the material bed is of above about 1000° C., the deviation may be by any value between the afore-mentioned values (e.g., from about 20% to about 40%, from about 30% to about 40%, or from about 25% to about 35%). Below 500° C. comprises ambient temperature, or room temperature (R.T.). Ambient refers to a condition to which people are generally accustomed. For example, ambient pressure may be 1 atmosphere. Ambient temperature may be a typical temperature to which humans are generally accustomed. For example, from about 0° C. to about 50° C., from about 15° C. to about 30° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a spaceship, a ship, a boat, or any other vehicle. Room temperature may represent the small range of temperatures at which the atmosphere feels neither hot nor cold, approximately 24° C. It may denote 20° C., 25° C., or any value from about 20° C. to about 25° C.

In some examples, the cross section of the tiling energy flux comprises a vector shaped scanning beam (VSB). The energy flux may comprise a variable energy flux profile shape. The energy flux may comprise a variable cross-sectional shape. The energy flux may comprise a (e.g., substantially) non-variable energy flux profile shape. The energy flux may comprise a (e.g., substantially) non-variable cross-sectional shape. The energy flux (e.g., VSB) may translate across the target surface (e.g., directly) to one or more locations specified by vector coordinates. The energy flux (e.g., VSB) may irradiate once over those one or more locations. The energy flux (e.g., VSB) may (e.g., substantially) not irradiate (or irradiated to a considerably lower extent) once between the locations.

In some examples, a cross sectional shape of the tiling energy flux is (e.g., substantially) the shape of the tile. The shape of the tiling energy flux cross section may (e.g., substantially) exclude a curvature. For example, the circumference of the tiling energy flux cross section, also known as the edge of its cross section, or beam edge) may (e.g., substantially) exclude a curvature. The shape of an edge of the tiling energy flux may (e.g., substantially) comprise non-curved circumference. The shape of the tiling energy flux edge may comprise non-curved sides on its circumference. The tiling energy flux edge can comprise a flat top beam (e.g., a top-hat beam). The tiling energy flux may have a (e.g., substantially) uniform energy density within its cross section. The beam may have a (e.g., substantially) uniform fluence within its cross section. (e.g., substantially) uniform may be nearly uniform. The beam may be formed by at least one (e.g., a multiplicity of) diffractive optical element, lens, deflector, aperture, or any combination thereof. The tiling energy flux that reaches the target surface may originate from a Gaussian beam. The target surface may be an exposed surface of the material bed and/or an exposed surface of a 3D object (or a portion thereof). The target surface may be an exposed surface of a layer of hardened material, or a platform. The tiling energy flux may comprise a beam used in laser drilling (e.g., of holes in printed circuit boards). The tiling energy flux may be similar to (e.g., of) the type of energy beam used in high power laser systems (e.g., which use chains of optical amplifiers to produce an intense beam). The tiling energy flux may comprise a shaped energy beam such as a vector shaped beam (VSB). The tiling energy flux may be similar to (e.g., of) the type used in the process of generating an electronic chip (e.g., for making the mask corresponding to the chip).

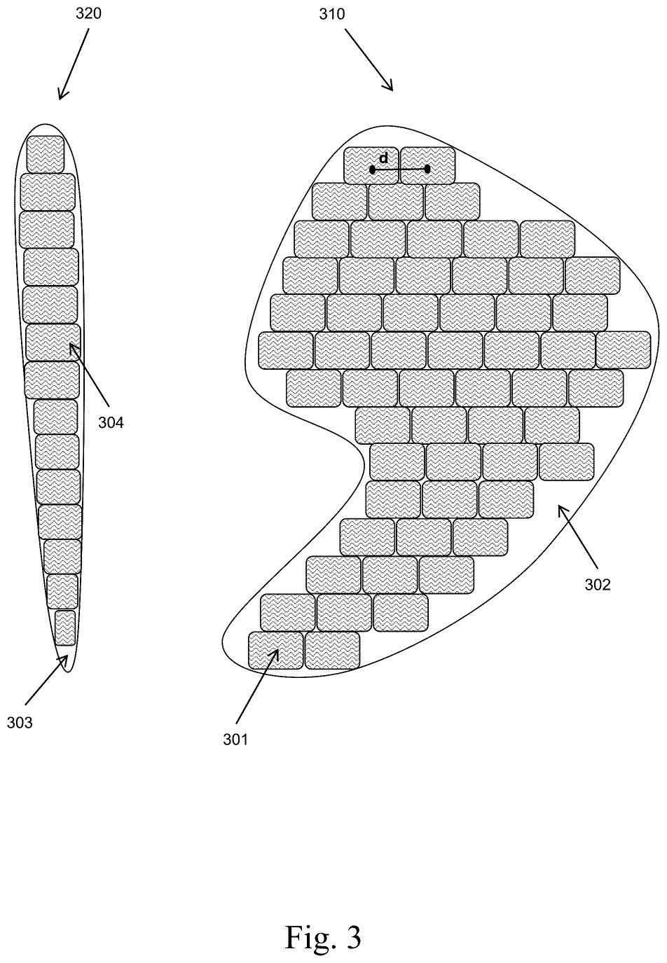

In some embodiments, the tiling energy source emits tiling energy flux that may slowly heat a tile within the exposed surface of a 3D object (e.g., FIG. 1, 106). Slowly may be in comparison to the scanning energy beam. The tile may correspond to a cross section (e.g., or footprint) of the tiling energy flux. The footprint may be on the target surface. The radiative energy source may emit radiative energy that (e.g., substantially) evenly heats a tile in the target surface (e.g., of a 3D object, FIG. 1, 106). FIG. 3 shows an example of a top view of two target surfaces 310 and 320 respectively. The target surface 310 is filled with tiles that have been formed by irradiation (e.g., heating) by the tiling energy flux (e.g., 301). The target surface 320 is filled with tiles that have been formed by irradiation (e.g., heating) by the tiling energy flux (e.g., 304).

The dimension (e.g., FLS) and/or shape of the tile may be varied within the target surface (e.g., a layer of powder material), and/or between target surfaces (e.g., layers of powder material which are irradiated by the tiling energy beam). The variation in the dimension and/or shape of the tile may depend on the geometry of the requested 3D object, deformation of at least a portion of the layer of hardened material that is being formed, deformation of a previously formed layer of hardened material, or any combination thereof. The variation in the dimension and/or shape of the tile may depend on the degree of a requested deformation within the forming layer of hardened material. The degree of requested deformation may consider the ability of the layer of hardened material (e.g., that is forming) to resist future deformation (e.g., by formation of subsequent layers).

In some examples, the gradual irradiation by the (e.g., low power density) tiling energy flux cause at least a portion of hardened material within the irradiated area (e.g., 301) to transform (e.g., melt). In some instances, a uniformly heated area may be generated (e.g., 301). In some instances, a uniformly transformed (e.g., molten) area may be generated within the heated area. The tiles in the target surface may be heated sequentially, non-sequentially, at random, or in a series. The sequence of heating may be determined for a single target surface or for several target surfaces (e.g., forming layers, or forming layer portions).

At times, when transforming at least a fraction of the exposed surface within (e.g., including the rim of) the tiles, the tiling energy flux may heat (e.g., transform) a corresponding fraction of the material at the target surface and/or in an area beneath the target surface. The heating may allow reaching an elevated temperature that is above the solidus temperature of the material (e.g., and at or below its liquidus temperature), transforming (e.g., melting), liquefying, becoming liquidus, and/or plastic yielding of the heated layer of hardened material and/or one or more layers beneath the heated layer (e.g., the bottom skin layer). For example, the heating may penetrate one, two, three, four, five, six, seven, eight, nine, ten, or more layers of the hardened material (e.g., not only the layer that is exposed, but also deeper layers within the 3D object), or the entire 3D object (e.g., or unsupported portion thereof) reaching the bottom skin layer. For example, heating may penetrate one, two, three, four, five, six, seven, eight, nine, ten, or more layers of the pre-transformed material (e.g., not only the layer that is exposed in the material bed, but also deeper layers within the material bed), or the entire depth of the material bed (e.g., fuse the entire depth of the material bed). The very first formed layer of hardened material in a 3D object is referred to herein as the “bottom skin.” In some embodiments, the bottom skin layer is the very first layer in an unsupported portion of a 3D object. The unsupported portion may not be supported by auxiliary supports. The unsupported portion may be connected to the center (e.g., core) of the 3D object and may not be otherwise supported by, or anchored to, the platform. For example, the unsupported portion may be a hanging structure (e.g., a ledge) or a cavity ceiling.

In some embodiments, the tiles are arranged in a space-filling pattern. The space-filling pattern may comprise a herringbone, stacked bond, running bond, or basket weave pattern. The tile may be a polyform. For example, the tile may be a polyomino (i.e., a plane geometric shape formed by joining one or more equal squares edge to edge). The tile may be a polyabolo (i.e., a plane geometric shape composed of isosceles right triangles joined along edges of the same length, also known as a polytan). The tiles may have a shape of a space-filling polygon. The tiles may comprise a rectangle.

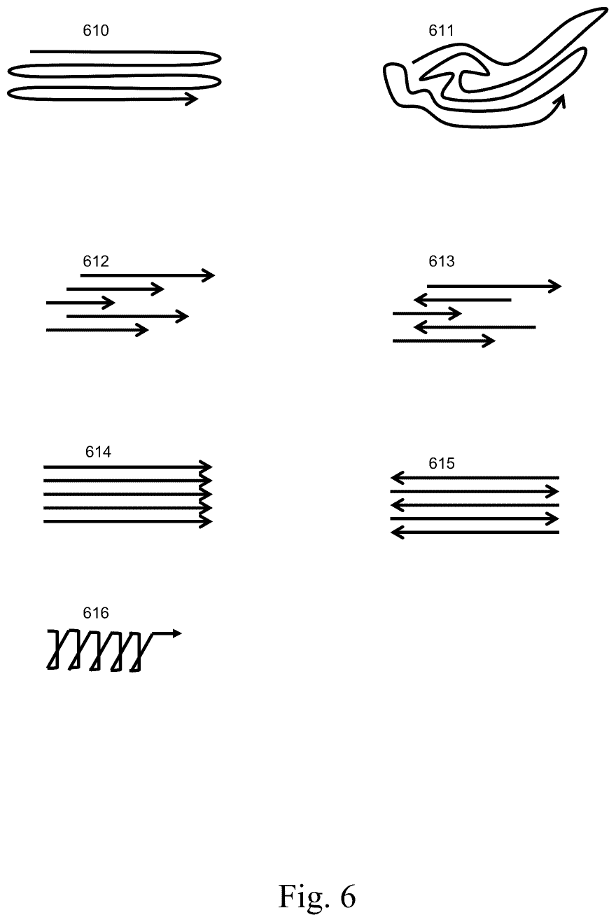

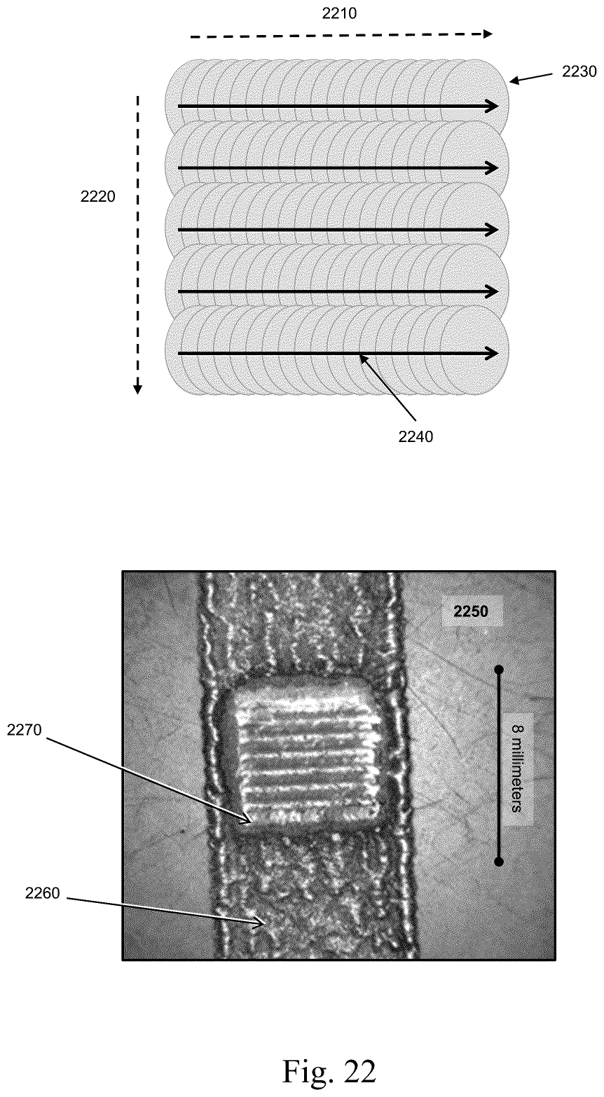

In some instances, the tiles at least partially overlap each other in a target surface. At times, the tiles may (e.g., substantially) overlap. The overlapped area may be at least about 10%, 20%, 30%, 40%, 50%, 60%, 70%, 80% or 90% of the average or mean tile area. The overlapped area may be at most about 10%, 20%, 30%, 40%, 50%, 60%, 70%, 80% or 90% of the average or mean tile area. The overlapped area may between any of the afore-mentioned values (e.g., from about 10% to about 90%, from about 10% to about 50%, or from about 40% to about 90%) of the average or mean tile area. The percentage of overlapped area may be (e.g., substantially) identical along the path of the tiling energy flux. The percentage of overlapped area may be (e.g., substantially) identical in a generated layer of hardened material. FIG. 22 shows examples of paths along which the tiling energy flux may travel (also herein “path-of-tiles.” E.g., 2240), forming tiles that partially overlap each other (e.g., 2222). Arrow 2210 designates the direction along the path-of-tiles. Arrow 2220 designates the direction perpendicular to the path-of-tiles. The 3D object in frame 2250 shows a top view of a 3D object that includes a bottom skin layer 2260 on which a second layer (e.g., having tiles 2270) is generated with the tiling energy flux traveling along the path-of-tiles, which direction of path-of-tile is visible by the lines formed in the second layer (e.g., having tiles 2270). The 3D object in frame 2250 is made of Inconel 718 and is formed from an Inconel powder bed by melting a portion thereof. The percentage of overlapped area may be (e.g., substantially) identical along the path-of-tiles and between these paths (e.g., in the direction 2220). The percentage of overlapped area may be (e.g., substantially) identical along the path of the tiling energy flux (e.g., path-of-tiles) and perpendicular to that path. The percentage of overlapped area may be varied along the path of the tiling energy flux. The percentage of overlapped area may be varied along the path of the tiling energy flux and between paths. The percentage of overlapped area may be varied along the path of the tiling energy flux and perpendicular to that path. The percentage of overlapped area may be different along the path of the tiling energy flux. The percentage of overlapped area may be different along the path of the tiling energy flux and between paths. The percentage of overlapped area may be different along the path of the tiling energy flux and perpendicular to that path. For example, along the path, the tiles may overlap by at least about 60%, and between paths or perpendicular to that path, the tiles may overlap by at least about 30%. At times, the tiles may overlap more along the path, than between paths. At times, the tiles may overlap more along the path, than perpendicular to that path. At times, the tiles may overlap less along the path, than between paths. At times, the tiles may overlap less along the path, than perpendicular to that path. FIG. 22 shows an example where the overlap of the formed tiles along the path is (e.g., substantially) identical, the overlap of the formed tiles in a direction perpendicular to the path is (e.g., substantially) identical, and the overlap of the formed path along the path is different from the overlap of the formed tiles perpendicular to the path. FIG. 22 shows an example where the overlap of the formed path along the path is greater than the overlap of the formed tiles perpendicular to that path. The path-of-tiles may be any path described herein for the energy beam (e.g., FIG. 6).

At least a portion of the target surface can be heated by the energy source (e.g., of the scanning energy beam and/or tiling energy flux). The portion of the material bed can be heated to a temperature that is greater than or equal to a temperature wherein at least a portion of the target surface (e.g., comprising a pre-transformed material) is transformed. For example, the portion of the powder bed can be heated to a temperature that is greater than or equal to a temperature wherein at least a portion of the powder material is transformed to a liquid state (referred to herein as the liquefying temperature) at a given pressure (e.g., ambient pressure). The liquefying temperature can be equal to a liquidus temperature where the entire material is at a liquid state at a given pressure (e.g., ambient). The liquefying temperature of the powder material can be the temperature at or above which at least part of the powder material transitions from a solid to a liquid phase at a given pressure (e.g., ambient). A powder material comprises a solid particulate material.

The temperature and/or energy profile over time of the path-of-tiles may comprise intermissions in which the path is irradiated with the tiling energy flux with an energy that is insufficient to transform the respective portion of the target surface. For example, the path may comprise intermissions in which the path is not irradiated with the tiling energy flux. During the intermission time, the tiling energy flux may travel elsewhere in the material bed and irradiate a different portion of the target surface than along the subject path-of-tiles. That different position may be a different tile or a different path-of-tiles. The different portion may be distant or adjacent to the path-of-tiles.

In some embodiments, the tiling energy flux may irradiate (e.g., substantially) one position during the dwell time (within the path-of-tiles) to form the tile. In some examples, the tiling energy flux remains along the path-of-tiles during the intermission. In some examples, the tiling energy flux translates during the intermissions (e.g., off time) until it reaches a second dwell (e.g., irradiative) position. For example, during the intermission time, the tiling energy flux may travel elsewhere in the material bed and irradiate a different portion of the material bed than the recently tiled position. The different portion may be distant or adjacent to the recently tiled position (e.g., the tile that has just been formed). The tiling energy flux may dwell in (e.g., substantially) one position during the dwell time within the forming tile, and translate during the intermissions (e.g., off time) until it reaches the second dwell (e.g., irradiative) position. Melting may comprise complete melting into a liquid state.

The intermission time may allow the first formed tile to harden (e.g., completely harden), prior to forming the second tile along the path of tiles. The intermission may allow at least the exposed surface of the first tile to harden (e.g., while its interior is still in a liquid state), prior to forming the second tile along the path of tiles. The intermission may allow at least the outer rim of the first tile to harden, prior to forming the second tile along the path of tiles. The intermission may allow at least the exposed surface of the overlapping portion of the first tile to harden, prior to forming the second tile along the path of tiles. In some examples, there is (e.g., substantially) no intermission between the dwell times. In some examples, the dwell time of the tiling energy flux is continuous. The intermissions may comprise a reduced amount of radiation of the tiling energy flux. The reduced amount of radiation may not be sufficient to transform the portion of the material bed that is irradiated by the tiling energy flux during the intermission. The intermission can last at least about 1 msec, 10 msec, 50 msec, 250 msec, or 500 msec. The intermission can last any time-period between the afore-mentioned time-periods (e.g., from about 1 msec to about 500 msec).

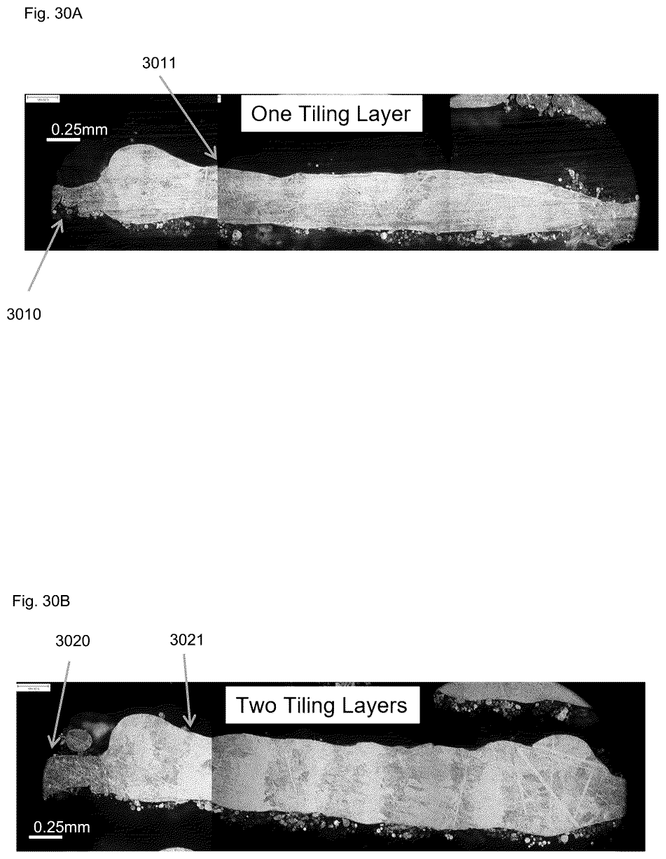

In some examples, the melt pool that is generated by the tiling energy flux is larger (e.g., have a larger FLS) than the melt pool generated by the scanning energy beam. Larger may be in the horizontal and/or vertical direction. The melt pool that is generated by the tiling energy flux may have a FLS that is larger than the FLS of the melt pool generated by the energy beam by about 10%, 20%, 30%, 40%, 50%, 60%, 70%, 70%, 80%, 90%, or 95%. The melt pool that is generated by the tiling energy flux may have a FLS that is larger than the FLS of the melt pool generated by any value between the afore-mentioned values (e.g., from about 10% to about 95%, from about 10% to about 60%, from about 50% to about 95%). The tiling energy flux may transform portions of previously formed layers. The tiling energy beam may form melt pools that span into previously formed layers (e.g., bottom skin). FIG. 27 shows an example of a vertical cross section of a 3D object made of Inconel 718, which 3D object includes a multiplicity of layers of hardened material formed by the methods disclosed herein, wherein the melt pools that are lastly formed (e.g., 2705), penetrate to previously formed layers; for example, to the bottom skin layer (e.g., 2706). FIGS. 30A-30B show examples of a vertical cross section of various 3D objects formed of Inconel 718, which 3D object includes a multiplicity of layers of hardened material formed by the methods disclosed herein. FIG. 30A shows an example of a two-layered object that includes a bottom skin layer 3010 and a second layer 3011. The melt pools in the 3D object of FIG. 30A are hardly visible, since the entire 3D object is formed of very large melt pools and reach the bottom skin layer. FIG. 30B shows an example of a three-layered objects that includes a bottom skin layer 3020 and two additional layers 3021. The melt pools in the 3D object of FIG. 30B are very broad and reach the bottom skin layer.

In some examples, the tiling energy flux injects energy into one or more pre-formed layers (e.g., deeper layers) of hardened material that are disposed below the target layer (e.g., layer of pre-transformed material) that is irradiated by the tiling energy flux. The injection of energy into the one or more deeper layers may heat those deeper layers up. Heating of the deeper layers may allow those deeper layers to release stress (e.g., elastically and/or plastically). For example, the heating of the deeper layers allows those layers to deform beyond the stress point. For example, the heating of the deeper layers may allow a position of the deeper layer that is parallel to the irradiated position to reach an elevated temperature that is above the solidus temperature (e.g., and at or below the liquidus temperature), liquefy (e.g., become partially liquid), transform (e.g., melt), become liquidus (e.g., fully liquid), and/or plastically yield (e.g., stress-yield).

In some embodiments, the tiling energy flux is used at least in part in forming the layers of hardened material that form the 3D object (e.g., all the layers). In some embodiments, the tiling energy flux is used at least in part in forming at least a portion of the layers of hardened material that form the 3D object (e.g., all the layers). The portion may be the initial portion (e.g., layers in the first 1 or 2 millimeters of the 3D object). The portion may be up to a certain accumulated thickness of the 3D object, referred to herein as the “critical layer thickness.” The certain critical layer thickness may be at least about 500 μm, 600 μm, 700 μm, 800 μm, 900 μm, 1000 μm, 1200 μm, 1500 μm, 1800 μm, or 2000 m. The critical layer thickness may be of any value between the afore-mentioned values (e.g., from about 500 μm to about 2000 μm, from 500 μm to 1000 μm, or from 800 μm to 2000 μm). The critical layer thickness may be a critical thickness above which at least an additionally accumulated layer of hardened material will not contribute substantial deformation of the 3D object (or portion thereof). Substantial deformation is relative to the intended purpose of the 3D object. The at least a portion may be devoid of auxiliary supports. The at least a portion may float anchorlessly in the material bed during its formation.

In some embodiments, the scanning energy beam is used at least in part in forming the layers of hardened material that form the 3D object (e.g., all the layers). The portion may be the later portion (e.g., beyond the critical thickness). In some embodiments, the energy beam is used (e.g., at least in part) to form the bottom skin layer. In some embodiments, the energy beam is used to form the bottom skin layer without the use of the tiling energy flux. The portion may be from a certain accumulated thickness of the 3D object onwards. The energy beam may be using in forming a layer of hardened material in combination with the tiling energy flux, alone, or without the aid of the tiling energy flux.

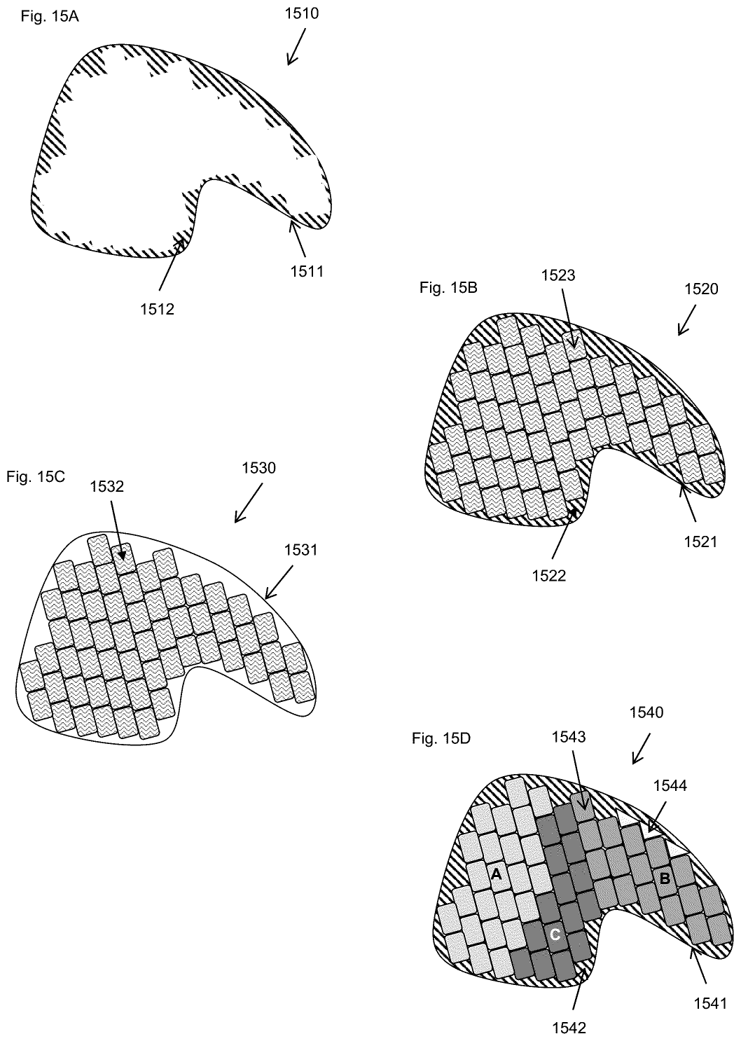

In some examples, the scanning energy beam forms a contour (e.g., FIG. 15C, 1531; or FIG. 15A, 1511) of hardened material around at least a portion of the area to be filled with the path-of-tiles (e.g., FIG. 15C, 1532) generated by the tiling energy flux and/or hatches made by the scanning energy beam (e.g., FIG. 15A, 1512). In some examples, the scanning energy beam propagates in hatches along the target surface. The contour may be a closed line or an open line (e.g., comprising intermissions). The contour may be a continuous line or a discontinuous line. The contour may precede, supersede, or be formed contemporaneously with the formation of the interior tiles. FIGS. 15A-15D show examples of top view of a layer of hardened material illustrating various possible stages in the formation of a layer of hardened material. FIG. 15A shows an example where the contour 1511 and the hatches made by the scanning energy beam (e.g., 1512) are made prior to forming the path-of-tiles. FIG. 15B shows an example of a completed layer of hardened material 1520 comprising a contour 1515, hatching made by the scanning energy beam (e.g., 1522), and tiles may by the tiling energy flux (e.g., 1523). FIG. 15C shows an example where the contour 1531 and the tiles (e.g., 1532) made by the tiling energy flux are made prior to forming the hatches. FIG. 15D shows an example of a completed layer of hardened material 1540 comprising a contour 1541, hatches made by the scanning energy beam (e.g., 1542), and tiles may by the tiling energy flux that include complete tiles (e.g., 1543) and redacted tiles (e.g., 1544). The path of tiles may sequentially fill the entire target layer of hardened material (e.g., corresponding to a target slice of the 3D object model). In some examples, the area to be filled with tiles may be separated to patches. The path of tiles may fill the entire target layer in patches. The patches may separate the sequence of filling the target space (e.g., corresponding to a target slice of the 3D object model) FIG. 15D can be used to illustrate an example of patch filling. For example, the tiles in patch B may be formed first, followed by forming tiles in patch A, then followed by forming the tiles in patch C, and finally followed by the redacted patches (e.g., 1544). In the example of FIG. 15D, the lighter tiles belong to patch A, darkest tiles belong to patch C, and intermediate gray tile belong to patch B. Forming the tiles may follow any ordering combination of patches. Forming the layer of hardened material may comprise forming a contour, hatches made by the scanning energy beam, one or more patches of path-of-tiles, redacted tiles (e.g., partial tiles, see FIG. 2), individual tiles, or any permutation or combination thereof. In some examples, most of the area of the layer of hardened material is formed from tiles (e.g., FIG. 15B, 1523). The tiles may be formed by the tiling energy flux. In some embodiments, most of the area of the layer (e.g., horizontal cross section thereof) may be at least about 51%, 60%, 70%, 80%, 90%, or 95% of the area of the layer. In some examples, a minor part of the layer of hardened material is formed by hatching (e.g., 1522). The hatching may be formed by the scanning energy beam. A minor part of the layer (e.g., horizontal cross section thereof) may be at most about 49%, 40%, 30%, 20%, 10%, 5%, or 1% of the area of the layer.

In some examples, the tiles have a geometric shaped cross section. The tile can comprise a cross-section (e.g., horizontal cross section) that is circular, triangular, square, rectangular, pentagonal, hexagonal, partial shapes thereof, and/or combinations thereof. The tile can comprise a polygonal cross-section. The tile cross section may be a parallelogram. The tiles on the target surface may comprise any combination of tile shapes (e.g., that would tightly fill a space). For example, a combination of triangle and hexagon shaped tiles. The tiles in a first target surface and in a second target surface that is adjacent (e.g., above or below) to the first target surface may be (e.g., substantially) aligned. The tiles in a first target surface and in a second target surface that is adjacent (e.g., above or below) to the first target surface, may be (e.g., substantially) misaligned (e.g., may be arranged in a face centered cubic (FCC) or hexagonal closed packed (HCP) arrangement).

In some embodiments, the tiling methodology includes a step and repeat process. In some embodiments, the tiling methodology includes heating a first area in a target surface, moving to a second area in the target surface, and heating the second area. The areal heating may utilize a tiling energy flux that irradiates the area while (e.g., substantially) not moving, or a scanning energy beam that irradiates the area while hatching it. The sequential heating of the target surface using the tiling methodology may follow a path. The path may include a path of the tiles in the layer (herein also “path-of-tiles”), which corresponds to the sequence in which the portions (e.g., tiles) are heated. The tiles may follow a vectorial path (e.g., a predesigned path). The tiles may follow a rasterized path. Heating may be to a temperature below, at, or above a transformation temperature.

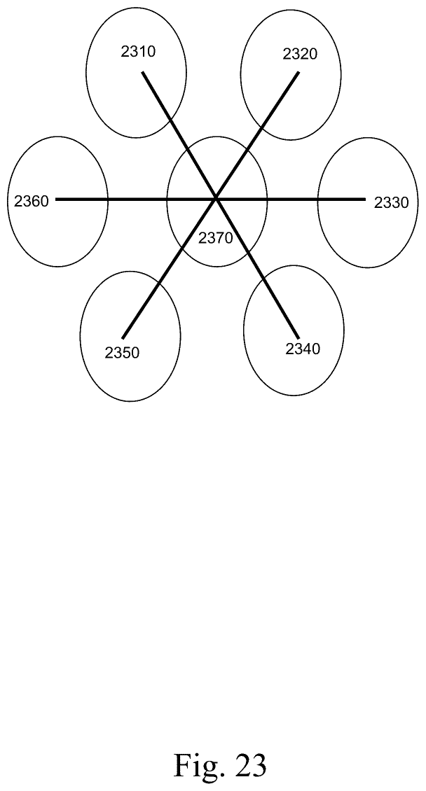

The layer of hardened material that comprises the heated (e.g., formed) tiles may utilize a symmetric or asymmetric path (e.g., path-of-tiling) for their heating. The tiling energy flux may form the tiles in a symmetric or asymmetric manner from a layer of pre-transformed material. During the generation of a layer of hardened material, the tiling energy flux may heat (e.g., form) the tiles in a symmetric or asymmetric manner. For example, the symmetric manner comprises using a point, axis or plane of symmetry disposed (e.g., substantially) in the center of the area of the material bed to be transformed. FIG. 23 shows an example of a tile formation sequence. Per a point symmetry sequence, the tiling can be formed in the following order: 2310, 2340, 2320, 2350, 2330, and finally 2360. Per a mirror symmetry sequence, the tiling can be formed in the following order: 2310, 2350, 2320, 2340, 2360, and finally 2330. Per a rotational symmetry, the tiling can be formed in the following order: 2310, 2350, 2320, 2340, 2360, and finally 2330. An asymmetric sequence may be formed when all the vectorial paths point towards a single direction (e.g., FIG. 6, 614). Per a directional asymmetric tiling sequence, the tiling can be formed in the following order: 2310, 2320, 2360, 2370, 2330, 2350, and finally 2340. In some examples, an asymmetric sequence results in a layer of hardened material (e.g., 3D plane) that is bent (e.g., warped). In some examples, a symmetric tiling sequence results in a layer of hardened material (e.g., 3D plane) that is (e.g., substantially) planar. The usage of symmetric tiling sequence may reduce the amount of curvature (e.g., warping) in the formed layer of hardened material. An example of a symmetric path may be a path-of-tiles that comprises opposing vector paths (e.g., FIG. 6, 615), or a serpentine path (e.g., FIG. 6, 610). In some examples, the path-of-tiles is heated (e.g., formed) from the edge of the area to be tiled, towards the center of the area to be tiles (e.g., the edge of the formed layer of hardened material, towards its center). The inward bound path-of-tiles sequence may reduce the curvature of the resulting layer of hardened material. The inward bound path-of-tiles may comprise symmetric or asymmetric tiling sequence. Tile number 2370 in the example of FIG. 23, may be formed last following an inward bound path-of tile sequence, whereas the tiles 2310-2360 may be formed prior to the formation of tile 2370.

The heating (e.g., generation) of a tile may utilize irradiation of a (e.g., low power density) wide cross sectional tiling energy flux at (e.g., substantially) one position. Alternatively or additionally, the generation of a tile may utilize a (e.g., high power density) narrow cross sectional energy beam (e.g., scanning energy beam) that travels along hatches to generate the shape of the tile. In some embodiments, the path traveled by the tiling energy flux or by a first scanning energy beam may be heated (to a temperature below transformation temperature of the material) by a second scanning energy beam. The second scanning energy beam may the same scanning energy beam that is used to generate the tile of transformed material. The second scanning energy beam may a different scanning energy beam from the one used to form the tiles of transformed material (e.g., first scanning energy beam, or tiling energy flux). The second scanning energy beam may be generated by a second scanning energy source. The second scanning energy source may be the same scanning energy source that is used to generate the first scanning energy beam, or may be a different energy source. The second scanning energy source may be the same scanning energy source that is used to generate the tiling energy flux, or be a different energy source. In some embodiments, the tiling energy flux may heat (but not transform) portions of the target surface, and the second energy beam may transform material within the heated tiles. The pre or post transformation heating may reduce temperature gradients in the target surface, reduce deformation, and/or generate certain microstructure(s). The second scanning energy beam may be a (e.g., substantially) collimated beam (e.g., an electron beam or a laser). The second scanning energy beam may not be a dispersed beam. The second scanning energy beam may follow a path. The path may form an internal path (e.g., vectorial path) within target surface portions during the formation of a layer of transformed material (e.g., in a similar manner to the first energy beam). The path may form material-filled portions along the target surface.

In some embodiments, the tiling energy flux is used to heat portions of the target surface (e.g., tiles) to a temperature below the transformation temperature, while the (e.g., second) energy beam is used to transform material in these target surface portions (e.g., tiles). In some embodiments, the scanning energy beam is used to heat portions of the target surface (e.g., tiles) to a temperature below the transformation temperature, while the tiling energy flux is used to transform material in these target surface portions (e.g., tiles). The heating to a temperature below the transformation temperature may be before by one energy radiation, after, and/or contemporaneous to transformation by the other energy radiation.

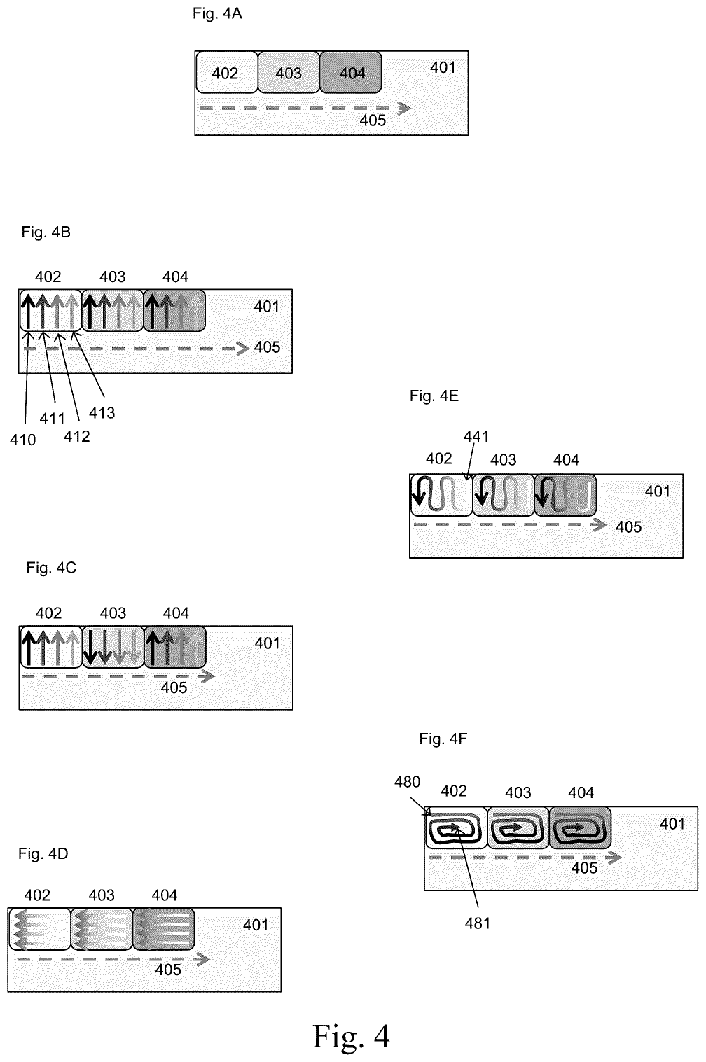

In some embodiments, a tile is generated using a scanning energy beam. For example, the scanning energy beam can transform the material bed using hatches along a path within an area designated for a tile. The path of the scanning energy beam within the tile cross section is designated herein as the “internal path” within the tiles. The internal path within the tile cross section may be of (e.g., substantially) the same general shape as the shape of the path-of-tiles (e.g., both sine waves). The internal path within the tiles may be of a different general shape than the shape of the path-of-tiles (e.g., vector lines vs. a sine wave). The internal path may be straight, e.g., vectorial. FIG. 4B shows examples of the internal path within the heated tile 402 generated at the exposed surface 401 of a material bed, which internal path follows a non-curved (e.g., a vectorial) shape of hatches 410-413 to form tile 402. Tiles 403-404 are formed in a similar manner to form a path of tiles along direction 405, with the hatches in tiles 403 and 404 following the same hatch scheme as in FIG. 402 of FIG. 4B. FIG. 4C shows examples of the internal path within the heated tile 402 generated at the exposed surface 401 of a material bed, which internal path follows a non-curved (e.g., a vectorial) shape of hatches (same as the hatches 410-413 of FIG. 4B) to form tile 402 of FIG. 4C. Tiles 403-404 are formed in a similar manner to form a path of tiles along direction 405, but every consecutive tile is formed of a hatch scheme that has opposite vectorial direction. FIG. 4D shows examples of the internal path within the heated tile 402 generated at the exposed surface 401 of a material bed, which internal path follows a non-curved (e.g., a vectorial) shape of hatches (that are perpendicular to hatches 410-413 of FIG. 4B) to form tile 402 of FIG. 4D. Tiles 403-404 of FIG. 4D are formed in a similar manner to form a path of tiles along direction 405. The path may follow a spiraling shape, or a random shape (e.g., FIG. 6, 611). FIG. 4E shows examples of the internal path within the tiles 402 that follows a curved shape 441, on exposed surface 401 of a material bed. Tiles 403-404 of FIG. 4E are formed in a similar manner to form a path of tiles along direction 405. FIG. 4F shows examples of the internal path within the heated tile 402 on exposed surface 401 of a material bed, the internal path having a spiraling shape starting at position 480 and ending at position 481. Tiles 403-404 of FIG. 4F are formed in a similar manner to that of tile 402, to form a path of tiles along direction 405. The internal path may be overlapping (e.g., FIG. 6, 616) or non-overlapping. The internal path may comprise at least one overlap. The internal path may be (e.g., substantially) devoid of overlap (e.g., FIG. 6, 610). The internal path may comprise a curvature or may be devoid of a curvature. The path of the scanning energy beam may comprise a finer path (e.g., sub-path). The finer path may be an oscillating path. FIG. 5 shows an example of a path of the scanning energy beam 501. The path 501 is composed of an oscillating sub-path 502. The oscillating sub path can be a zigzag or sinusoidal path. The finer path may include or (e.g., substantially) exclude a curvature. The scanning energy beam may travel in a path that comprises or excludes a curvature. FIG. 6 shows various examples of paths. The scanning energy beam may travel in each of this type of paths. The path may (e.g., substantially) exclude a curvature (e.g., 612-615). The path may include a curvature (e.g., 610-611). The path may comprise hatching (e.g., 612-615). The hatching may be directed in the same direction (e.g., 612 or 614). Every adjacent hatching may be directed in an opposite direction (e.g., 613 or 615). The hatching may have the same length (e.g., 614 or 615). The hatching may have varied length (e.g., 612 or 613). The spacing between two adjacent path sections may be (e.g., substantially) identical (e.g., 610) or non-identical (e.g., 611). The path may comprise a repetitive feature (e.g., 610), or be (e.g., substantially) non-repetitive (e.g., 611). The path may comprise non-overlapping sections (e.g., 610), or overlapping sections (e.g., 616). The tile may comprise a spiraling progression (e.g., 616). The non-tiled sections of the target surface (e.g., FIG. 15A, 1512) may be irradiated by the scanning energy beam in any of the path types (e.g., hatch types) described herein.

In some instances, it is not requested to allow the heated tiles to exceed the rim of the exposed surface. At times, when the heated tiles exceed the rim of the target surface (e.g., surface of a 3D object), the irradiated energy flux may heat the pre-transformed material (e.g., powder) within the material bed adjacent to the target surface. That irradiated pre-transformed material may transform and/or adhere to the 3D object. The irradiated pre-transformed material may form a sintered structure (e.g., that is unwanted) adjacent to (e.g., connected or disconnected from) the 3D object. Heating the pre-transformed material within the material bed may cause the pre-transformed material to transform (e.g., melt, sinter, or cake) at least partially.

The tiling process (e.g., deep tiling, shallow tiling, or flash heating) may be used to heat and/or transform at least a portion of an exposed layer of a 3D object (e.g., comprising a hanging plane and/or wire). FIG. 3 shows an example of a top view of a plane 310 and a wire 320.

Some of the portion (e.g., heated portions, or tiles of hardened material) can be separated by a gap, touch each another heated tile, overlap each other, or any combination thereof. At least two tiles may fuse to each other. One tile may be separated from a second tile by a gap, while overlapping a third tile. For example, all the tiles may be separated from each other by gaps. At least two gaps may be (e.g., substantially) identical or different (e.g., in its FLS). Identical or different can be in length, width, height, volume, or any combination thereof. The gap size (e.g., height, length, and/or width) may be at most about 30 μm, 35 μm, 40 μm, 50 μm, 60 μm, 70 μm, 80 μm, 90 μm, 100 μm, 150 μm, or 200 μm. The gap size may be any value between the afore-mentioned values (e.g., from about 30 μm to about 200 μm, from about 100 μm to about 200 μm, from about 30 μm to about 100 mm, from about 80 mm to about 150 mm).

In some instances, the process of heating portions of the target surface continues until (e.g., substantially) all the gaps have been filled by tiles (e.g., except for the edge areas. E.g., FIG. 3, 302). Such process may be referred herein as “Pointillism.” Any gaps and/or edges can be filled by an energy beam (e.g., following a path). The pointillism method may comprise an area of preclusion (e.g., exclude heating three tiles that are adjacently situated and form a line).

The heating can be done by the one or more energy sources. At least two of the energy sources may heat target surface portions (e.g., tiles) simultaneously, sequentially, or a combination thereof. At least two target surface portions can be heated sequentially. At least two target surface portions can be heated (e.g., substantially) simultaneously. The time and/or special sequence of heating at least two of the target surface portions may overlap.

In some embodiments, the second heated tile area may be distant from the first heated tile area. The area can be a cross section. The heat from the first tile can negligently increase the temperature of the second tile (e.g., before it is heated). Heating the first target surface portion may elevate the temperature of the second tile (e.g., before it is heated) in at most about 0.1%, 0.5%, 1%, 5%, 10%, 15%, or 20%. Heating the first tile may elevate the temperature of the second tile (e.g., before it is heated) by any percentage between the afore-mentioned percentages (e.g., from about 0.1% to about 20%, or from about 0.1% to about 10%). The heat from the first tile can negligently alter the dimension of the second tile (e.g., expand in length, width, height, and/or volume). Heating the first tile may alter the form (e.g., dimension) of the target surface to be occupied by the second tile (e.g., before it is heated) by at most about 0.1%, 0.5%, 1%, 5%, 10%, 15%, or 20%. Heating the first tile may alter the form of the target surface to be occupied by the second tile (e.g., before it is heated) by any percentage between the afore-mentioned percentages (e.g., from about 0.1% to about 20%, or from about 0.1% to about 10%). The tile may be a portion of pre-transformed material, or a transformed material tile.

In some embodiments, no sequence of three tile is formed in a straight line (e.g., single file). The three tiles can be heated (e.g., transformed) sequentially such that the heating of the first tile is immediately followed by the heating of the second tile, that is in turn immediately followed by the heating of the third tile. In some embodiments, at least two of the three tiles are heated in parallel. In some embodiments, at least two of the three tiles are heated in an overlapping sequence. An example for an overlapping sequence of deposition of transformed material can be a first tile that is being formed on the exposed surface (e.g., layer), and while it is being formed, the second tile is beginning to form. The first tile can end its formation before, during, or after the formation of the second tile. In some embodiments, no sequence of three or more tiles that are situated close to each other (e.g., touching each other, or forming a gap (e.g., as described herein) with each other) is heated (and/or generated) in a straight line. The three or more tiles can include at least 4, 5, 6, 7, 8, 9, 10, 50, or 100 tiles. The three or more tiles can be any value between the afore-mentioned values (e.g., from 4 tiles to 100 tiles, from 5 tiles to 10 tiles, from 10 tiles to 100 tiles, or from 7 tiles to 50 tiles). “Between” as understood herein, is meant to be inclusive. The three or more tiles can exclude tiles that reached temperature equilibrium (e.g., with the environment). The three or more tiles can include hot tiles (e.g., comprising transformed material). The three or more tiles can comprise tiles that include transformed material and did not completely harden (e.g., solidify). The three or more tiles can exclude tiles that comprised transformed material that hardened into a hardened (e.g., solid) material (e.g., after their heating). The three or more tiles can include tiles that are disposed on a hot portion of the target surface. The three or more tiles can include tiles that are disposed on a portion of the exposed target surface that did not reach temperature equilibrium. The three or more tiles can exclude tiles that are disposed on a portion of the hardened material that is no longer susceptible to deformation (e.g., since it is sufficiently cold). In some embodiments, the area of preclusion may comprise a straight tile between two or more sequentially deposited tiles (e.g., when the two sequentially deposited tiles are in close proximity to each other separated by a gap, border each other, or overlap each other). The methods, systems, and/or apparatuses describe herein may aim to at least form successively (e.g., one after another) heated tiles in an area that is outside the area of preclusion. In some embodiments, the area of preclusion may include two tiles that are disposed sequentially one next to each other. Next to each other may be direct or indirect. For example, next to each other includes directly next to each other. Next to each other comprises next to a tile face, vertex, or edge of the tile. Next to each other may comprise touching a file face, vertex, or edge. Next to each other may comprise indirectly next to each other having a gap between the two tiles (e.g., any gap value disclosed herein).

In some examples, the area of preclusion depends on the temperature at various portions of the target surface, the time elapsed from heating at least one of two or more previously heated tiles of the first layer, the temperature at the potential area to be heated, the temperature gradient from at least one of the two or more prior tiles to the potential area to be heated, the temperature at the previously heated two or more portions, the heat deformation susceptibility of the exposed area to be heated by a third tile, or any combination thereof. In some examples, the area of preclusion depends on the physical state of matter within the heated two or more tile (e.g., liquid, partially liquid, or solid). The two or more tiles and the third tile to be heated (and/or formed) may be situated on a straight line.

In some embodiments, successively heating three or more tiles of the first layer disposed in a straight line will cause the layer (e.g., comprising the exposed surface) to deform (e.g., bend). The deformation may be disruptive (e.g., for the intended purpose of the 3D object). Such straight line may form (e.g., generate, create) a line of weakness in the first layer (e.g., layer of hardened material that is at least a portion of the 3D object). In some embodiments, successively heating at least three portions of the first layer in a pattern that differs from a straight line (e.g., FIG. 4D) will (e.g., substantially) lessen the degree of deformation of the layer of hardened material as compared to a straight-line heating and/or generation pattern (e.g., FIG. 4A). In some embodiments, successively heating and/or generating at least three tiles of the first layer in a pattern that differs from a straight line will (e.g., substantially) not cause the first layer to deform (e.g., bend). In some embodiments, successively heating at least three portions of the first layer in a pattern that differs from a straight line will retard (or prevent) the formation of lines of weakness. In some embodiments, successively heating at least three tiles of material in the layer of hardened material in a pattern that differs from a straight line (e.g., single file) will (e.g., substantially) not cause the first layer to deform (e.g., bend). In some embodiments, successively heating at least three tiles of material on the first layer in a pattern that differs from a straight line will retard (or prevent) the formation of lines of weakness.

In some instances, the methods, systems and/or apparatuses may comprise sensing (e.g., measuring) the temperature and/or the shape of the transformed (e.g., molten) fraction within the heated tile. The temperature measurement may comprise real time temperature measurement (e.g., during the formation of the 3D object, during the formation of a layer of the 3D object, or during the formation of the tile). The FLS (e.g., depth) of the transformed fraction may be estimated (e.g., based on the temperature measurements). The temperature measurements and/or estimation of the FLS of the transformed fraction (e.g., depth) may be used to control (e.g., regulate and/or direct) at least one characteristic of the energy irradiated at a particular portion. The at least one characteristic may comprise the power, dwell time, cross section, or footprint of the energy irradiated on the target surface. The control may comprise reducing (e.g., halting) the irradiated energy flux on reaching a target depth. The dwell time (e.g., exposure time) may be at least a few tenths of millisecond (e.g., from about 0.1), or at least a few milliseconds (e.g., from about 1 msec). The exposure time (e.g., dwell time) may be any dwell time disclosed herein. The control may comprise reducing (e.g., halting) the irradiated energy while considering the rate at which the heated portions cool down. The rate may depend on the ambient temperature (e.g., environmental temperature). The rate of heating and/or cooling the portions may facilitate formation of a requested microstructure (e.g., in particular areas). The requested microstructures may be formed in an area within the layer of hardened material, or in (e.g., substantially) the entire layer of hardened material. The temperature at the heated (e.g., heat tiled) area may be measured. The temperature measurements may comprise spectroscopy, visually, or using expansion properties of a known material (e.g., thermocouple or thermometer). The visual measurement may comprise using a camera (e.g., CCD camera, or video camera) or a spectrometer. The visual measurements may comprise using image processing. The transformation of the heated tile may be monitored (e.g., visually and/or electronically). The overall shape of the transforming fraction of the tile may be monitored (e.g., visually and/or in real-time). The FLS of the transformed(ing) fraction may be used to indicate the depth and/or volume of the transformed material (e.g., melt pool). The monitoring (e.g., of the heat and/or FLS of the transformed fraction within the tile) may be used to control one or more parameters (e.g., characteristics) of the tiling energy source, tiling energy flux, scanning energy source, and/or scanning energy beam. The parameters may comprise (i) power density, (ii) dwell time, (iii) travel speed, or (iv) cross section. The parameters may be during heating to a temperature below the transformation temperature, or during transformation of the material to form a tile of transformed material.

In some embodiments, the tiling energy flux is used, at least in part, to form at least the bottom skin layer. For example, the tiling energy flux is used to form at least the first 20, 25, 30, 35, or 40 layers of hardened material, or all the layers of hardened material in the 3D object. A subsequent layer of hardened material (e.g., second layer) is a layer that is formed on (e.g., directly on) a previously formed layer of hardened material as part of the 3D object. The tiling energy flux may be used at least in part to form the second layer of hardened material of the 3D object and/or any subsequent layer of hardened material of the 3D object. In some instances, a layer of pre-transformed (e.g., powder) material is dispensed above (e.g., on) a layer of hardened material (that is a part of the 3D object).

In some embodiments, the tiling energy flux forms a second layer of hardened material by transforming (e.g., melting) at least a portion of the newly dispensed layer of pre-transformed material. The tiling energy flux may heat (e.g., and transform) a portion of the newly deposited layer of pre-transformed material and a portion of at least one previously formed layer (or layers) of hardened material that is disposed beneath the newly dispensed layer of pre-transformed material. The tiling energy flux may transform a portion of at least one newly deposited layer of pre-transformed material and a portion of at least one previously formed layers of hardened material that is disposed beneath the newly dispensed layer of pre-transformed material. The previously formed layers may or may not comprise the bottom skin layer. The tiling energy flux may heat (e.g., transform) tiles by transforming a portion of the pre-transformed material in the material bed, by transforming (e.g., melting) a portion of the hardened material within at least one previously formed layer of hardened material. For example, by transforming (e.g., melting) a portion of the hardened material within a multiplicity of previously formed layer of hardened material. For example, the tiling energy flux may transform a portion of the hardened material that is disposed in the bottom skin layer of hardened material of the 3D object. Melting can be complete melting of the material (e.g., to a liquid state).

The first layer of hardened material may comprise fully dense hardened material. The first layer of hardened material may comprise hardened material that is not fully dense (e.g., that is porous). For example, the first layer of hardened material may comprise holes (e.g., pores). The tiling energy flux may be utilized to reduce the FLS of the holes. The tiling energy flux may be utilized to (e.g., substantially) reduce the number, FLS, and/or volume of the holes (e.g., eliminate the holes). The tiling energy flux may be used to cure the layer of hardened material to provide a (e.g., substantially) high density layer of hardened material. For example, a fully dense layer of hardened material. The external surface of the layer of hardened material (e.g., external surface of the 3D object) may comprise a pattern of the tiles. For example, the pattern may resemble a checkerboard pattern. The tiling energy flux may alter the microstructure within the tile (e.g., by heating and/or transforming at least a portion of the 3D object).

In some instances, it is requested to have a 3D object (or portion thereof) that has a certain amount of porosity. The hardened material may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The hardened material may have a porosity of at least about 0.05 percent (%), 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The hardened material may have a porosity between any of the afore-mentioned porosity percentages (e.g., from about 0.05% to about 0.2%, from about 0.05% to about 0.5%, from about 0.05% to about 20%, from about from about 0.05% to about 50%, or from about 30% to about 80%). In some instances, a pore may transverse the formed 3D object. For example, the pore may start at a face of the 3D object and end at the opposing face (e.g., bottom skin) of the 3D object. The pore may comprise a passageway extending from one face of the 3D object and ending on the opposing face of that 3D object (e.g., 3D plane). In some instances, the pore may not transverse the formed 3D object. The pore may form a cavity in the formed 3D object. The pore may form a cavity on a face of the formed 3D object (e.g., the face of the 3D plane). For example, pore may start on a face of the 3D plane and not extend to the opposing face of that 3D plane.

The first layer of hardened material may be originally formed from successively deposited melt pools having a first average FLS. The tiling energy flux that subsequently heats and/or transforms at least portions of the first layer of hardened material, may cause an alteration of the microstructure of the first layer of hardened material (e.g., alteration in melt pool FLS, melt pool orientation, material density distribution across the melt pool, degree of compound segregation to grain (e.g., melt pool) boundaries, degree of element segregation to grain boundaries, material phase, metallurgical phase, material porosity, crystal phase, crystal structure, or any combination thereof). For example, when the first layer of hardened material is originally formed from successively deposited melt pools having a first average FLS; the tiling energy flux (that subsequently heats and/or transforms at least portions of the first layer of hardened material) may cause an alteration of the microstructure of that first layer such that the newly formed melt pools in this first layer are larger than the first average FLS (e.g., original melt pool FLS). Larger may be larger by at least 1.5*, 2*, 3*, 5*, 10*, 20*, or 50* from the first average FLS of the melt pools. In some instances, the first layer will (e.g., substantially) comprise a single melt pool after subsequent heating by the tiling energy flux. The 3D object may be a 3D plane or a wire.

The subsequent layers of hardened material may be formed by using the tiling energy flux, the energy beam, or any combination thereof. In some examples, the bulk areas that form the layer of hardened material are formed using the tiling energy flux (e.g., larger cross section energy flux), and the fine features are formed using the energy beam (e.g., smaller cross section energy beam). The energy beam and/or flux may be focused or defocused.

The hardened material may be (e.g., substantially) planar (e.g., flat), or may be curved after its formation and/or heating by the tiling energy flux. The curvature may be positive or negative. The curvature may be any value of curvature and/or radius of curvature disclosed herein. The curvature may be of the layer of hardened material or of a portion thereof (e.g., of a single tile). Heating a layer of hardened material with the tiling energy flux may introduce curvature to that layer (or to a portion thereof). The manner of heating a layer of hardened material (or a portion thereof) with the irradiated energy may influence the degree and/or direction of the curvature. The manner of heating a layer of hardened material (or a portion thereof) with the irradiated energy may influence the stress at the top surface of the layer of hardened material (or the portion thereof). The manner of heating a layer of hardened material (or a portion thereof) may comprise controlling and/or altering the height of the powder layer, the density of the powder layer, the dwell time of the irradiated energy, the power density of the irradiated energy, the temperature of the material bed (e.g., or the exposed surface thereof), the temperature of the layer of hardened material, the temperature of the bottom skin layer, or any combination thereof. The control may depend on the temperature at the area that is heated (e.g., tiled), or an area at the vicinity of the heated area, or at the bottom skin layer. In some exhales, the vicinity is at most about 2, 3, 4, 5, 6, 7, or 10 melt pool FLS (e.g., diameters) away from the melt pool center. The control may depend on a FLS of the melt pool. The irradiated energy may comprise the tiling energy flux or the scanning energy beam.

In some instances, a layer of pre-transformed material may have a (e.g., substantially) fixed height. At times, the tiling energy flux and/or the energy beam may transform several (e.g., substantially) fixed height layers of pre-transformed material at once. At times, several layers of pre-transformed material of a (e.g., substantially) fixed height may be deposited sequentially in a material bed, followed by an energy irradiation that transforms a portion of the multiplicity of layers of powder material in one scanning of the irradiated energy. In this manner, several layers of pre-transformed material may be transformed together (referred to herein as “deep transformation”). The deep transforming can comprise deep melting (e.g., deep welding). Deep transformation may comprise deep tiling. The multiplicity of pre-transformed material layers may be of a single type of material, or of different types of material.

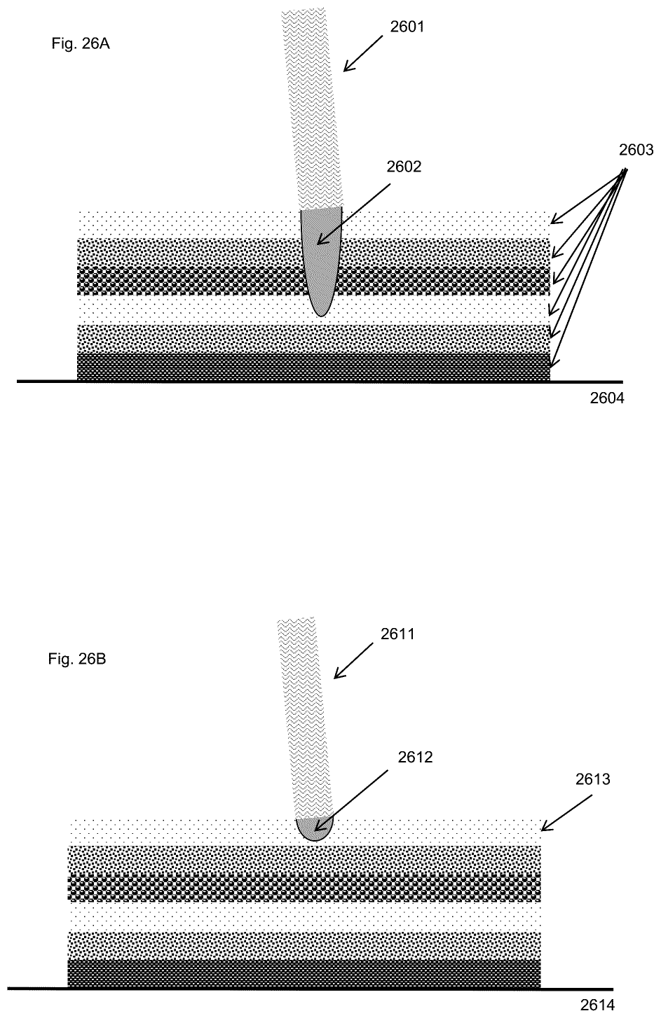

FIG. 26A shows an example of deep transformation. The irradiated energy 2601 may transform a portion of a material bed (e.g., formed of layers of pre-transformed material 2603) to form a melt pool 2602, which melt pool spans several layers of pre-transformed material. In the example shown in FIG. 26B, the layers of pre-transformed material are disposed above a platform 2604. In the example shown in FIG. 26A, the layers of pre-transformed material are disposed above a platform 2614.

FIG. 26B shows an example of shallow transformation. In some embodiments, a multiplicity of layers of pre-transformed material is sequentially deposited, and the top layer (or optionally at least 2, or 3 top layers) is transformed, wherein the bottom layers remain loose (e.g., uncompact) and flowable (e.g., flowable powder material). This process is referred to herein as “shallow transformation.” Shallow transformation may comprise shallow melting. FIG. 26B shows an example of shallow transformation. The irradiated energy 2611 may transform a portion of a material bed (e.g., formed of layers of pre-transformed material (e.g., 2613)) to form a melt pool 2612, which melt pool is confined in the uppermost layer of pre-transformed material (e.g., 2613). Shallow tiling excludes plastically deforming the bottom skin layer, while deep tiling includes at least reaching an elevated temperature that is above the solidus temperature, transforming (e.g., melting), becoming liquidus, and/or plastically yielding (e.g., deforming) the bottom skin layer. In some embodiments, deep tiling also includes transforming the bottom skin layer.

The shallow transformation may be effectuated by a shorter dwell time, and/or lower power density of the irradiated energy (e.g., shorter exposure times). The exposure time during the shallow transformation may be at least about 0.1 milliseconds (msec), 0.5 msec, 1 msec, 3 msec, 5 msec, 10 msec, 20 msec, 30 msec, 40 msec, or 50 msec. The exposure time during the shallow transformation may be at most about 3 msec, 5 msec, 10 msec, 20 msec, 30 msec, 40 msec, or 50 msec. The exposure time may be between any of the above-mentioned exposure times (e.g., from about 0.1 msec to about 50 msec, from about 0.1 to about 1 msec, from about 1 msec to about 10 msec, from about 10 msec to about 10 msec, from about 1 msec to about 1 msec, or from about 1 msec to about 20 msec).

The deep transformation may be effectuated by longer dwell times, and/or higher power density of the tiling energy flux and/or scanning energy beam (e.g., shorter exposure times). The exposure time during the deep transformation may be at least about 50 msec, 60 msec, 70 msec, 80 msec, 90 msec, 100 msec, 200 msec, 400 msec, 500 msec, 1000 msec, 2500 msec, or 5000 msec. The exposure time during the deep transformation may be at most about 60 msec, 70 msec, 80 msec, 90 msec, 100 msec, 200 msec, 400 msec, 500 msec, 1000 msec, 2500 msec, or 5000 msec. The exposure time may be between any of the above-mentioned exposure times (e.g., from about 50 msec to about 5000 msec, from about 100 msec to about 200 msec, from about 50 msec to about 400 msec, from about 100 msec to about 1000 msec, or from about 1000 msec to about 5000 msec).

The manner of heating the one or more layers of pre-transformed material (or a portion thereof) may comprise controlling and/or altering the height of the pre-transformed material layer, the density of the pre-transformed material layer, the dwell time of the irradiated energy, the power density of the irradiated energy, the temperature of the material bed, or any combination thereof. The temperature of the material bed may comprise the temperature of the exposed surface of the material bed, bottom of the material bed (e.g., at the platform), average material bed temperature, middle material bed temperature, or any combination thereof. The control may depend on the temperature at the area of the material bed that is heated (e.g., tiled), or an area at the vicinity of the heated area. Vicinity may be at most about 2, 3, 4, 5, 6, 7, 8, 9, or 10 times the FLS of the tile.

The control of the irradiating energy (e.g., beam and/or flux) may comprise (e.g., substantially) ceasing (e.g., stopping) to irradiate the target area when the temperature at the bottom skin reached a target temperature. The target temperature may comprise a temperature at which the material (e.g., pre-transformed or hardened) reaches an elevated temperature that is above the solidus temperature, transforms (e.g., re-transforms, e.g., re-melts), become liquidus, and/or plastically yields. The control of the irradiating energy may comprise (e.g., substantially) reducing the energy supplied to (e.g., injected into) the target area when the temperature at the bottom skin reached a target temperature. The control of the irradiated energy may comprise altering the energy profile of the energy beam and/or flux respectively. The control may be different (e.g., may vary) for layers that are closer to the bottom skin layer as compared to layers that are more distant from the bottom skin layer (e.g., beyond the critical layer thickness as disclosed herein). The control may comprise turning the irradiated energy on and off. The control may comprise reducing the power per unit area, cross section, focus, power, of irradiated energy. The control may comprise altering at least one property of the irradiated energy, which property may comprise the power, power per unit area, cross section, energy profile, focus, scanning speed, pulse frequency (when applicable), or dwell time of the irradiated energy. During the “off” times (e.g., intermission), the power and/or power per unit area of the energy beam and/or flux may be (e.g., substantially) reduced as compared to its value at the “on” times (e.g., dwell times). (e.g., substantially) may be in relation to the transformation of the material at the target surface. During the intermission, the irradiated energy may relocate away from the area that was tiled, to a different area in the material bed that is (e.g., substantially) distant from area which was tiled (see examples 1). During the dwell times, the irradiated energy may relocate back to the position adjacent to the area which was just tiled (e.g., as part of the path-of-tiles).

As understood herein: The solidus temperature of the material is a temperature wherein the material is in a solid state at a given pressure. The liquefying temperature of the material is the temperature at which at least part of the pre-transformed material transitions from a solid to a liquid phase at a given pressure. The liquefying temperature is equal to a liquidus temperature where the entire material is in a liquid state at a given pressure.

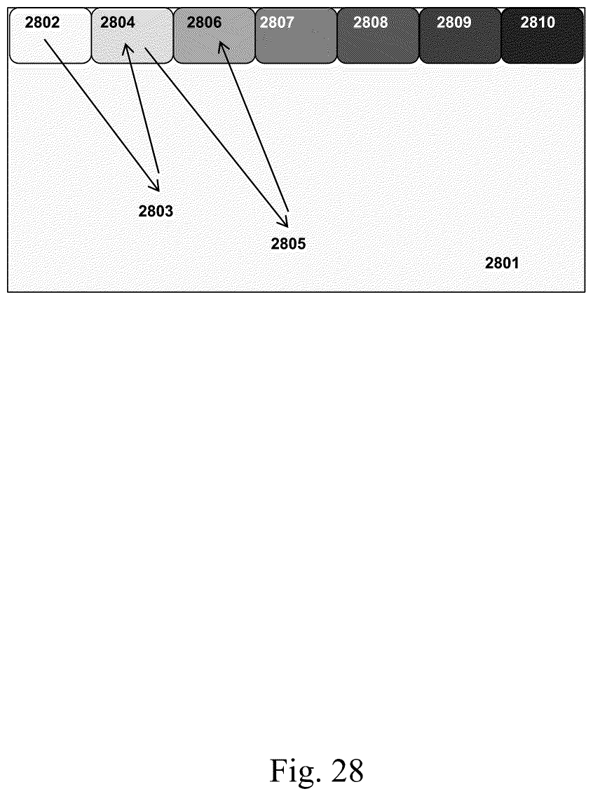

FIG. 28 shows an example of a top view of a target surface. The path of tiles in the example of FIG. 28 includes tiles 2802, 2804, and 2806-2810. The first tile formed by the irradiated energy is 2802 during a first dwell time, during the first intermission, the irradiated energy relocated to position 2803; during the second dwell time, the irradiated energy relocated back to the path-of-tiles and formed tile 2804; during the second intermission, the irradiated energy relocated to position 2805; during the third dwell time, the irradiated energy relocates back to the path-of-tiles and formed tile 2806. During the intermission, the irradiated energy may be heat and/or transform the material bed at the relocated position (e.g., 2803) that is distant from the path-of-tiles. The irradiated energy may form two distant paths-of-tiles by using the intermission time during the formation of the first path-of-tiles, to form the second path-of-tiles. The intermission of the first path of tiles can be a dwell time of the irradiated energy in the second path of tiles.

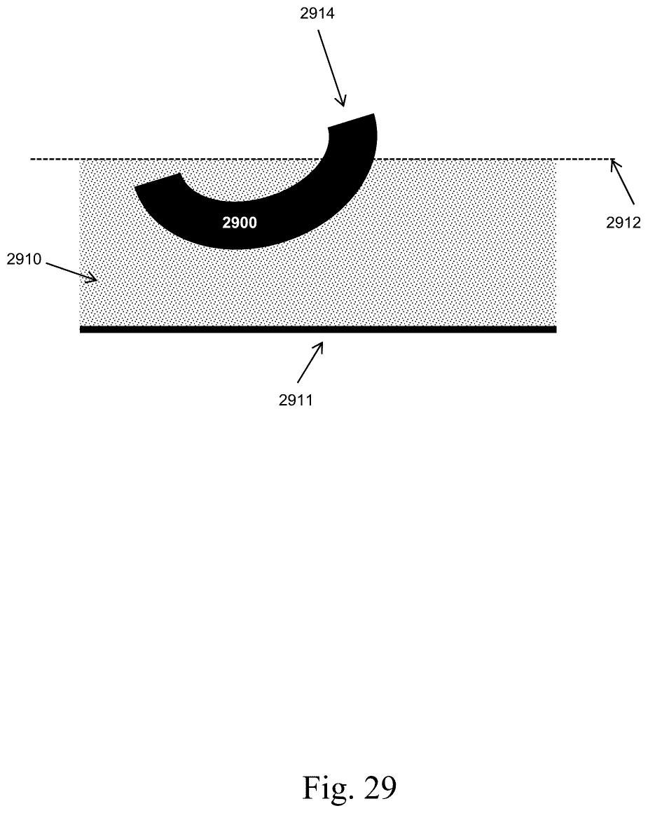

At times, hardened material may protrude from the exposed surface of the powder bed. FIG. 29 shows an example of a hardened material 2900 within the material bed 2910 that is located above a platform 2911. The material bed 2910 includes an exposed surface 2912. The hardened material 2900 protrudes from the exposed surface 2912 at a location 2914. The area of protrusion (e.g., horizontal cross section thereof) may be masked from the irradiated energy. In some instances, the irradiated energy may not irradiate the area (e.g., horizontal cross section thereof) which comprises the protruding hardened material. In some instances, the irradiated energy may irradiate the exposed surface of the material bed that is free of protruding objects (e.g., does not comprise protruding objects). In some instances, the irradiated energy may not irradiate the area which comprises the protruding object, and irradiate the exposed surface of the material bed that is free of protruding objects. The path in which the irradiated energy travels may exclude areas of protruding hardened material. The exclusion of the protrusion areas can be done before the irradiated energy transforms portions in a layer of pre-transformed material. The exclusion of the protrusion areas can be done in-real time (e.g., while the irradiated energy transforms portions in a layer of pre-transformed material (referred to herein as “dynamic path adjustment.”)) The path of the energy beam and/or flux can be adjusted dynamically as the irradiated energy travels along the exposed surface of the material bed. The adjustment of the path may consider a (e.g., optical) detection of the protruding object. Examples of real time (e.g., and in situ) optical detection, 3D printers, related control system, related methods, apparatuses, systems, and program instructions (e.g., software), can be found in U.S. patent application Ser. No. 15/435,090, filed Feb. 16, 2017; and in International Patent Application Serial No. PCT/US2017/018191 filed Feb. 16, 2017; each of which is incorporated herein by reference in their entirety.

The tiling of the target surface may follow a step and repeat sequence. The tiling of the target surface may follow a step and tile heating process to a temperature below the transformation temperature of the material at the target surface. The tiling of the target surface may follow a step and tile transforming (e.g., “filling”) process. The “step” may designate the distance from a first tile to a second tile (e.g., the distance “d” shown in the example of target surface 310 in FIG. 3). The distance may be constant within a layer of hardened material. At times, the distance may vary within a layer. The “repeat” may designate the repeated heating (e.g., transforming) the target surface by a tiled area (e.g., tile 301 shown in the example of target surface 310 in FIG. 3).

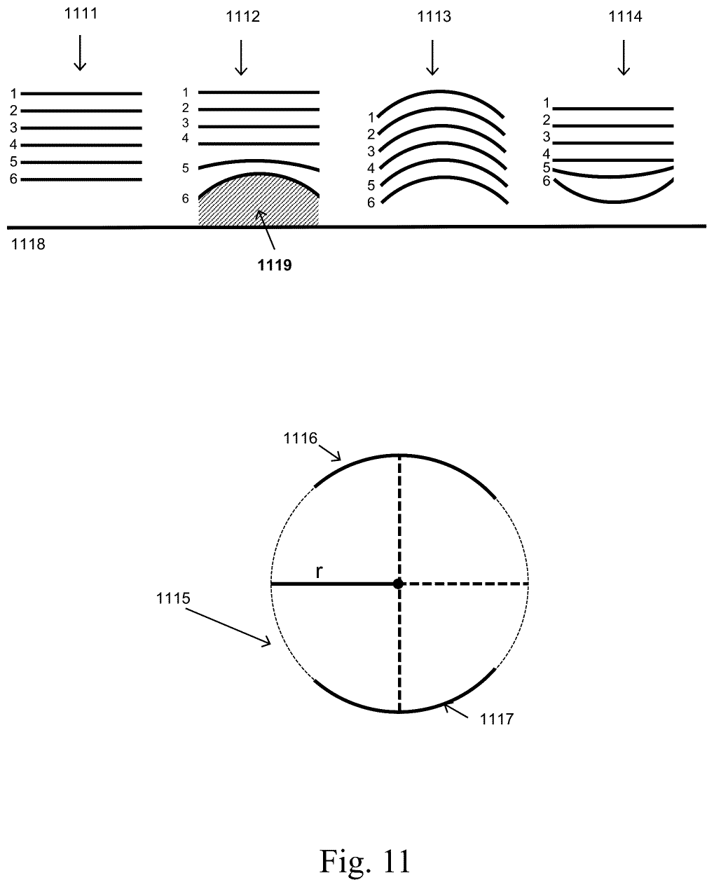

The flash heating and/or deep tiling process may regulate the deformation of at least one layer of hardened material. The flash heating and/or deep tiling process may reduce the magnitude of deformation of the at least one layer of hardened material. The flash heating and/or deep tiling process, in certain conditions, may increase the deformation at least one layer of hardened material (e.g., in a requested direction). For example, the flash heating and/or deep tiling process may form at least one layer of hardened material that is negatively warped (e.g., comprises a negative curvature, FIG. 11, 1112, layer number 6). Examples of methods forming a negatively warped object, 3D printers, related control system, other related methods, apparatuses, systems, and program instructions (e.g., software), can be found in U.S. patent application Ser. No. 15/339,712, filed Oct. 31, 2016; and in International Patent Application Serial No. PCT/US16/59781 filed on Oct. 31, 2016; each of which is entirely incorporated herein by reference. The certain conditions may comprise the geometry of the 3D object, the geometry of the at least one layer of hardened material, the power of the irradiated energy, the dwell time of the irradiated energy (e.g., time to make a tile), or the speed of the irradiated energy (e.g., along the path).

The layer of hardened material may have a curvature. The curvature can be positive or negative with respect to the platform and/or the exposed surface of the material bed. FIG. 11 shows examples of a vertical cross sections in various layered structures. For example, layered structure 1112 comprises layer number 6 that has a curvature that is negative, as the volume (e.g., area in a vertical cross section of the volume) bound from the bottom of it to the platform 1118 is a convex object 1119. Layer number 5 of 1112 has a curvature that is negative. Layer number 6 of 1112 has a curvature that is more negative (e.g., has a curvature of greater negative value) than layer number 5 of 1112. Layer number 4 of 1112 has a curvature that is (e.g., substantially) zero. Layer number 6 of 1114 has a curvature that is positive. Layer number 6 of 1112 has a curvature that is more negative than layer number 5 of 1112, layer number 4 of 1112, and layer number 6 of 1114.

In some embodiments, the curvature of all the layers within the 3D object is from at most about 0.02 millimeters⁻¹ (i.e., 1/millimeters). In some embodiments, the layers within the 3D object are (e.g., substantially) planar (e.g., flat). In some embodiments, all the layers of hardened material can have a curvature of at least about zero (e.g., a (e.g., substantially) planar layer) to at most about 0.02 millimeters⁻¹. The curvature can be at most about −0.05 mm⁻¹, −0.04 mm⁻¹, −0.02 mm⁻¹, −0.01 mm⁻¹, −0.005 mm⁻¹, −0.001 mm⁻¹, (e.g., substantially) zero mm⁻¹, 0.001 mm⁻¹, 0.005 mm⁻¹, 0.01 mm⁻¹, 0.02 mm⁻¹, 0.04 mm⁻¹, or 0.05 mm⁻¹. The curvature can be any value between the afore-mentioned curvature values (e.g., from about −0.05 mm⁻¹ to about 0.05 mm⁻¹, from about −0.02 mm⁻¹ to about 0.005 mm⁻¹, from about −0.05 mm⁻¹ to (e.g., substantially) zero, or from about (e.g., substantially) zero to about 0.05 mm⁻¹). The curvature may refer to the curvature of a surface. The surface can be of the layer of hardened material (e.g., first layer). The surface may be of the 3D object (or any layer thereof).

The radius of curvature, “r,” of a curve at a point is a measure of the radius of the circular arc (e.g., FIG. 11, 1116) which best approximates the curve at that point. The radius of curvature is the inverse of the curvature. In the case of a 3D curve (also herein a “space curve”), the radius of curvature is the length of the curvature vector. The curvature vector can comprise of a curvature (e.g., the inverse of the radius of curvature) having a particular direction. For example, the particular direction can be the direction to the platform (e.g., designated herein as negative curvature), or away from the platform (e.g., designated herein as positive curvature). For example, the particular direction can be the direction towards the direction of the gravitational field (e.g., designated herein as negative curvature), or opposite to the direction of the gravitational field (e.g., designated herein as positive curvature). A curve (also herein a “curved line”) can be an object similar to a line that is not required to be straight. A line can be a special case of curve wherein the curvature is (e.g., substantially) zero. A line of (e.g., substantially) zero curvature has a (e.g., substantially) infinite radius of curvature. The curve may represent a cross section of a curved plane. A line may represent a cross section of a flat (e.g., planar) plane. A curve can be in two dimensions (e.g., vertical cross section of a plane), or in three-dimension (e.g., curvature of a plane).

In some embodiments, cooling the tiles comprises introducing a cooling member (e.g., heat sink) to the heated area. FIG. 1 shows an example of a cooling member 113 that is disposed above the exposed (e.g., top) surface of the material bed 104. The cooling member may be translatable vertically, horizontally, or at an angle (e.g., planar or compound). The translation may be controlled manually and/or by a controller. The translation may be during the 3D printing. The cooling member may be operatively coupled to the controller. The tiling energy source, first scanning energy source, second scanning energy source, and/or cooling member may be translatable vertically, horizontally, or at an angle (e.g., planar or compound). The translation may be controlled manually and/or by a controller. The translation may be during at least a portion the 3D printing. In some embodiments, the energy sources are stationary. The tiling energy source, first scanning energy source, and/or second scanning energy source may be operatively coupled to the controller. The tiling energy source, first scanning energy source, second scanning energy source, and/or cooling member may be translated by a scanner. The cooling member may control (e.g., prevent) accumulation of heat in certain portions of the exposed 3D object (e.g., exposed layer of hardened material). Heating a tile on the target surface in a particular area may control (e.g., regulate) accumulation of heat in certain portions of the exposed 3D object (e.g., exposed layer of hardened material).

The flash heating, deep tiling, and/or shallow tiling method may further comprise preheating the material bed. Preheating the material bed may subsequently require less power to transform at least a portion of the exposed surface of the target surface with the aid of the tiling energy flux and/or scanning energy beam (e.g., first and/or second). Preheating and/or cooling the material bed may be from above, below, and/or sides of the material bed. The cooling member may assist in maintaining the temperature of the material bed and/or prevent transforming (e.g., fusing or caking) the pre-transformed material within the material bed and/or (e.g., within any cavities of the 3D object).

The control may comprise a closed loop control, or an open loop control (e.g., based on energy calculations comprising an algorithm). The closed loop control may comprise feed-back or feed-forward control. The algorithm may consider one or more temperature measurements (e.g., as disclosed herein), metrological measurements, geometry of at least part of the 3D object, heat depletion/conductance profile of at least part of the 3D object, or any combination thereof. The controller may modulate the irradiative energy and/or the energy beam. The algorithm may consider object pre-print correction (OPC) to compensate for any distortion of the final 3D object. The algorithm may comprise instructions to form a correctively deformed object. The algorithm may comprise modification applied to the model of a requested 3D object. Examples of modifications (e.g., corrective deformations such as object pre-print correction), 3D printers, related control system, other related methods, apparatuses, systems, and program instructions (e.g., software), can be found in in U.S. patent application Ser. No. 15/808,777, filed Nov. 9, 2017; and in PCT Patent application Serial No. PCT/US16/34857 that was filed on May 27, 2016; each of which is entirely incorporated herein by reference. The control may be any control disclosed in U.S. patent application Ser. No. 15/435,065 filed Feb. 16, 2017; and in PCT/US17/18191 filed Feb. 16, 2017; each of which is incorporated herein by reference in their entirety.

The methods for generating one or more 3D objects described herein may comprise: depositing a layer of pre-transformed material (e.g., powder) in an enclosure; providing (e.g., irradiating) energy to a portion of the layer of material (e.g., according to a path); transforming at least a section of the portion of the layer of pre-transformed material to form a transformed material by utilizing the energy; optionally allowing the transformed material to harden into a hardened material; and optionally repeating operations (a) to (d) to generate the one or more 3D objects. The enclosure may comprise a platform (e.g., a substrate and/or base). The enclosure may comprise a container. The 3D object may be printed adjacent to (e.g., above) the platform. The pre-transformed material may be deposited in the enclosure by a material dispensing system to form a layer of pre-transformed material within the enclosure. The deposited material may be leveled by a leveling mechanism. The deposition of pre-transformed material in the enclosure may form a material bed. The leveling mechanism may comprise a leveling operation where the leveling mechanism does not contact the exposed surface of the material bed. The material dispensing system may comprise one or more dispensers (e.g., FIG. 1, 116). The material dispensing system may comprise at least one material (e.g., bulk) reservoir. The material may be deposited by a layer dispensing mechanism (e.g., recoater). The layer dispensing mechanism may level the dispensed material without contacting the powder bed (e.g., the top surface of the powder bed). The layer dispensing mechanism may comprise a layer dispensing mechanism (e.g., FIG. 1, 116), a material removal mechanism (e.g., 118), or a leveling mechanism (e.g., 117). Examples of layer dispensing mechanism, 3D printers, related control system, related methods, apparatuses, systems, and program instructions (e.g., software), can be found in Patent application Serial No. PCT/US15/36802 titled “APPARATUSES, SYSTEMS AND METHODS FOR 3D PRINTING” that was filed on Jun. 19, 2015, which is incorporated herein by reference in its entirety. The layer dispensing mechanism may comprise a material dispensing mechanism, material leveling mechanism, material removal mechanism, or any combination thereof. In some embodiments, the pre-transformed material may be added and leveled by the layer dispensing mechanism sequentially during the same run (e.g., as it levels a layer of material in the material bed). For example, during one progression of the layer dispensing mechanism along the material bed, the layer dispenser may dispense material into (or to form) the material bed, which dispensed material is subsequently leveled (e.g., without contacting the top surface of the material bed), more material is dispensed (e.g., as the layer dispensing mechanism is translating along the material bed), and the more material is subsequently leveled, etc. The layer dispensing mechanism can perform one, two, or more material dispensing operations as it completes one lateral sweep of the material bed. The layer dispensing mechanism can perform one, two, or more material leveling operations as it completes one lateral sweep of the material bed. The layer dispensing mechanism can perform one, two, or more material removal operations as it completes one lateral sweep of the material bed. The layer dispensing mechanism can perform one, two, or more material dispensing operations as it completes one lateral sweep of the material bed. The lateral sweep of the material bed can be a sweep of the material bed from one edge of the material bed to an opposite (e.g., laterally opposing) edge of the material bed.

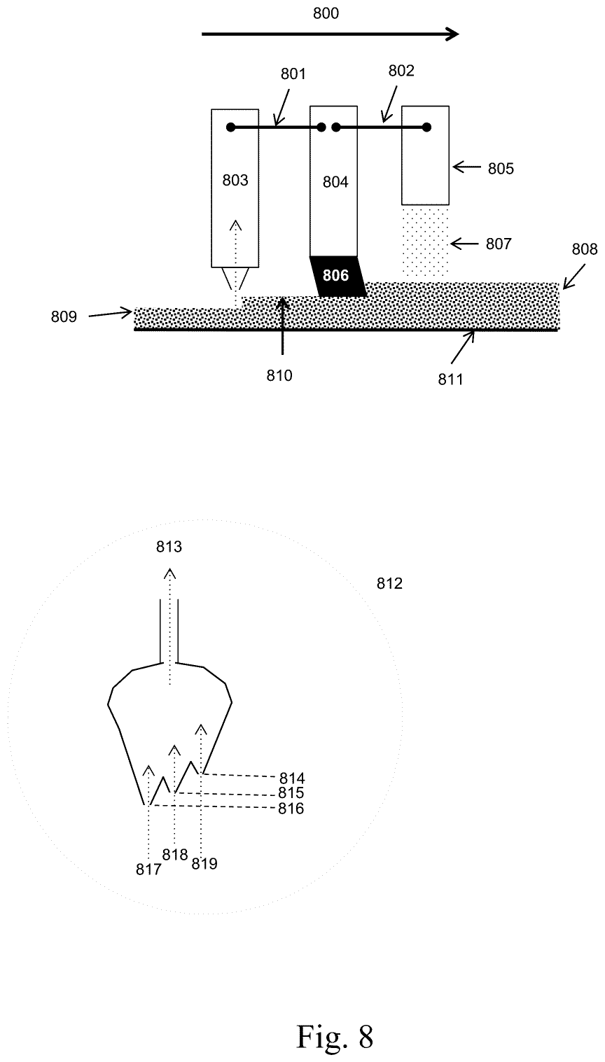

The layer dispensing mechanism may comprise at least two of: a material dispensing mechanism (e.g., dispenser), a leveling mechanism, and a material removal mechanism. FIG. 1 shows an example of a layer dispensing mechanism comprising a material dispensing mechanism 116, a leveling mechanism 117, and a material removal mechanism 118 (The white arrows in 116 and 118 designate the direction in which the pre-transformed material flows into/out of the material bed 104). FIG. 8 shows another example of a layer dispensing mechanism comprising a material dispensing mechanism 805, a leveling mechanism (including 806 and 804), and a material removal mechanism 803, in which the three mechanism 805, 806 & 804 and 803 are connected (e.g., 801 and 802). The layer removal mechanism and/or the layer dispensing mechanism may comprise one or more nozzles. In the example of FIG. 8, 812 depicts an example of a nozzle comprising three openings 814, 815, and 816 through which material (e.g., pre-transformed material) may be attracted (e.g., pulled, or flow) into the nozzle (e.g., along arrows 817, 818 and 819). The flow of the material into the layer removing mechanism may comprise laminar flow. The flow of the material from the material bed into the layer removal mechanism may be in the upwards direction (e.g., against the gravitational center, and/or away from the platform).

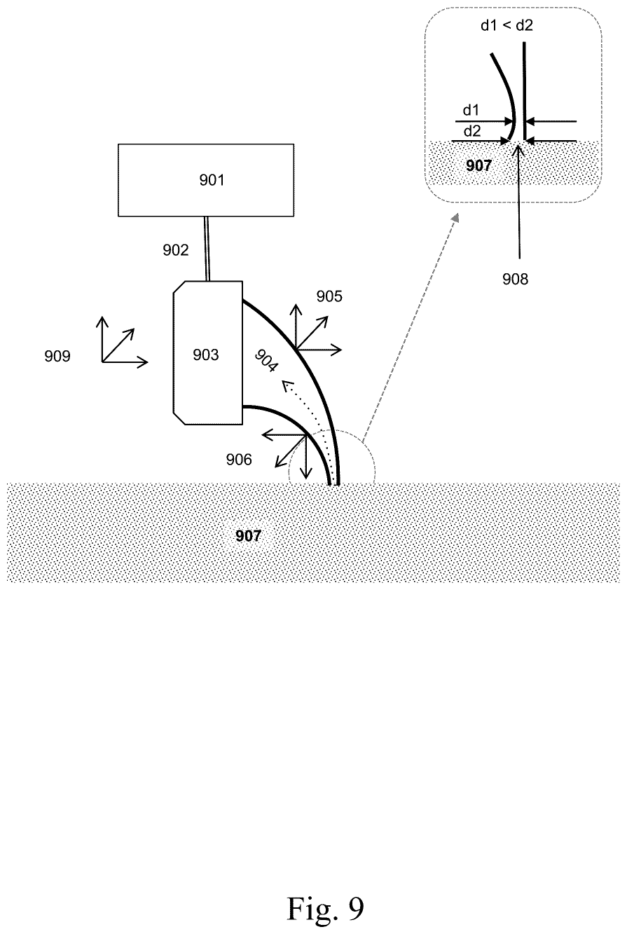

The layer dispensing mechanism may comprise a material (e.g., powder) removal mechanism (e.g., 803) that comprises one or more openings. The one or more openings may be included in a nozzle. The nozzle may comprise an adjustable opening (e.g., regulated by a controller). The height of the nozzle opening relative to the exposed surface of the material bed may be adjustable (e.g., regulated by a controller). The material removal mechanism may comprise a reservoir in which the material may at least temporarily accumulate. The evacuated material may comprise a pre-transformed material that is evacuated by the material removal mechanism. The evacuated material may comprise a transformed material that did not form the 3D object. FIG. 9 shows an example of a material removal mechanism comprising a nozzle 904 through which material flows from the material bed 907 into a reservoir 903. In the example in FIG. 9, the reservoir is connected to an attractive force source 901 (such as a vacuum pump) through a channel (e.g., tube) 902. At least one portion of the nozzle body may be adjustable. In some embodiments, at least one part of the nozzle body is adjustable at a vertical, horizontal, or angular direction (e.g., with respect to the exposed surface of the material bed, and/or the building platform). The nozzle may be formed of one or two thick portions (e.g., of which at least one is movable). The thick section(s) may allow an internal volume of the nozzle to be sealed (e.g., without forming a gap) by two opposing side walls that are disposed parallel to the movement axis of the material removal mechanism and span the maximum allowed movement of the at least one thick section (e.g., along 905 and/or 906). The material removal mechanism (e.g., comprising the nozzle and the internal reservoir) may translate vertically, horizontally, and/or at an angle (e.g., along 909). The translation may be before, after, and/or during at least a portion of the 3D printing (e.g., to planarize the exposed surface of the material bed). In the example of FIG. 9, one or two parts of the nozzle body are adjustable at a vertical, horizontal, or angular direction (e.g., with respect to the exposed surface of the material bed, and/or the building platform) as indicated by arrows 905 and 906. The nozzle may comprise an adjustable opening (e.g., controlled by a controller). The height of the nozzle opening relative to the exposed surface of the material bed may be adjustable (e.g., controlled by a controller). The material removal mechanism may comprise a reservoir in which the material (that is evacuated by the material removal mechanism) may at least temporarily accumulate. Control may include regulate and/or direct.

The FLS of the opening (e.g., cross section thereof) of the material removal mechanism (e.g., nozzle diameter) may be at least about 0.1 mm, 0.4 mm, 0.7 mm, 0.9 mm, 1.1 mm, 1.3 mm, 1.5 mm, 2 mm, 2.5 mm, 3 mm, 3.5 mm, 5 mm, 7 mm, or 10 mm. The FLS of the opening of the material removal mechanism (e.g., nozzle diameter) may be at most about 0.1 mm, 0.4 mm, 0.7 mm, 0.9 mm, 1.1 mm, 1.3 mm, 1.5 mm, 2 mm, 2.5 mm, 3 mm, 3.5 mm, 5 mm, 7 mm, or 10 mm. The FLS of the opening of the material removal mechanism (e.g., nozzle diameter) may be of any value between the afore-mentioned values (e.g., from about 0.1 mm to about 7 mm, from about 0.1 mm to about 0.6 mm, from about 0.6 mm to about 0.9 mm, from about 0.9 mm to about 3 mm, or from about 3 mm to about 10 mm).

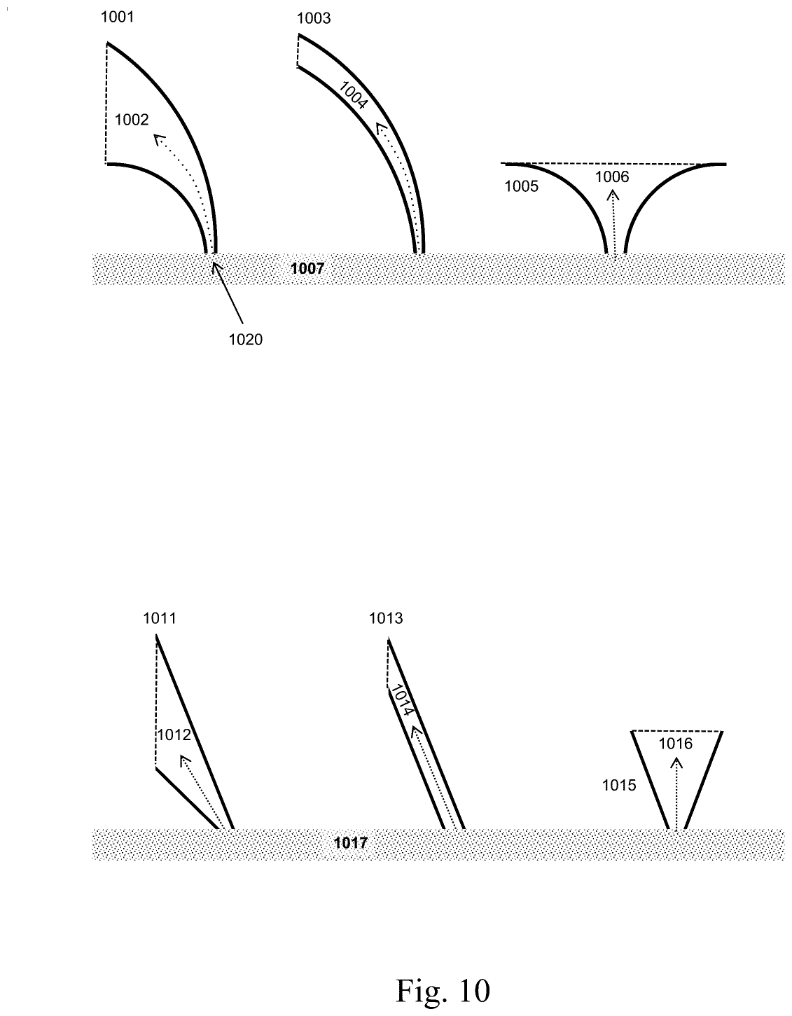

The nozzle may comprise a material entrance opening through which material enters from the material bed (e.g., 908) into the nozzle (e.g., along arrow 904). The nozzle can be a Venturi nozzle. The opening may comprise a narrow portion (e.g., a “bottle neck”). Sometimes, the narrow portion is at the entrance of the nozzle (e.g., FIG. 10, 1020). At times, the narrow portion is away from the opening (e.g., FIG. 9, 908, the narrow opening is designated by “dl”). At time, the FLS (e.g., diameter) of the opening is larger than the FLS of the narrow portion within the nozzle. At time the FLS of the opening is the narrows portion of the nozzle. The FLS of the narrow portion may be constant or variable. The FLS of the narrow portion may be varied mechanically, electronically, thermally, hydraulically, magnetically, or any combination thereof.

The nozzle may be symmetric or asymmetric. A vertical and/or horizontal cross section of the nozzle may be asymmetric. For example, a vertical cross section of the nozzle interior may reveal its asymmetry. The asymmetry can be in the materials from which the nozzle is composed. The asymmetry can be manifested by a lack of at least one symmetry axis. For example, a lack of n fold rotational axis (e.g., lack of Cn symmetry axis, wherein n equals at least 2, 3, or 4). For example, a lack of at least one symmetry plane. For example, a lack of inversion symmetry. In some embodiments, the nozzle comprises a symmetry plane, but lack rotational symmetry. In some embodiments, the nozzle lacks both a rotational symmetry axis, and a symmetry plane. The axis of symmetry may be (e.g., substantially) perpendicular to the average surface of the exposed surface of the material bed, to the building platform, or to a plane normal to the direction of the gravitational force. The axis of symmetry may be at an angle between about 0 degrees and about 90 degrees relative to the average surface of the exposed surface of the material bed, to the building platform, to a plane normal to the direction of the gravitational force, to any combination thereof. The nozzle may have a bent shape. The nozzle can have a crooked shape. The bent shape may follow a function. The function may be exponential or logarithmic. The function may be a portion of a circle or a parabola. The bent shape can roughly resemble the letter “L” or “J.” The bent shape can be a smoothly bent shape. The bent shape can be a curved shape. FIG. 10 shows an example of vertical cross section of various nozzles 1001, 1003, 1005, 1011, and 1013. In some examples, material flows into or out of the nozzles. Arrows 1002, 1004, 1006, 1012, 1014, and 1016 show an example of the direction in which material flows from the material bed (e.g., 1007 or 1017 respectively) into the appropriate nozzles. Nozzles 1005 and 1010 show examples of symmetrical cross sections of nozzles, with a mirror axis of symmetry along the arrows 1006 and 1016 respectively. Nozzles 1003, 1001, show examples of non-symmetrical cross sections of nozzles as this cross section lacks an axis of symmetry. The nozzle may be a long nozzle (e.g., vacuum nozzle) in the horizontal and/or vertical direction. The nozzle may be symmetric or asymmetric. The symmetry axis may be in a horizontal and/or vertical cross-section of the nozzle. FIG. 10 shows examples of nozzles depicted as vertical cross sections. Nozzle 1003 shows an example of a nozzle that is long in the vertical direction. The axis of symmetry for nozzle 1010 can be along the arrow 1016. The nozzle may be a vacuum nozzle. The nozzle may comprise laminar or turbulent flow during its operation (e.g., suction). The magnitude of laminar flow between two sides of the nozzle (e.g., two vertical sides of the nozzle) can be the same or different. The magnitude of laminar flow between two sides of the asymmetric nozzle (e.g., the two asymmetric vertical sides of the nozzle) can be the same or different. The gas flow within the nozzle (e.g., during its operation) may comprise laminar flow. The gas flow within the nozzle (e.g., during its operation) may comprise turbulence. The gas flow between the exposed surface and the nozzle entrance (e.g., during its operation) may comprise laminar flow. The gas flow between the exposed surface and the nozzle entrance (e.g., during its operation) may comprise turbulence. The turbulence may be a requested turbulence. The flow rate of the gas within the nozzle (e.g., suction power) may depend on the size and/or mass of the particulate material (e.g., particles forming the powder bed).

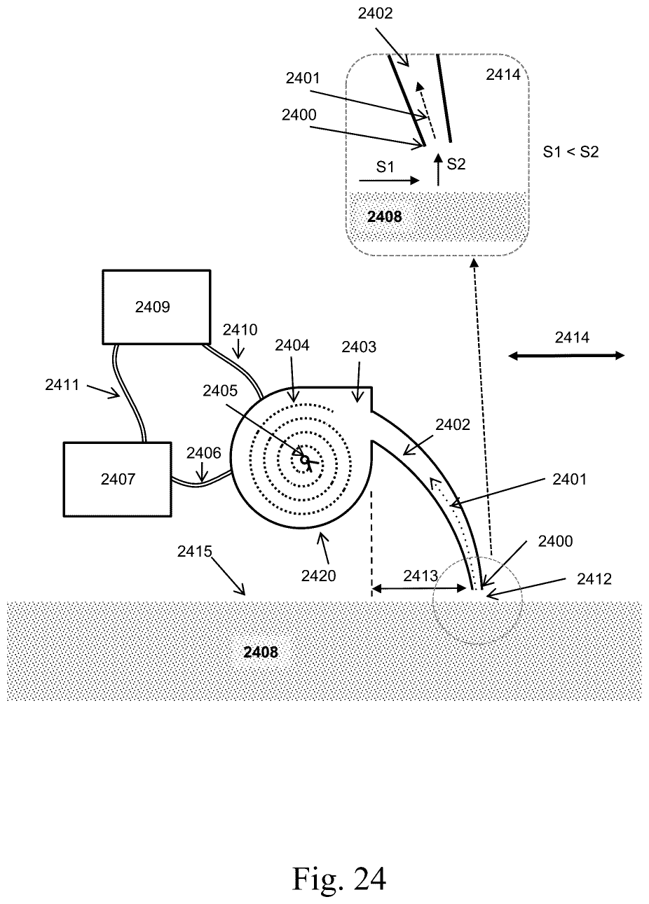

In some embodiments, the pre-transformed material (e.g., powder) is attracted utilizing the force source to the opening port of the material removal mechanism and flows above the material bed in a (e.g., substantially) horizontal flow. FIG. 24 shows an example of a material removal mechanism, and illustrates a horizontal flow S1 of the pre-transformed material toward the opening port 2400. The (e.g., substantially) horizontal flow of the pre-transformed material above the material bed may be relative to the position of the material bed (e.g., relative speed). The relative speed (e.g., velocity) of (e.g., substantially) horizontal flow towards the opening port of the material removal member may be at least 0.5 meter per second (m/sec), 1 m/sec, 2 m/sec, 3 m/sec, 4 m/sec, 5 m/sec, 6 m/sec, 7 m/sec, 8 m/sec, 9 m/sec, 10 m/sec, 20 m/sec, 30 m/sec, 40 m/sec, or 50 m/sec. The relative speed of (e.g., substantially) horizontal flow towards the opening port of the material removal member may be any speed between the afore-mentioned speed values (e.g., from about 0.5 m/sec to about 50 m/sec, from about 1.5 m/sec to about 3 m/sec, from about 3 m/sec to about 6 m/sec, from about 6 m/sec to about 10 m/sec, or from about 10 m/sec to about 50 m/sec).

In some embodiments, the particulate material (e.g., powder) is attracted to the opening port of the material removal mechanism and flows toward a position above the material bed in a (e.g., substantially) vertical flow. FIG. 24 shows an example of a material removal mechanism, and illustrates a vertical flow S2 of the pre-transformed material toward the opening port 2400. The speed of (e.g., substantially) vertical flow towards the opening port of the material removal member may be at least 30 meter per second (m/sec), 40 m/sec, 50 m/sec, 60 m/sec, 70 m/sec, 80 m/sec, 90 m/sec, 100 m/sec, 200 m/sec, 300 m/sec, 400 m/sec, 500 m/sec, 600 m/sec, or 700 m/sec. The speed of (e.g., substantially) vertical flow towards the opening port of the material removal member may be any speed between the afore-mentioned speed values (e.g., from about 30 m/sec to about 700 m/sec, from about 30 m/sec to about 60 m/sec, from about 60 m/sec to about 500 m/sec, from about 60 m/sec to about 100 m/sec, or from about 100 m/sec to about 700 m/sec).

In some embodiments, the speed of the vertical flow is greater than the speed of the horizontal flow. The speed of the vertical flow may be greater by at least about 1.5*, 2*, 2.5*, 3*, 4*, 5*, 6*, or 10*(e.g., times) the speed of the horizontal flow. The speed of the vertical flow may any value between the afore-mentioned values (e.g., from about 1.5* to about 10*, from about 1.5* to about 2.5*, from about 2.5* to about 5*, or from about 5* to about 10* (i.e., times) the speed of the horizontal flow).

The (e.g., laminar) flow of pre-transformed (e.g., powder) material into the (e.g., vacuum) nozzle may create an area of low pressure, which may in turn generate a vertical force which would result in a horizontal force acting on the pre-transformed (e.g., particulate) material (e.g., at the exposed surface of the material bed). Due to the operation of the nozzle, the pre-transformed material in the material bed (e.g., exposed surface thereof) may be subject to the Bernoulli principle.

In some embodiments, the nozzle is separated from the exposed surface of the material bed by a gap (e.g., vertical distance, FIG. 24, 2412). The gap may comprise a gas. The gas may be an atmospheric gap. The extent of the gap and/or the FLS of the opening port (e.g., diameter) of the nozzle may be changeable (e.g., before, after, and/or during the 3D printing). For example, that change in the nozzle opening port may occur during the operation of the material removal mechanism. For example, that change may occur before the initiation of the 3D printing. For example, that change may occur during the formation of the 3D object. For example, that change may occur during the formation of a layer of hardened material. For example, that change may occur after transforming a portion of a layer of pre-transformed (e.g., powder) material. For example, that change may occur before deposition a subsequent layer of pre-transformed material. For example, that change may occur during the progression of the layer dispensing mechanism (e.g., of which the material removal mechanism is a part of) along the exposed surface of the material bed. The progression may be parallel to the exposed surface of the material bed. The progression may be a lateral progression (e.g., from one side of the material bed to the opposite side of the material bed). In some embodiments, the extent of the gap and/or the FLS of the opening port (e.g., diameter) of the nozzle may be unchanged before, after, and/or during the formation of: the 3D object, layer of hardened material, transformed material, or any combination thereof. The extent of the gap and/or the FLS of the opening port (e.g., diameter) of the nozzle may be unchanged during the formation of: the 3D object, layer of hardened material, transformed material, or any combination thereof. The vertical distance of the gap from the exposed surface of the target surface to the entrance opening of the nozzle (e.g., 2412) may be at least about 0.05 mm, 0.1 mm, 0.25 mm, 0.5 mm, 1 mm, 2 mm, 3 mm, 4 mm, 5 mm, 6 mm, 7 mm, 8 mm, 9 mm, or 10 mm. The vertical distance of the gap from the exposed surface of the powder bed may be at most about 0.05 mm, 0.1 mm, 0.25 mm, 0.5 mm, 1 mm, 2 mm, 3 mm, 4 mm, 5 mm, 6 mm, 7 mm, 8 mm, 9 mm, 10 mm, or 20 mm. The vertical distance of the gap from the exposed surface of the powder bed may be any value between the afore-mentioned values (e.g., from about 0.05 mm to about 20 mm, from about 0.05 mm to about 0.5 mm, from about 0.2 mm to about 3 mm, from about 0.1 mm to about 10 mm, or from about 3 mm to about 20 mm).

The velocity (e.g., speed) of the material removal mechanism may be altered. The velocity by which a pre-transformed (e.g., powder) material is removed from the material bed by the material removal system may be altered. The force exerted by the material removal mechanism (e.g., through the nozzle) on the pre-transformed material (e.g., powder) disposed in the material bed, may be altered. The alteration may be before, after, and/or during the formation of: the 3D object, layer of hardened material, transformed material, or any combination thereof. The alteration may be during the formation of the 3D object, layer of hardened material, transformed material, or any combination thereof.

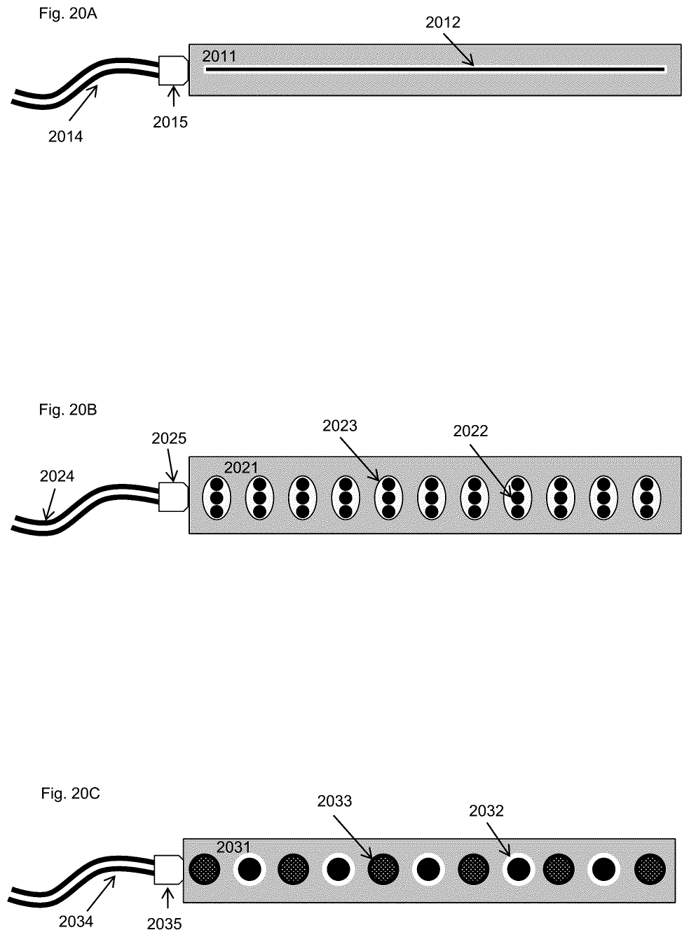

FIGS. 20A-C and 21A-E schematically depict bottom views of various mechanisms for removing the pre-transformed material as part of the material removal mechanism. FIG. 20A schematically depicts a bottom view of a material removal mechanism 2011 having an elongated material entrance opening port 2012, which material removal mechanism is connected 2015 to channel 2014 through which the pre-transformed material leaves the material removal mechanism. FIG. 20B schematically depicts a bottom view of a material removal member having manifolds (e.g., 2023) of multiple pre-transformed material (e.g., powder) entrance opening ports (e.g., 2022). FIG. 20C schematically depicts an integrated material dispensing-removal member having material entrance opening ports (e.g., 2032), and material exit openings, e.g., opening ports such as 2033. Examples of material removal mechanisms, 3D printers, related control system, related methods, apparatuses, systems, and program instructions (e.g., software), can be found in International Patent Application Serial No. PCT/US15/36802, which is entirely incorporated herein by reference in its entirety.

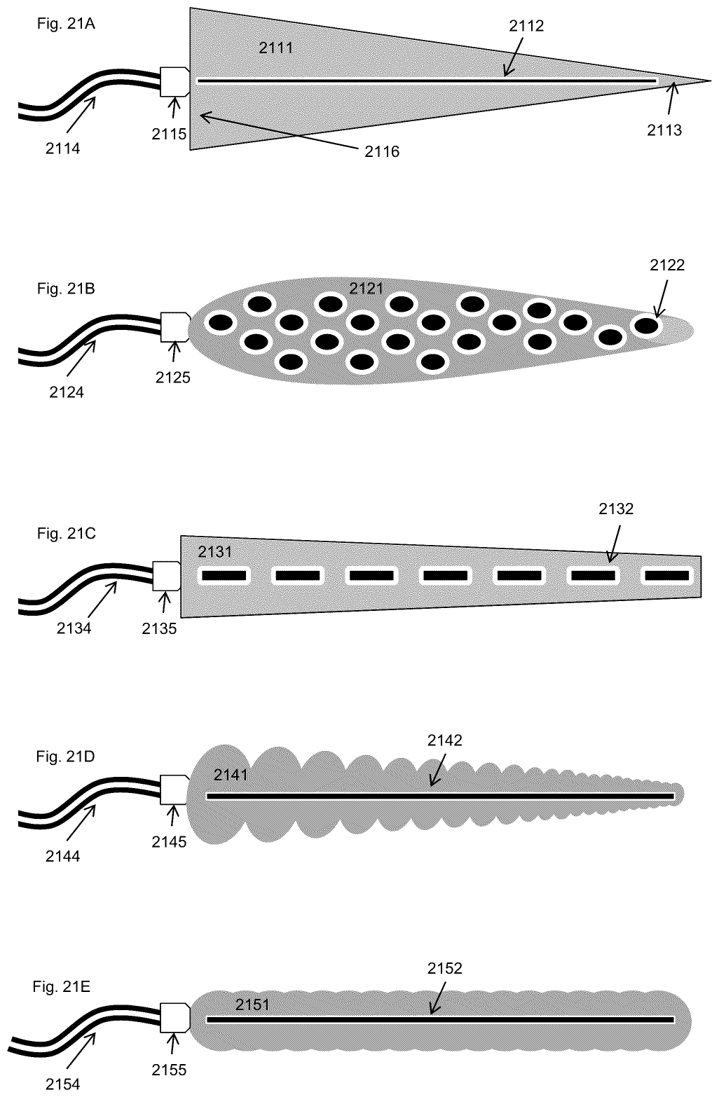

FIG. 21A schematically depicts a bottom view of a material removal mechanism having an elongated material entrance opening port 2112 and an internal compartment having a triangular horizontal cross section 2111 the material remover is coupled to a channel 2114 (hose) through coupler 2115 (e.g., connector) at its wide end 2116 opposing is narrow end 2113. FIG. 21B schematically depicts a bottom view of a material removal member having a multiplicity of pre-transformed material entrance opening ports (e.g., 2122) and an internal compartment having an egg-like cross section 2121, the material remover being coupled to a channel 2124 (hose) through coupler 2125 (e.g., connector). FIG. 21C schematically depicts a bottom view of a material removal member having multiple pre-transformed material (e.g., powder) entrance opening ports (e.g., 2132) and an internal compartment having a trapezoid horizontal cross section 2131, the material remover being coupled to a channel 2134 (hose) through coupler 2135, e.g., connector. FIG. 21D schematically depicts a bottom view of a material removal member having a pre-transformed material entrance opening port 2142 and an internal compartment having cross section 2141 of a narrowing helix (e.g., narrowing screw), the material remover being coupled to a channel 2144 (hose) through coupler 2145, e.g., connector. In some embodiments, the cross section is a horizontal cross section. In some examples, the horizontal cross section spans (e.g., approximately) the width or length of the target surface (e.g., FIG. 19). In some examples, the horizontal cross section is less than (e.g., approximately) the width or length of the target surface. In some examples, the horizontal cross section exceeds (e.g., approximately) the width or length of the target surface. FIG. 21E schematically depicts a bottom view of a material removal member having a pre-transformed material entrance opening port 2152 and an internal compartment having a horizontal cross section 2151 of a tubular helix (e.g., Archimedean screw), the material remover being coupled to a channel 2154 (hose) through coupler 2155, e.g., connector.

The nozzle may be a long nozzle (e.g., vacuum nozzle) in the horizontal direction. The long nozzle may be referred herein as an elongated nozzle. FIG. 20A shows an example of an elongated nozzle in the horizontal direction, having a horizontally elongated material entry port 2012, the material remover being coupled to a channel 2114 (hose) through coupler 2115, e.g., connector. The channel may be connected to an attractive force (e.g., vacuum). In some examples, the nozzle spans at least a portion of the width or length of the material bed. In some examples, the nozzle spans less than the width or length of the material bed. FIG. 19 shows examples of a width and a length. The nozzle may span approximately the width or length of the material bed. The nozzle may be symmetric or asymmetric. The symmetry axis may be horizontal and/or vertical (e.g., (e.g., substantially) parallel to the platform). A cross section of the material removal member opening port (e.g., nozzle entrance) may be rectangular (e.g., 2112, 2132), or elliptical (e.g., 2122). The rectangular opening may be a square. The elliptical opening may be a circle (e.g., 2032). A cross section of the material removal member opening port (e.g., nozzle entrance) may comprise a curvature (e.g., curved edge) or a straight line (e.g., straight edge). The FLS (e.g., width to length) of the opening port cross section may have an aspect ratio of at least 1:2, 1:10, 1:100, 1:1000, 1:1000, or 1:10000.

The material removal member may comprise a connector. The connector may be to a power source (herein referred to as “power source connector”). The connector may be to a reservoir. The connector may be both to a reservoir and to the power source connection. FIG. 20B shows an example of an elongated nozzle in the horizontal direction, having a entry ports 2022 grouped into groups such as group 2023, the material remover being coupled to a channel 2024 (hose) through coupler 2025, e.g., connector. The channel may be connected to an attractive force (e.g., vacuum). The power source may be a source of gas flow (e.g., compressed gas, or vacuum), electrostatic force, and/or magnetic force. The connector may allow a fluid connection (e.g., such that the pre-transformed material may flow through). FIG. 20C show an example of a fluid connection 2034 (e.g., to the power source). The connector may allow pre-transformed material, debris, and/or small bits of transformed material to flow through the channel (e.g., FIG. 20B, 2024) and towards the attractive force source. The connector may allow gas to flow through. The connector may comprise connection to a channel (e.g., FIG. 20A, 2014). The channel (e.g., tube) may be flexible or non-flexible. Examples of connectors are shown in 2015, 2025, 2035, 2115, 2125, 2135, 2145, and 2155. Examples of channels are shown in 2014, 2024, 2034, 2114, 2124, 2134, 2144, and 2154. FIG. 20C shows an example of an elongated nozzle in the horizontal direction, having two types of material entry port 2033 and 2032 respectively arranged in a series along a line, the material remover being coupled to a channel 2034 (hose) through coupler 2035, e.g., connector. The channel may be connected to an attractive force (e.g., vacuum).

In some examples, the material removal member comprises an internal compartment. The internal compartment may be a pre-transformed material collection compartment. For example, the internal compartment may be a powder collection compartment, or a liquid collection compartment. The internal compartment may connect (e.g., fluidly connect) to the power source (e.g., through the connector and the channel). The internal compartment may comprise the connector. FIG. 20A shows an example of a connector 2015. The internal compartment may connect (e.g., fluidly) to the one or more nozzles. The internal compartment may connect (e.g., fluidly) to the one or more nozzles and to the power source and/or reservoir. The internal compartment may be symmetric or asymmetric. The symmetry or asymmetry may be in the horizontal and/or vertical direction. The internal compartment may comprise the shape of a cylinder, cone, box, ellipsoid, egg, or a spiral. The cross section (e.g., horizontal and/or vertical) may comprise the shape of a triangle (e.g., 2111), ellipse, rectangle (e.g., 2011), parallelogram, trapezoid (e.g., 2131), egg cross section (e.g., 2121), spiral cross section (e.g., 2141 or 2151), star, sickle, or crescent. The cross section (e.g., horizontal and/or vertical) may comprise a concave shape or a convex shape. FIG. 20B shows an example of an internal compartment having a cross section of a rectangle 2021. The long axis of the internal compartment may be (e.g., substantially) parallel to the platform. A short axis of the internal compartment may be (e.g., substantially) perpendicular to the platform. The internal compartment may comprise a curvature. The internal compartment may comprise a curved plane. The internal compartment may comprise a planar (e.g., non-curved, or flat) plane. A horizontal cross section of the internal compartment may be symmetric (e.g., a rectangle) or asymmetric (e.g., a triangle). The internal compartment may be wider (e.g., 2116) towards the connector (e.g., 2115). The internal compartment may be narrower (e.g., 2113) away from the connector. The shape of the internal compartment may allow substantial uniform removal (e.g., suction) of the pre-transformed material by the nozzle(s) of the material removal member along its horizontal span. The internal shape of the internal compartment may narrow towards a distant position from the connector. The narrowing may be gradual or non-gradual. The narrowing may be linear, logarithmic, or exponential. The internal compartment of the material removal member may have a shape that allows movement of the pre-transformed material within the compartment. The movement of the pre-transformed material within the compartment may comprise laminar or curved movement. The curved movement may comprise a spiraling movement. The curved movement may comprise a helical movement. The internal compartment may have an internal shape of a helix, spiral, or screw. The screw may be a narrowing screw, a cylindrical screw, or any combination thereof (e.g., a household type screw, or an Archimedean screw). Viewed from below, the opening port of the nozzle may horizontally overlap the internal compartment (e.g., centered below as shown for example in FIG. 20A), or not overlap. In some embodiments, the opening port of the nozzle is horizontally separated from the internal compartment by a gap (e.g., FIG. 24, 2413). The power source, reservoir, and/or internal compartment may be stationary or translational with respect to the material bed. The material removal mechanism (or any of its components) may translate relative to the material bed. For example, the material removal mechanism may be stationary, and the material bed may be translating. For example, the material removal mechanism may translate, and the material bed may be stationary. For example, both the material removal mechanism and the material bed may be translating (e.g., in the same direction, in opposite directions and/or at different speeds).

In some embodiments, the shape of the internal compartment, opening port, and/or nozzle reduces turbulence of the pre-transformed material as it travels towards the power source. The shape of the internal compartment, opening port, and/or nozzle may (e.g., substantially) prevent turbulence of the pre-transformed material as it travels towards the power source. The shape of the internal compartment, opening port, and/or nozzle may promote a spiral and/or helical flow of the pre-transformed material as it travels towards the power source. The shape of the internal compartment, opening port, and/or nozzle may promote a laminar flow of the pre-transformed material as it travels towards the power source.

In some embodiments, pre-transformed material from the material bed relocates into the material removal mechanism through a material entrance port. The relocation may be induced by an attractive force (e.g., vacuum, electrostatic force, and/or magnetic force). The relocation may be actively induced. The active inducement may be by a gas flow (e.g., positive or negative), magnetic force, and/or electrostatic force. The relocated pre-transformed material entering through the entrance port (e.g., nozzle opening) may travel into an internal compartment. The relocated pre-transformed material may travel through the internal compartment towards the power source. The relocated pre-transformed material may travel through the opening (e.g., entrance) port towards the power source. The relocated pre-transformed material may travel through the opening (e.g., entrance) port towards the power source, into a reservoir. The relocated pre-transformed material may accumulate in the reservoir. The relocated pre-transformed material in the reservoir may be recycled and re-used (e.g., by the material dispensing mechanism) to provide at least a portion of the material bed. The recycling may be before, after, and/or during the formation of: the 3D object, layer of hardened material, transformed material, or any combination thereof. The reservoir can be disposed horizontally above, on the same plane, or below the entrance opening port (e.g., nozzle entrance opening) of the material removal member.

The multiplicity of opening ports (e.g., material entrance ports, or nozzle opening ports) of the material removal mechanism may be arranged in groups (e.g., 2023), in an array, in a single file (e.g., 2132), staggered file (e.g., 2123 and 2124), randomly, or any combination thereof. The opening port of the material removal mechanism may be a single opening port or a multiplicity of opening ports.

In some embodiments, the pre-transformed material accumulates in the internal compartment of the material removal mechanism. The opening port through which material enters the material removal mechanism, may be away from the position in which the pre-transformed material accumulates in the internal compartment. Away may be vertically and/or horizontally away. Away may be distant. Away may be in a position that (e.g., substantially) prevents the pre-transformed material to flow back into the opening port through which it entered (e.g., and back into the material bed). Away may be in a position that allows the pre-transformed material to be trapped in the internal compartment and not fall back to the material bed (e.g., through the opening port). Away may be in a position that allows the pre-transformed material to flow into the reservoir. FIG. 24 shows an example of a side view of a material removal mechanism having a nozzle 2402 through which pre-transformed material flows inwards 2401 towards the internal compartment of the material removal mechanism 2403. Nozzle 2402 is but one example that represents any nozzle (e.g., FIG. 10). In the example shown in FIG. 24, the pre-transformed material is flowing (e.g., in a spiraling motion 2404) toward a connection 2405. The connection can connect the internal compartment to a reservoir 2407 (e.g., through a channel (e.g., hose) 2406). The connection can connect the internal compartment to a force source 2409 (e.g., through a channel (e.g., hose) 2410). Internal compartment 2410 is but one example that represents any internal compartment (e.g., FIGS. 20A-C, or FIGS. 21A-E). The force source can connect to the internal compartment, to the reservoir, or to both. The reservoir can connect directly or indirectly to the internal compartment. The internal compartment can connect directly or indirectly to the nozzle. In some examples, the nozzle has an entrance port 2400 through which the pre-transformed material enters the material removal mechanism. The material removal mechanism may be separated from the exposed surface of the material bed (e.g., 2415) by a gap (e.g., 2412). In some examples, the material removal mechanism contacts the material bed. For example, the opening port may contact the exposed surface of the material bed. The material removal mechanism may translate laterally (e.g., 2414) along the material bed. For example, in some embodiments, the pre-transformed material (e.g., and/or debris) in the internal compartment of the material removal mechanism is evacuated (e.g., using a second force source) while the material dispensing mechanism is outside of the area occupied by the target surface (e.g., the material bed). The first force source may be chosen such that it may not (e.g., substantially) evacuate the pre-transformed material (e.g., and/or debris) in the internal compartment. In some embodiments, the dimensions and/or shape of the internal compartment are chosen such that the pre-transformed material (e.g., and/or debris) that is evacuated from the target surface while planarizing it, will not overburden the evacuation operation by the first force source. In some embodiments, the second force (e.g., and/or second force source) is chosen such that the pre-transformed material (e.g., and/or debris) that is evacuated from the target surface while planarizing it, will not overburden the evacuation operation by the first force source. In some embodiments, the first force (e.g., and/or first force source) is chosen such that the pre-transformed material (e.g., and/or debris) that is evacuated from the target surface while planarizing it, will not overburden the evacuation operation by the first force source. The second force may comprise compressed and reduced pressure. For example, when a force source is a pump (e.g., peristaltic pump), the pump pressurized gas on one of its ends, and a reduced pressure at another of its ends. One pump end (e.g., forming pressurized gas) may operatively couple to one side of the internal compartment (e.g., 3428), while the other pump end may operatively couple to the other side of the internal compartment (e.g., 3429). The coupling may be direct or indirect.

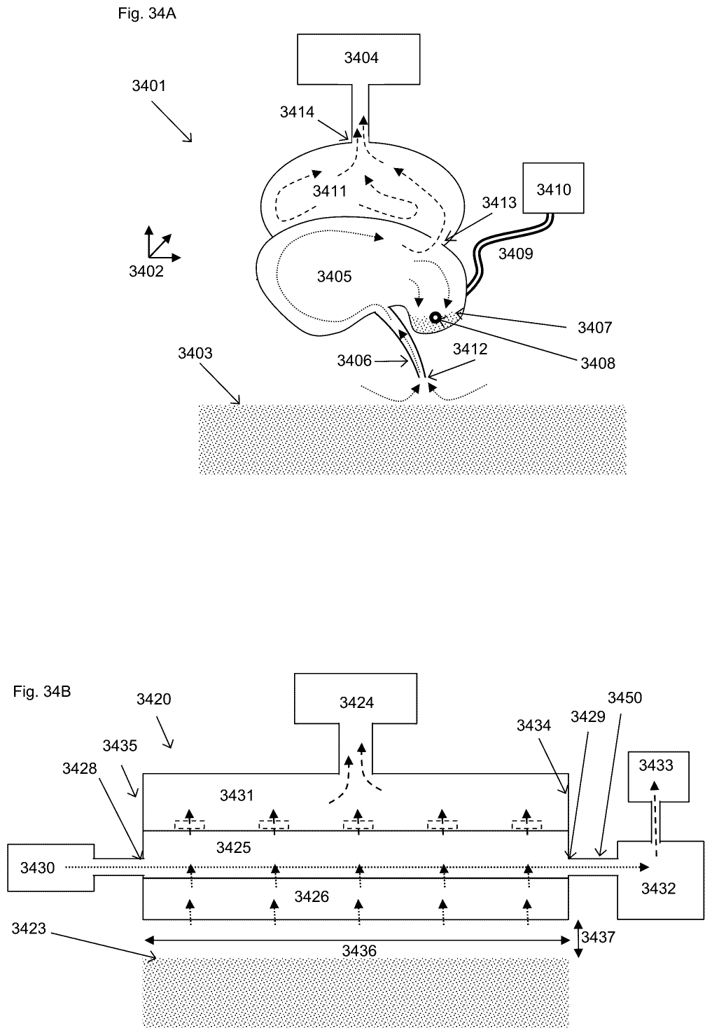

FIG. 34A shows an example of a side view of a material removal mechanism 3401 that can translate vertically, horizontally, and/or at an angle (e.g., 3402). Pre-transformed material and/or debris from the target surface 3403 is attracted by a force source 3404 (e.g., vacuum pump) into an internal compartment 3405, through a nozzle 3406, as depicted by the dotted arrows. The attracted pre-transformed material and/or debris accumulates in a portion of the internal compartment 3407 during the planarization operation of the material removal member. After at least one planarization operation by the material removal mechanism, the accumulated pre-transformed material and/or debris can be removed. Their removal may utilize a second force source (e.g., 3410), such as for example, a pressurized gas that is injected through an entrance opening (e.g., 3408), and expelled through an exit opening (e.g., that is opposing this entrance opening) and allow outflow of the accumulated pre-transformed material through a channel (e.g., 3409).

FIG. 34B shows an example of a front view of a material removal mechanism 3420 that can translate according vertically, horizontally, and/or at an angle 3402. Pre-transformed material and/or debris from the target surface 3423 is attracted by a source force 3424 into an internal compartment 3425, through a nozzle 3426, as depicted by the dotted upward pointing arrows. After at least one planarization operation by the material removal mechanism, the accumulated pre-transformed material and/or debris can be removed. Their removal may utilize a second force source (e.g., 3430), such as for example, a pressurized gas that is injected through an entrance opening (e.g., 3428), and expelled through an exit opening (e.g., 3429, e.g., that is opposing this entrance opening) and allow outflow of the accumulated pre-transformed material through a channel (e.g., 3450). Their removal may optionally or additionally utilize a third force source opposite to the second force source (e.g., in type and/or amount) that removes (e.g., or aids in removal of) the accumulated pre-transformed material from the internal compartment. For example, the third force source may be (e.g., directly or indirectly) coupled to the opening 3429. The expelled pre-transformed material and/or debris may be treated in a treatment station 3432. The treatment station may comprise separation, sorting, or reconditioning. For example, it may be separated (e.g., using a material separator). The material separator may comprise a filter (e.g., sieve, and/or membrane), separation column, and/or cyclonic separator. For example, it may be sorted as to material type and/or size. For example, it may be sorted using a gas classifier that classifies gas-borne material (e.g., liquid or particulate) material. For example, using an air-classifier. For example, using a powder gas classifier. The reconditioning may comprise removing of an oxide layer forming on any particulate material. Reconditioning may comprise physical and/or chemical reconditioning. The physical reconditioning may comprise ablation, spattering, blasting, or machining. The chemical reconditioning may comprise reduction. The expelled (and/or treated) pre-transformed material may be accumulated in a reservoir 3433. The accumulated material in the reservoir 3433 may be recycled and/or reused in the 3D printing (e.g., by the material dispensing mechanism).

The material removal mechanism may optionally comprise an equilibration chamber (e.g., shown as side view 3411 and front view 3431). The equilibration chamber may equilibrate the gas pressure within the equilibration chamber to be (e.g., substantially) equal from one of its sides (e.g., 3455) to its opposing side (e.g., 3434), such that when the material removal member attracts pre-transformed material from the target surface, the force excreted on this pre-transformed material will be (e.g., substantially) equal along (i) the width (e.g., 3436) of the material dispensing mechanism nozzle (e.g., 3436) opening and/or (ii) the width of the target surface (e.g., 3423).

The force source may be connected to the internal compartment (e.g., optionally through the equilibration chamber) through one or more openings. The connection may be through rigid and/or flexible channels. The channels may have a narrowing or constant cross section. The connection may be through one or more slits. The openings may be (e.g., substantially) constant and/or varied. For example, positions closer to the force source may have narrower openings, than positions farther away from the force source.

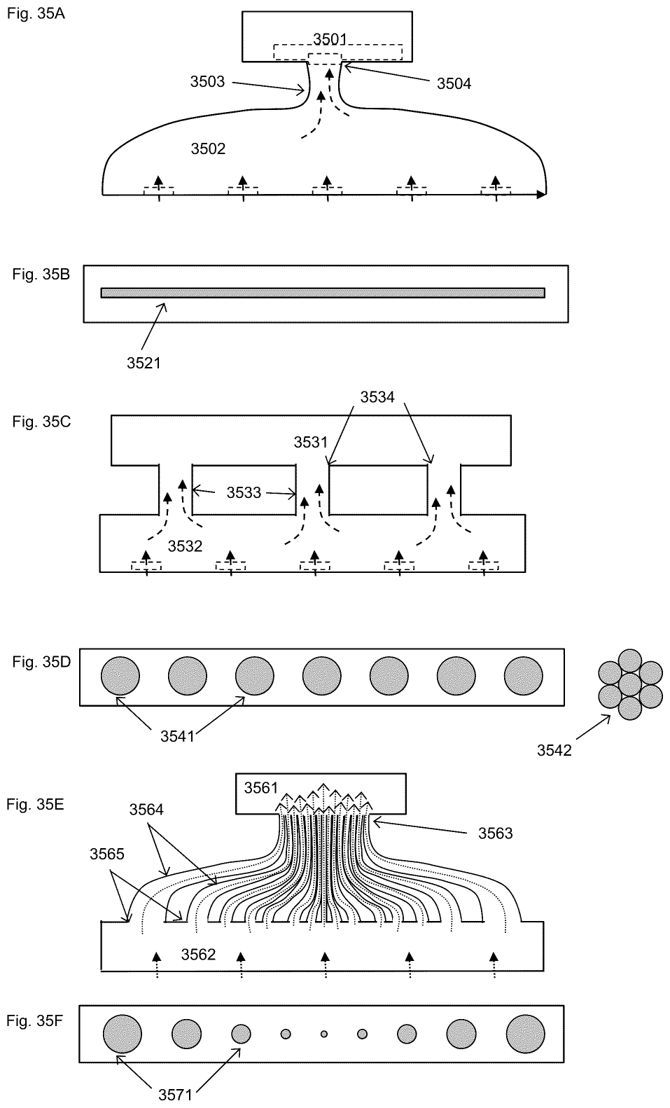

FIG. 35A shows an example of a front view of a force source 3501 that is connected to a chamber 3502 (e.g., equilibration chamber, or internal compartment) of the material removal mechanism through a channel 3503. The flow of attracted material and/or gas is schematically shown by the dotted arrows in FIG. 35A. The chamber may comprise an aerodynamic shape (e.g., 3502). The upward flowing gas and/or material may flow upward in a direction opposite to the target surface and/or the gravitational center through one (e.g., shown in FIG. 35B, 3521) or more (e.g., FIG. 35D, 3541) material and/or gas openings. The material and/or gas openings may be slits. The one or more material and/or gas openings may be (i) the opening of the nozzle (e.g., FIG. 34, 3412), (ii) the opening (e.g., 3413) between the internal compartment (e.g., 3405) and the pressure equilibration chamber (e.g., 3411), (iii) the opening (e.g., 3414) between the gas equilibration chamber (e.g., 3411) and the force source (e.g., 3404), (iv) the opening between the internal compartment (e.g., FIG. 9, 903) and the force source (e.g., 901) (e.g., in case there is no pressure equilibration chamber).

FIG. 35C shows an example of a front view of a force source 3531 that is connected to a chamber 3532 (e.g., equilibration chamber, or internal compartment) of the material removal mechanism through a plurality of channels (e.g., 3533). The flow of attracted material and/or gas is schematically shown by the dotted arrows in FIG. 35C. The cross section of the channel may be rectangular (e.g., 3521, e.g., square), or elliptical (e.g., round, e.g., 3541). The cross section of the channel may be oval. FIG. 35D show an example of a bottom view of material and/or gas openings that are equal in cross section. FIG. 35F show an example of a bottom view of material and/or gas openings that are unequal in cross section. The force source may comprise one (e.g., 3504) or more (e.g., 3534) openings. The force source may connect to a channel bundle. FIG. 35E shows an example of a channel bundle cross section 3542. The channels in the bundle may separate further away from the force source, and connect (e.g., separately) to the internal compartment and/or pressure equilibration chamber of the material removal mechanism. FIG. 35E shows an example of a force source 3561 that has an exit opening 3563 to which a channel bundle is connected, which channels are separated (e.g., 3564) and connect to the internal compartment or pressure equilibration chamber 3562 in material and/or gas openings 3565 respectively. In FIG. 35E, the material and/or gas openings are varied in cross section. FIG. 35F shows a bottom view of the material and/or gas openings such as 3571, with some of which having varied in their corresponding cross sections. The gas equilibration chamber and/or varied location, and/or shape (e.g., FLS) of the material and/or gas openings may facilitate a homogenous pressure distribution along the nozzle opening. The area of the horizontal cross section of the nozzle entrance opening (e.g., FIG. 21A, 2112) is greater by at least about 2 times (“*”), 3*, 5*, 10*, 15*, 30*, or 50* the vertical cross section of the internal compartment of the material removal mechanism (e.g., FIG. 24, 2403). The nozzle entrance opening is shown, for example, in FIG. 24, 2400.

In some embodiments, the internal compartment can connect to one or more force sources. For example, the internal compartment can connect to two force sources. For example, the internal compartment can connect to a vacuum source and to a pressurized air source. The transformed material that is attracted into the internal compartment can rest there (e.g., be trapped there). For example, the curved surface 2420 may facilitate concentrating the pre-transformed material within the internal compartment. This concentrated material may be disposed in a manner that will minimally (e.g., not) hinder attracting subsequent pre-transformed material from entering the internal compartment. In some embodiments, the pre-transformed material (and/or debris) that enters the internal compartment occupies at most about 50%, 40%, 20%, 10%, or 10% of the internal compartment volume. In some embodiments, the pre-transformed material is attracted into the internal compartment using a first force source, and is evacuated from the internal compartment using a second source force that is different from the first force source in its intensity and/or type. The evacuation of the pre-transformed material (and/or debris) from the internal compartment can be during, before, and/or after the planarization operation of the target surface by the material removal mechanism. For example, the material removal mechanism may planarize a powder bed layer while sucking powder material using vacuum, which sucked powder material accumulates in the internal compartment; and after the planarization operation a pressurized air flows into the internal compartment (e.g., with or without blocking the nozzle opening) and evacuates the accumulated powder material (e.g., through the opening 2405). The pressurized air may be directed towards the exit opening (e.g., 2405). In some embodiments, after the accumulated powder material has been removed from the internal compartment, the material removal mechanism is ready to suck and planarize a new layer of powder material.

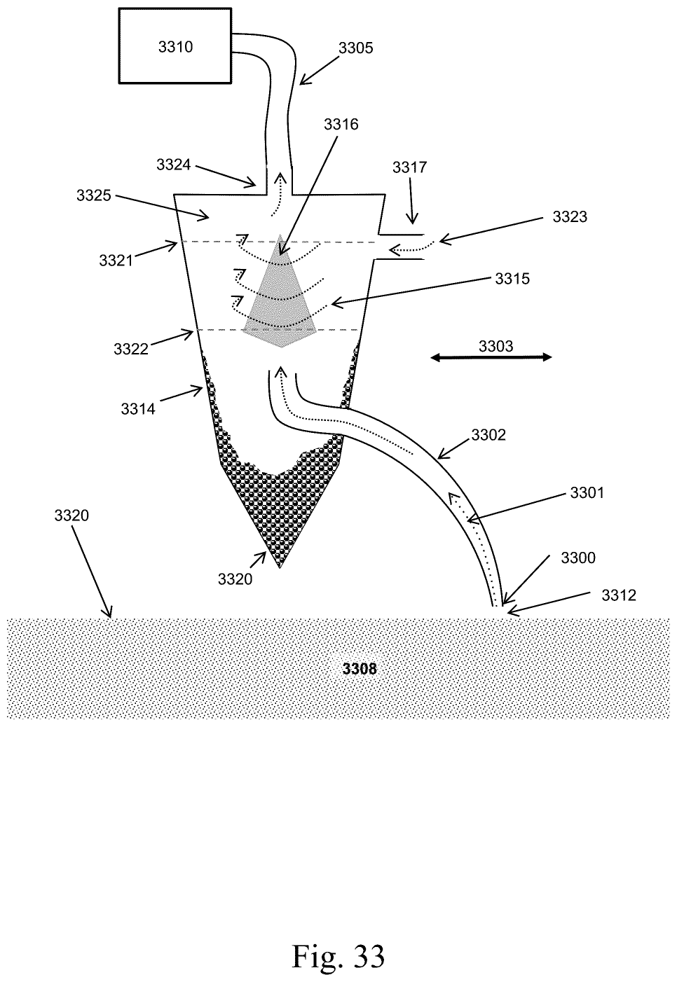

In some embodiments, the operation of the material removal mechanism comprises separating the pre-transformed material (e.g., particulate material) from a gas (e.g., in which the pre-transformed material is carried in) without the use of one or more filters. For example, the operation of the material removal mechanism comprises can comprise a vortex separation (e.g., using a cyclone). For example, the operation of the material removal mechanism can comprise a centrifugal separation (e.g., using a cyclone). FIG. 33 shows an example of an internal compartment 3325 of the material removal mechanism. In some embodiment, the internal compartment of the material removal member comprises a cyclone. In some embodiments, the material removal mechanism comprises a cyclonic separator. In some embodiments, the material removal mechanism comprises cyclonic separation. The operation of the material removal mechanism can comprise gravitational separation. The operation of the material removal mechanism can comprise rotation of the pre-transformed material and/or debris (e.g., in the internal compartment of the material removal mechanism).

In some embodiments, the pre-transformed material that is attracted to the force source rests at the bottom of the internal compartment of the material removal mechanism. Bottom may be towards the gravitational center, and/or towards the target surface. The force source can be a vacuum source that may be connected to internal compartment (e.g., at a top position, e.g., 3324). The pre-transformed material may be sucked into the internal compartment from the target surface (e.g., 3320) through the nozzle (e.g., 3301) into the internal compartment (e.g., 3325). The gas(es) that is sucked with the pre-transformed material into the internal compartment (e.g., 3315) may rotate within at a rotational speed to form a cyclone. The internal compartment may comprise a cone having its long axis perpendicular to the target surface and/or its narrow end pointing towards the target surface. Alternatively, the internal compartment may comprise a cone having its long axis parallel to the target surface and/or its narrow end pointing towards a side wall of the enclosure. The gas may flow in the internal compartment in a helical pattern along the long axis of the cyclone. During the process, the pre-transformed material (and/or debris) sucked into the cyclone, may concentrate at the walls of the cyclone (e.g., 3314) and gravitate to and accumulate at its bottom (e.g., 3320). The accumulated pre-transformed material (e.g., and/or debris) may be removed from the bottom of the cyclone. For example, after one or more operation of planarizing a layer of pre-transformed material in the material bed, the bottom of the cyclone may be opened and the accumulated pre-transformed material (e.g., and/or debris) within may be evacuated. In some examples, the pre-transformed material that enters the internal compartment of the material removal member is of a first velocity, and is attracted towards the force source (e.g., 3310), that is connected to the internal compartment through a connector 3324. On its way to the connector, the pre-transformed material may lose its velocity in the internal compartment and precipitate at the bottom of the cyclone. In some examples, the gas(es) material that enters the internal compartment of the material removal member from the nozzle is of a first velocity, and is attracted towards the force source (e.g., 3310), that is connected to the internal compartment through a connector 3324. On its way to the connector, the gas(es) material may lose its velocity in the internal compartment, for example, due to an expansion of the cross section of the internal compartments (e.g., diameter 3322 is smaller than diameter 3321). An optional hurdle (e.g., 3316) may be placed to exacerbate the volume difference between portions of the cyclone that are closer to the exit opening (e.g., 3324) relative to those further from the exit opening.

In some examples, a secondary air flow can flow into the cyclone (e.g., 3323) from an optional gas opening port (e.g., 3317). The gas opening port may dispose adjacent to the nozzle (e.g., at the same side of the nozzle with respect to the direction of travel (e.g., 3303). The gas opening port may be disposed at a direction relative to the direction of travel, that is different from the direction where the nozzle is disposed. The secondary air flow may reduce abrasion of the internal surface of the internal compartment walls (e.g., 3314). The secondary air flow may push the pre-transformed material from the walls of the internal compartment towards the narrow end of the cyclone (e.g., where it is collected).

The layer dispensing mechanism may comprise a planarizing (e.g., flattening) mechanism. The planarizing mechanism may comprise a leveling mechanism (e.g., FIGS. 8, 806 and 804) or a material removal mechanism (e.g., 803). The layer dispensing mechanism may comprise a material dispensing mechanism (e.g., FIG. 8, 805) and a planarizing mechanism. The layer dispensing mechanism may be movable (e.g., in the direction 800). The layer dispensing mechanism may be movable horizontally, vertically or at an angle. The layer dispensing mechanism may be movable manually and/or automatically (e.g., controlled by a controller). The movement of the layer dispensing mechanism may be programmable. The movement of the layer dispensing mechanism may be predetermined. The movement of the layer dispensing mechanism may be according to an algorithm. The layer dispensing mechanism may travel laterally (e.g., substantially) from one end of the material bed to the opposite end to effectuate disposal of a planarized layer of pre-transformed material on the exposed surface of the material bed or platform.

In some examples, the layer dispensing mechanism comprises at least one material dispensing mechanism and at least one planarizing mechanism. The at least one material dispensing mechanism and at least one planarizing mechanism may be connected or disconnected. The blade of the leveling mechanism may be tapered. Examples of tapered blades, 3D printers, related control system, related methods, apparatuses, systems, and program instructions (e.g., software), can be found in PCT/US15/36802, which is incorporated herein by reference in its entirety.

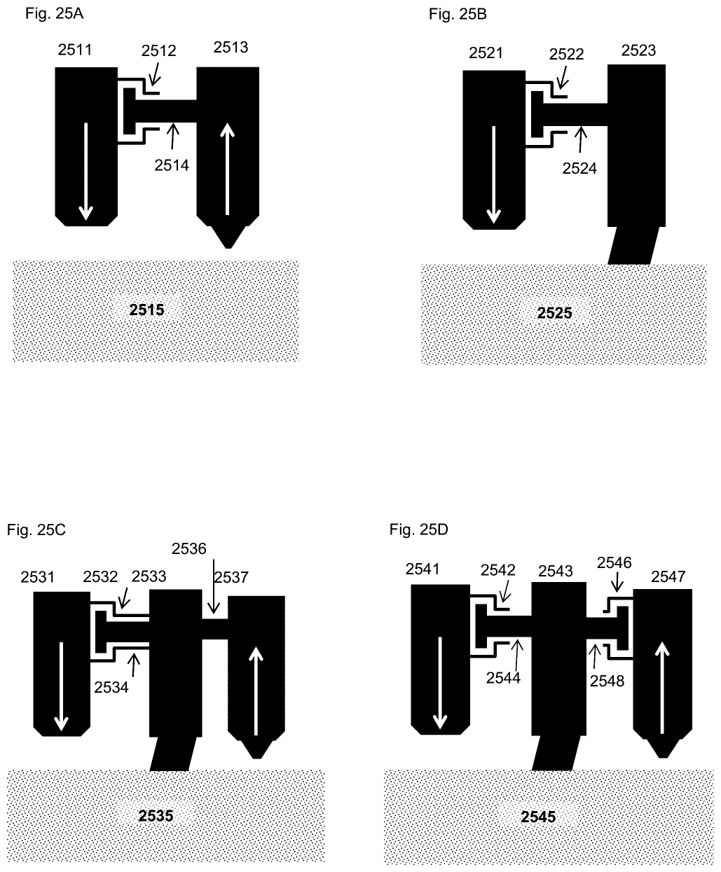

The material dispensing mechanism can operate in concert with the planarizing mechanism (e.g., shearing blade and/or vacuum suction) and/or independently with the planarizing mechanism. At times, the material dispensing mechanism (e.g., powder dispenser) proceed before the leveling mechanism, that proceeds before the material removal mechanism, as they progress along the material bed (e.g., laterally). At times, the material dispensing mechanism may proceed before the material removal mechanism, as they progress along the material bed. At times, the material dispensing mechanism may proceed before the leveling mechanism as they progress along the material bed. The planarizing mechanism may include the material removal mechanism and/or the leveling mechanism. The material dispensing mechanism or any part thereof (e.g., its internal reservoir) may freely vibrate. The vibrations may be induced by one or more vibrators. The material dispensing mechanism, or any part thereof may vibrate without (e.g., substantially) vibrating the planarizing mechanisms. The material dispensing mechanism, or any part thereof may vibrate without (e.g., substantially) vibrating the material removal mechanism and/or the leveling mechanism. The material dispensing mechanism may be connected to the planarizing mechanism by a compliant mounting. The compliant mounting may allow the planarizing mechanism to attach and/or detach from the material dispensing mechanism. FIGS. 25A-D show side view examples of layer dispensing mechanisms comprising a material dispensing mechanism (e.g., 2511) attached to a planarizing mechanism (e.g., material removal mechanism 2513, or leveling mechanism 2523); attached through compliant mounting (e.g., FIG. 25A, 2512 and 2514; and FIG. 25B, 2522 and 2524). In some examples, the compliant mounting comprises two separate parts that are intertwined with each other. FIG. 25D shows an example of two configurations of compliant mountings: the first including 2542 and 2544, and the second including 2546 and 2548. In an embodiment where the planarizing mechanism comprises two components (e.g., the leveling mechanism and the material removal mechanism), at least one of the components may be connected by a compliant mounting. For example, each one of the components may be connected by a compliant mounting (e.g., FIG. 25D), or one of the components may be connected by a compliant mounting (e.g., FIG. 25C).

FIG. 25A shows an example of a layer dispensing mechanism comprising: a material dispensing mechanism 2511 which is connected by a compliant mounting 2512 and 2514 to a material removal mechanism 2513, which layer dispensing mechanism is disposed above the material bed 2515. FIG. 25B shows an example of a layer dispensing mechanism comprising: a material dispensing mechanism 2521 which is connected by a compliant mounting 2522 and 2524 to a leveling mechanism 2523, which layer dispensing mechanism is disposed above the material bed 2525. FIG. 25C shows an example of a layer dispensing mechanism comprising: a material dispensing mechanism 2531 which is connected by a compliant mounting 2532 and 2525 to a leveling mechanism 2533, which in turn is (e.g., directly) connected (e.g., 2536) to a material removal member 2537, which layer dispensing mechanism is disposed above the material bed 2535. FIG. 25D shows an example of a layer dispensing mechanism comprising: a material dispensing mechanism 2541 which is connected by a compliant mounting 2542 and 2544 to a leveling mechanism 2543, which in turn is connected by a compliant mounting 2546 and 2548 to a material removal mechanism 2547, which layer dispensing mechanism is disposed above the material bed 2545.

The distance between the functionalities of the various components of the layer dispensing mechanism is referred to herein as the “distance-between-functionalities.” The distance-between-functionalities can be at least about 100 μm, 150 μm, 200 μm, 300 μm, 400 μm, 500 μm, 600 μm, 700 μm, 800 μm, 900 μm, or 1000 m. The distance-between-functionalities can be at most about 1000 μm, 900 μm, 800 μm, 700 μm, 60 μm, 500 μm, 450 μm, 400 μm, 350 μm, 300 μm, 250 μm, 200 μm, or 150 μm. The distance-between-functionalities can be of any value between the afore-mentioned values (e.g., from about 100 m to about 1000 μm, 100 μm to about 500 μm, 300 μm to about 600 μm, 500 μm to about 1000 μm). In some examples, the distance between the blade (e.g., tip thereof) of the leveling mechanism and the opening port of the material removal mechanism is equal to the distance-between-functionalities. In some examples, the distance between the blade (e.g., tip thereof) of the leveling mechanism and the opening port of the material dispensing mechanism (or of the material fall) is equal to the distance-of-functionalities. In some examples, the distance between the opening port of the material dispensing mechanism (or of the material fall) and the opening port of the material removal mechanism is equal to the distance-of-functionalities. The material fall (e.g., FIG. 8, 807) is formed when the material is dispensed from the material dispensing mechanism through the opening port (e.g., exit opening, or exit port) towards the platform (e.g., towards the material bed). The components of the layer dispensing mechanism (e.g., material dispensing mechanism, material removal mechanism, and/or leveling mechanism) can be evenly or non-evenly spaced. For example, the blade (e.g., tip hereof), entrance opening port of the material removal mechanism, and exit opening (e.g., exit port) of the material dispensing mechanism may be evenly or non-evenly spaced.

The force exerted by the force source through the material removal mechanism may cause at least a portion of the pre-transformed material (e.g., powder particles) to lift (e.g., become airborne) from the material bed, and travel (e.g., influx) towards the entrance port of the material removal mechanism (e.g., nozzle entrance). The lifted pre-transformed material (or at times, unwanted transformed material) may further travel (e.g., flow) within the material removal mechanism (e.g., within the internal compartment and/or within the nozzle). The influx may comprise laminar, turbulent, or curved movement of the lifted pre-transformed material. The influx may be towards the reservoir. The influx may be towards the force source. The gap between the exposed surface of the material bed and the entrance port of the material removal mechanism (e.g., nozzle entrance) may depend on the average FLS and/or mass of the pre-transformed material sections (e.g., particulate material). The gap between the exposed surface of the material bed and the entrance port of the material removal mechanism (e.g., nozzle entrance) may depend on the mean FLS and/or mass of the particulate material. The structure of the internal compartment and/or nozzle enables uniform removal of pre-transformed material from the material bed. In some examples, the amount of force generated by the force source and/or its distribution through the internal compartment and/or nozzle of the material removal mechanism enables uniform removal of pre-transformed material from the material bed. For example, the structure of the internal compartment and/or nozzle enables uniform suction of pre-transformed material from the material bed. The structure of the internal compartment and/or nozzle may influence the velocity of the influx of pre-transformed material into the material removal mechanism. The amount of force generated by the force source and/or its distribution through the internal compartment and/or nozzle of the material removal mechanism may influence the homogeneity of the influx velocity along the entrance port(s) and/or along the material bed.

The layer dispensing mechanism (e.g., recoater) may dispense a portion of a layer of pre-transformed material. The dispensed portion of a layer of pre-transformed material may comprise an exposed surface that is (e.g., substantially) planar (e.g., horizontal, flat, smooth, and/or unvaried).

A (e.g., substantially) planar exposed surface of the material bed may comprise a (e.g., substantially) uniform pre-transformed material (e.g., powder) height of the exposed surface. The layer dispensing mechanism (e.g., leveling member) can provide material uniformity height (e.g., powder uniformity height) across the exposed layer of the material bed such that portions of the bed that are separated from one another by at least about 1 mm, 2 mm, 3 mm, 4 mm, 5 mm, or 10 mm, have a height deviation of at most about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm, 70 μm, 60 μm, 50 μm, 40 μm, 30 μm, 20 μm, or 10 μm. The layer dispensing mechanism can provide material uniformity across the exposed layer of the material bed such that portions of the bed that are separated from one another by any value between the afore-mentioned height deviation values (e.g., from about 1 mm to about 10 mm) have a height deviation from about 10 mm to about 10 m. The layer dispensing mechanism may achieve a deviation from a planar uniformity of the exposed layer of the material bed (e.g., horizontal plane) of at most about 20%, 10%, 5%, 2%, 1% or 0.5%, as compared to an ideal planarity. The layer dispensing mechanism may achieve a deviation from a planar uniformity of the exposed layer of the material bed (e.g., horizontal plane) of at most about 150 μm, 130 μm, 100 μm, 70 μm, 50 μm, 40 μm, 30 μm, 20 μm, 10 μm or 5 μm. The layer dispensing mechanism may achieve a deviation from a planar uniformity of the exposed layer of the material bed between any of the afore-mentioned values (e.g., from about 5 μm to about 150 μm, from about 5 μm to about 50 μm, from about 30 μm to about 100 μm, or from about 100 μm to about 150 μm). The layer dispensing mechanism may dispense a layer of material having a height of at most about 100 μm, 70 μm, 50 μm, 40 μm, 30 μm, 20 μm, or 10 μm. The layer dispensing mechanism may dispense a layer of material having a height between any of the aforementioned values, e.g., from about 100 m to about 10 μm, or from about 70 μm to about 10 μm.

The material removal mechanism may remove at least a portion (e.g., the entire) of at least the exposed surface of the material bed. The at least a portion may be at a designated location (e.g., controlled manually or by the controller). For example, the material removal mechanism may form depressions (e.g., voids) in a material bed comprising a first pre-transformed material, which depressions may be subsequently filed with a layer or sub-layer of a second pre-transformed material. The second pre-transformed material may be (e.g., substantially) identical, or different from the first pre-transformed material. The sub layer may be smaller from a layer with respect to their height and/or horizontal cross section.

The layer dispensing mechanism (e.g., material removal mechanism) may facilitate the formation of a 3D object that has a locally different microstructure. The locally different microstructure can be between different layers, or within a given layer. For example, at least one portion of a layer within the 3D object may differ from another portion within that same layer, in terms of its microstructure. The microstructure difference may be any difference recited above.

In another aspect, the system and apparatuses for generating the 3D object(s) comprises a mechanism for separating the 3D object(s) from the remainder of the material bed that is not the 3D object, and/or cleaning the 3D object (e.g., within the enclosure). In some embodiments, both the material bed and the mechanism for separating the 3D object(s) from the remainder of the material bed that is not the 3D object are enclosed in the same atmosphere. The atmosphere can be an inert, non-reactive, oxygen depleted, humidity depleted, or passive atmosphere with respect to the material bed, pre-transformed material, and/or 3D object. The 3D object may be subsequently cleaned and/or cooled within the enclosure (e.g., at the second enclosure portion). The cleaning may comprise using gas pressure (e.g., positive and/or negative), vibration, and/or surface friction (e.g., brush). Examples of cleaning, 3D printers, related control system, other related methods, apparatuses, systems, and program instructions (e.g., software), can be found in PCT/US15/36802, which is incorporated herein by reference in its entirety.

In some embodiments, the 3D object is devoid of surface features that are indicative of the use of a post printing process. In some embodiments, the 3D object is including surface features that are indicative of the use of a post printing process. The post printing process may comprise a trimming process (e.g., to trim auxiliary supports). The trimming process may comprise ablation by an energy beam (e.g., laser), mechanical, or chemical trimming. The trimming process may be an operation conducted after the completion of the 3D printing process (e.g., using the pre-transformed material). The trimming process may be a separate operation from the 3D printing process. The trimming may comprise cutting (e.g., using a piercing saw). The trimming can comprise polishing or blasting. The blasting can comprise solid blasting, gas blasting, or liquid blasting. The solid blasting can comprise sand blasting. The gas blasting can comprise air blasting. The liquid blasting can comprise water blasting. The blasting can comprise mechanical blasting.

In some instances, one, two, or more 3D objects may be generated in a material bed (e.g., a single material bed; the same material bed). The multiplicity of 3D object may be generated in the material bed simultaneously or sequentially. For example, at least two 3D objects may be generated side by side. For example, at least two 3D objects may be generated one on top of the other. For example, at least two 3D objects generated in the material bed may have a gap between them (e.g., gap filled with pre-transformed material). For example, at least two 3D objects generated in the material bed may contact (e.g., and not connect to) each other. In some embodiments, the 3D objects are independently built one above the other. The generation of a multiplicity of 3D objects in the material bed may allow continuous generation of 3D objects.

The FLS of the holes may be adjustable or fixed. In some embodiments, the stage comprises a mesh. The mesh may be movable. The movement of the mesh may be controlled manually or automatically (e.g., by a controller). The relative position of the two or more meshes with respect to each other may determine the rate at which at least the pre-transformed material passes through the hole (or holes). The FLS of the holes may be electrically controlled. The fundamental length scale of the holes may be thermally controlled. The mesh may be heated or cooled. The stage may vibrate (e.g., controllably vibrate). The temperature and/or vibration of the stage may be controlled manually or by the controller. The holes of the stage can shrink or expand as a function of the temperature and/or electrical charge of the stage. The stage can be conductive. The mesh may comprise a mesh of standard mesh number 50, 70, 90, 100, 120, 140, 170, 200, 230, 270, 325, 550, or 625. The mesh may comprise a mesh of standard mesh number between any of the afore-mentioned mesh numbers (e.g., from 50 to 625, from 50 to 230, from 230 to 625, or from 100 to 325). The standard mesh number may be US or Tyler standards. The two meshes may have at least one position where no pre-transformed material can pass through the holes. The two meshes may have a least one position where a maximum amount of material can pass through the holes. The two meshes can be identical or different. The size of the holes in the two meshes can be identical or different. The shape of the holes in the two meshes can be identical or different. The shape of the holes can be any hole shape described herein.

In some embodiments, the 3D object comprises layers of hardened material. The layered structure of the 3D object can be a (e.g., substantially) repetitive layered structure. In some examples, each layer of the layered structure has an average layer thickness greater than or equal to about 5 micrometers (μm). In some examples, each layer of the layered structure has an average layer thickness less than or equal to about 1000 micrometers (μm). The layered structure can comprise individual layers of the successive solidified melt pools. The layer can be formed by depositing droplets or a continuous stream of transformed material. At least two of the successive solidified melt pools can comprise a (e.g., substantially) repetitive material variation selected from the group consisting of variation in grain orientation, variation in material density, variation in the degree of compound segregation to grain boundaries, variation in the degree of element segregation to grain boundaries, variation in material phase, variation in metallurgical phase, variation in material porosity, variation in crystal phase, and variation in crystal structure. At least one of the successive solidified melt pools can comprise a crystal. The crystal can comprise a single crystal. The layered structure can comprise one or more features indicative of solidification of melt pools during the three-dimensional printing process. The layered structure can comprise a feature indicative of the use of the three-dimensional printing process (e.g., as disclosed herein). The three-dimensional printing process can comprise selective laser melting. In some embodiments, a fundamental length scale of the three-dimensional object can be at least about 120 micrometers.

In some embodiments, the layer of hardened material layer (or a portion thereof) has a thickness (e.g., layer height) of at least about 50 μm, 100 μm, 150 μm, 200 μm, 300 μm, 400 μm, 500 μm, 600 μm, 700 μm, 800 μm, 900 μm, or 1000 μm. In some examples, the hardened material layer (or a portion thereof) has a thickness of at most about 1000 μm, 900 μm, 800 μm, 700 μm, 600 μm, 500 μm, 450 μm, 400 μm, 350 μm, 300 μm, 250 μm, 200 μm, 150 μm, 100 μm, 75 μm, or 50 μm. A hardened material layer (or a portion thereof) may have any value in between the afore-mentioned layer thickness values (e.g., from about 50 μm to about 1000 μm, from about 500 μm to about 800 μm, from about 300 μm to about 600 μm, from about 300 μm to about 900 μm, or from about 50 μm to about 200 μm). In some instances, the bottom skin layer may be thinner than the subsequent layers. In some instances, the bottom skin layer may be thicker than the subsequent layers. The bottom skin layer may have any value disclosed herein for the layer of hardened material. In some instances, the layer comprising the path-of-tiles is thinner than the layers formed without using the path-of-tiles (e.g., formed by the energy beam). In some instances, the layer comprising the path-of-tiles is thicker than the layers formed without using the path-of-tiles (e.g., formed by the energy beam).

The material (e.g., pre-transformed material, transformed material, and/or hardened material) may comprise elemental metal, metal alloy, ceramics, or an allotrope of elemental carbon. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball or a carbon nanotube. The ceramic material may comprise cement. The ceramic material may comprise alumina. The material may comprise sand, glass, or stone. In some embodiments, the material may comprise an organic material, for example, a polymer or a resin. The organic material may comprise a hydrocarbon. The polymer may comprise styrene. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The solid material may comprise powder material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) or wires.

The material may comprise a powder material. The material may comprise a solid material. The material may comprise one or more particles or clusters. The term “powder,” as used herein, generally refers to a solid having fine particles. The powder may also be referred to as “particulate material.” Powders may be granular materials. The powder particles may comprise micro particles. The powder particles may comprise nanoparticles. In some examples, a powder comprising particles having a fundamental length scale having a central tendency of at least about 5 nanometers (nm), 10 nm, 20 nm, 30 nm, 40 nm, 50 nm, 100 nm, 200 nm, 300 nm, 400 nm, 500 nm, 1 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, or 100 μm. The particles comprising the powder may have a fundamental length scale having a central tendency of at most about 100 μm, 80 μm, 75 μm, 70 μm, 65 μm, 60 μm, 55 μm, 50 μm, 45 μm, 40 μm, 35 μm, 30 μm, 25 μm, or 20 μm. In some cases, the powder may have an average fundamental length scale having a central tendency between any of the values of the average particle fundamental length scale listed above, e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm. In some embodiments, the powder material is in the micrometer scale and at least one type of debris (e.g., soot) is in the nanometer scale.

The powder can be composed of individual particles. The individual particles can be spherical, oval, prismatic, cubic, or irregularly shaped. The particles can have a fundamental length scale. The powder can be composed of a homogenously shaped particle mixture such that all the particles have (e.g., substantially) the same shape and fundamental length scale magnitude within at most 1%, 5%, 8%, 10%, 15%, 20%, 25%, 30%, 35%, 40%, 50%, 60%, or 70%, distribution of fundamental length scale. In some cases, the powder can be a heterogeneous mixture such that the particles have variable shape and/or fundamental length scale magnitude.

At least parts of the layer can be transformed to a transformed material that may subsequently form at least a fraction (also used herein “a portion,” or “a part”) of a hardened (e.g., solidified) 3D object. At times a layer of transformed or hardened material may comprise a cross section of a 3D object (e.g., a horizontal cross section). At times a layer of transformed or hardened material may comprise a deviation from a cross section of a 3D object. The deviation may include vertical or horizontal deviation. A pre-transformed material may be a powder material. A pre-transformed material layer (or a portion thereof) can have a thickness (e.g., layer height) of at least about 0.1 μmicrometer (μm), 0.5 μm, 1.0 μm, 10 μm, 50 μm, 100 μm, 150 μm, 200 μm, 300 μm, 400 μm, 500 μm, 600 μm, 700 μm, 800 μm, 900 μm, or 1000 μm. A pre-transformed material layer (or a portion thereof) can have a thickness of at most about 1000 μm, 900 μm, 800 μm, 700 μm, 60 μm, 500 μm, 450 μm, 400 μm, 350 μm, 300 μm, 250 μm, 200 μm, 150 μm, 100 μm, 75 μm, 50 μm, 40 μm, 30 μm, 20 μm, 10 μm, 5 μm, 1 μm, or 0.5 μm. A pre-transformed material layer (or a portion thereof) may have any value in between the afore-mentioned layer thickness values (e.g., from about 0.1 μm to about 1000 μm, from about 1 μm to about 800 μm, from about 20 μm to about 600 μm, from about 30 μm to about 300 μm, or from about 10 μm to about 1000 μm).

In some embodiments, the material composition of at least one layer within the material bed differs from the material composition within at least one other layer in the material bed. The difference (e.g., variation) may comprise difference in crystal or grain structure. The variation may comprise variation in grain orientation, variation in material density, variation in the degree of compound segregation to grain boundaries, variation in the degree of element segregation to grain boundaries, variation in material phase, variation in metallurgical phase, variation in material porosity, variation in crystal phase, or variation in crystal structure. The microstructure of the printed object may comprise planar structure, cellular structure, columnar dendritic structure, or equiaxed dendritic structure.

In some examples, the pre-transformed materials of at least one layer in the material bed differs in the FLS of its particles (e.g., powder particles) from the FLS of the pre-transformed material within at least one other layer in the material bed. A layer may comprise two or more material types at any combination. For example, two or more elemental metals, two or more metal alloys, two or more ceramics, two or more allotropes of elemental carbon. For example, an elemental metal and a metal alloy, an elemental metal and a ceramic, an elemental metal and an allotrope of elemental carbon, a metal alloy and a ceramic, a metal alloy and an allotrope of elemental carbon, a ceramic and an allotrope of elemental carbon. In some embodiments, all the layers of pre-transformed material deposited during the 3D printing process are of the same material composition. In some instances, a metal alloy is formed in situ during the process of transforming at least a portion of the material bed. In some instances, a metal alloy is not formed in situ during the process of transforming at least a portion of the material bed. In some instances, a metal alloy is formed prior to the process of transforming at least a portion of the material bed. In a multiplicity (e.g., mixture) of pre-transformed (e.g., powder) materials, one pre-transformed material may be used as support (e.g., supportive powder), as an insulator, as a cooling member (e.g., heat sink), or as any combination thereof.

Examples of cooling members, 3D printers, related control system, related methods, apparatuses, systems, and program instructions (e.g., software), can be found in U.S. Provisional patent application Ser. No. 62/252,330, U.S. Provisional Patent Application Ser. No. 62/317,070, U.S. Provisional patent application Ser. No. 62/396,584, International Patent Application Serial No. PCT/US15/36802, or International Patent Application Serial No. PCT/US16/59781; each of which is entirely incorporated herein by reference.

In some instances, adjacent components in the material bed are separated from one another by one or more intervening layers. In an example, a first layer is adjacent to a second layer when the first layer is in direct contact with the second layer. In another example, a first layer is adjacent to a second layer when the first layer is separated from the second layer by at least one layer (e.g., a third layer). The intervening layer may be of any layer size disclosed herein.

At times, the pre-transformed material is chosen such that the material is the requested and/or otherwise predetermined material for the 3D object. In some cases, a layer of the 3D object comprises a single type of material. For example, a layer of the 3D object can comprise a single elemental metal type, or a single metal alloy type. In some examples, a layer within the 3D object may comprise several types of material (e.g., an elemental metal and an alloy, an alloy and a ceramic, an alloy and an allotrope of elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member (e.g., an allotrope) of elemental carbon (e.g., graphite). In some cases, a layer of the 3D object comprises more than one type of material. In some cases, a layer of the 3D object comprises more than one member of a material type.

The elemental metal can be an alkali metal, an alkaline earth metal, a transition metal, a rare-earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare-earth metal can be a lanthanide, or an actinide. The lanthanide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

The metal alloy can be an iron-based alloy, nickel-based alloy, cobalt-based alloy, chrome-based alloy, cobalt chrome-based alloy, titanium-based alloy, magnesium-based alloy, copper-based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, i-pad), air conditioning, generators, furniture, musical equipment, art, jewelry, cooking equipment, or sport gear. The metal (e.g., alloy or elemental) may comprise an alloy used for products for human or veterinary applications comprising implants, or prosthetics. The metal alloy may comprise an alloy used for applications in the fields comprising human or veterinary surgery, implants (e.g., dental), or prosthetics.

The alloy may include a superalloy. The alloy may include a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy (e.g., Haynes 282), Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron alloy comprises Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may include cast iron, or pig iron. The steel may include Bulat steel, Chromoly, Crucible steel, Damascus steel, Hadfield steel, High speed steel, HSLA steel, Maraging steel (e.g., M300), Reynolds 531, Silicon steel, Spring steel, Stainless steel, Tool steel, Weathering steel, or Wootz steel. The high-speed steel may include Mushet steel. The stainless steel may include AL-6XN, Alloy 20, celestrium, marine grade stainless, Martensitic stainless steel, surgical stainless steel, or Zeron 100. The tool steel may include Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade such as 440F, 410, 312, 430, 440A, 440B, 440C, 304, 305, 304L, 304L, 301, 304LN, 301LN, 2304, 316, 316L, 316LN, 317L, 2205, 409, 904L, 321, 254SMO, 316Ti, 321H, 17-4, 15-5, 420, or 304H. The steel may comprise stainless steel of at least one crystalline structure selected from the group consisting of austenitic, superaustenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may include 316LVM. The steel may include 17-4 Precipitation Hardening steel (also known as type 630, a chromium-copper precipitation hardening stainless steel, 17-4PH steel).

The titanium-based alloys may include alpha alloys, near alpha alloys, alpha and beta alloys, or beta alloys. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances, the titanium base alloy includes Ti-6A1-4V or Ti-6A1-7Nb.

The Nickel alloy may include Alnico, Alumel, Chromel, Cupronickel, Ferronickel, German silver, Hastelloy, Inconel, Monel metal, Nichrome, Nickel-carbon, Nicrosil, Nisil, Nitinol, Hastelloy-X, Cobalt-Chromium, or Magnetically “soft” alloys. The magnetically “soft” alloys may comprise Mu-metal, Permalloy, Supermalloy, or Brass. The brass may include Nickel hydride, Stainless or Coin silver. The cobalt alloy may include Megallium, Stellite (e.g. Talonite), Ultimet, or Vitallium. The chromium alloy may include chromium hydroxide, or Nichrome.

The aluminum alloy may include AA-8000, Al—Li (aluminum-lithium), Alnico, Duralumin, Hiduminium, Kryron Magnalium, Nambe, Scandium-aluminum, or Y alloy. The magnesium alloy may be Elektron, Magnox, or T-Mg—Al—Zn (Bergman phase) alloy.

The copper alloy may comprise Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may include Calamine brass, Chinese silver, Dutch metal, Gilding metal, Muntz metal, Pinchbeck, Prince's metal, or Tombac. The Bronze may include Aluminum bronze, Arsenical bronze, Bell metal, Florentine bronze, Guanin, Gunmetal, Glucydur, Phosphor bronze, Ormolu, or Speculum metal. The copper alloy may be a high-temperature copper alloy (e.g., GRCop-84).

In some examples, the material (e.g., powder material) comprises a material wherein its constituents (e.g., atoms or molecules) readily lose their outer shell electrons, resulting in a free-flowing cloud of electrons within their otherwise solid arrangement. In some examples, the material is characterized in having high electrical conductivity, low electrical resistivity, high thermal conductivity, or high density (e.g., as measured at ambient temperature (e.g., R.T., or 20° C.)). The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the afore-mentioned electrical conductivity values (e.g., from about 1*10⁵ S/m to about 1*10⁸ S/m). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the afore-mentioned electrical resistivity values (e.g., from about 1×10⁻⁵ Ω*m to about 1×10⁻⁸ Ω*m). The high thermal conductivity may be at least about 20 Watts per meters times Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the afore-mentioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore-mentioned density values (e.g., from about 1 g/cm³ to about 25 g/cm³).

In some examples, a metallic material (e.g., elemental metal or metal alloy) comprises small amounts of non-metallic materials, such as, for example, oxygen, sulfur, or nitrogen. In some cases, the metallic material comprises the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (based on weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (based on weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

The one or more layers within the 3D object may be (e.g., substantially) planar (e.g., flat). The planarity of the layer may be (e.g., substantially) uniform, e.g., having a central tendency of planarity. The height of the layer at a particular position may be compared to an average plane. The average plane may be defined by a least squares planar fit of the top-most part of the surface of the layer of hardened material. The average plane may be a plane calculated by averaging the material height at each point on the top surface of the layer of hardened material. The deviation from any point at the surface of the planar layer of hardened material may be at most 20%, 15%, 10%, 5%, 3%, 1%, or 0.5% of the height (e.g., thickness) of the layer of hardened material. The (e.g., substantially) planar one or more layers may have a large radius of curvature. FIG. 11 shows an example of a vertical cross section of a 3D object 1112 comprising planar layers (layers numbers 1-4) and non-planar layers (e.g., layers numbers 5-6) that have a radius of curvature. FIGS. 11, 1116 and 1111 are super-positions of curved layer on a circle 1115 having a radius of curvature “r.” The one or more layers may have a radius of curvature equal to the radius of curvature of the layer surface. The radius of curvature may equal infinity (e.g., when the layer is planar). The radius of curvature of the layer surface (e.g., all the layers of the 3D object) may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The radius of curvature of the layer surface (e.g., all the layers of the 3D object) may have any value between any of the afore-mentioned values of the radius of curvature (e.g., from about 10 cm to about 90 μm, from about 50 cm to about 10 μm, from about 5 cm to about 1 μm, from about 50 cm to about 5 μm, from about 5 cm to infinity, or from about 40 cm to about 50 m). In some embodiments, a layer with an infinite radius of curvature is a layer that is planar. In some examples, the one or more layers may be included in a planar section of the 3D object, or may be a planar 3D object (e.g., a flat plane). In some instances, part of at least one layer within the 3D object has the radius of curvature mentioned herein.

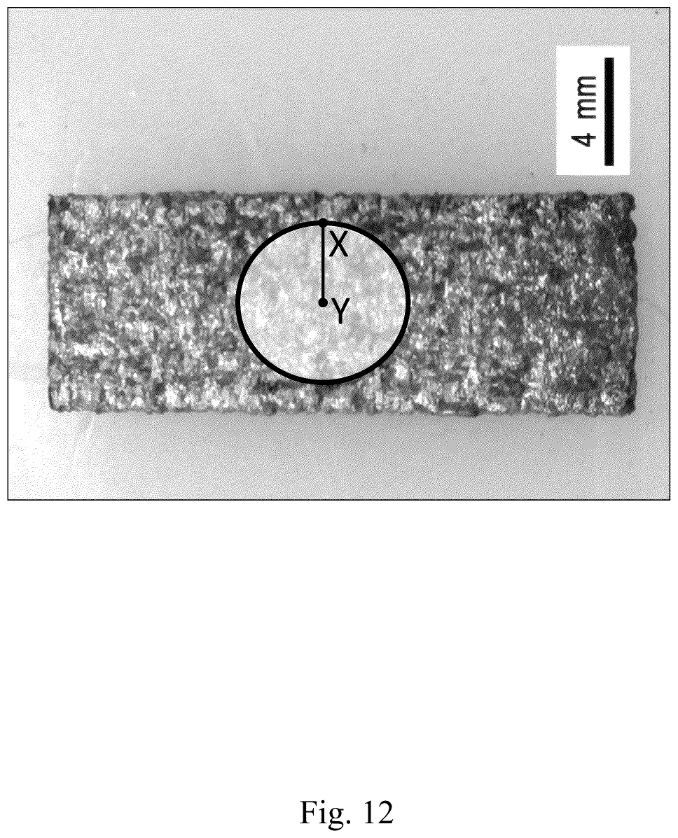

In some examples, the 3D object comprises a layering plane N of the layered 3D structure. The 3D object may comprise points X and Y, which reside on the surface of the 3D object, wherein X is spaced apart from Y by at least about 10.5 millimeters or more. FIG. 12 shows an example of points X and Y on the surface of a 3D object. In some embodiments, X is spaced apart from Y by the auxiliary support feature spacing distance disclosed herein. In some examples, a sphere of radius XY that is centered at X lacks one or more auxiliary supports or one or more auxiliary support marks that are indicative of a presence or removal of the one or more auxiliary support features. In some embodiments, Y is spaced apart from X by at least about 10.5 millimeters or more. In some examples, an acute angle between the straight line XY and the direction normal to N may be from about 45 degrees to about 90 degrees, or from about 60 degrees to about 90 degrees. The acute angle between the straight line XY and the direction normal to the layering plane may be of the value of the acute angle alpha disclosed herein. When the angle between the straight line XY and the direction of normal to N is greater than 90 degrees, one considers the complementary acute angle. The layer structure may comprise any material(s) used for 3D printing described herein. Each layer of the 3D structure can be made of a single material or of multiple materials. Sometimes one part of the layer may comprise one material, and another part may comprise a second material different than the first material. A layer of the 3D object may be composed of a composite material. The 3D object may be composed of a composite material. The 3D object may comprise a functionally graded material.

In some embodiments, the generated 3D object is generated with the accuracy of at least about 5 μm, m, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm as compared to a model of the 3D object (e.g., the requested 3D object). In some embodiments, the generated 3D object is generated with the accuracy of at most about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 m as compared to a model of the 3D object. As compared to a model of the 3D object, the generated 3D object may be generated with the accuracy of any accuracy value between the afore-mentioned values (e.g., from about 5 μm to about 100 μm, from about 15 μm to about 35 μm, from about 100 μm to about 1500 μm, from about 5 μm to about 1500 μm, or from about 400 μm to about 600 μm).

In some situations, the hardened layer of transformed material deforms (e.g., during and/or after the 3D printing). For example, the deformation causes a height deviation from a uniformly planar layer of hardened material. The height uniformity (e.g., deviation from average surface height) of the planar surface of the layer of hardened material may be at least about 100 μm, 90 μm, 80 μm, 70 μm, 60 μm, 50 μm, 40 μm, 30 μm, 20 μm, 10 μm, or 5 μm. The height uniformity of the planar surface of the layer of hardened material may be at most about 100 μm, 90 μm, 80 μm, 70 μm, 60 μm, 50 μm, 40 μm, 30 μm, 20 μm, 10 μm, or 5 μm. The height uniformity of the planar surface of the layer of hardened material may be any value between the afore-mentioned height deviation values (e.g., from about 100 μm to about 5 μm, from about 50 μm to about 5 μm, from about 30 μm to about 5 μm, or from about 20 μm to about 5 μm). For example, the height uniformity be included in a high precision uniformity of the 3D printing. In some embodiments, the resolution of the 3D object is at least about 100 dots per inch (dpi), 300 dpi, 600 dpi, 1200 dpi, 2400 dpi, 3600 dpi, or 4800 dpi. In some embodiments, the resolution of the 3D object is at most about 100 dpi, 300 dpi, 600 dpi, 1200 dpi, 2400 dpi, 3600 dpi, or 4800 dpi. The resolution of the 3D object may be any value between the afore-mentioned values (e.g., from 100 dpi to 4800 dpi, from 300 dpi to 2400 dpi, or from 600 dpi to 4800 dpi).

In some embodiments, the height uniformity of a layer of hardened material persists across a portion of the layer surface that has a width or a length of at least about 1 mm, 2 mm, 3 mm, 4 mm, 5 mm, or 10 mm, have a height deviation of at least about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm, 70 μm, 60 μm, 50 μm, 40 μm, 30 μm, 20 μm, or 10 μm. In some embodiments, the height uniformity of a layer of hardened material persists across a portion of the target surface that has a width or a length of most about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80, 70 μm, 60 μm, 50 μm, 40 μm, 30 μm, 20 μm, or 10 μm. The height uniformity of a layer of hardened material may persist across a portion of the target surface that has a width or a length of or of any value between the afore-mentioned width or length values (e.g., from about 10 mm to about 10 μm, from about 10 mm to about 100 μm, or from about 5 mm to about 500 μm).

Characteristics of the hardened material and/or any of its parts (e.g., layer of hardened material) can be measured by any of the following measurement methodologies. For example, the FLS values (e.g., width), height uniformity, auxiliary support space, an/d or radius of curvature of the layer of the 3D object and any of its components (e.g., layer of hardened material) may be measured by any of the following measuring methodologies. The FLS of opening ports may be measured by one or more of following measurement methodologies. The measurement methodologies may comprise a microscopy method (e.g., any microscopy method described herein). The measurement methodologies may comprise a coordinate measuring machine (CMM), measuring projector, vision measuring system, and/or a gauge. The gauge can be a gauge distometer (e.g., caliper). The gauge can be a go-no-go gauge. The measurement methodologies may comprise a caliper (e.g., vernier caliper), positive lens, interferometer, or laser (e.g., tracker). The measurement methodologies may comprise a contact or a non-contact method. The measurement methodologies may comprise one or more sensors (e.g., optical sensors and/or metrological sensors). The measurement methodologies may comprise a metrological measurement device (e.g., using metrological sensor(s)). The measurements may comprise a motor encoder (e.g., rotary and/or linear). The measurement methodologies may comprise using an electromagnetic beam (e.g., visible or IR). The microscopy method may comprise ultrasound or nuclear magnetic resonance. The microscopy method may comprise optical microscopy. The microscopy method may comprise electromagnetic, electron, or proximal probe microscopy. The electron microscopy may comprise scanning, tunneling, X-ray photo-, or Auger electron microscopy. The electromagnetic microscopy may comprise confocal, stereoscope, or compound microscopy. The microscopy method may comprise an inverted and/or non-inverted microscope. The proximal probe microscopy may comprise atomic force, or scanning tunneling microscopy, or any other microscopy described herein. The microscopy measurements may comprise using an image analysis system. The measurements may be conducted at ambient temperatures (e.g., room temperature).

The microstructures (e.g., of melt pools) of the 3D object may be measured by a microscopy method (e.g., any microscopy method described herein). The microstructures may be measured by a contact or by a non-contact method. The microstructures may be measured by using an electromagnetic beam (e.g., visible or IR). The microstructure measurements may comprise evaluating the dendritic arm spacing and/or the secondary dendritic arm spacing (e.g., using microscopy). The microscopy measurements may comprise using an image analysis system. The measurements may be conducted at ambient temperatures (e.g., R.T.).

Various distances relating to the chamber can be measured using any of the following measurement techniques. Various distances within the chamber can be measured using any of the following measurement techniques. For example, the gap distance (e.g., from the cooling member to the exposed surface of the material bed) may be measured using any of the following measurement techniques. The measurements techniques may comprise interferometry and/or confocal chromatic measurements. The measurements techniques may comprise at least one motor encoder (rotary, linear). The measurement techniques may comprise one or more sensors (e.g., optical sensors and/or metrological sensors). The measurement techniques may comprise at least one inductive sensor. The measurement techniques may include an electromagnetic beam (e.g., visible or IR). The measurements may be conducted at ambient temperature (e.g., R.T.).

The methods described herein can provide surface uniformity across the exposed surface of the material bed (e.g., top of a powder bed) such that portions of the exposed surface that comprises the dispensed material, which are separated from one another by a distance of from about 1 mm to about 10 mm, have a height deviation from about 100 m to about 5 m. The methods described herein may achieve a deviation from a planar uniformity of the layer of pre-transformed material (e.g., powder) in at least one plane (e.g., horizontal plane) of at most about 20%, 10%, 5%, 2%, 1% or 0.5%, as compared to the average plane (e.g., horizontal plane) created at the exposed surface of the material bed (e.g., top of a powder bed). The height deviation can be measured by using one or more sensors (e.g., optical sensors).

The 3D object can have various surface roughness profiles, which may be suitable for various applications. The surface roughness may be the deviations in the direction of the normal vector of a real surface, from its ideal form. The surface roughness may be measured as the arithmetic average of the roughness profile (hereinafter “Ra”). In some examples, the formed 3D object can have a Ra value of at most about 300 μm, 200 μm, 100 μm, 75 μm, 50 μm, 45 μm, 40 μm, 35 μm, 30 μm, 25 μm, 20 μm, 15 μm, 10 μm, 7 μm, or 5 μm. The 3D object can have a Ra value between any of the afore-mentioned Ra values (e.g., from about 300 μm to about 5 μm, from about 300 μm to about 40 μm, from about 100 μm to about 5 μm, or from about 100 μm to about 20 μm). The Ra values may be measured by a contact or by a non-contact method. The Ra values may be measured by a roughness tester and/or by a microscopy method (e.g., any microscopy method described herein). The measurements may be conducted at ambient temperatures (e.g., R.T.). The roughness may be measured by a contact or by a non-contact method. The roughness measurement may comprise one or more sensors (e.g., optical sensors). The roughness measurement may comprise a metrological measurement device (e.g., using metrological sensor(s)). The roughness may be measured using an electromagnetic beam (e.g., visible or IR).

The 3D object may be composed of successive layers (e.g., successive cross sections) of solid material that originated from a transformed material (e.g., fused, sintered, melted, bound or otherwise connected powder material), and subsequently hardened. The transformed pre-transformed material may be connected to a hardened (e.g., solidified) material as part of its transformation. The hardened material may reside within the same layer, or in another layer (e.g., a previously formed layer of hardened material). In some examples, the hardened material comprises disconnected parts of the 3D object, that are subsequently connected by the newly transformed material (e.g., by fusing, sintering, melting, binding or otherwise connecting a pre-transformed material).

A cross section (e.g., vertical cross section) of the generated (e.g., formed) 3D object may reveal a microstructure or a grain structure indicative of a layered deposition. Without wishing to be bound to theory, the microstructure or grain structure may arise due to the solidification of transformed powder material that is typical to and/or indicative of the 3D printing method. For example, a cross section may reveal a microstructure resembling ripples or waves that are indicative of solidified melt pools that may be formed during the 3D printing process. The repetitive layered structure of the solidified melt pools may reveal the orientation at which the part was printed. The cross section may reveal a (e.g., substantially) repetitive microstructure or grain structure. The microstructure or grain structure may comprise (e.g., substantially) repetitive variations in material composition, grain orientation, material density, degree of compound segregation or of element segregation to grain boundaries, material phase, metallurgical phase, crystal phase, crystal structure, material porosity, or any combination thereof. The microstructure or grain structure may comprise (e.g., substantially) repetitive solidification of layered melt pools. The layer of hardened material may have an average layer height of at least about 0.5 μm, 1 μm, 5 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, or 500 μm. The layer of hardened material may have an average layer height of at most about 500 μm, 450 μm, 400 μm, 350 μm, 300 μm, 250 μm, 200 μm, 150 μm, 100 μm, 90 μm, 80 μm, 70 μm, 60 μm, 50 μm, 40 μm, 30 μm, 20 μm, or 10 μm. The layer of hardened material may have an average layer height of any value between the afore-mentioned values of layer heights (e.g., from about 0.5 μm to about 500 μm, from about 15 μm to about 50 μm, from about 5 μm to about 150 μm, from about 20 μm to about 100 μm, or from about 10 μm to about 80 μm).

The pre-transformed material within the material bed (e.g., powder) can be configured to provide support to the 3D object. For example, the supportive pre-transformed may be of the same type of pre-transformed material from which the 3D object is generated, of a different type, or any combination thereof. In some instances, a low flowability pre-transformed material (e.g., powder) can support a 3D object better than a high flowability pre-transformed material. A low flowability pre-transformed material can be achieved inter alia with a particulate material composed of relatively small particles, with particles of non-uniform size or with particles that attract each other. The pre-transformed material may be of low, medium, or high flowability. The pre-transformed material may have compressibility of at least about 1%, 2%, 3%, 4%, 5%, 6%, 7%, 8%, 9%, or 10% in response to an applied force of 15 kilo Pascals (kPa). The pre-transformed material may have a compressibility of at most about 9%, 8%, 7%, 6%, 5%, 4.5%, 4.0%, 3.5%, 3.0%, 2.5%, 2.0%, 1.5%, 1.0%, or 0.5% in response to an applied force of 15 kilo Pascals (kPa). The pre-transformed material may have basic flow energy of at least about 100 milli-Joule (mJ), 200 mJ, 300 mJ, 400 mJ, 450 mJ, 500 mJ, 550 mJ, 600 mJ, 650 mJ, 700 mJ, 750 mJ, 800 mJ, or 900 mJ. The pre-transformed material may have basic flow energy of at most about 200 mJ, 300 mJ, 400 mJ, 450 mJ, 500 mJ, 550 mJ, 600 mJ, 650 mJ, 700 mJ, 750 mJ, 800 mJ, 900 mJ, or 1000 mJ. The pre-transformed material may have basic flow energy in between the above listed values of basic flow energy (e.g., from about 100 mj to about 1000 mJ, from about 100 mj to about 600 mJ, or from about 500 mj to about 1000 mJ). The pre-transformed material may have a specific energy of at least about 1.0 milli-Joule per gram (mJ/g), 1.5 mJ/g, 2.0 mJ/g, 2.5 mJ/g, 3.0 mJ/g, 3.5 mJ/g, 4.0 mJ/g, 4.5 mJ/g, or 5.0 mJ/g. The pre-transformed material may have a specific energy of at most 5.0 mJ/g, 4.5 mJ/g, 4.0 mJ/g, 3.5 mJ/g, 3.0 mJ/g, 2.5 mJ/g, 2.0 mJ/g, 1.5 mJ/g, or 1.0 mJ/g. The powder may have a specific energy in between any of the above values of specific energy (e.g., from about 1.0 mJ/g to about 5.0 mJ/g, from about 3.0 mJ/g to about 5 mJ/g, or from about 1.0 mJ/g to about 3.5 mJ/g).

In some embodiments, the 3D object includes one or more auxiliary features. The auxiliary feature(s) can be supported by the material (e.g., powder) bed. The term “auxiliary features,” as used herein, generally refers to features that are part of a printed 3D object, but are not part of the requested, intended, designed, ordered, modeled, or final 3D object. Auxiliary features (e.g., auxiliary supports) may provide structural support during and/or after the formation of the 3D object. Auxiliary features may enable the removal or energy from the 3D object that is being formed. Examples of auxiliary features comprise heat fins, wires, anchors, handles, supports, pillars, columns, frame, footing, scaffold, flange, projection, protrusion, mold, or other stabilization features. In some instances, the auxiliary support is a scaffold that encloses the 3D object or part thereof. The scaffold may comprise lightly sintered or lightly fused powder material. The 3D object can have auxiliary features that can be supported by the material bed (e.g., powder bed) and not touch the base, substrate, container accommodating the material bed, or the bottom of the enclosure. The 3D part (3D object) in a complete or partially formed state can be completely supported by the material bed (e.g., suspended anchorlessly in the material bed without touching the substrate, base, container accommodating the material bed, or the enclosure). The 3D object in a complete or partially formed state can be completely supported by the material bed (e.g., without touching anything except the material bed). The 3D object in a complete or partially formed state can be suspended in the material bed without resting on any additional support structures. In some cases, the 3D object in a complete or partially formed (e.g., nascent) state can freely float (e.g., anchorless) in the material bed. In some examples, the 3D object may not be anchored (e.g., connected) to the platform and/or walls that define the material bed (e.g., during formation). The 3D object may not touch (e.g., contact) to the platform and/or walls that define the material bed (e.g., during formation). The 3D object be suspended (e.g., float) anchorlessly in the material bed. The scaffold may comprise a continuously sintered (e.g., lightly sintered) structure that is at most 1 millimeter (mm), 2 mm, 5 mm or 10 mm. The scaffold may comprise a continuously sintered structure that is at least 1 millimeter (mm), 2 mm, 5 mm or 10 mm. The scaffold may comprise a continuously sintered structure having dimensions between any of the afore-mentioned dimensions (e.g., from about 1 mm to about 10 mm, or from about 1 mm to about 5 mm). In some examples, the 3D object may be printed without a supporting scaffold. The supporting scaffold may engulf the 3D object. The supporting scaffold may float anchorlessly in the material bed. The scaffold may comprise a lightly sintered structure.

In some embodiments, the printed 3D object is printed (i) without the use of auxiliary supports, (ii) using a reduced number of auxiliary supports, or (iii) using spaced apart auxiliary supports. In some embodiments, the printed 3D object may be devoid of one or more auxiliary supports or auxiliary support marks that are indicative of a presence or removal of the auxiliary support features. The 3D object may be devoid of one or more auxiliary supports and of one or more marks of an auxiliary feature (including a base structure) that were removed (e.g., subsequent to, or contemporaneous with, the generation of the 3D object). In some embodiments, the printed 3D object comprises a single auxiliary support mark. The single auxiliary feature (e.g., auxiliary support or auxiliary structure) may be a platform (e.g., a building platform such as a base or substrate), or a mold. The auxiliary support may be adhered (e.g., and anchored) to the platform or mold. The 3D object may comprise marks belonging to one or more auxiliary structures. The 3D object may comprise two or more marks belonging to auxiliary features. The 3D object may be devoid of marks pertaining to an auxiliary support. The 3D object may be devoid of auxiliary support. The mark may comprise variation in grain orientation, variation in layering orientation, layering thickness, material density, the degree of compound segregation to grain boundaries, material porosity, the degree of element segregation to grain boundaries, material phase, metallurgical phase, crystal phase, or crystal structure; wherein the variation may not have been created by the geometry of the 3D object alone, and may thus be indicative of a prior existing auxiliary support that was removed. The variation may be forced upon the generated 3D object by the geometry of the support. In some instances, the 3D structure of the printed object may be forced by the auxiliary support (e.g., by a mold). For example, a mark may be a point of discontinuity (e.g., formed due to a cut or trimming) that is not explained by the geometry of the 3D object, which does not include any auxiliary supports. A mark may be a surface feature that cannot be explained by the geometry of a 3D object, which does not include any auxiliary supports (e.g., a mold). The two or more auxiliary features or auxiliary support feature marks may be spaced apart by a spacing distance of at least 1.5 millimeters (mm), 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm, 300 mm, or 500 mm. The two or more auxiliary support features or auxiliary support feature marks may be spaced apart by a spacing distance of at most 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The two or more auxiliary support features or auxiliary support feature marks may be spaced apart by a spacing distance of any value between the afore-mentioned auxiliary support space values (e.g., from 1.5 mm to 500 mm, from 2 mm to 100 mm, from 15 mm to 50 mm, or from 45 mm to 200 mm). Collectively referred to herein as the “auxiliary support feature spacing distance.”

The 3D object may comprise a layered structure indicative of 3D printing process that is devoid of one or more auxiliary support features or one or more auxiliary support feature marks that are indicative of a presence or removal of the one or more auxiliary support features. The 3D object may comprise a layered structure indicative of 3D printing process, which includes one, two, or more auxiliary support marks. The supports or support marks can be on the surface of the 3D object. The auxiliary supports or support marks can be on an external, on an internal surface (e.g., a cavity within the 3D object), or both. The layered structure can have a layering plane. In one example, two auxiliary support features or auxiliary support feature marks present in the 3D object may be spaced apart by the auxiliary feature spacing distance. The acute (e.g., sharp) angle alpha between the straight line connecting the two auxiliary supports or auxiliary support marks and the direction of normal to the layering plane may be at least about 45 degrees (°), 50°, 55°, 60°, 65°, 70°, 75°, 80°, or 85°. The acute angle alpha between the straight line connecting the two auxiliary supports or auxiliary support marks and the direction of normal to the layering plane may be at most about 90°, 85°, 80°, 75°, 70°, 65°, 60°, 55°, 50°, or 45°. The acute angle alpha between the straight line connecting the two auxiliary supports or auxiliary support marks and the direction of normal to the layering plane may be any angle range between the afore-mentioned angles (e.g., from about 45 degrees (°), to about 90°, from about 60° to about 90°, from about 75° to about 90°, from about 80° to about 90°, from about 85° to about 90°). The acute angle alpha between the straight line connecting the two auxiliary supports or auxiliary support marks and the direction normal to the layering plane may from about 87° to about 90°. An example of a layering plane can be seen in FIG. 11 showing a vertical cross section of a 3D object 1111 that comprises layers 1 to 6, each of which are planar. In the schematic example in FIG. 11, the layering plane of the layers can be the layer. For example, layer 1 could correspond to both the layer and the layering plane of layer 1. When the layer is not planar (e.g., FIG. 11, layer 5 of 3D object 1112), the layering plane would be the average plane of the layer. The two auxiliary supports, or auxiliary support feature marks can be on the same surface. The same surface can be an external surface or an internal surface (e.g., a surface of a cavity within the 3D object). When the angle between the shortest straight line connecting the two auxiliary supports or auxiliary support marks and the direction of normal to the layering plane is greater than 90 degrees, one can consider the complementary acute angle. In some embodiments, any two auxiliary supports, or auxiliary support marks are spaced apart by the auxiliary feature spacing distance.

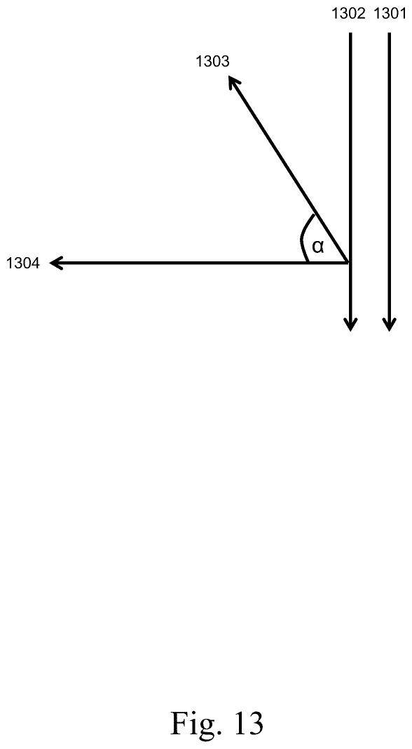

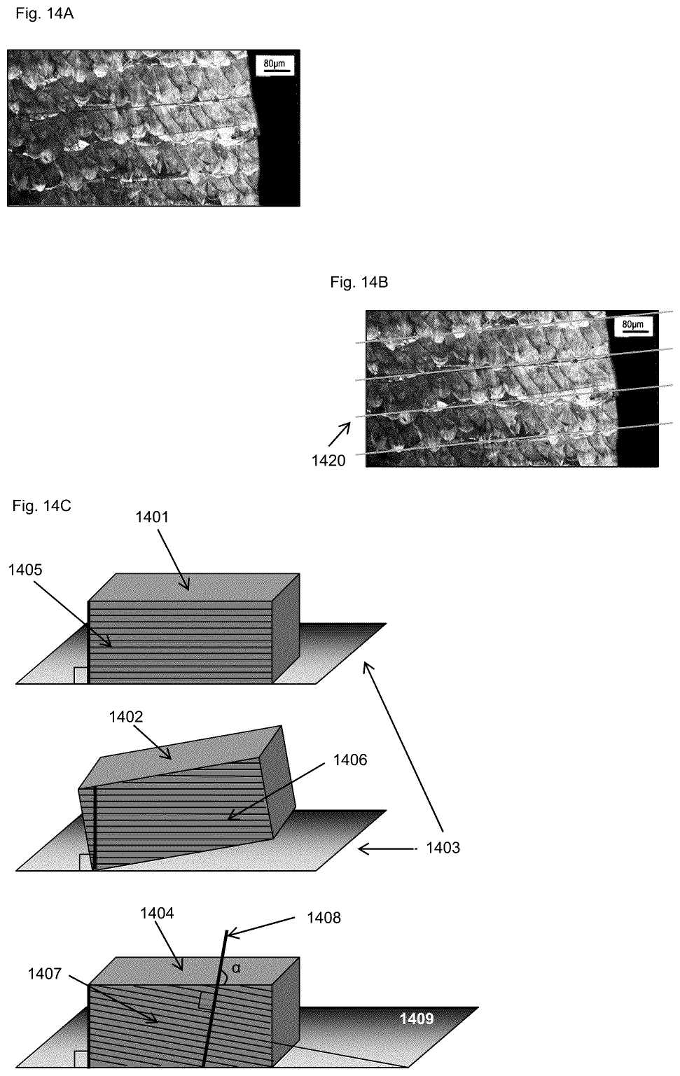

FIG. 14C shows an example of a 3D object comprising an exposed surface 1401 that was formed with layers of hardened material (e.g., having layering plane 1405) that are (e.g., substantially) planar and parallel to the platform 1403. FIG. 14C shows an example of a 3D object comprising an exposed surface 1402 that was formed with layers of hardened material (e.g., having layering plane 1406) that are (e.g., substantially) planar and parallel to the platform 1403 resulting in a tilted 3D object (e.g., box). The 3D object that was formed as a tiled 3D object during its formation, is shown lying flat on a surface 1409 as a 3D object having an exposed surface 1404 and layers of hardened material (e.g., having layering plane 1407) having a normal 1408 to the layering plane that forms acute angle alpha with the exposed surface 1404 of the 3D object. FIGS. 14A and 14B show 3D objects comprising layers of solidified melt pools that are arranged in layers having layering planes (e.g., 1420). FIG. 13 shows a vertical cross section in a coordinate system. Line 1304 represents a vertical cross section of the top surface of a platform. Line 1303 represents a normal to the average layering plane. Line 1302 represent the normal to the top surface of the platform. Line 1301 represents the direction of the gravitational field. The angle alpha in FIG. 13 is formed between the normal to the layering plane, and the top platform surface.

In some instances, the one or more auxiliary features are specific to a 3D object and can increase the time needed to generate the requested 3D object. The one or more auxiliary features can be removed prior to use or distribution of the requested 3D object. Eliminating the need for auxiliary features can decrease the time and cost associated with generating the three-dimensional part. In some examples, the diminished number of auxiliary supports or lack of one or more auxiliary support, will provide a 3D printing process that requires a smaller amount of material, produces a smaller amount of material waste, and/or requires smaller energy as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the aforesaid values (e.g., from about 1.1 to about 10, or from about 1.5 to about 5).

In some examples, the 3D object is formed with auxiliary features. In some examples, the 3D object may be formed with contact (e.g., but not anchor) to the container accommodating the material bed (e.g., side(s) and/or bottom of the container). The longest dimension of a cross-section of an auxiliary feature can be at most about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension of a cross-section of an auxiliary feature can be at least about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension of a cross-section of an auxiliary feature can be any value between the above-mentioned values (e.g., from about 50 nm to about 300 mm, from about 5 m to about 10 mm, from about 50 nm to about 10 mm, or from about 5 mm to about 300 mm).

At least a portion of the 3D object can sink in the material bed. At least a portion of the 3D object can be surrounded by pre-transformed material within the material bed (e.g., submerged). At least a portion of the 3D object can rest in the pre-transformed material without substantial sinking (e.g., vertical movement). Lack of substantial sinking can amount to a sinking (e.g., vertical movement) of at most about 40%, 20%, 10%, 5%, or 1% layer thickness. Lack of substantial sinking can amount to at most about 100 μm, 30 μm, 10 μm, 3 μm, or 1 μm. At least a portion of the 3D object can rest in the pre-transformed material without substantial movement (e.g., horizontal movement, movement at an angle). Lack of substantial movement can amount to at most 100 μm, 30 μm, 10 μm, 3 μm, or 1 μm. The 3D object can rest on the substrate when the 3D object is sunk or submerged in the material bed.

In some embodiments, the 3D printing takes place in a 3D printing system comprising an enclosure (e.g., chamber) having an atmosphere different from the ambient atmosphere external to the enclosure. FIG. 1 depicts an example of a system that can be used to generate a 3D object using a 3D printing process disclosed herein. The system can include an enclosure, e.g., 107 having internal volume 126 having an atmosphere. At least a fraction of the components in the system can be enclosed in the chamber (e.g., comprising the enclosure). At least a fraction of the chamber can be filled with at least one gas to create a gaseous environment (e.g., an atmosphere). The gas can comprise an inert gas (e.g., Argon, Neon, Helium, Nitrogen). The chamber can be filled with another gas or mixture of gases. The gas can be a non-reactive gas (e.g., an inert gas). The gaseous environment can comprise argon, nitrogen, helium, neon, krypton, xenon, hydrogen, carbon monoxide, or carbon dioxide. The gas can be an ultrahigh purity gas. For example, the ultrahigh purity gas can be at least about 99%, 99.9%, 99.99%, or 99.999% pure. The gas may comprise less than about 2 ppm oxygen, less than about 3 ppm moisture, less than about 1 ppm hydrocarbons, or less than about 6 ppm nitrogen. In some examples, the pressure in the chamber is at least about 10 Torr, 100 Torr, 150 Torr, 200 Torr, 300 Torr, or 400 Torr, above atmospheric pressure (e.g., above 760 Torr). In some examples, the pressure in the chamber is at least about 10 Torr, 100 Torr, 150 Torr, 200 Torr, 300 Torr, 400 Torr, 500 Torr, or 600 Torr, above atmospheric pressure (e.g., above 760 Torr). The pressure in the chamber can be at a range between any of the afore-mentioned pressure values above atmospheric pressure, e.g., from about 10 Torr to about 600 Torr, from about 100 Torr to about 200 Torr, the values representing a pressure difference above atmospheric pressure (e.g., above 760 Torr). The pressure in the chamber is at least about 20 Kilo Pascal (KPa), 18 KPa, 16 KPa, 14 KPa, 12 KPa, 10 KPa, or 5 KPa above atmospheric pressure, e.g., above 101 KPa. The pressure in the chamber can be at a range between any of the afore-mentioned pressure values above atmospheric pressure, e.g., from about 5 KPa to about 20 KPa, the values representing a pressure difference above atmospheric pressure, e.g., above 101 KPa. The pressure can be measured by a pressure gauge. The pressure can be measured at ambient temperature, e.g., Room Temperature. In some cases, the pressure in the chamber can be standard atmospheric pressure. In some cases, the pressure in the chamber can be ambient pressure (e.g., pressure at the surrounding environment outside of the chamber). In some examples, the chamber can be under vacuum pressure. In some examples, the chamber can be under a positive pressure (e.g., above ambient pressure external to the chamber). The pressure in the enclosure may be maintained at a (e.g., substantially) constant value at least during a portion of the 3D printing process, e.g., during the entire 3D printing. In some embodiments, the 3D printing takes place in a (e.g., substantially) constant pressure. Constant pressure excludes pressure gradients in the material bed during the 3D printing.

The concentration of oxygen and/or humidity in the enclosure (e.g., chamber) can be minimized, e.g., below a predetermined threshold value. For example, the gas composition of the chamber can contain a level of oxygen that is at most about 4000 parts per million (ppm), 3000 ppm, 2000 ppm, 1500 ppm, 1000 ppm, 500 ppm, 400 ppm, 100 ppm, 50 ppm, 10 ppm, or 5 ppm. The gas composition of the chamber can contain an oxygen level between any of the afore-mentioned values (e.g., from about 4000 ppm to about 5 ppm, from about 2000 ppm to about 500 ppm, from about 100 ppm to about 5 ppm, or from about 1500 ppm to about 100 ppm). For example, the gas composition of the chamber can contain a level of humidity that correspond to a dew point of at most about −10° C., −15° C., −20° C., −25° C., −30° C., −35° C., −40° C., −50° C., −60° C., or −70° C. The gas composition of the chamber can contain a level of humidity that correspond to a dew point of between any of the aforementioned values, e.g., from about −70° C. to about −10° C., from about −60° C. to about −10° C., or from about −30° C. to about −20° C. The gas composition may be measures by one or more sensors (e.g., an oxygen and/or humidity sensor). In some cases, the chamber can be opened at or after printing the 3D object. When the chamber is opened, ambient air containing oxygen and/or humidity can enter the chamber. Exposure of one or more components inside of the chamber to air can be reduced by, for example, flowing an inert gas while the chamber is open (e.g., to prevent entry of ambient air), or by flowing a heavy gas (e.g., argon) that rests on the surface of the powder bed. In some cases, components that absorb oxygen and/or humidity on to their surface(s) can be sealed while the chamber is open. In some embodiments, the chamber is minimally exposed to the external environment by usage of one or more load lock chambers. In the load lock chamber, the purging of gas may be done in a smaller gas volume as compared to the chamber gas volume.

The chamber can be configured such that gas inside of the chamber has a relatively low leak rate from the chamber to an environment outside of the chamber. In some cases, the leak rate can be at most about 100 milliTorr/minute (mTorr/min), 50 mTorr/min, 25 mTorr/min, 15 mTorr/min, 10 mTorr/min, 5 mTorr/min, 1 mTorr/min, 0.5 mTorr/min, 0.1 mTorr/min, 0.05 mTorr/min, 0.01 mTorr/min, 0.005 mTorr/min, 0.001 mTorr/min, 0.0005 mTorr/min, or 0.0001 mTorr/min. The leak rate may be between any of the afore-mentioned leak rates (e.g., from about 0.0001 mTorr/min to about, 100 mTorr/min, from about 1 mTorr/min to about, 100 mTorr/min, or from about 1 mTorr/min to about, 100 mTorr/min). The leak rate may be measured by one or more pressure gauges and/or sensors (e.g., at ambient temperature). The enclosure can be sealed such that the leak rate of gas from inside the chamber to an environment outside of the chamber is low (e.g., below a certain level). The seals can comprise O-rings, rubber seals, metal seals, load-locks, or bellows on a piston. In some cases, the chamber can have a controller configured to detect leaks above a specified leak rate (e.g., by using at least one sensor). The sensor may be coupled to a controller. In some instances, the controller identifies and/or control (e.g., direct and/or regulate). For example, the controller may be able to identify a leak by detecting a decrease in pressure inside of the chamber over a given time interval.

In some examples, a pressure system is in fluid communication with the enclosure and/or material removal mechanism. The pressure system can be configured to regulate the pressure in the enclosure and/or material removal mechanism. In some examples, the pressure system includes one or more vacuum pumps selected from mechanical pumps, rotary vain pumps, turbomolecular pumps, ion pumps, cryopumps, and diffusion pumps. The vacuum pump may be any pump disclosed herein. The pressure system can include a pressure sensor for measuring the pressure and relaying the pressure to the controller, which can regulate the pressure with the aid of one or more vacuum pumps of the pressure system. The pressure sensor can be operatively coupled to a control system. The pressure can be electronically or manually controlled (during, before, or after the 3D printing). The pressure may be measured in the enclosure, and/or in the material removal mechanism. For example, the pressure can be measured (i) just outside the nozzle, (ii) in the internal reservoir, and/or (iii) in the nozzle of the material removal mechanism. The pressure can be measured along the channel that couples the material removal mechanism to the force generator, e.g., pressure pump.

In some examples, the system and/or apparatus components described herein are adapted and configured to generate a 3D object. The 3D object can be generated through a 3D printing process. A first layer of material can be provided adjacent to a platform. A base can be a previously formed layer of the 3D object or any other surface upon which a layer or bed of material is spread, held, placed, or supported. In the case of formation of the first layer of the 3D object the first material layer can be formed in the material bed without a base, without one or more auxiliary support features (e.g., rods), or without other supporting structure other than the material (e.g., within the material bed). Subsequent layers can be formed such that at least one portion of the subsequent layer melts, sinters, fuses, binds and/or otherwise connects to the at least a portion of a previously formed layer. In some instances, the at least a portion of the previously formed layer that is transformed and subsequently hardens into a hardened material, acts as a base for formation of the 3D object. In some cases, the first layer comprises at least a portion of the base. The material of the material can be any material described herein. The material layer can comprise particles of homogeneous or heterogeneous size and/or shape.

The system and/or apparatus described herein may comprise at least one energy source, e.g., the scanning energy source generating the first scanning energy, second scanning energy; e.g., the tiling energy source generating the tiling energy flux. In some cases, the system can comprise 1, 2, 3, 4, 5, 6, 7, 8, 9, 10, 16, 30, 64, 100, 300, 1000 or more energy fluxes (e.g., beams) and/or sources. The system can comprise an array of energy sources (e.g., laser diode array) and/or fluxes. Alternatively or additionally the target surface, material bed, 3D object (or part thereof), or any combination thereof may be heated by a heating mechanism. The heating mechanism may comprise dispersed energy beams. In some cases, the at least one energy source is a single (e.g., first) energy source. An energy source can be a source configured to deliver energy to an area (e.g., a confined area). An energy source can deliver energy to the confined area through radiative heat transfer. The energy source can project energy (e.g., heat energy, and/or energy beam). The energy (e.g., beam) can interact with at least a portion of the material bed. The energy can heat the material bed portion before, during and/or after the material is being transformed. The energy can heat at least a fraction of a 3D object at any point during formation of the 3D object. Alternatively or additionally, the material bed may be heated by a heating mechanism projecting energy (e.g., radiative heat and/or energy beam). The energy may include an energy beam and/or dispersed energy (e.g., radiator or lamp). The radiative heat may be projected by a dispersive energy source (e.g., a heating mechanism) comprising a lamp, a strip heater (e.g., mica strip heater, or any combination thereof), a heating rod (e.g., quartz rod), or a radiator (e.g., a panel radiator). The heating mechanism may comprise an inductance heater. The heating mechanism may comprise a resistor (e.g., variable resistor). The resistor may comprise a varistor or rheostat. A multiplicity of resistors may be configured in series, parallel, or any combination thereof. In some cases, the system can have a single (e.g., first) energy source. An energy source can be a source configured to deliver energy to an area (e.g., a confined area). An energy source can deliver energy to the confined area through radiative heat transfer (e.g., as described herein).

In some examples, the energy beam includes a radiation comprising an electromagnetic, or charged particle beam. The energy beam may include radiation comprising electromagnetic, electron, positron, proton, plasma, or ionic radiation. The electromagnetic beam may comprise microwave, infrared, ultraviolet, or visible radiation. The energy beam may include an electromagnetic energy beam, electron beam, particle beam, or ion beam. An ion beam may include a cation or an anion. A particle beam may include radicals. The electromagnetic beam may comprise a laser beam. The energy beam may comprise plasma. The energy source may include a laser source. The energy source may include an electron gun. The energy source may include an energy source capable of delivering energy to a point or to an area. In some embodiments, the energy source is a laser source. The laser source may comprise a CO₂, Nd:YAG, Neodymium (e.g., neodymium-glass), an Ytterbium, or an excimer laser. The laser may be a fiber laser. The energy source may include an energy source capable of delivering energy to a point or to an area. The laser beam may comprise a corona laser beam, e.g., a laser beam having a footprint similar to a doughnut shape. The energy source (e.g., first scanning energy source such as a laser source) can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source (e.g., first scanning energy source) can provide an energy beam having an energy density of at most about 50 J/cm², 100 J/cm², 200 J/cm², 300 J/cm², 400 J/cm², 500 J/cm², 600 J/cm², 700 J/cm², 800 J/cm², 1000 J/cm², 500 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source (e.g., first scanning energy source) can provide an energy beam having an energy density of a value between the afore-mentioned values (e.g., from about 50 J/cm² to about 5000 J/cm², from about 200 J/cm² to about 1500 J/cm², from about 1500 J/cm² to about 2500 J/cm², from about 100 J/cm² to about 3000 J/cm², or from about 2500 J/cm² to about 5000 J/cm²). In an example a laser (e.g., first scanning energy source) can provide light energy at a peak wavelength of at least about 100 nanometer (nm), 400 nm, 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 750 nm, 500 nm, 400 nm, or 100 nm. The laser can provide light energy at a peak wavelength between any of the afore-mentioned peak wavelength values (e.g., from about 100 nm to about 2000 nm, from about 500 nm to about 1500 nm, or from about 1000 nm to about 1100 nm). The energy source (e.g., laser) may have a power of at least about 0.5 Watt (W), 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy source may have a power of at most about 0.5 W, 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500, 2000 W, 3000 W, or 4000 W. The energy source may have a power between any of the afore-mentioned laser power values (e.g., from about 0.5 W to about 100 W, from about 1 W to about 10 W, from about 100 W to about 1000 W, or from about 1000 W to about 4000 W). The first energy source (e.g., producing the first scanning energy beam) may have at least one of the characteristics of the second energy source (e.g., producing the second scanning energy beam). The tiling energy flux may have at least one of the characteristics disclosed herein for the energy beam. The tiling energy flux may be generated from the same energy source or from different energy sources as compared with the scanning energy beam. The tiling energy flux may be of a lesser power density as compared to the scanning energy beam. Lesser power may be by about 0.25, 0.5, 0.75, or 1 (one) order of magnitude. The scanning energy beam may operate independently or synchronously with the tiling energy flux (e.g., during the 3D printing). In some examples, the scanning energy beam and the tiling energy flux are generated by the same energy source that operates in two modules (e.g., different modules) respectively.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a doughnut (e.g., corona) beam profile. For example, the energy beam may print a first portion of the 3D object using a gaussian beam profile, and then print a second portion of the 3D object using a doughnut shaped beam profile.

An energy beam from the energy source(s) can be incident on, or be directed perpendicular to, the target surface. An energy beam from the energy source(s) can be directed at an acute angle within a value of from parallel to perpendicular relative to the target surface. The energy beam can be directed to a pre-transformed and/or a transformed material for a specified time-period. That pre-transformed and/or a transformed material can absorb the energy from the energy beam and, and as a result, a localized region of the material bed can increase in temperature. The energy beam can be moveable (e.g., using a scanner) such that it can translate relative to the target surface. At times, the energy source of the irradiated energy is movable such that it can translate relative to the target surface. At times, the energy source of the irradiated energy is stationary. At least two (e.g., all) of the energy sources can be movable with the same scanner. A least two (e.g., all) of the energy beams can be movable with the same scanner. At least two of the energy source(s) and/or beam(s) can be translated independently of each other. In some cases, at least two of the energy source(s) and/or beam(s) can be translated at different rates (e.g., velocities). In some cases, at least two of the energy source(s) and/or beam(s) can comprise at least one different characteristic. The characteristics of the irradiated energy may comprise wavelength, power, amplitude, trajectory, footprint, intensity, energy, fluence, Andrew Number, hatch spacing, scan speed, or charge. The charge can be electrical and/or magnetic charge. Andrew number is proportional to the power of the irradiating energy over the multiplication product of its velocity (e.g., scan speed) by its hatch spacing. The Andrew number is at times referred to as the area filling power of the irradiating energy.

The energy source can be an array, or a matrix, of energy sources (e.g., laser diodes). Each of the energy sources in the array, or matrix, can be independently controlled (e.g., by a control mechanism) such that the energy beams can be turned off and on independently. At least a part of the energy sources in the array or matrix can be collectively controlled such that the at least two (e.g., all) of the energy sources can be turned off and on simultaneously. In some embodiments, the energy per unit area (or intensity) of at least two energy sources in the matrix or array are modulated independently (e.g., by a control mechanism or system). At times, the energy per unit area or intensity of at least two (e.g., all) of the energy sources in the matrix or array is modulated simultaneously (e.g., by a control mechanism). The energy source can scan along target surface by mechanical movement of the energy source(s), one or more adjustable reflective mirrors, and/or one or more polygon light scanners. The energy source(s) can project energy using a DLP modulator, a one-dimensional scanner, a two-dimensional scanner, or any combination thereof. The target and/or source surface can translate vertically, horizontally, or in an angle (e.g., planar or compound).

The energy source can comprise a modulator. The irradiated energy by the energy source can be modulated. The modulator can include amplitude modulator, phase modulator, or polarization modulator. The modulation may alter the intensity of the energy beam. The modulation may alter the current supplied to the energy source (e.g., direct modulation). The modulation may affect the irradiated energy (e.g., external modulation such as external light modulator). The modulation may include direct modulation (e.g., by a modulator). The modulation may include an external modulator. The modulator can include an acousto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

In some examples, the irradiated energy is moveable relative to the target surface such that it can translate relative to the target surface. The scanner may comprise a galvanometer scanner, a polygon, a mechanical stage (e.g., X-Y stage), a piezoelectric device, gimble, or any combination of thereof. The galvanometer may comprise a mirror. The scanner may comprise a modulator. The scanner may comprise a polygonal mirror. The scanner can be the same scanner for two or more energy sources and/or beams. At least two (e.g., each) energy source and/or beam may have a separate scanner. The energy sources can be translated independently of each other. In some cases, at least two irradiated energies (e.g., the scanning energy beam and the tiling energy flux) can be translated at different rates, along different trajectories, and/or along different paths (e.g., during formation of a layer of hardened material). For example, the movement of the scanning energy beam may be faster (e.g., greater rate) as compared to the movement of the tiling energy flux. In some embodiments, the systems and/or apparatuses disclosed herein comprise one or more shutters (e.g., safety shutters). The galvanometer scanner may comprise a two-axis galvanometer scanner. The scanner may comprise a modulator (e.g., as described herein). The energy source(s) can project energy and translate it using a DLP modulator, a one-dimensional scanner, a two-dimensional scanner, or any combination thereof. The energy source(s) can be stationary or translatable. The irradiated energy can translate vertically, horizontally, or in an angle (e.g., planar or compound angle). The scanner can be included in an optical system that is configured to direct energy from the energy source to a predetermined position on the target surface (e.g., exposed surface of the material bed). The controller can be programmed to control a trajectory of the irradiated energy with the aid of the optical system. The controller can regulate a supply of energy from the energy source to the material (e.g., at the target surface) to form a transformed material.

In some embodiments, the layer dispensing mechanism dispenses the material, level, distribute, spread, and/or remove the material in a material bed. The layer dispensing mechanism may comprise at least one, two or three of (i) a material dispensing mechanism, (ii) material removal mechanism, and (iii) material leveling mechanism. The layer dispensing mechanism may be controlled by the controller. At least a part (e.g., portion and/or component) of the layer dispensing mechanism may be temperature regulated (e.g., heated, temperature maintained, or cooled). At least one component within the layer dispensing mechanism may be heated or cooled. At least one component within the layer dispensing mechanism that contacts the material (e.g., powder and/or transformed material) may be heated or cooled. The movement of the layer dispensing mechanism may be programmable. The movement of the layer dispensing mechanism may be predetermined. The movement of the layer dispensing mechanism may be according to an algorithm (e.g., considering the model of the 3D object).

In some embodiments, the layer dispensing mechanism or any of its components are exchangeable, removable, non-removable, or non-exchangeable. The layer dispensing mechanism (e.g., any of its components) may comprise exchangeable parts. The layer dispensing mechanism may distribute material across the target surface. The layer dispensing mechanism or any of its components (e.g., flattening mechanism) can provide a pre-transformed material (e.g., powder) uniformity across the target surface (e.g., exposed surface of the material bed) such that portions of the target surface (e.g., that comprise the dispensed material) that are separated from one another by at least about 1 mm, 2 mm, 3 mm, 4 mm, 5 mm, or 10 mm, have a height deviation of at most about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm, 70 μm, 60 μm, 50 μm, 40 μm, 30 μm, 20 μm, or 10 μm; or of any value between the afore-mentioned height deviation values (e.g., from about 10 μm to about 10 μmm, from about 10 μm to about 1 μmm, from about 50 μm to about 100 μm, from about 40 μm to about 200 μm, or from about 10 μm to about 200 μm). The layer dispensing mechanism may achieve a deviation from a planar uniformity of the target surface in at least one plane (e.g., horizontal plane) of at most about 20%, 10%, 5%, 2%, 1% or 0.5%, as compared to the average plane (e.g., horizontal plane) created at the target surface (e.g., top of a powder bed). The layer dispensed by the layer dispensing mechanism may be (e.g., substantially) planar (e.g., flat). The exposed surface that was leveled by the planarizing mechanism may be (e.g., substantially) planar (e.g., flat). The exposed surface that was leveled by the leveling and/or material removal mechanism may be (e.g., substantially) planar (e.g., flat).

In some examples, at least two components of the layer dispensing mechanism (e.g., material dispensing mechanism, leveling member, and/or material removal member) are individually or jointly controlled. Jointly controlled may include simultaneously controlled. Individually controlled may be non-simultaneously controlled. Individually controlled may be separately controlled. At least one component of the layer dispensing mechanism follows another component relative to the direction of travel. When the layer dispensing mechanism reaches the end of the material bed, or precedes the end of the powder bed, the direction of movement may switch. Sometimes, the switch may involve concerted alteration of the relative positions of the components of the layer dispensing mechanism. Sometimes, the switch may not involve concerted alteration of the relative positions of the components of the layer dispensing mechanism. Examples of layer dispensing mechanism, 3D printers, related control system, related methods, apparatuses, systems, and program instructions (e.g., software), can be found in U.S. patent application Ser. No. 15/374,318, filed Dec. 9, 2016; in International Patent Application Serial No. PCT/US16/66000 filed Dec. 9, 2016; and International Patent Application Serial No. PCT/US15/36802 filed Jun. 19, 2015; each of which is entirely incorporated herein by reference. Examples of a material removal mechanism, 3D printers, related control system, related methods, apparatuses, systems, and program instructions (e.g., software), can be found in International Patent Application Serial No. PCT/US15/36802, which is entirely incorporated herein by reference. The material removal mechanism may be coupled to the material dispensing mechanism and/or the material leveling mechanism. The material removal mechanism can be disposed adjacent to (e.g., above, below, or to the side of) the material bed. The material removal mechanism may translatable horizontally, vertically, or at an angle. The powder removal mechanism may be movable. The removal mechanism may be movable manually and/or automatically (e.g., controlled by a controller). The movement of the material removal mechanism may be programmable. The movement of the material removal mechanism may be predetermined. The movement of the powder removal mechanism may be according to an algorithm.

In some examples, the material removal mechanism comprises a material entrance opening port and a material exit opening (e.g., exit port). The material entrance port and material exit port may be the same opening. The material entrance port and material exit port may be different openings. The material entrance and material exit ports may be spatially separated. The spatial separation may be on the external surface of the material removal mechanism. The spatial separation may be on the surface area of the material removal mechanism. The material entrance and material exit ports may be connected. The material entrance and material exit ports may be connected within the material removal mechanism. The connection may be an internal cavity within the material removal mechanism.

In some embodiments, the material removal mechanism comprises a force that causes the material to travel from the material bed (e.g., exposed surface thereof) towards the interior of the material removal mechanism (e.g., the reservoir). That travel may be in an anti-gravitational manner and/or upwards direction. The material removal mechanism may comprise negative pressure (e.g., vacuum), electrostatic force, electric force, magnetic force, or physical force. In some examples, the material removal mechanism does not contact the target surface while removing material from it. For example, the material removal mechanism is separated from the target surface by a gas gap. The material dispensing mechanism may comprise negative pressure (e.g., vacuum) that causes the material to leave the target surface and travel into the entrance opening of the material removal mechanism. The material dispensing mechanism may comprise positive pressure (e.g., a gas flow) that causes the material to leave the target surface and travel into the entrance opening of the material removal mechanism. The gas may comprise any gas disclosed herein. The gas may aid in fluidizing the pre-transformed material (e.g., powder) that remains in the material bed. The removed material may be recycled and re-applied into the source surface by the material dispensing mechanism. The pre-transformed material may be continuously recycled through the operation of the material removal system. The pre-transformed material may be recycled after each layer of material has been removed (e.g., from the source surface). The pre-transformed material may be recycled after several layers of material have been removed. The pre-transformed material may be recycled after each 3D object has been printed.

Any of the material removal mechanism described herein can comprise a reservoir of pre-transformed material and/or a mechanism configured to deliver the pre-transformed material from the reservoir to the material dispensing mechanism. The pre-transformed material in the reservoir can be treated. The treatment may include heating, cooling, maintaining a predetermined temperature, sieving, filtering, charging, or fluidizing (e.g., with a gas). The reservoir can be emptied after each pre-transformed material layer has been deposited and/or leveled, at the end of the build cycle, and/or at a whim. The reservoir can be continuously emptied during the operation of the material removal mechanism. At times, the material removal mechanism does not have a reservoir. At times, the material removal mechanism is (e.g., fluidly) connected to a reservoir. At times, the material removal mechanism constitutes a material removal (e.g., a suction) channel that leads to an external reservoir and/or to the material dispensing mechanism. The material removal and/or dispensing mechanism may comprise an internal reservoir and/or an opening port. The reservoir of the material dispensing mechanism and/or the material removal mechanism can be of any shape. For example, the reservoir can be a tube (e.g., flexible or rigid). The reservoir can be a funnel. The reservoir can have a rectangular cross section or a conical cross section. The reservoir can have an amorphous shape.

The material removal mechanism may include one or more suction nozzles. The suction nozzle may comprise any of the nozzles described herein. The nozzles may comprise of a single opening, or a multiplicity of openings as described herein. The openings may be vertically leveled or not leveled. The openings may be vertically aligned, or misaligned (e.g., FIGS. 8, 817, 818, and 819). In some examples, at least two of the multiplicity of openings may be misaligned. The multiplicity suction nozzles may be aligned at the same height relative to the surface (e.g., source surface), or at different heights (e.g., vertical height). The different height nozzles may form a pattern, or may be randomly situated in the suction device. The nozzles may be of one type, or of different types. The material removal mechanism (e.g., suction device) may comprise a curved surface, for example adjacent to a side of a nozzle (e.g., FIG. 24, 2420). Pre-transformed material that enters through the nozzle (e.g., along 2401) may be collected at the curved surface. The nozzle may comprise a cone. The cone may be a converging cone or a diverging cone.

In an example, the material removal mechanism travels laterally before the leveling mechanism (e.g., a roller) relative to the direction of movement. In an example, the material removal mechanism travels laterally after the leveling mechanism, relative to the direction of movement. The material removal mechanism may be integrated (e.g., electronically and/or mechanically) with the leveling mechanism. The material removal mechanism may be (e.g., reversibly) connected to the leveling mechanism (e.g., FIG. 25D, 2543 and 2547). The material removal mechanism may be disconnected from the leveling mechanism.

In some embodiments, the material removal mechanism and the material dispensing mechanism are integrated into one mechanism (e.g., FIG. 20C). For example, the exit opening (e.g., exit ports) of the material dispensing mechanism and the material entrance ports of the material removal mechanism may be integrated into a single mechanical component. For example, the two port types may be arranged in a single file. For example, the two port types may be interchangeably arranged. The material removal mechanism may comprise an array of material entry ports (e.g., suction devices or nozzles). The ports (e.g., material entry and/or exit ports) within the array may be spaced apart evenly or unevenly. The ports within the array may be spaced apart at most about 0.1 mm, 0.5 mm, 1 mm, 1.5 mm, 2 mm, 3 mm, 4 mm, or 5 mm. The ports within the array may be spaced apart at least about 0.1 mm, 0.3 mm, 0.5 mm, 1 mm, 1.5 mm, 2 mm, 3 mm, 4 mm, or 5 mm. The ports within the array may be spaced apart between any of the afore-mentioned spaces (e.g., from about 0.1 mm to about 5 mm, from about 0.1 mm to about 2 mm, from about 1.5 mm to about 5 mm).

In some embodiments, one or more sensors (at least one sensor) detect the topology of the exposed surface of the material bed and/or the exposed surface of the 3D object or any part thereof. The sensor can detect the amount of material deposited on the target surface. The sensor can be a proximity sensor. For example, the sensor can detect the amount of pre-transformed material deposited on the exposed surface of a material bed. The sensor can detect the physical state of material deposited on the target surface (e.g., liquid or solid (e.g., powder or bulk)). The sensor can detect the crystallinity of pre-transformed material deposited on the target surface. The sensor can detect the amount of pre-transformed material deposited by the material dispensing mechanism. The sensor can detect the amount of relocated by a leveling mechanism. The sensor can detect the temperature of the pre-transformed material. For example, the sensor may detect the temperature of the in a material dispensing mechanism, and/or in the material bed. The sensor may detect the temperature of the material during and/or after its transformation (e.g., in real-time). The sensor may detect the temperature and/or pressure of the atmosphere within an enclosure (e.g., chamber). The sensor may detect the temperature of the material (e.g., powder) bed at one or more locations. The detection by the sensor can be before, after, and/or during the 3D printing (e.g., in real-time).

In some embodiments, the at least one sensor is operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may include temperature sensor, weight sensor, material (e.g., powder) level sensor, metrology sensor, gas sensor, or humidity sensor. The metrology sensor may comprise a measurement sensor (e.g., height, length, width, angle, and/or volume). For example, the metrology sensor can be a height sensor. The metrology sensor may comprise a magnetic, acceleration, orientation, or optical sensor. The sensor may transmit and/or receive sound (e.g., echo), magnetic, electronic, or electromagnetic signal. The electromagnetic signal may comprise a visible, infrared, ultraviolet, ultrasound, radio wave, or microwave signal. The metrology sensor may measure (e.g., a metrology property of) the tile. The metrology sensor may measure the gap. The metrology sensor may measure at least a portion of the layer of material. The layer of material may be a pre-transformed material (e.g., powder), transformed material, or hardened material. The metrology sensor may measure at least a portion of the 3D object. The gas sensor may sense any of the gas delineated herein. The distance sensor can be a type of metrology sensor. The metrological sensor may be configured to depict a topology of a target surface. For example, the metrological detector may comprise a height mapper. Examples of metrological detectors, apparatuses, devices, and components (e.g., material dispensing mechanisms and material removal mechanisms), controllers, software, and 3D printing processes can be found in U.S. patent application Ser. No. 17/986,814 filed Nov. 14, 2022, titled “ACCURATE ADDITIVE MANUFACTURING,” which is incorporated herein by reference in its entirety. The distance sensor may comprise an optical sensor, or capacitance sensor. The temperature sensor can comprise Bolometer, Bimetallic strip, Calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, CCD camera). The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensors, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The weight of the material bed can be monitored by one or more weight sensors in, or adjacent to, the material. For example, a weight sensor in the material bed can be at the bottom of the material bed. The weight sensor can be between the bottom of the enclosure (e.g., FIG. 1, 111) and the substrate (e.g., FIG. 1, 109) on which the base (e.g., FIG. 1, 102) or the material bed (e.g., FIG. 1, 104) may be disposed. The weight sensor can be between the bottom of the enclosure and the base on which the material bed may be disposed. The weight sensor can be between the bottom of the enclosure and the material bed. A weight sensor can comprise a pressure sensor. The weight sensor may comprise a spring scale, a hydraulic scale, a pneumatic scale, or a balance. At least a portion of the pressure sensor can be exposed on a bottom surface of the material bed. In some cases, the weight sensor can comprise a button load cell. The button load cell can sense pressure from pre-transformed material adjacent to the load cell. In another example, one or more sensors (e.g., optical sensors or optical level sensors) can be provided adjacent to the material bed such as above, below, or to the side of the material bed. In some examples, the one or more sensors can sense the pre-transformed material level (e.g., height or volume). The pre-transformed material level sensor can be in communication with a material dispensing mechanism (e.g., powder dispenser). Alternatively, or additionally a sensor can be configured to monitor the weight of the material bed by monitoring a weight of a structure that contains the material bed. One or more position sensors (e.g., height sensors) can measure the height of the material bed relative to the substrate. The position sensors can be optical sensors. The position sensors can determine a distance between one or more energy beams (e.g., a laser or an electron beam) and a surface of the material (e.g., powder). The one or more sensors may be connected to a control system (e.g., to a processor, to a computer).

The systems and/or apparatuses disclosed herein may comprise one or more actuators. The actuator may comprise a motor. The motors may comprise servomotors. The servomotors may comprise actuated linear lead screw drive motors. The motors may comprise belt drive motors. The motors may comprise rotary encoders. The apparatuses and/or systems may comprise switches. The switches may comprise homing or limit switches. The motors may comprise actuators. The actuators may comprise linear actuators. The motors may comprise belt driven actuators. The motors may comprise lead screw driven actuators. The systems and/or apparatuses disclosed herein may comprise one or more pistons.

In some examples, the pressure system includes one or more pumps. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump, or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valveless pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump. The pump may be a vacuum pump. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector. The pressure system can include valves, such as throttle valves.

The systems, apparatuses, and/or methods described herein can comprise a material recycling mechanism. The recycling mechanism can collect unused pre-transformed material and return the unused pre-transformed material to a reservoir. The reservoir can be of a material dispensing mechanism (e.g., the material dispensing reservoir), or to the bulk reservoir that feeds into the material dispensing mechanism. Unused pre-transformed material may be material that was not used to form at least a portion of the 3D object. At least a fraction of the pre-transformed material removed from the material bed by the leveling mechanism and/or material removal mechanism can be recovered by the recycling system. At least a fraction of the material within the material bed that did not transform to subsequently form the 3D object can be recovered by the recycling system. A vacuum nozzle (e.g., which can be located at an edge of the material bed) can collect unused pre-transformed material. Unused pre-transformed material can be removed from the material bed without vacuum. Unused pre-transformed (e.g., powder) material can be removed from the material bed manually. Unused pre-transformed material can be removed from the material bed by positive pressure (e.g., by blowing away the unused material). Unused pre-transformed material can be removed from the material bed by actively pushing it from the material bed (e.g., mechanically or using a positive pressurized gas). Unused pre-transformed material can be removed from the material bed by the material removal mechanism. Unused pre-transformed material can be removed from the material bed by utilizing the force source. A gas flow can direct unused pre-transformed material to the vacuum nozzle. A material collecting mechanism (e.g., a shovel) can direct unused material to exit the material bed (and optionally enter the recycling mechanism). The recycling mechanism can comprise one or more filters to control a size range of the particles returned to the reservoir. In some cases, a Venturi scavenging nozzle can collect unused material. The nozzle can have a high aspect ratio (e.g., at least about 2:1, 5:1, 10:1, 20:1, 30:1, 40:1, or 100:1) such that the nozzle does not become clogged with material particle(s). In some embodiments, the material may be collected by a drainage mechanism through one or more drainage ports that drain material from the material bed into one or more drainage reservoirs. The material in the one or more drainage reservoirs may be re used (e.g., after filtration and/or further treatment).

In some cases, unused material can surround the 3D object in the material bed. The unused material can be (e.g., substantially) removed from the 3D object. In some embodiments, the unused material is removed from the 3D object in the environment (e.g., atmosphere and/or enclosure) in which the 3D object is printed. In some embodiments, the unused material is removed from the 3D object in a different environment (e.g., atmosphere and/or enclosure) from the one in which the 3D object is printed. The unused material is referred herein as the “remainder.” Substantial removal may refer to material covering at most about 20%, 15%, 10%, 8%, 6%, 4%, 2%, 1%, 0.5%, or 0.1% of the surface of the 3D object after removal. Substantial removal may refer to removal of all the material that was disposed in the material bed and remained as material at the end of the 3D printing process (referred to here as the “remainder”), except for at most about 10%, 3%, 1%, 0.3%, or 0.1% of the weight of the remainder. Substantial removal may refer to removal of all the remainder except for at most abbot 50%, 10%, 3%, 1%, 0.3%, or 0.1% of the weight of the printed 3D object. The unused material can be removed to permit retrieval of the 3D object without digging through the material bed. For example, the unused material can be suctioned out of the material bed by one or more vacuum ports (e.g., nozzles) built adjacent to the material bed, by brushing off the remainder of unused material, by lifting the 3D object from the unused material, by allowing the unused material to flow away from the 3D object (e.g., by opening an exit opening (e.g., exit port) on the side(s) or on the bottom of the material bed from which the unused material can exit). After the unused material is evacuated, the 3D object can be removed, and the unused material can be re-circulated to a material reservoir for use in future builds. Unused material can be removed from the 3D object by system and apparatuses to clean a 3D object. Examples for cleaning system, 3D printers, related control system, related methods, apparatuses, systems, and program instructions (e.g., software), can be found in International Patent Application Serial No. in U.S. patent application Ser. No. 15/374,318, International Patent Application Serial No. filed Dec. 9, 2016; PCT/US16/66000 filed Dec. 9, 2016; and in International Patent Application Serial No. PCT/US15/36802 filed Jun. 19, 2015; each of which is entirely incorporated herein by reference.

In some embodiments, the final form of the 3D object is retrieved soon after cooling of a final material layer. Soon after cooling may be at most about 1 day, 12 hours (h), 6 h, 5 h, 4 h, 3 h, 2 h, 1 h, 30 minutes, 15 minutes, 5 minutes, 240 s, 220 s, 200 s, 180 s, 160 s, 140 s, 120 s, 100 s, 80 s, 60 s, 40 s, 20 s, 10 s, 9 s, 8 s, 7 s, 6 s, 5 s, 4 s, 3 s, 2 s, or 1 s. Soon after cooling may be between any of the afore-mentioned time values (e.g., from about is to about 1 day, from about is to about 1 hour, from about 30 minutes to about 1 day, or from about 20 s to about 240 s). In some cases, the cooling can occur by method comprising active cooling by convection using a cooled gas or gas mixture comprising argon, nitrogen, helium, neon, krypton, xenon, hydrogen, carbon monoxide, carbon dioxide, or oxygen. Cooling may be cooling to a temperature that allows a person to handle the 3D object. Cooling may be cooling to a handling temperature. The 3D object can be retrieved during a time-period between any of the afore-mentioned time-periods (e.g., from about 12 h to about Is, from about 12 h to about 30 min, from about 1 h to about 1 s, or from about 30 min to about 40 s).

In some embodiments, the generated 3D object requires very little or no further processing after its retrieval. In some examples, the diminished further processing or lack thereof, will afford a 3D printing process that requires smaller amount of energy and/or less waste as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the afore-mentioned values (e.g., from about 1.1 to about 10, or from about 1.5 to about 5). Further processing may comprise trimming, as disclosed herein. Further processing may comprise polishing (e.g., sanding). For example, in some cases the generated 3D object can be retrieved and finalized without removal of transformed material and/or auxiliary features. The 3D object can be retrieved when the three-dimensional part, composed of hardened (e.g., solidified) material, is at a handling temperature that is suitable to permit the removal of the 3D object from the material bed without substantial deformation. The handling temperature can be a temperature that is suitable for packaging of the 3D object. The handling temperature a can be at most about 120° C., 100° C., 80° C., 60° C., 40° C., 30° C., 25° C., or 20° C. The handling temperature can be of any value between the afore-mentioned temperature values (e.g., from about 120° C. to about 20° C.).

The methods and systems provided herein can result in fast and efficient formation of 3D objects. In some cases, the 3D object can be transported at a rate of at least about 0.1 centimeters squared per second (cm²/sec), 0.5 cm²/sec, 1.0 cm²/sec, 1.5 cm²/sec, 2.0 cm²/sec, 2.5 cm²/sec, 5 cm²/sec, 10 cm²/sec, 15 cm²/sec, 20 cm²/sec, 30 cm²/sec, 50 cm²/sec, 70 cm²/sec, 80 cm²/sec, 90 cm²/sec, 100 cm²/sec, or 120 cm²/sec. In some cases, the 3D object is transported at a rate that is between the above-mentioned rates (e.g., from about 0.1 cm²/sec to about 120 cm²/sec, from about 1.5 cm²/sec to about 80 cm²/sec, or from about 1.0 cm²/sec to about 100 cm²/sec). In some examples, the 3D part has the herein stated accuracy value immediately after its formation, without additional processing and/or manipulation.

In some embodiments, one or more 3D object (e.g., a stock of 3D objects) are supplied to a customer. A customer can be an individual, a corporation, organization, government, non-profit organization, company, hospital, medical practitioner, engineer, retailer, any other entity, or individual. The customer may be one that is interested in receiving the 3D object and/or that ordered the 3D object. A customer can submit a request for formation of a 3D object. The customer can provide an item of value in exchange for the 3D object. The customer can provide a design or a model for the 3D object. The customer can provide the design in the form of a stereo lithography (STL) file. The customer can provide a design where the design can be a definition of the shape and dimensions of the 3D object in any other numerical or physical form. In some cases, the customer can provide a 3D model, sketch, or image as a design of an object to be generated. The design can be transformed into instructions usable by the printing system to additively generate the 3D object. The customer can provide a request to form the 3D object from a specific material or group of materials (e.g., a material as described herein). In some cases, the design may not contain auxiliary features or marks of any past presence of auxiliary support features.

In an embodiment, in response to the customer request the 3D object is formed with the printing method, system and/or apparatus described herein, using one or more materials as specified by the customer. The 3D object can subsequently be delivered to the customer. The 3D object can be formed without generation or removal of auxiliary features (e.g., that is indicative of a presence or removal of the auxiliary support feature). Auxiliary features can be support features that prevent a 3D object from shifting, deforming or moving during the 3D printing.

In some instances, the intended dimensions of the 3D object derive from a model design of the 3D object. The 3D object (e.g., solidified material) that is generated for the customer can have an average deviation value from the intended dimensions of at most about 0.5 microns (m), 1 m, 3 m, 10 m, 30 m, 100 m, 300 m, or less. The deviation can be any value between the afore-mentioned values (e.g., from about 0.5 m to about 300 μm, from about 10 m to about 50 μm, from about 15 m to about 85 μm, from about 5 m to about 45 μm, or from about 15 m to about 35 m). The 3D object can have a deviation from the intended dimensions in a specific direction, according to the formula Dv+L/K_{Dv}, wherein Dv is a deviation value, L is the length of the 3D object in a specific direction, and K_{Dv} is a constant. Dv can have a value of at most about 300 μm, 200 μm, 100 μm, 50 μm, 40 μm, 30 μm, 20 μm, 10 μm, 5 μm, 1 μm, or 0.5 μm. Dv can have a value of at least about 0.5 μm, 1 μm, 3 μm, 5 μm, 10 μm, 20 μm, 30 μm, 50 μm, 70 μm, 100 μm, or 300 μm. Dv can have any value between the afore-mentioned values (e.g., from about 0.5 μm to about 300 μm, from about 10 m to about 50 μm, from about 15 m to about 85 μm, from about 5 m to about 45 μm, or from about 15 m to about 35 m). K_{dv} can have a value of at most about 3000, 2500, 2000, 1500, 1000, or 500. K_{dv} can have a value of at least about 500, 1000, 1500, 2000, 2500, or 3000. K_{dv} can have any value between the afore-mentioned values (e.g., from about 3000 to about 500, from about 1000 to about 2500, from about 500 to about 2000, from about 1000 to about 3000, or from about 1000 to about 2500).

The system and/or apparatus can comprise a controlling mechanism (e.g., a controller). The methods, systems, and/or apparatuses disclosed herein may incorporate a controller mechanism that controls one or more of the components of the 3D printer described herein. The controller may comprise a computer-processing unit (e.g., a computer) coupled to any of the systems and/or apparatuses, or their respective components (e.g., the energy source(s)). The computer can be operatively coupled through a wired and/or through a wireless connection. In some cases, the computer can be on board a user device. A user device can be a laptop computer, desktop computer, tablet, smartphone, or another computing device. The controller can be in communication with a cloud computer system and/or a server. The controller can be programmed to selectively direct the energy source(s) to apply energy to the at least a portion of the target surface at a power per unit area. The controller can be in communication with the scanner configured to articulate the energy source(s) to apply energy to at least a portion of the target surface at a power per unit area.

The controller may control the layer dispensing mechanism and/or any of its components. The controller may control the platform. The control may comprise controlling (e.g., directing and/or regulating) the speed (velocity) of movement. The movement may be horizontal, vertical, and/or in an angle. The controller may control the level of pressure (e.g., vacuum, ambient, or positive pressure) in the material removal mechanism material dispensing mechanism, and/or the enclosure (e.g., chamber). The pressure level (e.g., vacuum, ambient, or positive pressure) may be constant or varied. The pressure level may be turned on and off manually and/or by the controller. The controller may control the force generating mechanism. For example, the controller may control the amount of magnetic, electrical, pneumatic, and/or physical force generated by force generating mechanism. For example, the controller may control the polarity type of magnetic, and/or electrical charge generated by the force generating mechanism. The controller may control the timing and the frequency at which the force is generated. The controller may control the direction and/or rate of movement of the translating mechanism. The controller may control the cooling member (e.g., external and/or internal). In some embodiments, the external cooling member may be translatable. The movement of the layer dispensing mechanism or any of its components may be predetermined. The movement of the layer dispensing mechanism or any of its components may be according to an algorithm. The control may be manual and/or automatic. The control may be programmed and/or be effectuated a whim. The control may be according to an algorithm. The algorithm may comprise a printing algorithm, or motion control algorithm. The algorithm may consider the model of the 3D object.

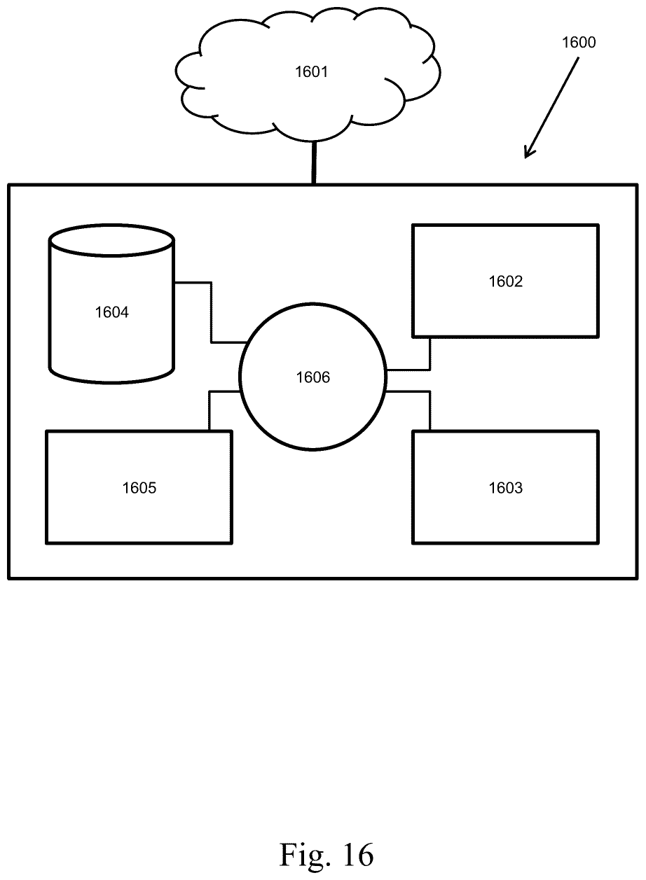

The controller may comprise a processing unit. The processing unit may be central. The processing unit may comprise a central processing unit (herein “CPU”). The controllers or control mechanisms (e.g., comprising a computer system) may be programmed to implement methods of the disclosure. The controller may control at least one component of the systems and/or apparatuses disclosed herein. FIG. 16 is a schematic example of a computer system 1600 that is programmed or otherwise configured to facilitate the formation of a 3D object per the methods provided herein. The computer system 1600 can control (e.g., direct and/or regulate) various features of printing methods, apparatuses and systems of the present disclosure, such as, for example, regulating force, translation, heating, cooling and/or maintaining the temperature of a powder bed, process parameters (e.g., chamber pressure), scanning route of the energy source, position and/or temperature of the cooling member(s), application of the amount of energy emitted to a selected location, or any combination thereof. The computer system 1601 can be part of, or be in communication with, a printing system or apparatus, such as a 3D printing system or apparatus of the present disclosure. The computer may be coupled to one or more mechanisms disclosed herein, and/or any parts thereof. For example, the computer may be coupled to one or more sensors, valves, switches, motors, pumps, or any combination thereof.

Control may comprise regulate, monitor, restrict, limit, govern, restrain, supervise, direct, guide, manipulate, or modulate. The controller can be operatively coupled to one or more of the apparatuses, system and/or their parts as disclosed herein. Examples of 3D printers, related control system, related methods, apparatuses, systems, and program instructions (e.g., software), can be found in U.S. patent application Ser. No. 15/435,078, filed Feb. 16, 2017; International patent application Ser. No. PCT/US17/18191, filed Feb. 16, 2017; U.S. patent application Ser. No. 15/339,712, filed Oct. 31, 2016; and International patent application Ser. No. PCT/US16/59781, filed Oct. 31, 2016; each of which is entirely incorporated herein by reference.

The computer system 1600 can include a processing unit 1606 (also “processor,” “computer” and “computer processor” used herein). The computer system may include memory or memory location 1602 (e.g., random-access memory, read-only memory, flash memory), electronic storage unit 1604 (e.g., hard disk), communication interface 1603 (e.g., network adapter) for communicating with one or more other systems, and peripheral devices 1605, such as cache, other memory, data storage and/or electronic display adapters. The memory 1602, storage unit 1604, interface 1603, and peripheral devices 1605 are in communication with the processing unit 1606 through a communication bus (solid lines), such as a motherboard. The storage unit can be a data storage unit (or data repository) for storing data. The computer system can be operatively coupled to a computer network (“network”) 1601 with the aid of the communication interface. The network can be the Internet, an Internet and/or extranet, or an intranet and/or extranet that is in communication with the Internet. The network in some cases is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 1602. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 1600 can be included in the circuit.

The storage unit 1604 can store files, such as drivers, libraries and saved programs. The storage unit can store user data, e.g., user preferences and user programs. The computer system in some cases can include one or more additional data storage units that are external to the computer system, such as located on a remote server that is in communication with the computer system through an intranet or the Internet.

The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

Methods as described herein can be implemented by way of machine (e.g., computer processor) executable code stored on an electronic storage location of the computer system, such as, for example, on the memory 1602 or electronic storage unit 1604. The machine executable or machine-readable code can be provided in the form of software. During use, the processor 1606 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code, or can be compiled during runtime. The code can be supplied in a programming language that can be selected to enable the code to execute in a pre-compiled or as-compiled fashion.

The processing unit may include one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The integrated circuit chip may comprise at least 0.2 billion transistors (BT), 0.5 BT, 1 BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The multiplicity of cores can be parallel cores. The multiplicity of cores can function in parallel. The multiplicity of cores may include at least 2, 10, 40, 100, 400, 1000, 2000, 3000, 4000, 5000, 6000, 7000, 8000, 9000, or 10000 cores. The multiplicity of cores may include at most 1000, 2000, 3000, 4000, 5000, 6000, 7000, 8000, 9000, 10000, or 40000 cores. The multiplicity of cores may include cores of any number between the afore-mentioned numbers (e.g., from 2 to 40000, from 2 to 400, from 400 to 4000, from 2000 to 4000, or from 4000 to 10000 cores). The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating-point operations per second (FLOPS). The number of FLOPS may be at least about 1 Tera Flops (T-FLOPS), 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 5 T-FLOPS, 6 T-FLOPS, 7 T-FLOPS, 8 T-FLOPS, 9 T-FLOPS, 10 T-FLOPS, 20 T-FLOPS, or 30 T-FLOPS. The number of FLOPS may be any value between the afore-mentioned values (e.g., from about 1 T-FLOP to about 30 T-FLOP, from about 4 T-FLOPS to about 10 T-FLOPS, from about 1 T-FLOPS to about 10 T-FLOPS, or from about 10 T-FLOPS to about 30 T-FLOPS. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK refers to a software library for performing numerical linear algebra on a digital computer. DGEMM refers to double precision general matrix multiplication. STREAM. PTRANS. MPI refers to Message Passing Interface.

The computer system may include hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

The computer system may include an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

The computer system may include configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration.

The computing system may include an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most 0.1 microsecond (μs), 1 μs, 10 μs, 100 μs, or 1 millisecond (msec). The physical unit may produce the algorithm output in any time between the above-mentioned times (e.g., from about 0.1 μs, to about 1 msec, from about 0.1 μs, to about 100 μs, or from about 0.1 μs to about 10 μs). In some instances, the controller may use calculations, real time measurements, or any combination thereof to regulate the energy beam(s). In some instances, the real-time measurements (e.g., temperature measurements) may provide input at a rate of at least about 0.1 KHz, 1 KHz, 10 KHz, 100 KHz, 1000 KHz, or 10000 KHz). In some instances, the real-time measurements may provide input at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processing unit may be at least about 1 gigabyte per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may be at most about 1 gigabyte per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s).

Aspects of the systems, apparatuses, and/or methods provided herein, such as the computer system, can be embodied in programming. Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

The memory may comprise a random-access memory (RAM), dynamic random-access memory (DRAM), static random-access memory (SRAM), synchronous dynamic random-access memory (SDRAM), ferroelectric random-access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. The memory and/or storage may comprise a storing device external to and/or removable from device, such as a Universal Serial Bus (USB) memory stick, or a hard disk. Many of these forms of computer readable media may be involved in carrying one or more sequences of one or more instructions to a processor for execution.

The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms that have been pre-programmed. The feedback mechanisms may rely on input from sensors (described herein) that are connected to the control unit (e.g., control system or control mechanism e.g., computer). The computer system may store historical data concerning various aspects of the operation of the 3D printing system. The historical data may be retrieved at predetermined times and/or at a whim. The historical data may be accessed by an operator and/or by a user. The historical and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output the amount of oxygen, water, and pressure in the printing chamber (e.g., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

The system and/or apparatus described herein (e.g., controller) and/or any of their components may comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen. The system and/or apparatus described herein (e.g., controller) and/or any of their components may comprise Bluetooth technology. The system and/or apparatus described herein (e.g., controller) and/or any of their components may comprise a communication port. The communication port may be a serial port or a parallel port. The communication port may be a Universal Serial Bus port (USB). The system and/or apparatus described herein (e.g., controller) and/or any of their components may comprise USB ports. The USB can be a micro or a mini USB. The USB port may relate to device classes comprising 00 h, 01 h, 02 h, 03 h, 05 h, 06 h, 07 h, 08 h, 09 h, 0 Ah, 0 Bh, 0 Dh, 0 Eh, 0 Fh, 10 h, 11 h, DCh, E0 h, EFh, FEh, or FFh. The system and/or apparatus described herein (e.g., controller) and/or any of their components may comprise a plug and/or a socket (e.g., electrical, AC power, DC power). The system and/or apparatus described herein (e.g., controller) and/or any of their components may comprise an adapter (e.g., AC and/or DC power adapter). The system and/or apparatus described herein (e.g., controller) and/or any of their components may comprise a power connector. The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

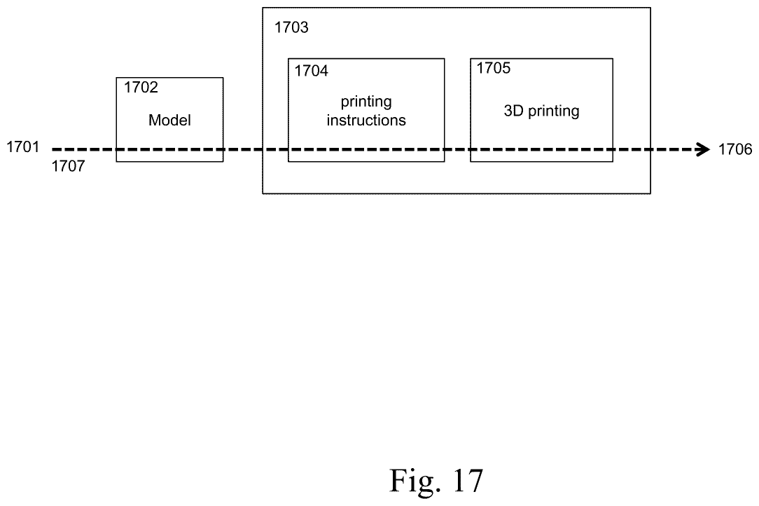

The systems, methods, and/or apparatuses disclosed herein may comprise receiving a request for a 3D object (e.g., from a customer). The request can include a model (e.g., CAD) of the requested 3D object. Alternatively or additionally, a model of the requested 3D object may be generated. The model may be used to generate 3D printing instructions. The 3D printing instructions may exclude the 3D model. The 3D printing instructions may be based on the 3D model. The 3D printing instructions may take the 3D model into account. The 3D printing instructions may be based on simulations. The 3D printing instructions may use the 3D model. The 3D printing instructions may comprise using an algorithm (e.g., embedded in a software) that considers the 3D model. The algorithm may consider a deviation from the model. The deviation may be a corrective deviation. The corrective deviation may be such that at least a portion of the 3D object is printed as a deviation from the 3D model, and upon hardening, the at least a portion of the 3D object (and/or the entire 3D object) will not (e.g., substantially) deviate from the model of the requested 3D object. The printing instructions may be used to print the requested 3D object. The printed 3D object may (e.g., substantially) correspond to the requested 3D object. In some embodiments, the algorithm used to form the 3D printing instructions excludes a feedback control loop (e.g., closed loop). 3D printing instructions may exclude considering metrology measurements of the generated 3D object (e.g., measurements of the 3D object) or parts thereof. In some embodiments, the 3D printing instructions may comprise an open loop control. The algorithm may use historical (e.g., empirical) data. The empirical data may be of characteristic structures (e.g., that are included in the requested 3D object). The characteristic structures may be (e.g., substantially) similar at least portions of the 3D object. The empirical data may be previously obtained. In some embodiments, the algorithm may use a theoretical model. The algorithm may use a model of energy flow (e.g., heat flow). The generation of the 3D object using an altered model may exclude an iterative process. The generation of the 3D object may not involve an alteration of the 3D model (e.g., CAD), but rather generate a new set of 3D printing instructions. In some embodiments, the algorithm is used to alter instructions received by at least one of the components involved in the 3D printing process (e.g., energy beam). In some embodiments, the algorithm does not alter the 3D model. The algorithm may comprise a generic approach to printing a requested 3D object or portions thereof. In some embodiments, the algorithm is not based on altering 3D printing instructions that are based on printing the requested 3D object, measuring errors in the printed 3D object, and revising the printing instructions. In some embodiments, the algorithm is not based on an iterative process that considers the requested and printed 3D object (e.g., in real-time). The algorithm may be based on an estimation of one or more errors during the printing of the requested 3D object. The algorithm may be based on correct the estimated errors through the generation of respective 3D printing instructions that considers the anticipated errors. In this manner, the algorithm may circumvent the generation of the errors. The algorithm may be based on an estimation of one or more errors during the printing of the requested 3D object, and correcting them through the generation of respective 3D printing instructions that considers the anticipated errors and thus circumvent the generation of the errors. The error may comprise the deviation from the model of the requested 3D object. The estimation may be based on simulation, modeling, and/or historical data (e.g., of representative structures or structure segments). FIG. 17 shows an example of a flow chart representing the 3D printing process operations that are executed by a 3D printing system and/or apparatus described herein. The requested 3D object is requested in operation 1701. A 3D model is provided or generated in operation 1702. Operation 1704 illustrates the generation of printing instructions for the 3D object, in which both the model and the algorithm are utilized. The 3D object is subsequently generated using the printing instructions in operation 1705. The requested 3D object is delivered in operation 1706. Arrow 1707 designates the direction of the execution of the operations from operation 1701 to operation 1706. The absence of back feeding arrow represents the lack of feedback loop control.

At times, the material removal mechanism experiences disadvantaged conditions. For example, material (e.g., powder) attracted into the cavity of the material removal mechanism and channels leading away from the cavity, may accumulate in the cavity and in the channels, e.g., due to lower gas velocities in the cavity and connected channels (e.g., pipes). Such accumulation of material may necessitate its removal (e.g., during a maintenance operation). This may lead to an increase in time required to form an added planar layer to the material bed.

In some embodiments, the material removal mechanism comprises an elongated material entrance opening channel, and an internal compartment having a tapered internal cavity, e.g., having diminished volume along the elongated material entrance port. The material removal mechanism may be configured to attract (e.g., vacuum) a remainder of material (e.g., powder) dispensed to form a material bed. The material removal mechanism may be mounted to a mount. The mount may comprise triangular supports. The material removal mechanism may be a part of a layer dispensing mechanism (e.g., a recoater). The cavity may have an exit opening (e.g., exit port) (e.g., a hole) through which attracted material exits the cavity. The exit opening (e.g., exit port) may be on a side of the cavity, or along the long axis of the cavity. The cavity may have a long axis having a first end and an opposing second end. The exit opening may be close, or at, the first end of the cavity. The tapered cavity can be linearly or non-linearly tapered. The tapered cavity can be evenly or non-evenly tapered. In some embodiments, the material removal mechanism is configured to ease of manufacture, assembly, and/or functional optimization. The material removal mechanism may be formed from one integral portion, two integral portion, three integral portion, or more integral portion. Each integral portion may be a single piece of material (e.g., comprising elemental metal, metal alloy, ceramic, or an allotrope of elemental carbon). The integral piece may be molded, machined, or 3D printed. The integral portion may facilitate one or more functionalities of the material removal mechanism. For example, the integral portion may comprise a portion of an internal cavity and a portion of a nozzle. For example, the integral portion may comprise a portion of an internal cavity, a portion of a nozzle, and at least a portion of a mounting piece (e.g., a mount). A sealant may be disposed in at least one of the integral portions to facilitate tight connection and/or hinder spillage of material attracted through the material removal mechanism (e.g., through the nozzle, cavity, and material exit port). The seal may comprise a flexible material. The seal may comprise a solid-to-solid tight seal. At least two of the portions of the material removal mechanism may be coupled using one or more fasteners (e.g., screws or clips).

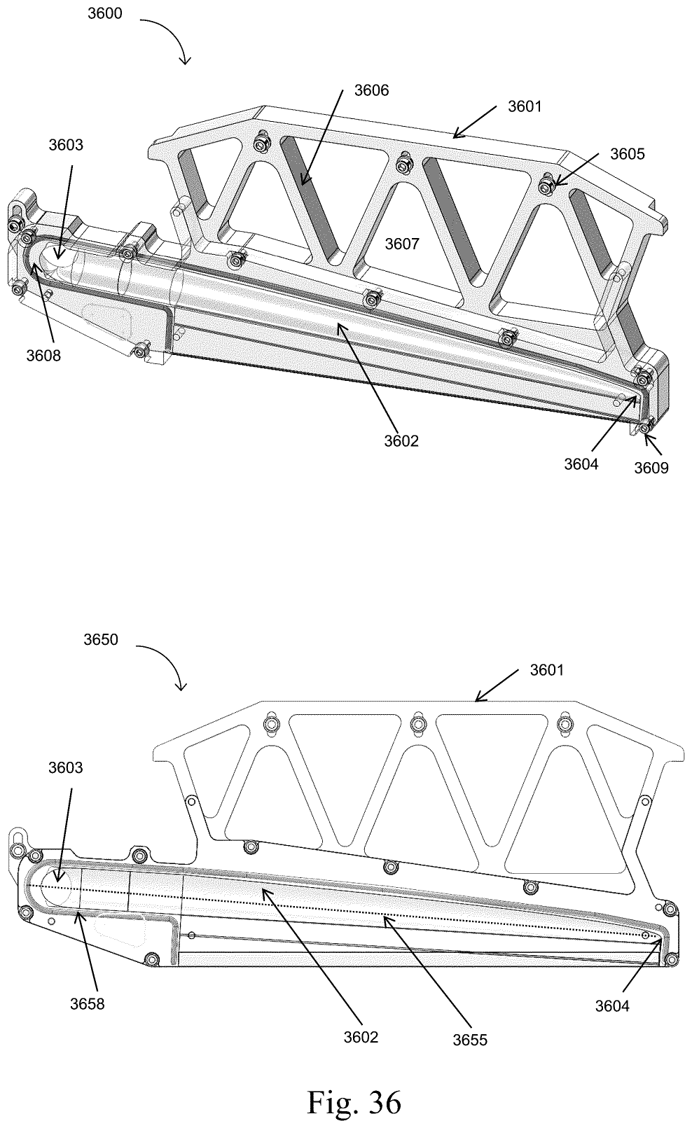

FIG. 36 depicts in 3600 a perspective vertical cross-sectional view of a cavity 3602 of a material removal mechanism, which cavity 3602 is tapered towards a first end 3604. The cavity has a second opposing end 3608 and an exit opening (e.g., exit port) 3603 close to the second opposing end. Exit opening 3603 is disposed along a long axis of the cavity. The material removal mechanism having cavity 3602, is mounted to mount 3602 using fasteners (screws) such as 3605. The mount comprises supporting beams such as 3606 arranged as sides of triangles forming triangular open spaces such as 3607. FIG. 36 depicts in 3650 a side vertical cross-sectional view of cavity 3602 showing exit opening 3603 and first end 3604 of tapered cavity 3602 having long axis 3655. In some embodiments, the mount is part of, or is operatively coupled to, at least one portion of the cavity of the material removal mechanism. In some embodiments, the material removal mechanism comprises three portions: a mount, a first half of a cavity and nozzle portion, and a second half of a cavity and nozzle portion. FIG. 36 shown in 3600 and in 3600 a mount coupled with fasteners (e.g., screws) to one half of the cavity and nozzle portion. In some embodiments, half of the cavity and half of the nozzle form one integral piece. The two halves of the integrated half-cavity and half-nozzle can be coupled together using fasteners (e.g., screws such as 3609). A sealant (e.g., flexible material) is disposed at one of the halves of the integral half-cavity and half-nozzle, e.g., to hinder any leakage of material attracted through the cavity. FIG. 36 shows an example of a sealant in 3658.

At times, a temperature of the material attracted by the recoater from the material bed changes during a material removal operation, e.g., as the material removal mechanism translates along the material bed and removes excess of material (e.g., powder) to facilitate a planar exposed surface of the material bed (e.g., for usage in a 3D printing process). At times, various portions of the exposed surface of a material bed have different temperatures. The material attracted, or to be attracted, by the material removal mechanism may be susceptible to temperature changes. The material attracted, or to be attracted, by the material removal mechanism may be susceptible to low humidity. For example, the material may exhibit tacky properties that are temperature and/or humidity dependent. The tacky properties may comprise the material clamping up, or aggregating. For example, when the material comprises particulate matter (e.g., powder), the powder may aggregate at certain temperature and/or humidity conditions, for example, high temperature and/or low humidity. Without wishing to be bound to theory, the aggregation in low humidity conditions may be due to static electricity. At times, using the same attractive force causes various amounts of material (of the same type) to be attracted (e.g., vacuumed) by the material removal mechanism. Without wishing to be bound to theory, this may be due to temperature dependency of tackiness (e.g., agglomeration and/or adhesion) of the material. For example, there may be a tendency to attract (e.g., vacuum) a different amount of material (e.g., powder) over hotter portion of the material bed as compared to over a cooler portion of the material bed, while using the same amount of attractive force. The different amount may be larger or smaller. A change in the geometry of the entrance opening (e.g., opening port) of the nozzle may facilitate and/or promote better performance of the material removal mechanism. The better performance may be better by at least about 5%, 10%, 20%, 30%, 50%, or 80%. The better performance may include lower variability between material removal cycles of the material removal mechanism. The better performance may include higher consistency regarding the rate of material removal between material removal cycles of the material removal mechanism. The better performance may include an even attraction of the material that (i) has reduce dependency on the temperature of the attracted, or to be attracted, material and/or (ii) attracts amount of material having lower variability between attraction cycles. An attraction cycle refers to removal of excess material from an exposed surface of a material be to forma planar exposed surface (e.g., single sweep of the material bed surface by the material removal mechanism). The change in geometry may comprise at least one bend (e.g., angled and/or curved) in the nozzle opening channel within the nozzle body. The change of geometry may form a nozzle entry channel that resembles a scooper, or a shovel.

In some embodiments, the nozzle is formed of a body having a nozzle channel and an internal cavity. The nozzle body may comprise sections (e.g., sides) that upon construction form the nozzle cavity. The nozzle body may comprise any material disclosed herein. For example, the nozzle body may comprise an elemental metal, a metal alloy, a ceramic, or an allotrope of elemental carbon. The nozzle may comprise a coating, e.g., that is resilient to abrasion of (e.g., pre-transformed) material traveling through the nozzle during its operation. The pre-transformed material may comprise powder. The pre-transformed material may comprise a starting material, a remainder, or debris, relating to three-dimensional printing process. For example, the pre-transformed material may comprise an elemental metal, a metal alloy, a ceramic, or an allotrope of elemental carbon. For example, the pre-transformed material may comprise metallic powder. The coating may be an anodized coating. The coating may comprise a durable metallic coating that is harder, stiffer, and/or more resilient, than the interior body of the nozzle body. More resilient is to friction of the surface by the pre-transformed material during operation. The interior may be of aluminum, and the coating may comprise chromium, nickel, alumina, or anodized aluminum.

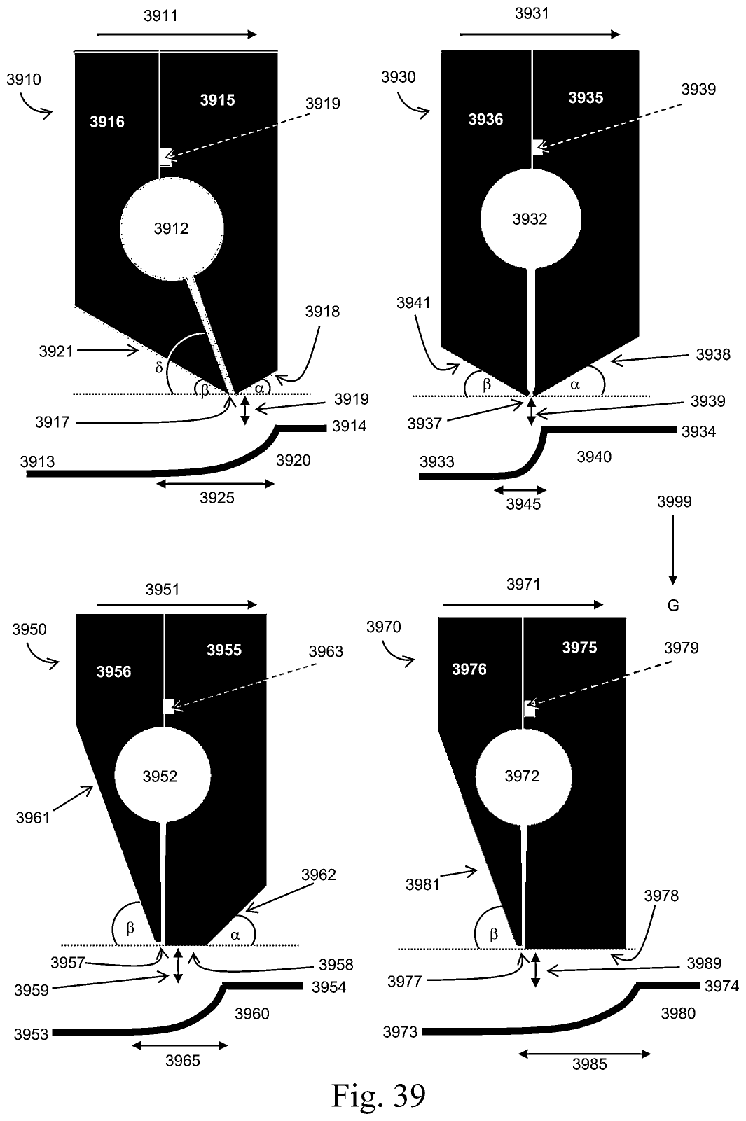

At times, a shape of the nozzle in the vicinity of its tip determines (i) the migration path of the material from the material bed into the nozzle cavity, (ii) a central tendency of planarity of the exposed surface, (iii) a reduction extend of the exposed surface after operation of the material removal, (iv) flowability or the removal material during its removal, or (v) any combination thereof. For example, the width of the nozzle channel may determine the velocity of the substance being attracted in the external vicinity of the nozzle through the nozzle channel during removal operation, the substance comprising a gas or a material forming the material bed. For example, the width of the nozzle channel may determine the velocity of the substance being attracted (i) through the nozzle channel, and/or (ii) in the external vicinity of the nozzle, during removal operation. For example, the width of the nozzle channel may determine the velocity of the gas and powder being attracted (i) through the nozzle channel, and/or (ii) in the external vicinity of the nozzle, during removal operation. At times, higher velocity of substance is required to have the substance enter the nozzle, as compared to a velocity required to maneuver the substance within the channel: from the entrance opening of the nozzle through the nozzle channel, to the exit opening of the nozzle and into the internal cavity. In some embodiments, the nozzle may be configured to slow the velocity of the attracted substance after it enters the nozzle channel. Without wishing to be bound to theory, a nozzle channel having a narrow entrance opening (e.g., tip) that abruptly expands internally (e.g., as in the example of FIG. 39, 3930) may cause the attracted substance to slow down after entry, while still being attracted into an internal cavity. In some embodiments, a FLS (e.g., width) of the nozzle entrance opening (e.g., tip) is at most about 0.5 mm, 0.75 mm, 1.0 mm, 1.25 mm, or 1.5 mm. In some embodiments, a FLS (e.g., width) of the exit opening of the nozzle is of at least about 1.5 mm, 1.75 mm, 2.0 mm, 2.25 mm, or 2.5 mm, with the exit opening of the nozzle being where the material exits the nozzle channel and enters the internal cavity of the nozzle. At times, an aspect ratio of respective FLSs (e.g., widths) of the nozzle entrance opening (being kept 1) and exit opening is of at least about 1:1.25, 1:1.5, 1:1.75, 1:2, 1:2.25, 1:2.5, 1:2.75, or 1:3. A pressure differential may be generated by the attractive force source (e.g., vacuum pump). The pressure differential may be any of the ones disclosed herein, e.g., between 15 KPa and 30 KPa. The force source may cause a flow of material into the nozzle channel by any rate disclosed herein, e.g., from about 3 milliliters per second to about 9 milliliters per second, the volume pertaining to the volume of pre-transformed material removed from the material bed. A slower velocity of the substance (e.g., powder) traveling inside the nozzle channel may ease the burden on the attractive force source (e.g., vacuum pump), and/or reduce erosion of the nozzle channel walls due to friction of the channel walls with the substance. At times, the material in the material bed (e.g., including in the exposed surface of the material bed) is harder to maneuver with an attractive force as compared to material that has already been separated from the material bed (e.g., and became gas borne). At times, during removal debris is being removed along with pre-transformed material of the material bed. The debris may comprise soot, spatter, or splatter. The debris may comprise by product of the 3D printing. The debris may be settling on the exposed surface during a 3D printing process. The planarizing may form a (e.g., substantially) planar exposed surface of the material bed having a central tendency of planarity. The planar exposed surface may be planar within a height error of at most about 500 micrometers, 300 micrometers, 200 micrometers, 150 micrometers, 100 micrometers, 50 micrometers, 30 micrometers, or 20 micrometers. The planar exposed surface may be planar within a height error range between any of the above mentioned values (e.g., from about 500 μm to about 20 μm, from about 150 μm to about 20 μm, or from about 50 μm to about 20 μm). For example, the planarizing may form a (e.g., substantially) planar exposed surface of the material bed within a height error of at most about 200 μm. The layer dispensing mechanism may achieve a deviation from a planar uniformity of the exposed layer of the material bed (e.g., horizontal plane) of any value (e.g., percentage, or scale value) disclosed herein.

In some embodiments, the material removal mechanism comprises nozzle body two sides separated to form a nozzle channel. The nozzle channel is configured to facilitate removal of material from a material bed through the nozzle channel and into a cavity of the material removal mechanism, e.g., when the cavity is coupled to an operating attractive force source (e.g., as disclosed herein). The formed nozzle channel may be symmetric or asymmetric. The formed nozzle channel may or may not comprise a curvature, e.g., the nozzle channel may be straight devoid of a curvature. The curvature may be configured to facilitate a scooping motion of the material as it is attracted into the nozzle channel from the exposed surface and into the cavity. For example, during the removal operation, the nozzle channel may comprise a concave shape that tilts away and/or caves away, relative to the direction of movements (e.g., bends away from the direction of movement). The two sides may or may not be symmetric with respect to the channel, with respect to the direction of suction of the material from the exposed surface into the internal compartment of the nozzle channel during operation of the nozzle channel, and/or with respect to the gravitational vector pointing towards the gravitational center of the environment (e.g., Earth). For example, one side may be thicker (e.g., more volumes) than the other. For example, one side may have a larger external surface area than the other. In some embodiments, the nozzle channel sides have external surfaces facing the material bed that (i) are different in cross section, (ii) are different in surface area, (iii) have different angle values with respect to the exposed surface of the material bed, (iii) have different angle directions with respect to the exposed surface of the material bed, (iv) have a curved surface, (v) have a non-curved surface, (vi) have a sharp edge, (v) have a curved edge, or (vi) any combination thereof. In some embodiments, the nozzle sides have external surfaces facing the material bed that do not have (i) different in cross section, (ii) different in surface area, (iii) different angle values with respect to the exposed surface of the material bed, (iii) different angle directions with respect to the exposed surface of the material bed, (iv) a curved surface, (v) a non-curved surface, (vi) a sharp edge, (v) a curved edge, or (vi) any combination thereof. The formed channel may be consistent in width or have a varied width. For example, the channel may expend (i) abruptly and/or (ii) continuously from the direction from the channel tip towards the internal cavity of the nozzle. For example, the channel may adopt a vertical cross section resembling a triangle having its head pointing toward the exposed surface of the material bed. A vertical cross section of the nozzle channel may have a shape of a trapezoid or of a vertical cross section of a truncated cone. The nozzle channel may have a narrow entrance opening (e.g., narrow tip) that is narrower than the rest of its interior, e.g., to force expansion of the space occupied by the attracted material as it travels towards the internal cavity. The nozzle channel may have a constant or an expandable (e.g., gradually expandable) interior. For example, the nozzle may have an abrupt expansion immediately after entry into the nozzle, followed by a constant width. For example, the nozzle may have an abrupt expansion immediately after entry into the nozzle, followed by a more gradual expansion (e.g., as compared to the abrupt expansion). The gradual expansion may be a linear expansion. The expansion may be of a cross section of the nozzle. The expansion may be of a volume of the nozzle.

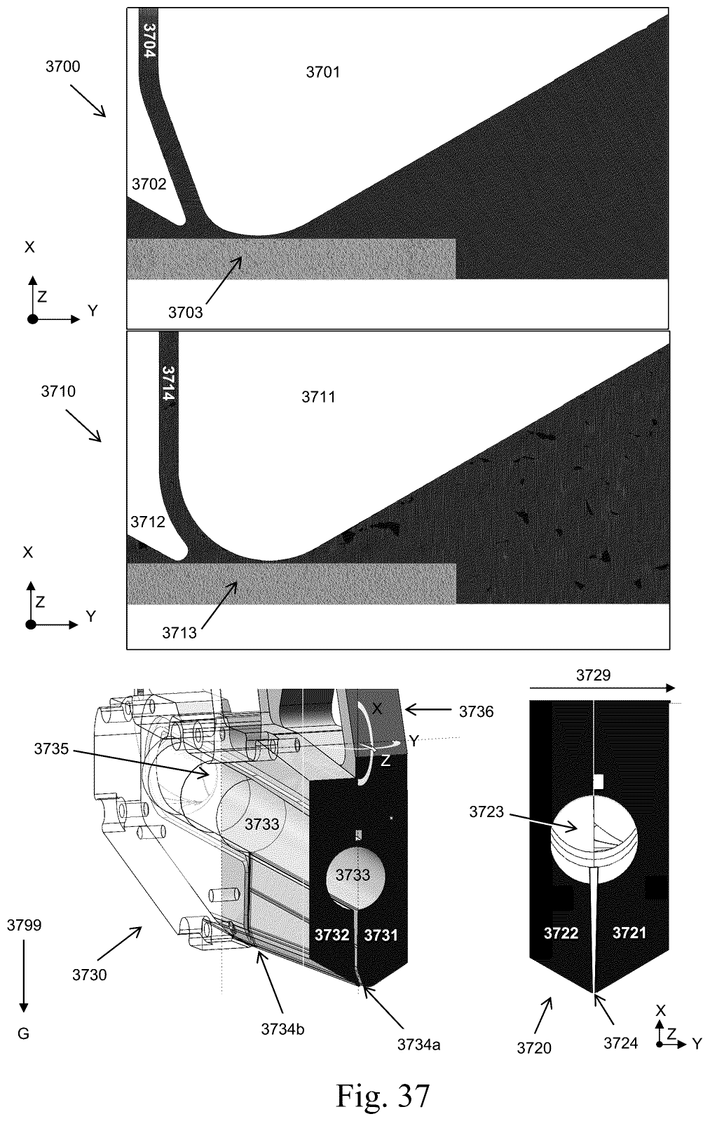

FIG. 37 shows in 3700 a vertical cross-sectional example of a tip (e.g., material entrance port) of the material removal mechanism having a first side 3701 and a second side 3702. The material removal mechanism nozzle tip is disposed adjacent to (and not contacting) an exposed surface of material bed 3703, with a gap disposed between the tip and the exposed surface of the material bed. In 3700, an entrance opening channel 3704 is formed by the two opposing sides 3702 and 3701 of the nozzle has a bent (e.g., angled) cross section. Side 3701 can be a leading side (e.g., comprising a leading edge) of the nozzle and side 3702 can be a tailing side (e.g., comprising a tailing edge) of the nozzle, e.g., with respect to an intended direction of movement of the nozzle as part of the material removal mechanism. The first side 3701 and the second side 3702 in example 3700 are asymmetric, e.g., with respect to the channel 3704, with respect to the direction of suction of the material from the exposed surface 3703 into the internal compartment of the nozzle during operation of the nozzle, and/or with respect to gravitational vector 3799. FIG. 37 shows in 3710 a vertical cross-sectional example of a tip of the material removal mechanism having a first side 3711 and a second side 3712. The material removal mechanism nozzle tip is disposed adjacent to (and not contacting) an exposed surface of material bed 3713, with a gap disposed between the tip and the exposed surface of the material bed. In 3710, an entrance opening channel 3714 is formed by the two opposing sides 3712 and 3711 of the nozzle has a bent (e.g., curved) cross section. The curved section in the 3710 is closer to the nozzle tip with respect to that of bent section 3700. Side 3711 can be a leading side of the nozzle and side 3712 can be a tailing side of the nozzle, e.g., with respect to an intended direction of movement of the nozzle, as part of the material removal mechanism. The first side 3711 and the second side 3712 in example 3710 are asymmetric, e.g., with respect to the channel 3714, with respect to the direction of suction of the material from the exposed surface 3713 into the internal compartment of the nozzle during operation of the nozzle, and/or with respect to gravitational vector 3799. FIG. 37 shows material removal mechanism 3720 a vertical cross-sectional example and internal view of a of looking into cavity 3723 to its far second side. Material removal mechanism is similar to the one depicted in the material removal mechanism view 3730, e.g., except for the nozzle channel being bent in 3730 and straight in 3720. In the example shown in 3720, two side 3721 and 3722 of the nozzle of the material removal system form a material entrance opening channel ending in tip 3724, which material entrance opening channel has a straight vertical cross section (e.g., is devoid of a curvature or an angle), that has a cross section similar to a triangle (e.g., a triangle truncated at its tip), with its tip pointing towards the target surface, e.g., exposed surface of a material bed. Side 3722 can be a tailing side of the nozzle, and 3721 can be a leading side of the nozzle, e.g., with respect to the direction of movement 3729 of the material removal mechanism during material removal operation. The direction of movement can be reversed (e.g., and thus reversing the “tailing” and “leading” edge roles of the edges of the nozzle). In 3720 the tailing and leading sides are symmetric, e.g., with respect to the nozzle channel and/or with respect to the direction of suction of the material from the exposed surface into the internal compartment of the nozzle during operation of the nozzle. FIG. 37 shows in a perspective and vertical cross-sectional example of material removal mechanism 3730 including a nozzle having a first side 3731 and a second side 3732. The first side 3731 and the second side 3732 in example 3730 are asymmetric, e.g., with respect to the channel, with respect to the direction of suction of the material from the exposed surface into the internal compartment of the nozzle during operation of the nozzle, and/or with respect to gravitational vector 3799. The material removal mechanism has a cavity 3733 configured to accommodate any material (e.g., powder) attracted to the cavity through the nozzle opening ending at tip 3734a. The nozzle opening extends along the tip of the material removal mechanism, e.g., from 3734a towards the opposing end, including position 3734b. Cavity 3733 has an exit opening (e.g., exit port) 3735 through which attracted material (e.g., from a material bed) is removed from cavity 3733. Opening 3735 can be operatively coupled (e.g., using a channel such as a hose) to an attractive force generator (e.g., a vacuum pump, a magnetic force, or an electrostatic force generator). In the example shown in material removal mechanism 3730, two side 3731 and 3732 of the nozzle of the material removal system form a material entrance opening channel ending in tip 3734a-3734b, which material entrance opening channel has a bent vertical cross section. The material removal mechanism in example 3730 shows the mount portion 3736 above one nozzle portion 3731. In the example of FIG. 37, portion 3736 of the mount and portion (e.g., half nozzle) 3731 of the nozzle form one integral piece. Material removal mechanism 3720 depicts another view of a material removal mechanism similar to the one in example 3730. Material removal mechanisms 3730 and 3720 are disposed in relation of gravitational vector 3799 directed towards gravitational center G.

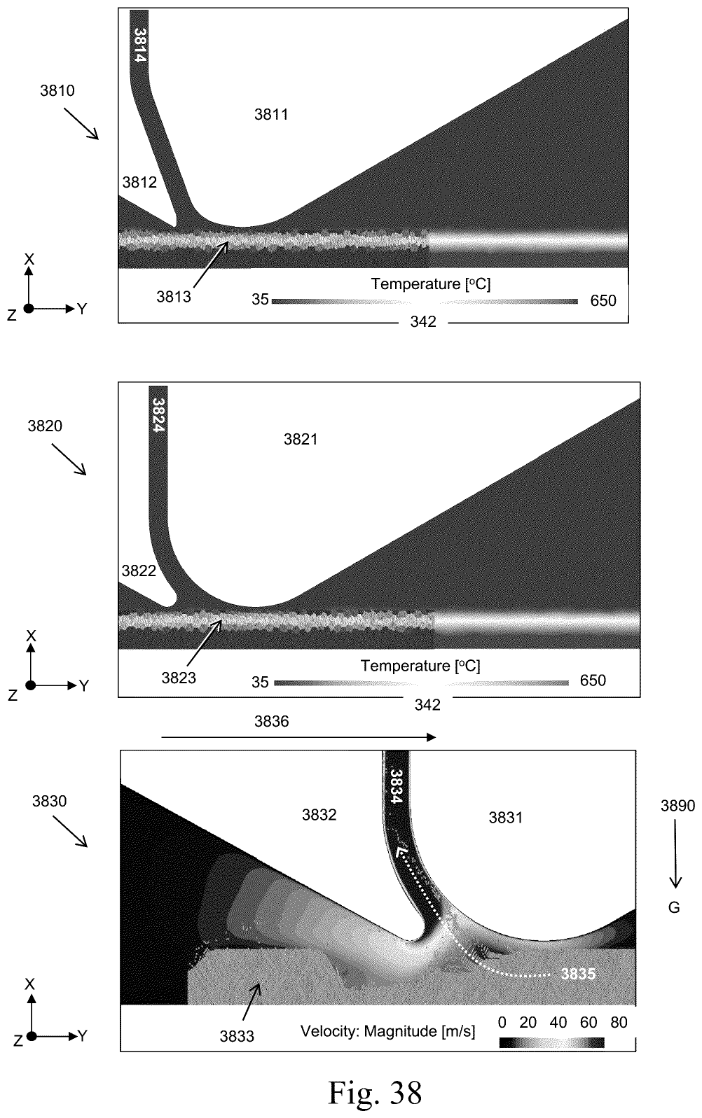

FIG. 38 shows in 3810 a vertical cross-sectional example of a tip of the material removal mechanism having a first side 3811 and a second side 3812. The material removal mechanism nozzle tip is disposed adjacent to an exposed surface of material bed 3813, with a gap disposed between the dip of the nozzle and the exposed surface. In 3810, an entrance opening channel 3814 is formed by the two opposing sides 3812 and 3811 of the nozzle has a bent (e.g., angled) cross section. The two opposing sides are asymmetric, e.g., with respect to the channel, with respect to the direction of suction of the material from the exposed surface into the internal compartment of the nozzle during operation of the nozzle, and/or with respect to gravitational vector 3890. Side 3811 can be a leading side of the nozzle and side 3812 can be a tailing side of the nozzle, e.g., with respect to an intended direction of movement of the nozzle as part of the material removal mechanism. FIG. 38 shows in 3820 a vertical cross-sectional example of a tip of the material removal mechanism having a first side 3821 and a second side 3822. The material removal mechanism nozzle tip is disposed adjacent to an exposed surface of material bed 3823, with a gap disposed between the dip of the nozzle and the exposed surface. FIG. 38 shows in 3810 and 3820 also temperature gradients (e.g., in the material beds 3813 and 3823 respectively). In 3820, an entrance opening channel 3824 formed by the two opposing sides 3822 and 3821 of the nozzle, the channel having a bent (e.g., curved) cross section. The two opposing sides 3822 and 3821 are asymmetrical, e.g., with respect to the channel 3824, with respect to the direction of suction of the material from the exposed surface into the internal compartment of the nozzle during operation of the nozzle, and/or with respect to gravitational vector 3890. Side 3821 can be a leading side of the nozzle and side 3822 can be a tailing side of the nozzle, e.g., with respect to an intended direction of movement of the nozzle as part of the material removal mechanism. FIG. 38 shows in 3830 a vertical cross-sectional example of a tip of the material removal mechanism having a first side 3831 and a second side 3832. The material removal mechanism nozzle tip is disposed adjacent to an exposed surface of material bed 3833 with a gap between the exposed surface and the nozzle tip. In 3830, an entrance opening channel 3834 formed by the two opposing sides 3832 and 3831 of the nozzle, has a bent (e.g., curved) cross section. Side 3831 can be a leading side of the nozzle and side 3832 can be a tailing side of the nozzle, e.g., with respect to the direction of movement 3836 of the nozzle, as part of the material removal mechanism. FIG. 38 shows in example 3830 illustrates how powder material from material bed 3833 is attracted into the cavity through the nozzle entrance opening channel 3834 along dotted line 3835, when the direction of movement of the material removal mechanism (and movement direction of the nozzle) is along arrow 3836. Entrance of the powder along 3835 is in a direction opposing movement direction 3836, and has a directional component opposing gravitational vector 3890. FIG. 38 shows in simulated example 3830 the velocity of gas attracted to the cavity through entrance opening channel 3834, as depicted by the grayscale indicating velocity in meters per second (m/s). The two opposing sides 3832 and 3831 are asymmetrical, e.g., with respect to the channel, with respect to the direction of suction of the material from the exposed surface into the internal compartment of the nozzle during operation of the nozzle, and/or with respect to gravitational vector 3890.

In some embodiments, the material removal mechanism removes material from a material bed to lower a first exposed surface of the material bed to a second exposed surface of the material bed. In some embodiments, the transition between the first exposed surface to the second exposed surface may form a slope. At times, it may be advantageous to lengthen a lateral (e.g., horizontal) length of the slope, e.g., form a moderate slope. At times, it may be advantageous to have an abrupt transition (e.g., minimize the slope's lateral length). An external shape of the surfaces of the body of the material dispensing mechanism facing the material bed, may play a role in the value, shape, and/or lateral length of the slope. At times, a nozzle generated by two symmetric body sides contacting the nozzle tip, may form an abrupt (e.g., steep) slope. For example, a nozzle generated by two symmetric body sides angled towards the nozzle tip, may form an abrupt (e.g., steep) slope. At times, a nozzle generated by two asymmetric body sides contacting the nozzle tip, may form a moderate (e.g., shallow) slope. For example, a nozzle generated by two asymmetric body sides, at least some of which are angled towards and contact the nozzle tip, may form a moderate (e.g., shallow) slope. For example, a nozzle generated by two asymmetric body sides, at least some of which have a surface parallel to the first/second exposed surface of the material bed that end at the nozzle tip, may form a moderate (e.g., shallow) slope. At times, having a shallower slope may facilitate removal of a smaller height from the first exposed surface of the material bed to form a second exposed surface of the material bed that is (e.g., substantially) planar. The lateral extend of the slope may be adjusted by (i) adjusting the lateral extend of the nozzle body's surface parallel to the exposed surface of the material bed, (ii) adjusting the asymmetry between the first side of the nozzle body and the second side of the nozzle body that form the nozzle channel, (iii) adjusting the gap between the nozzle tip and the first exposed surface of the material bed, (iv) adjusting the attractive force utilized for removal, or (v) any combination thereof. Adjusting the attractive force utilized for removal may comprise adjusting gas flow sucked into the nozzle through the nozzle channel, e.g., when the source force is vacuum. The external shape of the surface(s) of the material removal body facing the material bed, may influence (e.g., determine at least in part) a shape of the gas velocity function of the gas entering the nozzle channel, e.g., relative to a distance from the exposed surface of the material bed to the nozzle channel entrance opening. The external shape of the surface(s) of the material removal body facing the material bed, may influence (e.g., determine at least in part) a shape of the slope formed as the substance (e.g., gas and powder) enters the nozzle channel, e.g., relative to a distance from the exposed surface of the material bed to the nozzle channel entrance opening.

In some embodiments, the head of the material removal mechanism comprising the nozzle entrance opening, comprises one or more surfaces facing the exposed surface of the material bed. The one or more surfaces may (e.g., each) be planar. The one or more surfaces may comprise (i) a surface (e.g., substantially) parallel to the exposed surface, or (ii) a surface angled with respect to the exposed surface (e.g., central tendency thereof). Angled may be in a direction towards the nozzle channel opening. The one or more surfaces may reside on one side of the nozzle body. The one or more surface may reside on two sides of the nozzle body. For example, a first side of the surface body may have a surface angled with respect to the exposed surface. For example, a second side of the surface body may have a surface parallel with respect to the exposed surface. For example, a first side of the surface body may have (i) a first surface segment parallel with respect to the exposed surface, and (ii) a second surface segment parallel with respect to the exposed surface. For example, the first side of the surface body and the second side of the surface body may be symmetrically related to each other. For example, the first side of the surface body and the second side of the surface body may be asymmetrically related to each other.

In some embodiments, the material dispensing mechanism is configured to remove material from an exposed surface of the material bed when propagating along a direction. The two sides of the body of the material removal mechanism may be referred to as a leading side and a tailing side, with respect to the movement direction of the material removal mechanism during removal operation. These are disposed at two sides of the nozzle channel. At times, it may be preferable to have a surface of the tailing side angled away from the material bed the more the surface is distanced away from the nozzle channel entrance opening, the surface facing the material bed. For example, to minimize disturbance (e.g., turbulence) of the new exposed surface generated upon removal. At times, it may be preferable to have a surface of the leading side being parallel the material bed, the surface facing the material bed and contacting the nozzle channel entrance opening. For example, to facilitate (i) easy pickup (e.g., attraction) of the material from the exposed surface of the material bed into the nozzle opening channel, and/or (ii) generation of a (e.g., substantially) planar surface of the material bed.

In some embodiments, the material removal mechanism has a first body side and a second body side that come together, e.g., disposed at two sides of the nozzle channel (e.g., forming the nozzle channel). In some embodiments, at least a section of a surface facing the material bed and contacting the entrance opening, is angled with respect to a central tendency of the exposed surface of the material bed, the surface being of a body side. The angle may be at least about zero, 10°, 20°, 40°, 60°, 80°, or 85°. A distance of the gap between the original exposed surface (before material removal) and the tip of the material removal mechanism may be at least about 150 micrometers (μm), 200 μm, 300 μm, 400 μm, 500 μm, 600 μm, 700 μm, 800 μm, 1 millimeter (mm), or 1.5 mm. A distance of the gap between the original exposed surface (before material removal) and the tip of the material removal mechanism may be at most about 200 μm, 500 μm, 600 μm, 700 μm, 800 μm, 1 millimeter (mm), 1.5 mm, or 2 mm. A distance of the gap between the original exposed surface (before material removal) and the tip of the material removal mechanism may between the above referenced values (e.g., from about 150 μm to about 2 mm, from about 200 μm to about 1 mm, from about 200 μm to about 2 mm). At times, the material removal mechanism may be part of the layer dispensing mechanism that is devoid of a leveling mechanism (e.g., comprising a blade). At times, the material removal mechanism may be part of the layer dispensing mechanism that includes a leveling mechanism (e.g., comprising a blade).

FIG. 39 shows in example 3910, a vertical cross-sectional example of a of nozzle of the material removal mechanism looking into cavity 3912 to its far second side (e.g., of a nozzle similar to the one depicted in example FIG. 37, 3730), disposed with respect to gravitational vector 3999 pointing towards the environmental gravitational center. In the example shown in 3910, two sides of the nozzle—a first side 3915 and a second side 3916—form a material entrance opening channel extending from internal cavity 3912 to tip 3917. The channel in example 3910 has a straight vertical cross section (e.g., is devoid of a curvature or an angle), and is overall angled with respect to the first/second exposed surface by a channel angle delta (δ) that is different (and smaller) than 90 degrees. The tilt angle of the channel is away from the direction of movement 3911, e.g., during the removal operation. Side 3916 can be a tailing side of the nozzle, and side 3915 can be a leading side of the nozzle, e.g., with respect to the direction of movement 3911 of the material removal mechanism such as during the removal operation. The material removal mechanism is configured to attract material from a first exposed surface 3914 of material bed 3920 to generate a second exposed surface 3913 as it translates laterally along the exposed surface in direction 3911, e.g., when the material removal mechanism is connected to an operating attractive force source. Tip 3917 of the nozzle is disposed at a gap 3919 distanced from the first exposed surface 3914. First side 3915 has a first external surface 3918 facing the first/second exposed surface of the material bed, which first surface 3718 forms a first angle alpha (α) with the first/second exposed surface of material bed 3920. The second side 3916 has a second external surface 3921 facing the first/second exposed surface of material bed 3920, which second external exposed surface 3921 forms a second angle beta (ß) with the first/second exposed surface of material bed 3940. The first angle alpha (α) can be smaller, larger, or (e.g., substantially) equal to the second angle beta (ß). The second angle beta is smaller than the channel angle delta (δ). An optional O-ring may be disposed in location 3919 representing an optional O-ring groove. In the example shown in 3910, first external surface 3918 has (i) a smaller vertical cross section and (ii) occupies a smaller area, than those of the second external surface 3921 respectively. The two opposing sides 3916 and 3915 are asymmetric, e.g., with respect to the channel, with respect to the direction of suction of the material from the exposed surface into the internal compartment of the nozzle during operation of the nozzle, and/or with respect to gravitational vector 3999. A slope is formed between the first exposed surface 3914 and the second exposed surface 3913, having lateral length 3925.

FIG. 39 shows in example 3930, a vertical cross-sectional example of a of nozzle of the material removal mechanism looking into cavity 3932 to its far second side (e.g., of a nozzle similar to the one depicted in example FIG. 37, 3730), disposed with respect to gravitational vector 3999 pointing towards the environmental gravitational center. In the example shown in 3930, two sides of the nozzle—a first side 3935 and a second side 3936—form a material entrance opening channel extending from internal cavity 3932 to tip 3937. The channel in example 3930 has a straight vertical cross section (e.g., is devoid of a curvature or an angle), and is overall (e.g., substantially) normal to the first/second exposed. The tip 3937 of the channel is has a narrower vertical cross section as opposed to the channel, e.g., such that the material attracted from the tip of the channel to its interior cavity 3932 may expand as it enters the nozzle. Side 3936 can be a tailing side of the nozzle, and side 3935 can be a leading side of the nozzle, e.g., with respect to the direction of movement 3931 of the material removal mechanism such as during the removal operation. The material removal mechanism is configured to attract material from a first exposed surface 3934 of material bed 3940 to generate a second exposed surface 3933 as it translates laterally along the exposed surface in direction 3931, e.g., when the material removal mechanism is connected to an operating attractive force source. Tip 3937 of the nozzle is disposed at a gap 3939 distanced from the first exposed surface 3934. The first side 3935 has a first external surface 3938 facing the first/second exposed surface of material bed 3940, which first surface 3738 forms a first angle alpha (α) with the first/second exposed surface of material bed 3940. The second side 3936 has a second external surface 3941 facing the first/second exposed surface of material bed 3940, which second external exposed surface 3941 forms a second angle beta (ß) with the first/second exposed surface of material bed 3940. In the example shown in 3930, the first angle alpha (α) is substantially equal to the second angle beta (ß). An optional O-ring may be disposed in location 3939 representing an optional O-ring groove. In the example shown in 3930, first external surface 3938 has (i) a substantially equal vertical cross section and (ii) occupies a substantially similar area, as those of the second external surface 3941 respectively. The two opposing sides 3936 and 3935 are asymmetric, e.g., with respect to the channel, with respect to the direction of suction of the material from the exposed surface into the internal compartment of the nozzle during operation of the nozzle, and/or with respect to gravitational vector 3999. A slope is formed between the first exposed surface 3934 and the second exposed surface 3933, having lateral length 3945. Slope 3925 has a larger lateral length than slope 3945.

FIG. 39 shows in example 3950, a vertical cross-sectional example of a of nozzle of the material removal mechanism looking into cavity 3952 to its far second side (e.g., of a nozzle similar to the one depicted in example FIG. 37, 3730), disposed with respect to gravitational vector 3999 pointing towards the environmental gravitational center. In the example shown in 3950, two sides of the nozzle—a first side 3955 and a second side 3956—form a material entrance opening channel extending from internal cavity 3952 to tip 3957. The channel in example 3950 has a straight vertical cross section (e.g., is devoid of a curvature or an angle), and is overall (e.g., substantially) normal to the first/second exposed surface and slightly expands from the tip to the internal cavity, e.g., symmetrically along its long axis (e.g., to form a triangular vertical cross section). Side 3956 can be a tailing side of the nozzle, and side 3955 can be a leading side of the nozzle, e.g., with respect to the direction of movement 3951 of the material removal mechanism such as during the removal operation. Side 3956 is curved at its bottom most tip, whereas side 3955 has a (e.g., substantially) flat bottom side 3958 facing the first/second exposed surface of material bed 3960. The material removal mechanism is configured to attract material from a first exposed surface 3954 of material bed 3960 to generate a second exposed surface 3953 as it translates laterally along the exposed surface in direction 3951, e.g., when the material removal mechanism is connected to an operating attractive force source. Tip 3957 of the nozzle is disposed at a gap 3959 distanced from the first exposed surface 3954. The first side 3955 has a first external surface 3962 facing the first/second exposed surface of material bed 3960, which first surface 3762 forms a first angle alpha (α) with the first/second exposed surface of material bed 3960. The second side 3956 has a second external surface 3961 facing the first/second exposed surface of material bed 3960, which second external exposed surface 3961 forms a second angle beta (ß) with the first/second exposed surface of material bed 3960. In the example shown in 3950, the first angle alpha (α) is smaller than the second angle beta (ß). An optional O-ring may be disposed in location 3963 representing an optional O-ring groove. In the example shown in 3950, first external surface 3962 has (i) a smaller vertical cross section and (ii) occupies a smaller area, as those of the second external surface 3961 respectively. The two opposing sides 3956 and 3955 are asymmetric, e.g., with respect to the channel, with respect to the direction of suction of the material from the exposed surface into the internal compartment of the nozzle during operation of the nozzle, and/or with respect to gravitational vector 3999. first external surface 3962 borders the external surface of flat bottom side 3958. A slope is formed between the first exposed surface 3954 and the second exposed surface 3953, having lateral length 3965. Slope 3965 has a larger lateral length than slope 3945.

FIG. 39 shows in example 3970 a vertical cross-sectional example of a of nozzle of the material removal mechanism looking into cavity 3972 to its far second side (e.g., of a nozzle similar to the one depicted in example FIG. 37, 3730), disposed with respect to gravitational vector 3999 pointing towards the environmental gravitational center. In the example shown in 3970, two sides of the nozzle—a first side 3975 and a second side 3976—form a material entrance opening channel extending from internal cavity 3972 to tip 3977. The channel in example 3970 has a straight vertical cross section (e.g., is devoid of a curvature or an angle), and is overall (e.g., substantially) normal to the first/second exposed surface and slightly expands from the tip to the internal cavity, e.g., symmetrically along its long axis (e.g., to form a triangular vertical cross section). Side 3976 can be a tailing side of the nozzle, and side 3975 can be a leading side of the nozzle, e.g., with respect to the direction of movement 3971 of the material removal mechanism such as during the removal operation. Side 3976 is curved at its bottom most tip, whereas side 3975 has a (e.g., substantially) flat bottom side facing the first/second exposed surface of material bed 3980. The material removal mechanism is configured to attract material from a first exposed surface 3974 of material bed 3980 to generate a second exposed surface 3973 as it translates laterally along the exposed surface in direction 3971, e.g., when the material removal mechanism is connected to an operating attractive force source. Tip 3977 of the nozzle is disposed at a gap 3989 distanced from the first exposed surface 3974. The first side 3975 has a first external surface 3978 facing the first/second exposed surface of material bed 3980, which first external surface 3978 is of the flat bottom side. The first surface 3978 is disposed (e.g., substantially) parallel with the first/second exposed surface of material bed 3980. The second side 3976 has a second external surface 3981 facing the first/second exposed surface of material bed 3980, which second external exposed surface 3981 that forms an angle beta (ß) with the first/second exposed surface of material bed 3980. An optional O-ring may be disposed in location 3979 representing an optional O-ring groove. In the example shown in 3970, first external surface 3978 has (i) a smaller vertical cross section and (ii) occupies a smaller area, as those of the second external surface 3981 respectively. The two opposing sides 3976 and 3975 are asymmetric, e.g., with respect to the channel, with respect to the direction of suction of the material from the exposed surface into the internal compartment of the nozzle during operation of the nozzle, and/or with respect to gravitational vector 3999. A slope is formed between the first exposed surface 3974 and the second exposed surface 3973, having lateral length 3985. Slope 3985 has a larger lateral length than slope 3945. In example 3950, the flat bottom side 3958 parallel to the exposed surface is shorter than the first external surface 3978 parallel to the exposed surface in example 3870, and the lateral extend of slope 3965 is smaller than that of slope 3985.

In some embodiments, the material bed is generated by successive deposition of a planar layer of pre-transformed (e.g., starting) material. The planar layer of pre-transformed material may be generated by depositing an initial layer having a first height that has a relatively rough exposed surface, and attracting a portion of the initial layer to form a finalized layer having a second height smaller than the first height, the finalized layer having an exposed surface that is more planar (e.g., has a lower roughness) as compared to that of the initial layer. A non-contact material removing mechanism may be employed to attract the pre-transformed material from the material bed to generate the planar surface of the finalized layer. User of the non-contact recoater may be advantageous, e.g., when a 3D object is protruding from the exposed surface of the material bed. Such non-contact leveling may allow generating a planar layer of the material bed while reducing an opportunity to damage the layer dispensing mechanism, e.g., by the protruding object. Such non-contact leveling may allow generating a planar layer of the material bed while reducing an opportunity to move the (e.g., protruding) 3D object during the layer dispensing operation. The finalized layer having the (e.g., substantially) planar surface, can be irradiated by at least one energy beam to transform the pre-transformed material to a transformed material as part to the 3D object, e.g., allowing generation of a requested 3D object accurately (e.g., per requested tolerances). Between depositing the initial layer and planarizing it to form the finalized layer, a leveling operation may or may not take place.

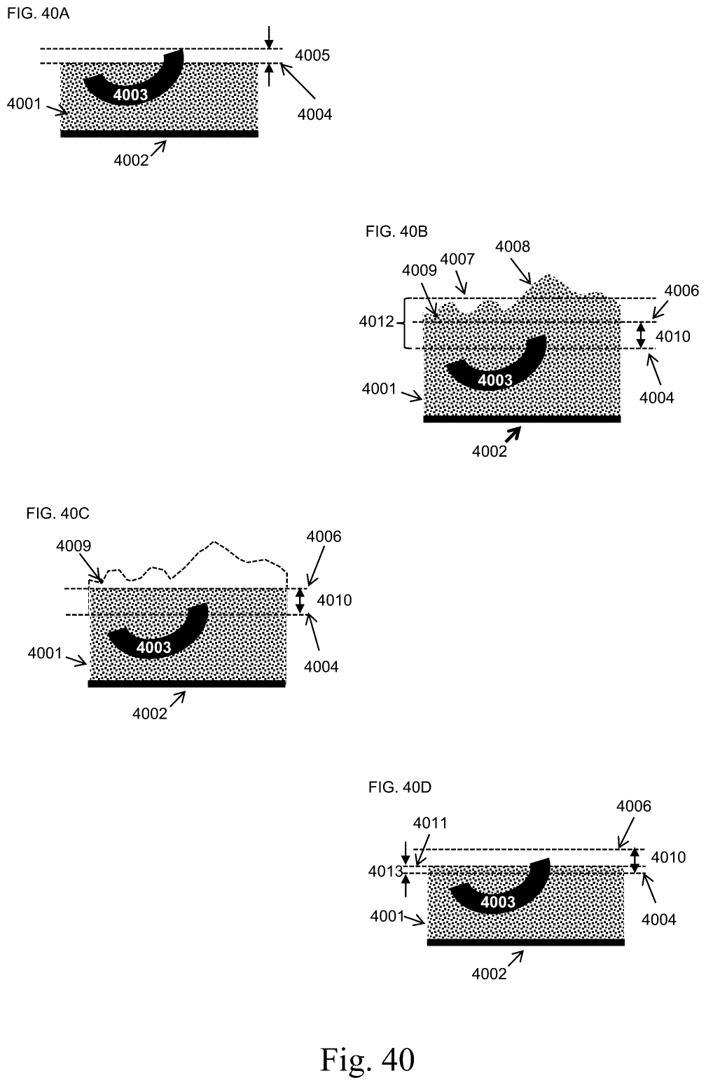

FIGS. 40A-D show examples of various stages of a layering method described herein. FIG. 40A shows a powder bed 4001 in which a deformed (bent) 3D object 4003 is suspended in the powder bed and is protruding from the exposed (top) surface of the powder bed by a distance 4005. The exposed surface of the powder bed can be leveled (e.g., as shown in FIG. 40A, having a planar exposed surface 4004), or not leveled. FIG. 40B shows a succeeding operation where an initial layer or pre-transformed material is deposited in the powder bed (e.g., above the plane 4004), the initial layer having an initial exposed surface, e.g., 4008. The newly deposited layer may have an exposed surface that is non-planar (e.g., 4008). In the example shown in FIG. 40B, the non-planar exposed (e.g., top) surface 4008 includes a lowest vertical point 4009. The plane 4006 is a plane that is situated at or below the lowest vertical point of the non-planar surface, and at or above the protruding height 4005. The plane 4006 is located higher than the top surface 4004 by a height 4010. FIG. 40C shows a succeeding optional operation where the initially dispensed layer is leveled by a leveling mechanism (e.g., FIG. 1, 117) to generate a planar layer having a height of 4006. That planarization can comprise shearing of the powder material. FIG. 40D shows a succeeding operation where the planar layer is planarized to a lower vertical plane level that is above 4004 and below 4006, and is designated as a final exposed surface 4011. This planarization operation may be conducted by the powder removal mechanism (e.g., FIG. 1, 118), which does not contact the exposed layer of the powder bed. the method may or may not include operation of the leveling mechanism (e.g., may or may not include operation 40C). The planarization operation by the material removal mechanism may or may not expose the protruding object. In the event that the operation by the leveling mechanism (e.g., knife) does not take place, operation 40C is omitted, and the material removal mechanism planarizes the initial exposed surface 4008 to generate the final exposed surface 4011. This planarization operation resulting in the final exposed surface (e.g., 4011) may result in an exposed surface having a higher planarization fidelity, e.g., resulting in an exposed surface having a lower roughness; as compared to exposed surface(s) generated by the other operation(s) in the layer dispensing process (e.g., 4008 and/or 4006). The final layer having the final exposed surface can be utilized for irradiation by the energy beam, to form a layer of 3D object(s). The material removed (e.g., by the material removal mechanism) may be recycled.

In some embodiments, as part of dispensing a planar layer of material utilized for transformation, an initial layer of pre-transformed material is deposited. The initial layer has an initial height and an initial roughness. The initial layer can be planarized to generate a final layer having a final height and a final roughness, the final height being lower than the initial height, and the final roughness being lower than the initial roughness. Achieving the final layer can include (i) leveling by a leveling mechanism and/or (ii) planarizing by a material removal mechanism such that material removal mechanism that does not contact the exposed surface of the material bed. A central tendency (e.g., average) of the height of the final layer may be at most about 150 micrometers (μm), 100 μm, 80 μm, 70 μm, 50 μm, 30 μm, 20 μm or 10 μm. A central tendency of the height of the final layer may be of any value between the aforementioned values, e.g., from about 150 μm to about 10 μm, from about 80 μm to about 20 μm, or from about 70 μm to about 20 μm. A central tendency of the difference in height from the initial layer to the final layer may be at most about 1500 micrometers (μm), 1100 μm, 1000 μm, 800 μm, 500 μm, 400 μm, 200 μm or 100 μm. A central tendency of the difference in height from the initial layer to the final layer may be between any value between the aforementioned values, e.g., from about 1500 μm to about 110 μm, from about 1500 μm to about 500 μm, or from about 500 μm to about 100 μm.

In some embodiments, the layer dispensing mechanism may progress at a (e.g., substantially constant) speed relative to the build platform. The speed of the layer dispensing mechanism (or at least one component thereof) may be of at least about 50 millimeters per second (mm/sec), 60 mm/sec, 75 mm/sec, 100 mm/sec, 150 mm/sec, 180 mm/sec, or 200 mm/sec. The speed of the layer dispensing mechanism (or at least one component thereof) may be any value between the afore-mentioned values, e.g., from about 50 mm/sec to about 200 mm/sec, or from about 60 mm/sec to about 180 mm/sec.

In some embodiments, the material removal mechanism may remove pre-transformed material from the material bed at a (e.g., substantially constant) rate. The material removal rate may be of at least about 2 milliliter per second, 3 ml/sec, 4 ml/sec, 6 ml/sec, 8 ml/sec, or 10 ml/sec, the volume (ml) referring to the volume of the material bed removed. The material removal rate may be of any value between the aforementioned values (e.g., from about 2 ml/sec to about 10 ml/sec, from about 3 ml/sec to about 6 ml/sec), the volume (ml) referring to the volume of the material bed removed.

In some embodiments, the material removal mechanism is configured to operatively couple (e.g., connect) to a vacuum source such as a pump. The vacuum source may generate a pressure differential in the material removal mechanism. The pressure differential may be of at least about 10 kilopascal (KPa), 15 KPa, 20 KPa, 25 KPa, or 30 KPa. The pressure differential may be of any value between the aforementioned values (e.g., from about 10 KPa to about 30 KPa, from about 15 KPa to about 25 KPa. The lowest pressure of the pressure differential may be above ambient pressure external to a processing chamber in which the material remover is disposed during printing, e.g., and during removal operation. The lowest pressure of the pressure differential may be at or below ambient pressure external to a processing chamber in which the material remover is disposed during printing, e.g., and during removal operation. The powder remover mechanism may be configured to attract a portion of the dispensed pre-transformed material (e.g., powder) to form a planar exposed surface of the powder bed, e.g., using vacuum. Usage of the vacuum may be such that the pressure in the processing chamber remained above ambient atmosphere during removal of the pre-transformed material with the material removal mechanism.

In some embodiments, the material removal mechanism does not contact the exposed surface of the material bed during removal. The material removal mechanism may have a nozzle having a tip facing the exposed surface of the material bed. The material removal mechanism may be distanced by a gap from its nozzle tip to the exposed surface of the layer it intends to plantaris, e.g., from the initial exposed surface such as 4008, from the central tendency of the initial exposed surface such as 4007, or from the intermediary exposed surface such as 4006. The gap distance may be of at most about 100 μm, 200 μm, 500 μm, 1000 μm, or 1500 μm. The gap distance may be of between any of the aforementioned distances (e.g., from about 1500 μm to about 100 μm, or from about 200 μm to about 1000 μm).

In some embodiments, the material removal mechanism planarizes the material bed to form a final exposed surface of a material layer, that is ready for a transformation operation as part of a 3D printing process to generate a layer of transformed (and hardened) material as part of the 3D object(s). In some examples, the final exposed surface a Ra value of at most about 70 μm, 50 μm, 20 μm, or 10 μm. The 3D object can have an Ra value between any of the afore-mentioned Ra values, e.g., from about 70 μm to about 10 μm, or from about 50 μm to about 20 μm.

In some embodiments, the 3D object(s) are printed from a material bed. At least one FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m or 5 m. The at least one FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The at least one FLS of the material bed can be between any of the afore-mentioned values (e.g., from about 50 mm to about 5 m, from about 250 mm to about 500 mm, from about 280 mm to about 1 m, or from about 500 mm to about 5 m). In some embodiments, a FLS of the material bed is in the direction of the gas flow. The At least one FLS of the material bed can correspond to a FLS of the build platform configured to support the material bed.

In some embodiments, an amount of material recycled by a recycling system (e.g., and by any of its components) is greater than an amount of material that remains in the material bed. The material that remains in the material bed may be that which remains following removal of excess material after dispensing the material. The material recycled may be excess material. The excess material may be removed (e.g., following a dispensing operation) to the recycling system by a leveling mechanism (e.g., a blade and/or a vacuum). For example, the amount of material recycled for a given deposited material layer may be greater than the amount of material that forms the given layer (e.g., that remains in the material bed). For example, the amount of material recycled (e.g., by the recycling system or any of its components) during formation of a 3D object may be greater than the amount of material deposited within a material bed during the formation of the 3D object. In some embodiments, the amount of material recycled by the recycling system (e.g., and by any of its components) may be a majority of the material dispensed (e.g., by a material dispenser). For example, the amount of material recycled may be at least about 51%, 60%, 70%, 80%, 85%, 90%, 95%, or 98% of the material dispensed by the material dispenser. The amount of material recycled may be any value within a range of the aforementioned values (e.g., from 51% to 98%, from 51% to 70%, or from 70% to 98%). The aforementioned (e.g., percentage) amount of recycled material may refer to a volume of material. The afore-mentioned (e.g., percentage) amount of recycled material may refer to a relative height of material (e.g., on the material bed). The recycling system may be configured to recycle at least 50 kilograms (kg), 100 kg, 200 kg, 500 kg, 1000 kg, 5000 kg, or 10000 kg of material during the printing and/or before the cartridge requires a change (e.g., without exchanging the filter). The recycling system (e.g., and by any of its components) may be configured to support these recycling characteristics.

At times, the height of material is with respect to a height over a prior-formed material layer (e.g., having an exposed surface such as in FIG. 40A, 4004). For example, material (e.g., FIG. 40B, 4008) may be deposited (e.g., by the dispenser) to have an average height of at least about 750 μm, 850 μm, 950 μm or 1000 μm above a prior-formed material layer. FIG. 40B depicts an example of a plane 4007 that is situated at the average height 4012 of the material that is deposited above the prior-formed material layer plane 4004. The material may be deposited to have an average height of any value within a range of the aforementioned values (e.g., from about 750 μm to about 1000 μm, from about 750 μm to about 850 μm, or from 850 μm to about 1000 μm). The material recycling may be such as to have a remaining material height (e.g., FIG. 40D, 4013) above the prior-formed layer of at least about 30 μm, 40 μm, 50 μm, 60 μm, 70 μm, or 80 μm. The remaining height above the prior-formed layer may be any value within a range of the aforementioned values (e.g., from about 30 μm to about 80 μm, from about 30 μm to about 50 μm, or from about 50 μm to about 80 μm). In some embodiments, the volume of (e.g., excess) material recycled is at least about a factor of about 5, 8, 10, 15, 20, or 25 times greater than a volume of material that remains in the material bed (e.g., that forms material layers in the material bed). The volume of recycled material may be any value within a range of the aforementioned values (e.g., from 5 to 25, from 5 to 15, or from 15 to 25). The recycling system may recycle the material continuously. The recycling system may recycle the material periodically (e.g., at predetermined times).

In some embodiments, the 3D printer comprises a layer dispensing mechanism (e.g., FIG. 1, 132). The pre-transformed material (e.g., powder) may be deposited in the enclosure by a layer dispensing mechanism, also referred to herein as a “layer dispenser,” or “dispenser”). In some embodiments, the layer dispensing mechanism includes one or more material dispensers (e.g., FIG. 1, material dispenser 116), and/or at least one material removal mechanism (also referred to herein as material “remover” or “material remover” such as in FIG. 1, 118) to form a layer of pre-transformed material (e.g., starting material) within the enclosure. The deposited starting material may be leveled by a material leveling mechanism (e.g., leveler such as in FIG. 1, 117) in a leveling operation. The leveling operation may comprise using a material removal mechanism that does not contact the exposed surface of the material bed. The material (e.g., powder) dispensing mechanism may comprise one or more dispensers. The material dispensing mechanism may comprise at least one material (e.g., bulk) reservoir. The material may be deposited by a layer dispensing mechanism (e.g., recoater). The layer dispensing mechanism may level the dispensed material without contacting the material bed (e.g., the top surface of the powder bed). The layer dispensing mechanism and energy beam can translate and form the 3D object adjacent to the platform, while the platform gradually lowers its vertical position to facilitate layer-wise formation of the 3D object. The layer dispensing mechanism and energy beam can translate and form the 3D object within the material bed (e.g., as described herein), in a 3D printing cycle during which the platform lowers its vertical position to facilitate layer-wise formation of the 3D object. The layer dispensing mechanism can be used to form at least a portion of the material bed. The layer dispensing mechanism can dispense material, remove material, and/or otherwise shape the material bed, e.g., shape an exposed surface of a layer of material of the material bed. The material can comprise a pre-transformed material or a debris. Shaping the material bed may comprise altering a shape of the exposed surface of the material bed, e.g., planarizing the exposed surface of the material bed.

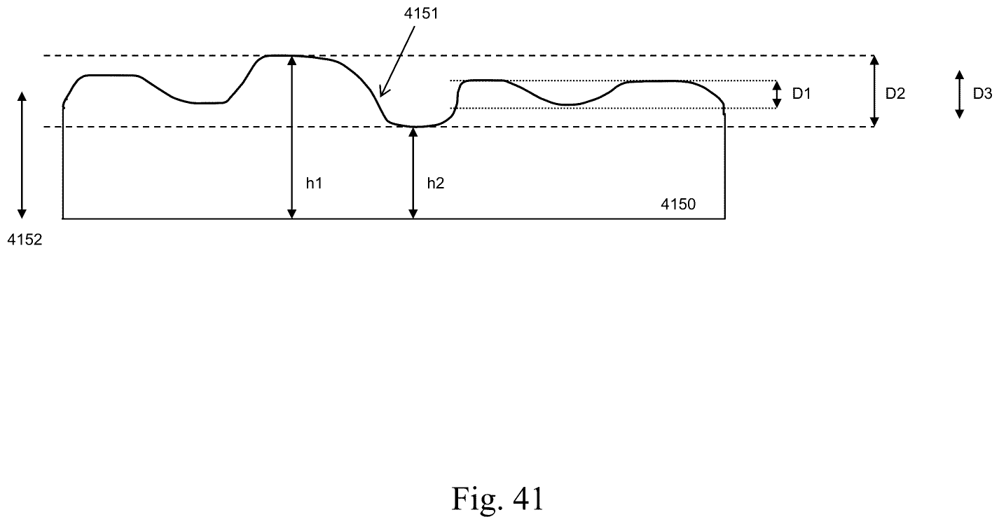

At times, the layer dispensing mechanism (e.g., recoater) may dispense at least a portion of a layer of pre-transformed material. The dispensed (e.g., portion of a) layer of pre-transformed material may comprise an exposed surface that is (e.g., substantially) planar. The planar exposed surface may be (e.g., substantially) horizontal, flat, smooth, and/or unvaried. The planar exposed surface may have a surface roughness, e.g., quantified by the deviations in the direction of the normal vector of a real surface from its ideal form. The surface roughness may be expressed using roughness parameter(s) such as the arithmetic average of profile height deviations from the mean line—denoted as Rₐ, maximum peak to valley height of the profile, within a single sampling length—denoted as R_{z}_{ᵢ}, or its average value over assessment length—denoted as R_{z}, or their area analogues, e.g., the Rₐ area analogue is a difference in height of each point compared to the arithmetical mean of the surface designated as Sₐ. The surface roughness may be referred to herein as planarity of the surface. A central tendency of planarity may be referred to an average, mean, or median of the planarity of that surface, or of a roughness of that surface. For example, the central tendency of planarity of a surface may be expressed as the Ra value of the surface. FIG. 41 shows an example of a vertical cross section of layer 4150 having exposed surface 4151, which layer 4150 is disposed in relation to gravitational vector 4199 directed towards gravitational center G. The layer has a central tendency of height (e.g., thickness) 4152 with the smallest height being h2 and the largest height being h1. In the schematic example shown in FIG. 41, the maximal roughness is Δ2 while the minimal roughness is Δ1, and exposed surface 4151 of the layer has a central tendency of planarity of Δ3 that can be referred to as the central tendency of the roughness of exposed surface 4151. A substantially planar exposed surface of the material bed may comprise a substantially uniform pre-transformed material (e.g., powder) height of the exposed surface. The layer dispensing mechanism can provide a layer of material having a height uniformity (e.g., powder uniformity height or thickness) across the exposed layer of the material bed such that portions of the bed that are separated from one another by at least about 1 mm, 2 mm, 3 mm, 4 mm, 5 mm, or 10 mm, have a height (e.g. a thickness) deviation of at most about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm, 70 μm, 60 μm, 50 μm, 40 μm, 30 μm, 20 μm, or 10 μm. The layer dispensing mechanism can provide layer height uniformity across the exposed layer of the material bed such that portions of the bed that are separated from one another by any value between the afore-mentioned height deviation values (e.g., from about 1 mm to about 10 mm) have a height deviation value of from about 10 mm to about 10 μm. The layer dispensing mechanism can provide a (e.g., substantially) uniform height (e.g., powder uniformity height such as FIG. 30, 3066) across the exposed surface of the material bed, such a height (e.g., thickness) variation of the layer may be at most about 60%, 50%, 45%, 40%, 35%, 30%, 25%, 20%, or less from a central tendency of the layer height, e.g., from an average, mean, or median of the layer height. The layer dispensing mechanism may dispense a layer of starting material having an exposed surface that has a central tendency of planarity (e.g., an Ra) value (e.g., a deviation from a horizontal plane) of at most about 150 μm, 130 μm, 100 μm, 70 μm, 50 μm, 40 μm, 30 μm, 20 μm, 10 μm, 5 μm, or less. The layer dispensing mechanism may dispense a layer of starting material having an exposed surface that has a central tendency of planarity (e.g., an Ra) value between any of the afore-mentioned values (e.g., from about 5 μm to about 150 μm, from about 5 μm to about 50 μm, from about 30 μm to about 100 μm, or from about 100 μm to about 150 μm). The layer dispensing mechanism can dispense a layer having a central tendency of layer thickness (e.g., layer height) of at least about 10 microns (μm), 20 μm, 30 μm, 40 μm, 50 μm, 100 μm, 150 μm, 200 μm, 250 μm, 300 μm, 350 μm, 400 μm, 450 μm, 500 μm, or more. The central tendency of layer thickness (e.g., layer height) of material dispensed in a layer of material can be between any of the afore-mentioned amounts (e.g., from about 10 μm to about 500 μm, from about 100 μm to about 500 μm, from about 10 μm to about 100 μm, from about 10 μm to about 500 μm). A central tendency may comprise mean, median, or mode. The mean may comprise a geometric mean. The time taken to dispense a layer of material can be at least about 0.1 seconds (sec), 0.2 sec, 0.3 sec, 0.5 sec, 1 sec, 2 sec, 3 sec, 4 sec, 5 sec, 8 sec, 9 sec, 10 sec, 15 sec, or 20 sec. The time taken to dispense a layer of material having an FLS (e.g., height or thickness) of any of the aforementioned values can be between any of the afore-mentioned times (e.g., from about 0.1 seconds to about 20 seconds, from about 0.2 seconds to about 1 second, from about 3 seconds to about 5 seconds, from about 0.5 seconds to about 20 seconds). The speed of movement of the layer dispensing mechanism during operation, e.g., during dispense of material onto a target surface, can range from about 25 millimeters/second (mm/sec) to about 1200 mm/sec. The speed of movement of the layer dispensing mechanism during operation can be at least about 25 mm/sec, 35 mm/sec, 50 mm/sec, 200 mm/sec, 500 mm/sec, 800 mm/sec, 1000 mm/sec, 1200 mm/sec or more. The speed of movement of the layer dispensing mechanism during operation can be between any of the afore-mentioned speeds (e.g., from about 25 mm/sec to about 500 mm/sec, from about 50 mm/sec to about 1000 mm/sec, or from about 35 mm/sec to about 1200 mm/sec). The layer dispensing mechanism may include any layer dispensing mechanism and/or material (e.g., powder) dispenser used in 3D printing such as. Examples of 3D printing systems, apparatuses, devices, and components (e.g., layer dispensing mechanisms), controllers, software, and 3D printing processes can be found in International Patent Application Serial No. PCT/US17/60035, filed Nov. 3, 2017; in International Patent Application Serial No. PCT/US22/16550, filed Feb. 26, 2022; and in International Patent Application Serial No. PCT/US17/39422 filed on Jun. 27, 2017, each of which is entirely incorporated herein by reference.

In some embodiments, the layer dispensing mechanism (e.g., layer dispenser) includes a material dispensing mechanism (e.g., a material dispenser) and a material removing mechanism (e.g., a material remover). The layer dispensing mechanism may be devoid of a leveler, e.g., devoid of a leveling knife. The dispenser may dispense a first layer having a first central tendency of planarity (e.g., a first Rₐ value) and a second central tendency of layer thickness. The remover may remove a portion of the material from the first layer resulting in a second layer having a third central tendency of planarity (e.g., a second Ra value) and a fourth central tendency of layer thickness. The fourth central tendency of layer thickness of the second layer may be smaller (e.g., thinner) than the second central tendency of layer thickness of the first layer, e.g., the second layer is thinner than the first layer. The third central tendency of planarity of the second layer may be smaller than the first central tendency of planarity of the first layer, e.g., the second layer is more planar than the first layer. For example, the second Rₐ value of the second layer may be smaller than the first Rₐ value of the first layer, e.g., the second layer is less rough than the first layer. At times, a first a central tendency of planarity (e.g., first Rₐ value) of an exposed surface of the material bed after depositing the first layer, is larger than a third a central tendency of planarity (e.g., second Rₐ value) of an exposed surface of the material bed after removal of a portion of the material from the first layer to form the second layer. The central tendency of planarity may comprise a central tendency of a standard deviation, root-mean-square (RMS) roughness, peak-to-valley height, or the like, of the layer. For example, a third central tendency of planarity (e.g., second Rₐ value, or second Rz value) of an exposed surface of the material bed after removal of a portion of the material from the first layer to form the second layer is at most about 20%, 30%, 40%, 50%, 60%, or 70% of the first central tendency of planarity (e.g., first Rₐ value, or first R_{z} value respectively) of the exposed surface of the material bed after depositing the first layer. For example, a third central tendency of planarity of an exposed surface of the material bed after removal of a portion of the material from the first layer to form the second layer, is smaller than a difference between (i) a fourth central tendency of the second thickness of the second layer and (ii) a second central tendency of first thickness of the first layer. For example, a third central tendency of planarity of an exposed surface of the material bed after removal of a portion of the material from the first layer to form the second layer is disclosed above for the layer of starting material dispensed by the layer dispensing mechanism.

In some embodiments, the layer dispensing mechanism includes a material dispensing mechanism (e.g., a dispenser) and a material remover (e.g., a remover). A first volume of pre-transformed (e.g., starting) material may be deposited in the enclosure by the material dispensing mechanism and a second volume of pre-transformed material may be removed from the enclosure by the material remover. For example, a second volume of removed material by the remover is at least about 45%, 50%, 75%, 80%, 90%, 95%, 97%, or 99% of the dispensed first volume of pre-transformed material. For example, a difference (e.g., Δ=L₂−L₁) between a fourth central tendency of thickness of the second layer (L₂) and a second central tendency of thickness of the first layer (L₁) can be from about 10 microns (μm) to about 800 μm. The difference between a fourth central tendency of thickness of the second layer (L₂) and a second central tendency of thickness of the first layer (L₁) can be at most about 800 μm, 750 μm, 500 μm, 450 μm, 250 μm, 150 μm, 100 μm, 50 μm, 10 μm, or less. Examples of 3D printing systems, apparatuses, devices, and components (e.g., material dispensing mechanisms and material removal mechanisms), controllers, software, and 3D printing processes can be found in International Patent Application serial number PCT/US15/36802 filed on Jun. 19, 2015, titled “APPARATUSES, SYSTEMS AND METHODS FOR THREE-DIMENSIONAL PRINTING”; in U.S. patent application Ser. No. 15/374,318, filed Dec. 9, 2016; and in patent application serial number PCT/US16/66000 filed on Dec. 9, 2016, titled “SKILLFUL THREE-DIMENSIONAL PRINTING”; each of which is incorporated herein in its entirety.

In some embodiments, the 3D object(s) are printed from a material bed. The FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m or 5 m. The FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The FLS of the material bed can be between any of the afore-mentioned values (e.g., from about 50 mm to about 5 m, from about 250 mm to about 500 mm, from about 280 mm to about 1 m, or from about 500 mm to about 5 m). In some embodiments, the FLS of the material bed is in the direction of the gas flow. The layer dispensing mechanism may include components comprising a material dispensing mechanism, material leveling mechanism, material removal mechanism, or any combination or permutation thereof.

### EXAMPLES

The following are illustrative and non-limiting examples of methods of the present disclosure.

### Example 1

In a 25 cm by 25 cm by 30 cm container at ambient temperature and pressure, Inconel 718 powder of average particle size 32 m is deposited in a container accommodating a powder bed. The container is disposed in an enclosure at ambient temperature and pressure. The enclosure is purged with Argon gas (Ar) for 5 min. Above the exposed surface of the powder bed, a planar layer of powder material with an average height of 0.05 mm was placed in the container accommodating a powder bed. A 200 W fiber 1060 nm laser beam fabricated a (e.g., substantially) flat surface that was anchorlessly suspended in the powder bed as follows: The exposed surface of the powder bed was irradiated with a defocused Gaussian spot of cross section diameter 0.4 mm for about 100 milliseconds to form a first tile of molten powder. After forming the first tile, the laser beam moved away to another spot on the powder bed that was far away from the tile. After more than 5 seconds (e.g., the intermission), the laser beam returned to the vicinity of the first tile, to form a second tile of molten powder. During the intermission, the molten material of the first tile cooled down. The distance between the centers of the first and second tiles ranges from about 0.1 mm to about 0.2 mm, forming overlapping tiles. The rectangular 3D object having one layer was fabricated by successively forming such tiles. The rectangular 3D object (box) measured 8 mm by 20 mm having a high as depicted in FIG. 30A. The 3D object was vertically cross sectioned, and a portion of its vertical cross section was imaged by a 2 Mega pixel charge-coupled device (CCD) camera, which portion of its vertical cross section is shown in the example in FIG. 30A.

### Example 2

Following the layer formed in Example 1, a second planar layer of powder material was deposited on the exposed surface of the powder bed (comprising the one layered 3D object), at ambient temperature and pressure, under Argon. The deposited planar powder layer had an average height of 0.05. The 200 W fiber 1060 nm laser beam fabricated a (e.g., substantially) flat surface on the first layer in Example 1, to form a second layer as part of the 3D object, which 3D object was anchorlessly suspended in the powder bed as described above for forming the first layer. The rectangular 3D object was fabricated by successively forming such tiles. A portion of the second layer deposited on the first layer is shown in the top view of FIG. 22, 2250. Tiles forming the second layer are shown in 2270, which second layer is disposed on the first layer 2260. The rectangular 3D object (box) measured 8 mm by 20 mm having a high as depicted in FIG. 30A. The 3D object was vertically cross sectioned, and portion of its vertical cross section was imaged by the 2 Mega pixel CCD camera, which portion of its vertical cross section is shown in the example in FIG. 30B.

### Example 3

Following the layer formed in Example 2, a third planar layer of powder material was deposited on the exposed surface of the powder bed (comprising the one layered 3D object), at ambient temperature and pressure, under Argon. The deposited planar powder layer had an average height of 0.05. The 200 W fiber 1060 nm laser beam fabricated a (e.g., substantially) flat surface on the second layer in Example 2, to form a third layer as part of the 3D object, which 3D object was anchorlessly suspended in the powder bed as described above for forming the second and first layer. The rectangular 3D object was fabricated by successively forming such tiles. The rectangular 3D object (box) measured 8 mm by 20 mm having a high as depicted in FIG. 27. The 3D object was vertically cross sectioned, and a portion of its vertical cross section was imaged by the 2 Mega pixel CCD camera, which portion of its vertical cross section is shown in the example in FIG. 27, 2710.

### Example 4

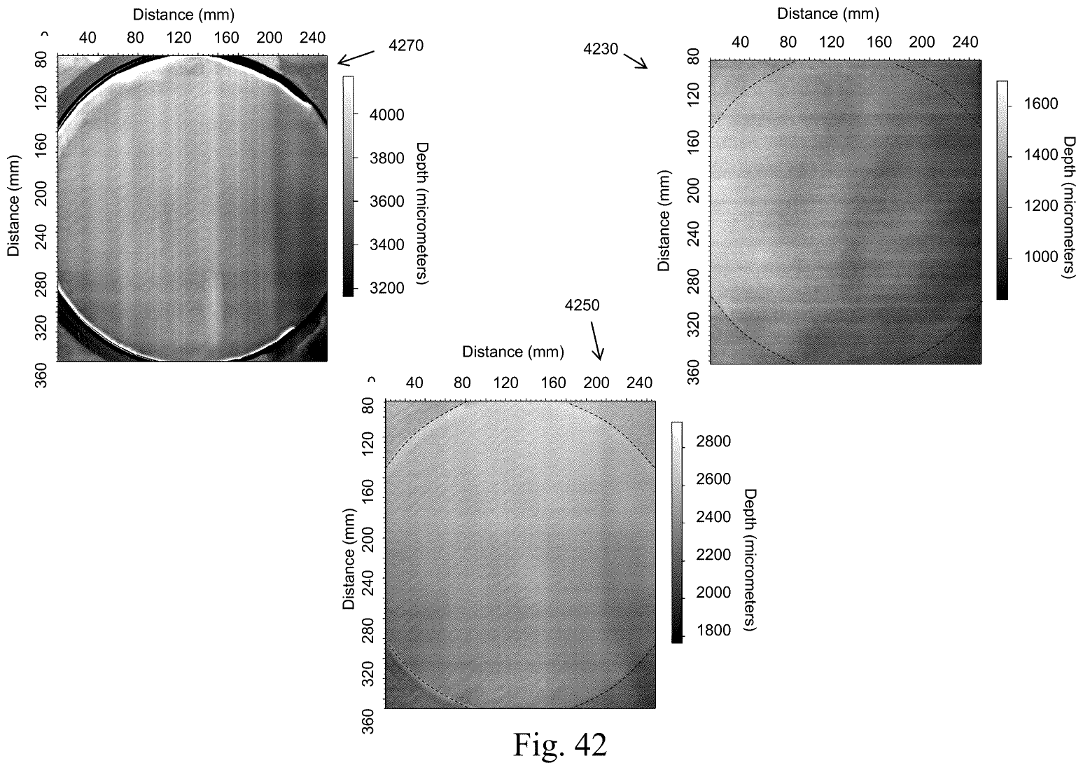

In a processing chamber, Copper alloy C18150 powder having a diameter distribution of from about 15 micrometers to about 53 micrometers was dispensed by a material dispensing mechanism, the powder being dispensed above a build plate having a diameter of about 350 millimeters (mm), to generate a first layer of powder having a first height of about 1860 μm and a first average roughness (e.g., Ra value) of at most about 8 μm. The processing chamber was under an atmosphere that is less reactive with the powder than the ambient atmosphere external to the processing chamber. The internal processing chamber atmosphere comprised argon, oxygen, and humidity. The oxygen as at a concentration of at most about 1000 ppm, and the humidity had a dew point of from about −55° C. to about −15° C. degrees Celsius (° C.). The internal processing chamber atmosphere had a pressure of about 19 Kilo Pascals (KPa) above atmospheric pressure (e.g., above 101 KPa), and was at an ambient temperature. A leveling mechanism was subsequently employed to planarized an exposed surface of the first layer. Thereafter, a material removal mechanism having a body similar to the one in FIG. 39, 3930 (having a body comprising aluminum) was employed to remove a portion of the first layer to generate a second layer having a second average height of about 1045 μm that is smaller than the first height; and a second roughness (as an Ra value) of about 17 μm. The material removal mechanism was coupled to a vacuum pump, and the pressure differential within the material remover was about 15 KPa. The distance between an exposed surface of the first layer, and a tip of the material removal mechanism, was about 200 μm. The average height of the first layer removed to generate the second layer, was about 1100 μm. The material remover mechanism translated laterally across the build platform at a speed of about 150 millimeters per second (mm/sec). The rate of powder removal by the powder remover mechanism was from about 14 milliliter per second (ml/sec). The exposed surface was detected using a metrology detection system (height mapper) as depicted in FIG. 42, 4230 showing relative distances of the exposed surface of a material bed disposed on the circular build plate (in millimeters), as a function of height variation indicated in micrometers.

### Example 5

In a processing chamber, Inconel-718 powder having a diameter distribution of from about 15 micrometers to about 45 micrometers was dispensed by a material dispensing mechanism, the powder being dispensed above a build plate having a diameter of about 350 mm, to generate a first layer of powder having a first height and a first average roughness (e.g., Ra value) of about 30 μm. The processing chamber was under an atmosphere that is less reactive with the powder than the ambient atmosphere external to the processing chamber. The internal processing chamber atmosphere comprised argon, oxygen, and humidity. The oxygen as at a concentration of at most about 1000 ppm, and the humidity had a dew point from about −55° C. to about −15° C. The internal processing chamber atmosphere had a pressure of about 16 KPa above atmospheric pressure (e.g., above 101 KPa), and was at ambient temperature. In this example, a leveling mechanism was not employed to planarized an exposed surface of the first layer. After the operation of the dispensing mechanism, a material removal mechanism having a body similar to the one in FIG. 39, 3950 (having a body comprising aluminum) was employed to remove a portion of the first layer to generate a second layer having a second average height of about 50 μm that is smaller than the first height; and a second roughness (as an Ra value) of about 20 μm that is smaller than the first roughness. The material removal mechanism was coupled to a vacuum pump, and the pressure differential within the material remover was about 15 KPa. The distance between an exposed surface of the first layer, and a tip of the material removal mechanism, was about 200 μm. The average height of the first layer removed to generate the second layer, was about 250 μm. The material remover mechanism translated laterally across the build platform at a speed of about 100 mm/sec. The rate of powder removal by the powder remover mechanism was from about 3 milliliter per second (ml/sec) to about 3.5 ml/sec. The exposed surface was detected using a metrology detection system (height mapper) as depicted in FIG. 42, 4530 showing relative distances of the exposed surface of a material bed disposed on the circular build plate (in millimeters), as a function of height variation indicated in micrometers, with edges of the material bed are illustrated with dotted lines.

### Example 6

In a processing chamber, Inconel-718 powder having a diameter distribution of from about 15 micrometers to about 45 micrometers was dispensed by a material dispensing mechanism, the powder being dispensed above a build plate having a diameter of about 350 mm, a first layer of powder having a first height and a first average roughness (e.g., Ra value) of about 30 μm. The processing chamber was under an atmosphere that is less reactive with the powder than the ambient atmosphere external to the processing chamber. The internal processing chamber atmosphere comprised argon, oxygen, and humidity. The oxygen as at a concentration of at most about 1000 ppm, and the humidity had a dew point from about −55° C. to about −15° C. The internal processing chamber atmosphere had a pressure of about 16 KPa above atmospheric pressure (e.g., above 101 KPa), and was at ambient temperature. In this example, a leveling mechanism was not employed to planarized an exposed surface of the first layer. After the operation of the dispensing mechanism, a material removal mechanism having a body similar to the one in FIG. 39, 3970 (having a body comprising aluminum) was employed to remove a portion of the first layer to generate a second layer having a second average height of about 50 μm that is smaller than the first height; and a second roughness (as an Ra value) of about 20 μm that is smaller than the first roughness. The material removal mechanism was coupled to a vacuum pump, and the pressure differential within the material remover was about 15 KPa. The distance between an exposed surface of the first layer, and a tip of the material removal mechanism, was about 200 μm. The average height of the first layer removed to generate the second layer, was about 250 μm. The material remover mechanism translated laterally across the build platform at a speed of about 100 mm/sec. The rate of powder removal by the powder remover mechanism was about 3.5 ml/sec. The exposed surface was detected using a metrology detection system (height mapper) as depicted in FIG. 42, 4570 showing relative distances of the exposed surface of a material bed disposed on the circular build plate (in millimeters), as a function of height variation indicated in micrometers, with edges of the material bed are illustrated with dotted lines.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A device for three-dimensional (3D) printing, the device comprising:
a first body side having a contacting surface; and
a second body side coupled with the first body side along the contacting surface to form (i) a nozzle, (ii) a channel in the nozzle, and (iii) a cavity coupled to the channel of the nozzle, the cavity having a long axis, the first body side and the second body side being asymmetrically related to each other,
the device being a portion of a layer dispensing mechanism configured to layerwise generate a material bed comprising pre-transformed material, wherein at least a portion of the pre-transformed in the material bed is being transformed to print at least one 3D object during the 3D printing,
the device being configured to, during use, attract the pre-transformed material from the material bed (a) into the nozzle through the channel and into the cavity, (b) in a direction opposing a gravitational vector pointing towards a gravitational center of an ambient environment external to the device, (c) while moving the device in a first lateral direction along an exposed surface of the material bed, (d) without the device contacting the exposed surface of the material bed, and (e) to generate the exposed surface that is planar.

2. The device of claim 1, wherein the first body side and the second body side are asymmetrically related to each other at least in part by the first body side comprising (I) a mount disposed above the nozzle during use of the device, the mount being configured to couple to one or more components to facilitate movement of the device along the first lateral direction during use of the device, above being in a direction opposing the gravitational vector, (II) an opening disposed asymmetrically along the long axis of the cavity, the opening being configured to allow evacuation of the pre-transformed material from the cavity during use of the device, the opening facing the first lateral direction of the movement of the device during use, or opposing the first lateral direction of movement of the device during use, and during use of the device the long axis is disposed along a second direction different from the first direction and different from the gravitational vector; or (III) a combination of (I) and (II).

3. The device of claim 2, wherein during use of the device, the first body side comprising the mount; and
optionally wherein the mount is a skeletal mount.

4. The device of claim 2, wherein the one or more components are one or more first components, wherein the second body side is devoid of (I) the mount, (II) another mount coupled to one or more second components to facilitate movement of the device along the first lateral direction during use of the device, (III) the opening, (IV) another opening configured to facilitate evacuation of the pre-transformed material from the cavity during use of the device, or (V) any combination thereof.

5. The device of claim 2, wherein the first body side comprises the opening disposed asymmetrically along the long axis of the cavity.

6. The device of claim 5, wherein during operation of the device, the long axis is disposed at an angle formed with a plane perpendicular to the gravitational vector, the angle being an acute angle.

7. The device of claim 1, wherein during operation of the device, the long axis is disposed at an angle formed with a plane perpendicular to the gravitational vector, the angle being an acute angle.

8. The device of claim 2, wherein the mount is disposed along a first portion of the long axis of the cavity, and the opening is disposed along a second portion of the long axis of the cavity; and optionally wherein the first body side is a leading side along the first lateral direction during the removal.

9. The device of claim 1, wherein upon use of the device, (a) the first body side comprises a first external surface configured to face the exposed surface of the material bed and form the first angle with a plane, and (b) the second body side comprises a second external surface configured to face the exposed surface of the material bed and form the second angle with the plane, each of the first angle and the second angle having a value from about 10 degrees to about 85 degrees, the plane being perpendicular to the gravitational vector;
and optionally wherein each of the first angle and the second angle has a value from about 10 degrees to about 30 degrees.

10. The device of claim 1, wherein the material bed comprises deposited layers of the pre-transformed material; and wherein the device is configured to generate the exposed surface having a planarity, the planarity having a height variation of at most about 60% from a central tendency of heights of the deposited layers; and optionally wherein the layer dispensing mechanism is devoid of a leveling knife.

11. The device of claim 1, wherein the device is configured to generate the exposed surface at a speed of movement of at least about 25 millimeters/second (mm/sec); and optionally wherein the device is configured to generate the exposed surface at a speed of movement of at least about 60 millimeters/second (mm/sec).

12. The device of claim 1, wherein the device is configured to attract the pre-transformed material (I) comprising a powder material, (II) comprising an elemental metal, a metal alloy, a ceramic, or an allotrope of elemental carbon, or (III) a combination of (I) and (II).

13. The device of claim 1, wherein the direction being a first direction; and wherein the cavity comprises an end extending in a second direction beyond the channel of the nozzle, the second direction begin different from the second direction and different from the gravitational vector; and optionally wherein the second direction is perpendicular, or substantially perpendicular, to the first direction and to the gravitational vector.

14. The device of claim 1, wherein the device is configured to attract the pre-transformed material from the material bed substantial uniformly along (i) an interior of the channel of the nozzle, (ii) an entrance port of the channel of the nozzle, or (iii) any combination of (i) and (ii).

15. The device of claim 14, wherein the device is configured to attract the pre-transformed material substantially uniformly along the entrance port of the channel of the nozzle; and optionally wherein the entrance port spans a fundamental length scale of the material bed.

16. The device of claim 14, wherein the device is configured to attract the pre-transformed material from the material bed substantial uniformly along the interior of the channel of the nozzle.

17. The device of claim 1, wherein (I) the device is configured to operatively couple to a tiling energy beam configured to for the three-dimensional printing comprising tiling, (II) the device comprises, or is operatively coupled with, a cyclonic separator configured to separate the pre-transformed material during use of the device, (IV) the layer dispensing mechanism comprises a material dispenser or a material leveler, (V) the device comprises, or is operatively coupled with, compliant mounting, (VI) the device is configured to evacuate the pre-transformed material from the cavity along a second direction, or (VII) the device comprises, or is operatively coupled with, an energy source, a scanner, or the scanner and the energy source, the scanner being configured to direct an energy beam to impinge on the material bed during the three-dimensional printing to transform the pre-transformed material to the transformed material that forms at least a portion of the at least one 3D object, the energy source being configured to generate the energy beam, the energy source, the scanner, or the energy source and the scanner, being controlled based at least in part on a physics simulation, or (VIII) any combination of (I) (II) (III) (IV) (V) (VI) and (VII); and optionally wherein the physics simulation consider thermal and/or material properties comprising (i) physical properties of the pre-transformed material, (ii) physical properties of the transformed material, or (iii) physical properties of a transformation of the pre-transformed material, or (iv) any combination of (i) (ii) and (iii).

18. A method of the three-dimensional printing, the method comprising: (a) providing the device of claim 1, and (b) using the device for the 3D printing.

19. An apparatus for the 3D printing, the apparatus comprising at least one controller configured to: (I) couple with a power source and operatively couple with the device of claim 1; and (II) direct the device to execute one or more operations associated with the device to facilitate the three-dimensional printing.

20. Non-transitory computer readable program instructions, the non-transitory computer readable program instructions, when read by one or more processors operatively coupled to the device of claim 1, cause the one or more processors execute one or more operations associated with the device for the 3D printing, the program instructions being inscribed on one or more media.
